(19) United States
(12) Patent Application Publication
(10) Pub. No.: US 2019/0334907 A1
(43) Pub. Date: Oct. 31, 2019

(54) RESOURCE OPTIMIZATION SYSTEM AND METHOD

(71) Applicant: Steelcase Inc., Grand Rapids, MI (US)

(72) Inventors: Steve Rodden, Sherwood, OR (US); Darrin Sculley, Byron Center, MI (US); William Scott Sadler, Grand Rapids, MI (US); Robert Scheper, Grand Rapids, MI (US)

(21) Appl. No.: 16/394,743

(22) Filed: Apr. 25, 2019

Related U.S. Application Data
(60) Provisional application No. 62/662,622, filed on Apr. 25, 2018.

(51) Int. Cl. H04L 29/06

(52) U.S. Cl. CPC H04L 63/10; G06F 9/50; H04L 63/0861

(57) ABSTRACT

A system and method for helping a user optimize time use during transition times between scheduled activities, includes the steps of maintaining a schedule database including at least first and second consecutive scheduled activities for a first system user with a transition period between the first and second consecutive scheduled activities, during the transition period subsequent to the first activity and prior to commencement of the second activity, detecting at least a first trigger set of circumstances, upon occurrence of the trigger set of circumstances, automatically identifying a secondary activities set including at least first and second secondary activities that may be initiated during the transition period, presenting the secondary activities set to the first user via at least one affordance, receiving selection from the user of at least one of the secondary activities from the activities set and facilitating the selected secondary activity via at least one affordance.

### CROSS-REFERENCE TO RELATED APPLICATIONS

This application claims the benefit of U.S. Provisional patent application Ser. No. 62/662,622 filed on Apr. 25, 2018 and entitled “Resource Optimization System and Method” and is incorporated herein by reference.

### STATEMENT REGARDING FEDERALLY SPONSORED RESEARCH OR DEVELOPMENT

Not applicable.

### BACKGROUND OF THE DISCLOSURE

The field of the disclosure is related to personal assistant systems and method for supporting user activities and more specifically to systems and methods that help user's optimize their activities essentially all the time given responsibilities, preferences and dynamic personal, environmental, and group factors.

Most people know the feeling they get when they have a great day full of energy, accomplishment and balanced between work and extracurricular activities (e.g., social with family and/or friends, physical exercise, entertainment, spiritual, etc.). Most people also have suffered less than optimal days where energy level is low, effectiveness seems diminished and a sense of balance is simply unattainable. Despite naturally wanting and striving for all great days, that goal is usually simply out of reach for most people.

Usually inability to consistently have great days is because our days or even longer periods of time (e.g., a week) are simply not balanced in a way that is consistent with our personal values, goals and conditions. In short, people's days are filled with too much of one thing or a small subset of things and not enough of the others. Sometimes a day is filled with too much work at the expense of sleep. Sometimes work activities are filled with too many meetings and no time to complete necessary individual work. Many people do not get enough exercise despite best intentions to-do so. Sometimes people get too much exercise and then are literally exhausted. While imbalance is necessary at times (e.g. to prepare for a big new product launch, to deal with unexpected emergencies, etc.), most of the time and over time imbalance is unhealthy, counterproductive, inefficient, unrewarding, and even destructive.

While most people know in hindsight when they have good days and bad days, most people are not good at figuring out why one day was great and another day was not so good for several reasons. First, most people simply do not understand all of the parameters that factor into the quality of their days. In this regard, while people generally know that some things like more sleep, better exercise routines, balance between work and extracurricular activities and some optimal level of stress (hereinafter “quality factors”) are important to their home and work happiness, many other less familiar factors play a role in how a person feels about her day. For instance, work environment (e.g., whether a person works from home or at an employer's facility, when at a facility, whether a person works in a quiet location or a high traffic location, who a person works near, etc.) can have a profound effect on a person's stress level, on the person's actual and perceived productivity, on a person's ability to engage in extracurricular activities, etc. As another instance, weather, traffic, news feeds and other “environmental” conditions can have a big effect on stress level in many cases. Many other life quality factors exist and are simply unrecognized or misperceived by many people.

Second, while people generally have some idea that sleep, exercise, balance and stress levels are important life quality factors, most people have no idea what their personal optimal levels of even these very intuitive factors should be. To this end, there is no one “size fits all” recipe for success when it comes to optimal life quality factors. Thus, for instance, a first person may thrive on 6 hours of sleep a night while a second person needs at least eight hours to be effective. As another instance, a first extroverted person may be energized by consecutive high energy meetings while a second introverted person may find consecutive meetings without any personal intervening rejuvenation time draining. As one other instance, a first person may benefit from periodic periods of reading the news throughout a day as a form of relaxation while a second person finds that type of activity to be distracting and stress inducing which reduces overall productivity during intervening periods. Most people are simply unclear about how to best balance even the most basic quality factors of their lives.

Third, many people misperceive the effects that certain activities have on their overall wellbeing. For instance, some people may be drawn to breaking news throughout a typical day. Here, while a person watching the news may consider the news entertainment and therefore may believe that news watching relieves stress, in fact, news watching may appreciably increase that person's stress level. As another instance, a person may think that trying to complete one more task prior to leaving her workstation for a meeting is efficient and optimal in some way without appreciating how that activity and the associated rush to get to her next meeting will affect her stress level and ability to fully participate in their next meeting and their colleague's that attend that next meeting. Thus, while a person may think she achieves optimality by her decisions throughout a day, week or longer period, in fact she may be completely unbalanced and therefore appreciably less effective in all daily activities.

Fourth, even if a person understood how to optimally balance their personal life quality factors, in most cases people simply do not have the ability to accurately track information required to assess optimality, how the factors are affecting them in the moment, and guide them toward better decisions. For instance, for a single person, sometimes stress is exhilarating while at other times it is exhausting. Given that stress makes us feel differently at different times, people have difficulty accurately measure stress and how it impacts their happiness, effectiveness, etc.? As another instance, all sleep is not equal so that eight hours of sleep with two restful REM cycles may be restful one night while eight hours a second night may be agitated so that its effect may be more akin to four hours than eight.

Fifth, in most cases life quality factors cannot be looked at on a factor by factor basis in a vacuum and, instead, each factor plays a role in how we are affected by the other factors we experience. For instance, a well-rested person can often deal more effectively with high stress than if that same person were sleep deprived. As another instance, many people sleep more soundly when they participate in a healthy exercise regimen. As still one other instance, most people sleep better when their stress level is minimal.

Exacerbating the complexity of how factors affect each other, at least some future conditions and circumstances have an effect on current factors. For instance, a person's stress level at night and their sleep efficacy is often affected by their schedule the following day. In this regard, if a person has four important meetings on Tuesday morning, for instance, that schedule may affect the person's sleep quality Monday night. Exacerbating the complexity of how factors affect each other even more, at least some future factors have an effect on other future factors. For instance, an hour of free time and an hour of exercise between two important meetings tomorrow may reduce overall stress appreciably for some people tomorrow. In effect, each person is a “cocktail” of their past, present, and at least their near term future where many life quality factors are intricately weaved together and affect each other in complex ways. While some intersecting effects are intuitive, others simply are not so that people have a difficult time distilling how combinations of factors affect overall balance and optimality.

Sixth, for many people each day is very different so that what works one day may not work the next day. For instance, a person may have six important meetings on Tuesday and only one meeting each morning on Wednesday and Thursday. Here, ideally more sleep or exercise may be important on Monday evening than on Tuesday or other evenings to adequately prepare for the busy Tuesday schedule.

Seventh, most people experience unexpected events and other circumstances that affect life quality factors in unforeseen ways. For example, late Monday night, an emergency meeting may be called by a person's colleague for early Tuesday morning and she may only learn of the meeting when she wakes up on Tuesday morning which throws off her morning routine and perhaps the rest of her day. As another example, on Tuesday evening, despite only one Wednesday morning meeting, a person may not sleep well due to a series of events in her personal life so that her ability to deal with stress and effectively participate in her morning meeting on Wednesday is substantially degraded. As yet one more example, on Thursday morning an unexpected snow storm may result in a two hour morning commute to work that throws off schedules, increases stress appreciably and results in a missed physical workout which in turn results in a higher overall stress level.

Eighth, many people schedule or participate in activities in response to offers from other people and know that they have to take into consideration schedules associated with other resources needed to accomplish various activities. Thus, for instance, a first person may receive a request at a specific time and at a specific location from her boss that invites ten other people to a meeting where the meeting time and place were selected based on existing availability of invitees as reflected in their schedules. Here, despite feeling anxious about accepting another time commitment in an already busy schedule (e.g., an innate sense of poor life quality associated with another commitment), the first person may accept the meeting invitation to accommodate the schedules of the other invitees and other required meeting resources. Here, while uneasy about her decision to accept the meeting invitation, the first person may simply not be able to marshal a clear reason why she should not accept the meeting when in fact a different time may be more suitable and result in higher quality participation.

As another instance, after a work day and while at home, many people will field calls from colleagues regardless of what they are doing and who they are with when a call comes in. For example, a person may leave dinner with her family to field a call that could have been handled after dinner while checking for communications prior to turning in for the evening. As another example, many people will receive and respond to work related e-mails while watching a football game or some other favorite show instead of fully relaxing and getting the maximum benefit out of their free time. In some cases and at some times that type of dedication makes sense but, at other times, that type of attention can have adverse consequences, especially in the case of an employee that is simply exhausted from recent work, personal or other activities.

Ninth, most people unintentionally tolerate “noisy” environments that are filled with distractions including in person encounters with other people, notifications like e-mails, voice mails, texts, news feeds, etc. and other distractions. While a small fraction of these distractions are necessary and even important at times, unfortunately, most people do not distinguish necessary and important distractions from others and instead, generally tolerate all of these types of distractions based on the few that are important or necessary. Unnecessary distractions reduce efficiency and effectiveness much more than people perceive. Even in the case of necessary or important distractions, in most cases those distractions occur at unnecessary times and cause needless resource (e.g., user time) utilization disruptions. Over time people become accustomed to needless or mistimed disruptions and their adverse effects on efficiency and no longer even perceive their negative effects.

Some solutions that attempt to align our use of time with our goals have been developed for small scale use in specific environments. For instance, people perform exercise “routines” in which they move from one exercise to another in a specific sequence. Here, while an exercise routine may only last an hour, routines are typically optimally developed by trained professionals for specific clients based on the client's specific body type, current fitness level and time commitment. As another instance, recognizing the importance of different postures during work activities, height adjustable “smart” workstations have been developed that track user sit and stand periods and provide periodic reminders to a user to change from sitting to standing and vice versa, while at the workstation.

While time and activity optimization in specific environments and during specific time durations can be advantageous, unfortunately, such optimization is typically done in a vacuum without accounting for other factors that precede and follow a person's time in the specific environment. The problem here is that, when considering optimal use of time, all hours are not created equal and how they should be optimally used is typically related to past and future life quality factors which, at best, for most people, minimally effect time use decisions. For instance, where a person stands for three hours at a convention prior to arriving at a smart workstation, it may make no sense for the station to encourage that person to stand after sitting for 30 minutes. In a similar case, where a person is scheduled to be at a convention for three hours in the afternoon where that person will likely be standing and walking most of the time, it may make no sense for the user's workstation to encourage that person to alternate between sitting and standing during morning work activities.

As another instance, where a person's schedule is open for appointments on Wednesday morning, if that person sleeps poorly on Tuesday evening, a sleep life quality factor may mean that that person would be better served by sleeping in on Wednesday morning instead of having an early Wednesday impromptu meeting scheduled just because her schedule is “open”. Here, all other things being equal, a Wednesday morning hour is not the same as an open Wednesday afternoon hour for the purposes of scheduling the impromptu meeting. Here, of course, not all other things are equal and in most cases, many other factors have an impact on how best to schedule any activity for any time slot in a person's day.

As another instance, in many cases people schedule recurring activities during a week, month, or other time periods where the only factors considered when selecting the activity times is the duration since the last time they participated in the activity and availability of the activity times generally. For instance, many people schedule recurring exercise activities on specific days and at specific recurring times of the week such as, for instance, every Monday and Thursday from 5 PM to 6 PM. As another instance, many people will schedule specific recurring work meetings like a meeting with a supervisor at the same time every week (e.g., every Tuesday at 9 AM) or month.

In these and other similar cases, recurring activities are pre-scheduled well in advance and irrespective of other factors that will occur temporally proximate (e.g., before and/or after) those activities that will impact a person's readiness to fully engage and participate. For example, assume a person has a full schedule all day on Tuesday so that it is foreseeable that she will be physically exhausted by the time a pre-scheduled recurring five o'clock workout session is to commence. In this case, should the person drag herself to her fitness club and participate halfheartedly in her typical workout session or should that session occur at a different time such as, for instance, the next morning or, alternatively, should she participate in some other less demanding exercise regimen designed to minimize stress while still affording some benefits associated with her typical workout routine? Similar questions are applicable to any recurring meeting activity where the impact of other life quality factors cannot be understood well in advance when activities are scheduled.

In many cases, similar questions are applicable to any meeting or other activity that is pre-scheduled well in advance where it is impossible to know how most life quality factors will affect the prudence of scheduling specific activities at specific times. For instance, a person may schedule a meeting with a colleague for 10 AM on Tuesday three weeks from now. In this case, how can the person scheduling the meeting know how any life quality factors will affect which open schedule time slot three weeks from now will be optimal for the meeting? How can a person know how well they will sleep three weeks from now the night before the scheduled meeting time slot or how many meetings or other activities the person will have on her schedule before or after the considered time? The answer is that the person simply cannot know the optimal time slot for a specific meeting weeks in advance.

As in the case of an individual, other resources that a person needs throughout her day either have their own life quality factors or can be characterized by a comparable set of quality factors that can be employed to assess use optimality. For instance, people need to interact with other people (e.g., human resources) most days and each person they interact with has his or her own set of life quality factors that affect optimality of their days. Ideally, a first person's optimized decisions and activities would mesh with the optimized decisions and activities associated with other people that the first person interacts with throughout her day. In reality, unfortunately, for the same reasons that most people cannot even optimize their life quality factors discussed above, people make decisions all the time that negatively affect other peoples' actual and perceived optimality. For instance, a first person's decision to complete one more task prior to embarking for a meeting with five other people so that the first person is 10 minutes late not only affects the first person's stress level and ability, upon arrival at the scheduled meeting place, to fully engage in the meeting, but also affects other attendee's stress levels and level of engagement. As another instance, where one person schedules a meeting with five other people based solely on “open” schedules where a first invitee already has many meetings that hem in the open time, the first invitee may grudgingly accept the invite increasing anxiety as well as setting up a situation where the first invitee will not be able to be fully engaged in the meeting.

Other resources like conference or meeting spaces can be characterized by “use quality factors” that are akin to a person's life quality factors. For instance, a simple use quality factor may be the percent of booked space time over a period for a specific conference room where excessive booking places stress on the space affordances, people that use the space and on staff that maintains the space (e.g., cleaning employees, refreshment restocking employees, IT maintenance employees, etc.). As another instance, another use quality factor may be related to how space scheduling affects employee “swirl” (e.g., interaction) in hallways or other spaces outside a meeting space that may result in impromptu business related employee interactions and relationship building. As yet one other instance, the degree to which specific resources are utilized for their intended purposes may be another use quality factor where greater intended use equates to higher optimality. For instance, where a workstation equipped with a high end telepresence system is almost always used for telepresence activities, a use quality factor may be high.

While space use is tracked in some systems and space scheduling systems sometimes guide user's to space optimized for specific uses, again, space use is typically directed based on simple available or busy schedule periods and not in a holistic manner accounting for overall space use quality factor optimality.

What is needed is a system for helping people and groups of people balance their time, activities and available resource use over days, weeks and even longer periods, in ways that are optimized based on personal life quality factors as well as quality factors associated with other people and resource use. What is also needed is a way to help people avoid participating in activities at non-optimal times.

### SUMMARY OF THE DISCLOSURE

In one aspect, the present disclosure provides a method for helping a user optimize time use during transition times between scheduled activities. The method comprises the steps of maintaining a schedule database including at least first and second consecutive scheduled activities for a first system user with a transition period between the first and second consecutive scheduled activities, during the transition period subsequent to the first activity and prior to commencement of the second activity, detecting occurrence of at least a first trigger set of circumstances, upon occurrence of the at least a first trigger set of circumstances, automatically identifying a secondary activities set including at least first and second secondary activities that may be initiated during the transition period, presenting the secondary activities set to the first user via at least one affordance, receiving selection from the user of at least one of the secondary activities from the activities set; and facilitating the selected secondary activity via at least one affordance.

In the method, the at least one affordance that presents the secondary activities set and the at least one affordance that facilitates the selected secondary activity can include the same affordances. In some embodiments, the at least one affordance used to facilitate the secondary activity includes a portable computing device.

A selected activity, further, can be facilitated via different affordance sets, the method further including the steps of, during the transition period, periodically identifying affordances within the vicinity of the user, identifying an optimal affordance set for facilitating the selected activity and, upon the optimal affordance set changing, switching from a current affordance set to the optimal affordance set to continue facilitating the selected activity. The step of switching can include automatically switching from the current affordance set to the optimal affordance set. The step of switching can also include presenting an option to the user to switch from the current affordance set to the optimal affordance set and, upon the user selecting the option to switch, switching from the current set to the optimal set.

The method can also include maintaining content associated with at least the first activity wherein at least one of the secondary activities includes options for handling the first activity content. The options for handling the first activity content may include accessing the first activity content for review. The content maintained may be associated with at least the second activity wherein at least one of the secondary activities includes options for handling the second activity content. The options for handling the second meeting content can include accessing the second activity content, and the options for handling the first meeting content and for handling the second meeting content may further include forwarding the content to another system user, deleting the content and saving the content to a database for subsequent access.

In some embodiments, at least one of the circumstances in the trigger set is related to duration of the transition period. Another trigger set circumstance may include availability of the second user to participate in a communication. The second user location may be tracked and second user availability may be determined at least in part on instantaneous location of the second user.

At least one of the trigger set circumstances can be related to at least one of the physical and cognitive condition of the first user, and the method can further include sensing biometric conditions of the first user and using that information to discern at least one of a physical or a cognitive condition of the first user. At least one of the trigger set circumstances can be related to user preferences specifying times when specific activities should be facilitated, at least one of the trigger set circumstances is related to a sensed user physical condition, at least one of the trigger set circumstances can be related to a time zone associated with where a system user is located and at least one of the trigger set circumstances is related to existence of additional content associated with at least one of the first and second activities.

At least one of a second user may have participated in the first activity or a second user may be anticipated to participate in the second activity. Further, a possible secondary activity can include contacting the second user.

The method can also include automatically monitoring information related to a second system user wherein the second activity involves the second system user, at least one of the secondary activities including consideration of the second system user information by the first user. The step of monitoring can include monitoring at least one of the second system user's schedule and a biometric condition associated with the second system user.

In another aspect, the disclosure provides a method for helping a user optimize time use during transition times between scheduled activities. The method comprises the steps of maintaining a schedule database including at least first and second consecutive scheduled activities for a first system user with a transition period between the first and second consecutive scheduled activities; detecting at least one physical or cognitive first user condition; during the transition period subsequent to the first activity and prior to commencement of the second activity, automatically identifying, based at least in part on the at least one physical or cognitive first user condition, a secondary activities set including at least first and second secondary activities that may be initiated during the transition period; presenting the secondary activities set to the first user via at least one affordance; receiving selection from the user of at least one of the secondary activities from the activities set; and facilitating the selected secondary activity via at least one affordance.

In yet another aspect, the disclosure provides a method for helping a user optimize time use during transition times between scheduled activities. The method comprises the steps of maintaining a schedule database including at least first and second consecutive scheduled activities for a first system user with a transition period between the first and second consecutive scheduled activities; detecting at least one physical or cognitive first user condition; during the transition period subsequent to the first activity and prior to commencement of the second activity, automatically identifying, based at least in part on the at least one physical or cognitive first user condition as well as the duration of the transition period, a secondary activities set including at least first and second secondary activities that may be initiated during the transition period; presenting the secondary activities set to the first user via at least one affordance; receiving selection from the user of at least one of the secondary activities from the activities set; and facilitating the selected secondary activity via at least one affordance.

In yet still another aspect, the disclosure provides a method for helping a user optimize time use. The method comprises the steps of storing a first user's schedule of activities; based at least in part on the first user's scheduled activities, automatically anticipating the first user's condition prior to occurrence of at least one of the scheduled activities; and identifying a schedule change related to the at least one of the scheduled activities that is likely to result in a more optimal first user condition.

The method may further include suggesting the schedule change to the first user and presenting an accept option to the first user to cause the schedule change to occur, upon detecting selection of the accept option, rescheduling the at least one of the scheduled activities to a different time.

The method may further include storing prior schedule activities with prior first user conditions, the step of anticipating including comparing schedule activities with the prior schedule activities to identify substantially similarity therebetween and, upon identifying substantial similarity, using the prior first user condition as the anticipated condition.

The method may further include detecting a current first user condition, the step of anticipating including anticipating based at least in part on each of the first user's scheduled activities and the current first user condition. The step of detecting a current first user condition can include detecting the user condition while the first user is sleeping. The anticipated first user condition can be less than an optimal condition for participating in the at least one of the scheduled activities. The step of detecting the current first user condition may include using a biometric sensor to detect the current first user condition. The first user condition can, for example, be related to anticipated stress level.

The method may further include automatically making the schedule change without intentional user authorization to make the change. The schedule change can includes rescheduling the at least one of the scheduled activities for a different time slot.

The at least one of the schedule activities can requires at least one additional resource, and the step of identifying a schedule change can include identifying a different time slot for the at least one of the scheduled activities during which the at least one additional resource is available. The at least one schedule change can also include rescheduling of at least the at least one of the scheduled activities and at least a second one of the scheduled activities. The rescheduling of the at least a second one of the scheduled activities can include swapping the at least a second one of the scheduled activities into the time slot originally associated with the at least one of the scheduled activities.

In addition, the disclosure provides many other concepts, systems, assemblies, features, processes, methods and combinations. A non-exhaustive partial list of subject matter supported by this disclosure follows. For example, methods in accordance with the disclosure can determine user condition, use that information along with information related to user's prior schedule and current circumstances to ID likely cause for the user's condition, and then adjust optimization software so that scheduling options include only options that will avoid similar circumstances in the future. The user condition can be received from the user, and can be detected via biometrics.

Methods and systems in accordance with the present disclosure can also present scheduling options to user for specific activities, track user selections, identify trends in user selections, and subsequently limit scheduling options presented to the user to reflect the trends. Methods in accordance with the present disclosure can also determine user's current conditions, present scheduling options for user based at least in part on user's current conditions.

Methods and systems in accordance with the present disclosure can also store a schedule including scheduled activities for a user, identify at least some anticipated circumstances for the user that are less than optimal given the user's schedule, identify better schedule options that are anticipated to result in better user circumstances. The schedule can, in at least some case, be changed automatically, or suggested to the user, and made when the change if authorized by the user. The user schedule can, further, be stored, optionally with user preferences, and with information regarding user conditions under certain circumstances. The system or method can present an anticipated week view that indicates user schedule as well as anticipated user conditions correlated with different schedule events.

Methods and systems in accordance with the present disclosure can also rank resources including people and other resources, and use those rankings to drive scheduling software to schedule activities with higher preferences prior to activities with lower preferences.

Methods and systems in accordance with the present disclosure can also specify a to do list, specify a user schedule, track a user location, or identify times when a specific to do list activities may be performed. The method or system may suggest at least one to do list activity to the user which can be, for example, dependent on where it is based on location relative some resource needed as well as duration of time until next scheduled time. The method or system may also specify aspirational meetings with, for example, a due date, track user locations of first and second users to meet and when there are plenty of options for the meeting prior to the due date, float the event until either, for example, a threshold duration to the due date occurs or until a convenient time occurs and then schedule. The method or system can also identify optimal user conditions for some activity, start to schedule the activity, and automatically locate time slots where the user's anticipated condition is optimal for the specific activity. The method or system can also present schedule to user with visual coding indicating anticipated non-optimal conditions or circumstances, select a slot, and present other options to user for rendering scheduled activities more optimal. (FIG. 14).

To “float” a meeting, a user may arrive and take a meeting space, and the system may associate the floated meeting with the space occupancy and automatically fill a schedule with the floated meeting, and automatically indicate the scheduled room via room occupancy reminder. (See, for example, FIG. 15). Many other concepts regarding floating and floating schedules that increase flexibility in user schedules to optimize scheduling can be provided to accommodate scheduling close to deadlines, resulting in better use of time, better use of resources, including human resources, and optimizing user conditions for specific activities, etc.

In some systems and methods, a preparation view (See FIG. 24) can be provided where content, agenda, role, files and other reminders are presented to a user to help preparation. In some systems and methods, the ability to track items, associate tracked items with specific activities, identify activities on a user's schedule prior to departure, identify locations of tracked items associated with the scheduled activities, and present reminders to the user to take the items can be provided. User locations and lists, such as a to do list, an aspirational list, etc., can also be tracked. Time required to complete a task or item can be estimated, along with time required to travel to next scheduled activity. The system or method can identify an opportunity to complete a list item, and indicate list item or items to a user. The user can accept the item to complete, and the system can start to process guidance to complete the item. (See, for example, FIG. 27).

The system and method of the pending disclosure can also provide a meeting view (See, for example, FIG. 28). The view can provide, for example, a graphical representation of who is present, who is not present and a duration of time until each invitee is present. The system or method can also show an anticipated departure time for each invitee based at least in part on user schedules.

The system or method can also identify information related to a recently completed meeting and provide information related to a subsequently scheduled meeting, and present the information to the user for selection.

### BRIEF DESCRIPTION OF THE SEVERAL VIEWS OF THE DRAWINGS

FIG. 1A is a schematic view of an optimization system that is consistent with at least some aspects of the present disclosure;

FIG. 1B shows the employer enterprise section of the system in FIG. 1A in more detail;

FIG. 2 is shows various sub-portions of the optimization system of FIG. 1A in greater detail;

FIG. 3 is a schematic diagram showing various types of user interface devices and different categories of sensing devices that may be used in the FIGS. 1A and 1B system;

FIG. 4 is a schematic diagram showing various types of output devices and their functions that may be included in systems consistent with the present disclosure;

FIG. 5 is a schematic diagram presenting a data based representation of an optimization system that is consistent with at least some aspects of the present disclosure;

FIG. 6 is an exemplary screen shot illustrating graphical tools for entering user activity preferences that is consistent with at least some aspects of the present disclosure;

FIG. 7 is similar to FIG. 6, albeit showing a different screen shot for entering additional user preferences;

FIG. 8 is similar to FIG. 6, albeit showing a different screen shot for entering additional user preferences;

FIG. 9 is similar to FIG. 6, albeit showing a different screen shot for entering additional user preferences;

FIG. 10 is similar to FIG. 6, albeit showing a different screen shot for entering additional user preferences;

FIG. 11 illustrates a flow chart and indicates a process or method that is consistent with at least some aspects of the present disclosure whereby a user's role and conditions are used to identify suitable scheduling time slots for an activity;

FIG. 12 is a flow chart illustrating a process or method whereby preparation requirements for an activity are considered and scheduled as part of an activity scheduling process;

FIG. 13 is a flow chart illustrating a floating schedule process that is consistent with at least some aspects of the present disclosure;

FIG. 14 illustrated a display screen shot for viewing a floating schedule that are consistent with at least some aspects of the present disclosure;

FIG. 15 is a top plan schematic view of a conference space and space occupancy indicators that is consistent with at least some aspects of the present disclosure;

FIG. 16 is another flow chart showing different aspects of a floating scheduling process;

FIG. 17 is a flow chart showing a process whereby a system automatically analyzes a user's scheduled activities as well as other scheduling options and presents other scheduling options that are more optimal for user consideration;

FIG. 18 is a continuation of the process shown in FIG. 17;

FIG. 19 is a continuation of the process shown in FIGS. 17 and 18;

FIG. 20 is a flow chart showing a processor for obtaining user feedback regarding user conditions and perceptions that is consistent with at least some aspects of the present disclosure;

FIG. 21 is a screen shot showing a prior 24 hour view of a use's schedule that indicates prior user activities, user condition information and other information related to a completed day period;

FIG. 22 is similar to FIG. 21, albeit showing a next day view of a user's schedule including scheduled user activities and anticipated user conditions and other information that is consistent with at least some aspects of the present disclosure;

FIG. 23 is similar to FIG. 22, albeit showing a modified next day schedule;

FIG. 24 is a screen shot showing a preparation and review interface that enables a system user to review and prepare information for upcoming scheduled activities;

FIG. 25 is a flow chart illustrating a process or method for identifying items needed for scheduled activities and for reminding a system user to obtain and take those items prior to departing a current location;

FIG. 26 is an exemplary screen shot that presents reminders to a user to take items upon departing a current location;

FIG. 27 is an exemplary screen shot that presents activity options to a system user automatically when a user has the ability to perform those activities;

FIG. 28 is a screen shot that indicates current status of a set of activity invitees as well as anticipated departure times for each of those invitees;

FIG. 29 is a screen shot that indicates an activity end time as well as anticipated departure times for activity attendees that is consistent with at least some aspects of the present disclosure;

FIG. 30 is a screen shot that presents a prior week view for a system user that indicates user condition and activities related to conditions outside some threshold range as well as other useful information that is consistent with at least some aspects of the present disclosure;

FIG. 31 is a screen shot that indicates a set of secondary activities for consideration by a user during a transition period between first and second scheduled activities;

FIG. 32 is similar to FIG. 31, albeit showing the screen shot with one activity option selected to reveal sub-options associated therewith; and

FIG. 33 is a screen shot showing automatically presented information designed to increase a system user's understanding of conditions while travelling home and increase user empathy with family member conditions.

### DETAILED DESCRIPTION OF THE DISCLOSURE

The various aspects of the subject disclosure are now described with reference to the drawings, wherein like reference numerals correspond to similar elements throughout the several views. It should be understood, however, that the drawings and detailed description hereafter relating thereto are not intended to limit the claimed subject matter to the particular form disclosed. Rather, the intention is to cover all modifications, equivalents, and alternatives falling within the spirit and scope of the claimed subject matter.

In the following detailed description, reference is made to the accompanying drawings which form a part hereof, and in which is shown by way of illustration, specific embodiments in which the disclosure may be practiced. These embodiments are described in sufficient detail to enable those of ordinary skill in the art to practice the disclosure. It should be understood, however, that the detailed description and the specific examples, while indicating examples of embodiments of the disclosure, are given by way of illustration only and not by way of limitation. From this disclosure, various substitutions, modifications, additions rearrangements, or combinations thereof within the scope of the disclosure may be made and will become apparent to those of ordinary skill in the art.

In accordance with common practice, the various features illustrated in the drawings may not be drawn to scale. The illustrations presented herein are not meant to be actual views of any particular method, device, or system, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or method. In addition, like reference numerals may be used to denote like features throughout the specification and figures.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the disclosure may be implemented on any number of data signals including a single data signal.

The various illustrative logical blocks, modules, circuits, and algorithm acts described in connection with embodiments disclosed herein may be implemented as electronic hardware, computer software, or combinations of both. To clearly illustrate this interchangeability of hardware and software, various illustrative components, blocks, modules, circuits, and acts are described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the embodiments of the disclosure described herein.

In addition, it is noted that the embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a function, a procedure, a subroutine, a subprogram, etc. Furthermore, the methods disclosed herein may be implemented in hardware, software, or both. If implemented in software, the functions may be stored or transmitted as one or more instructions or code on a computer-readable medium. Computer-readable media includes both computer storage media and communication media including any medium that facilitates transfer of a computer program from one place to another.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a computer and the computer can be a component. One or more components may reside within a process and/or thread of execution and a component may be localized on one computer and/or distributed between two or more computers or processors.

The word “exemplary” is used herein to mean serving as an example, instance, or illustration. Any aspect or design described herein as “exemplary” is not necessarily to be construed as preferred or advantageous over other aspects or designs.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Throughout this disclosure the phrase “output type” will be used to refer to a way in which information is delivered to and detected by a user. For instance audibly sensed output, visually sensed output and haptically sensed output may comprise first, second and third different output types, respectively.

The phrase “information type” will be used to characterize system output information based on the function associated with the output information. For instance, a visual alert which has the primary function of reminding or warning a user of something may comprise a first information type, a visual news feed (e.g., a news story presented as text or a video) which has the primary function of informing or entertaining a user may comprise a second information type, system output data provided to move a user's morning meeting to an open afternoon time slot has the primary function of changing a user's schedule and may comprise a third information type, etc.

Throughout this disclosure, computer processors and servers are described as running software to perform various algorithms that generate several information types. A subset of the algorithms are described as recognizing, identifying or discerning conclusions based on various factors. For instance, one algorithm may “recognize” that a user is in a high stress state based on several different types of biometric and other sensed data. Here, it should be appreciated that the conclusions recognized or identified by algorithms are simply the results of calculations based on factor sets and therefore, while accurate in some cases, may not be accurate in specific instances, thus, the terms “recognize” and “identify” are used herein to mean that a likely or highly probable conclusion is calculated, albeit where the conclusion may wrong.

An affordance that includes a processor, a transceiver (e.g., wired or wireless) and one or more actuators will be referred to herein as a “smart affordance”. For instance, a coffee maker may be equipped with a processor, a transceiver and an actuator where the coffee maker is controllable by one or several other system processors (e.g., the system server) to turn on and off and control other operating characteristics of the maker. In the case of some smart affordances the affordance will also include sensors for sensing affordance conditions and may be able to report back to other system processors as conditions change.

The phrase “smart communication device” will be used to refer to device assemblies primarily used for communication purposes that include a processor and some combination of sensor devices, input devices, output devices, a battery or power source and typically a wireless transceiver. Exemplary smart communication devices may include smart speakers, smart TVs, smart emissive surfaces integrated into other affordances (e.g., refrigerators, ovens, etc.), smart watches and bracelets, smart headphones, smart glasses or goggles, smart phones, smart pad type devices, smart badges, etc., where each of the smart devices already includes some combination of input, output sensing and processing capabilities.

The phrase “portable smart device” will be used to refer to portable devices intended to be carried by a user that include a processor and some combination of sensor devices, input devices, output devices, a battery or power source and typically a wireless transceiver. Exemplary types of portable smart devices include but are not limited to smart watches, smart phones, tablet type computing devices, a laptop computer, wearable headphones or ear buds, smart glasses or goggles, a smart badge, fob, pin, ring, clip (e.g., for a backpack or the like), necklace and even various clothing items like a hat, a shoe, etc.

The terms “optimal” or “optimization” will be used to qualify several different concepts such as, for instance, “time slots”, “resource use”, algorithm factors, etc. In these cases, unless indicated otherwise, the terms optimal and optimization will mean that the concept qualified meets some threshold level of optimality as opposed to the most optimal level. For instance, in the case of 100 time slots, “optimal time slots” may include the five most optimal time slots even though a most optimal time slot is more optimal than the second most optimal, the second most optimal time slot is more optimal than the third most optimal, and so on.

The present disclosure will be described in the context of an exemplary optimization system that includes a set of sensors and other types of activity and user condition and preference tracking tools (e.g., scheduling software, internet based applications, user input devices, etc.) as well as one or more servers or computer based processors that process sensor and other input data and use that data to help system users optimize use of time and other resources based on user preferences, perceived user conditions, user circumstances, user habits and other optimization factors. To support a user in various ways, the system also includes at least one and in most cases many information output devices as well as many different types of information output devices that are controlled to facilitate user notification functions, query functions to collect information from a user, query functions to seek user authorization to change various system aspects and information presentation functions to present information to a user to inform or entertain. In addition, in at least some cases, the system includes various environment affordances that are controlled to modify a user's environment to increase user comfort (e.g., adjust light, adjust window blinds, adjust HVAC characteristics, etc.) or provide services (e.g., control a coffee maker, start a shower, arrange for transport, book a conference room, start a vehicle, etc.) to the user.

In particularly useful cases the system is completely dynamic so that if some activity is scheduled for a user, the scheduled time and/or the activity itself may be changed as the mix of optimization factors associated with the user changes over time. In some cases prior to making changes to a user's scheduled or even current activities, the system may always query a user to confirm that the change should be made. In other cases some current or scheduled activities may be changed by the system processors automatically. In other cases some activity schedule changes may be automatic while other changes only occur after a user verifies that the change should occur.

In at least some embodiments, optimization algorithms will be modified based on many optimization factors including but not limited to user preferences and aspirations, habits, user perceptions of likes, dislikes, user perceived conditions and actual user conditions as measured by biometric sensors or as derived from sensed biometric data or other sensed information as they relate to recent, current and/or future environments, activities and circumstances and other factors.

In some cases the system processors also use preferences, aspirations, habits, perceived and actual conditions, locations, circumstances, etc., of all or at least a subset of system users in a user group or organization to optimize time and other resource use for the group as a whole as opposed to optimizing for a specific user. In addition, the system may also optimize resource use among several user groups within a specific organization.

Hereinafter, unless indicated otherwise, the optimization system and associated methods and processes will be described in the context of a first system user names Barb Blue who has several family members that she lives with and who works for an employer that operates several disparately located work facilities where each facility includes a campus and each campus includes several buildings and real estate between the buildings. The combined work facilities will be referred to as the employer's “enterprise”. It will also be assumed that Barb Blue works with several other enterprise employees and has several non-work related relationships in addition to relationships with her family members and the other people she has relationships with will be referred to as “other system users” or just “users” unless indicated otherwise. While parts of this disclosure are described in relation to user Barb Blue, it should be appreciated that all methods and processes described herein may, and indeed will be, simultaneously applicable to any system user so that all users are served at the same time.

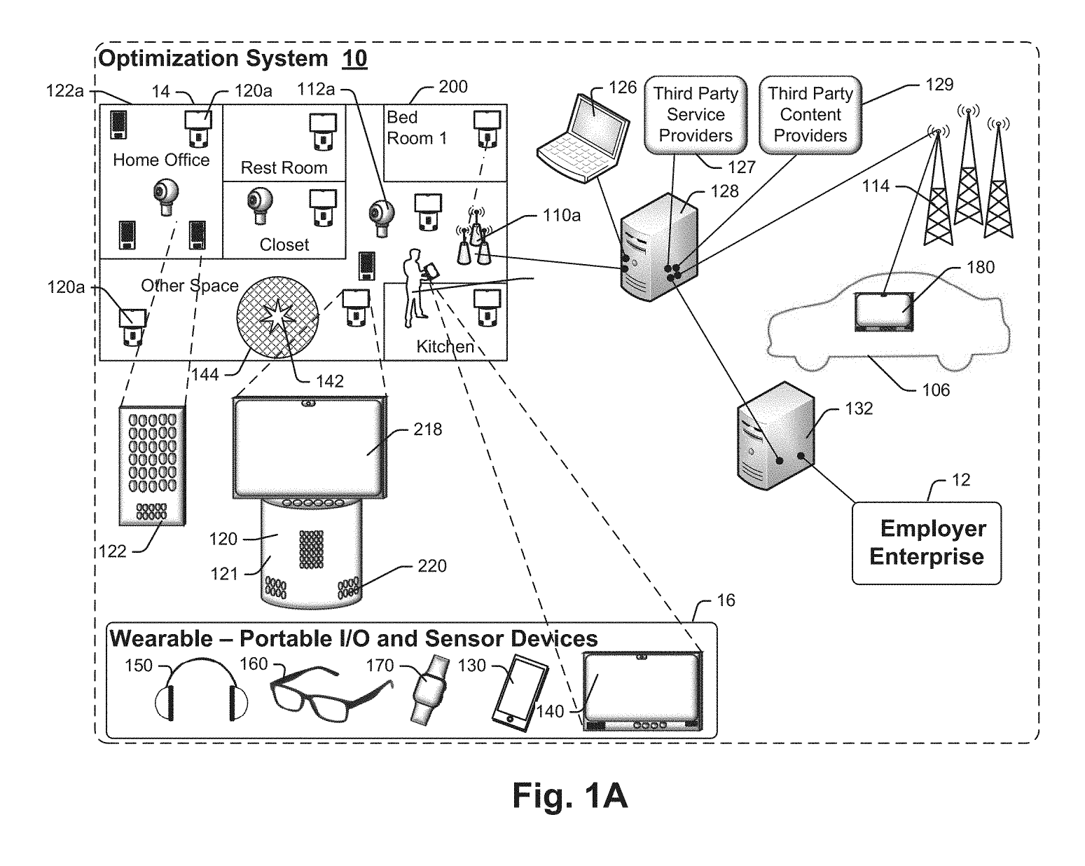

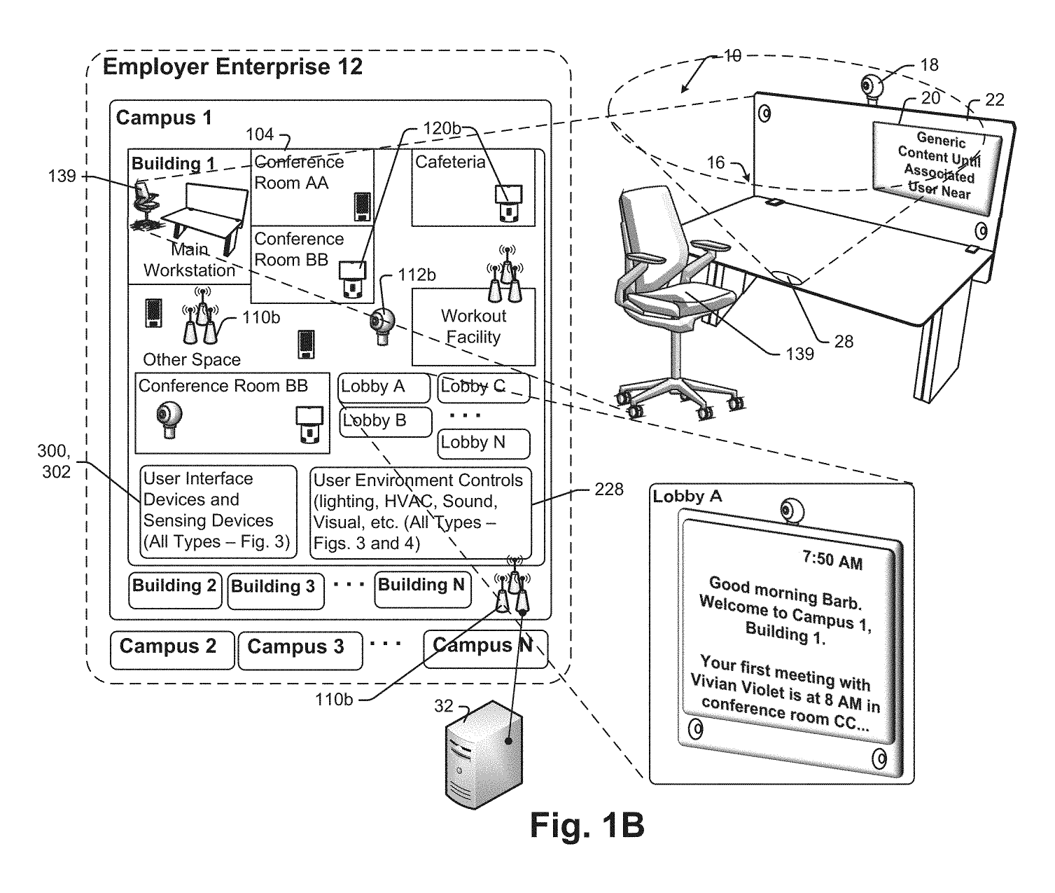

Referring now to the drawings wherein like reference numerals correspond to similar elements throughout the several views and, more specifically, referring to FIGS. 1A and 1B, the present disclosure will be described in the context of an exemplary optimization system 10 including various hardware components located within Barb Blue's home 14, within the employer's enterprise 12, and in the Barb's primary mode of transportation, in the exemplary case, Barb's vehicle 106. The system also includes one or more servers or other computer based processors 128 and 132 and a wireless/wired network system including, among other things, cell or other wireless towers 114 and WIFI access points 110a and 110b located at a user's house 102, throughout the employer's enterprise 12 and, in at least some cases, in other common areas controlled by third parties (e.g., a shopping mall operator, a store operator, an airport operator, etc.

In FIG. 1A the system is shown to include two servers including a local server 128 and a remote overall system server 132 where the local server 128 may be located at a user's home or place or work and the remote overall system server 132 may be located remote from space that is routinely used by at least a particular user. While two servers are shown, it should be appreciated that systems with many more servers or with only one server are contemplated as are systems where at least a subset of functions that will be described hereafter as being performed by server processors may be performed by other system computing devices. Indeed, as processors become more powerful and access to cloud and other network based data and applications becomes more rapid and reliable, some, most or even all of the server functions described herein may be performed by a high powered processor device or a federation of processing devices in a distributed system linked by communication networks. Hereinafter, while many different system processors or servers or other computing devices may cooperate to perform various functions, processes, methods and algorithms, unless indicated otherwise, the term “processor” or the phrase “system processor” will be used generally to refer to any processor in the system that performs any function, process, methods or algorithms, unless specifically indicated otherwise.

Referring still to FIG. 1A, cellular towers 114 and access points 110a, 110b and other wireless communication devices are distributed throughout space occupied by system users and are linked to the servers for obtaining information useable to determine user and resource locations and to facilitate wireless two way communication between the servers and communication networks and other system hardware, resources and affordances. To assess user locations, the access points and/or towers can perform various functions. For instance, the access points may receive signals from one or more of a user's portable computing devices that are used by a system server or processor as seed information for known triangulation algorithms to determine user location in a home, office or other location. Cell tower signals can receive signals that are used to drive similar triangulation algorithms to determine user locations. In other cases, other types of sensor devices within a home, office, transportation vehicle or at other locations may detect user presence within a relatively small space (e.g., a closet, a restroom, etc.) and that location information may be provided to the access points and a linked system server for identifying user location. In particularly advantageous cases cameras or similar types of sensor devices may obtain images that are provide via an access point or cell tower to system servers where the servers are programmed to identify specific users and user locations within the images and the environments associated with the images. Many other types of sensors in various environments are contemplated for detecting user locations or generating data that can be processed in order to detect user identities as well as locations.

In some environments user location granularity will not be particularly important while in other environments relatively precise location or precise location relative to affordances and resources will be required to feed various system algorithms. For instance, when Barb Blue is in her bedroom closet in the morning, location granularity that places her in her closet or even simply in her bedroom may be sufficient. Closet location should be contrasted with a user's location in a large open office space where location may operate as a contextual factor usable to ascertain a user's specific current activity. For instance, if the user is at her personal workstation, in a meeting space with four other people, in the rest room, in a refreshment alcove with one other person, etc., location granularity will be more important as it may operate as context for what the user is doing at a specific instance in time.

Because location granularity can be important in some environments, it is contemplated that location determining capabilities may be different for different environment spaces. In other cases, it is contemplated that precise user and resource locations (e.g., within one foot or one yard of actual locations) may be determined at all system locations at all times and, in these cases, a substantial network of access points, sensors, cameras, etc., may be employed to generate data useable to assess precise locations. In some cases system programs, applications and algorithms may operate best with high precision user and resource locations but nevertheless still be usable with less precise location information. In these cases it is contemplated that the programs, applications and algorithms may always employ location seed data in an optimal fashion to assess user location as precisely as possible or, in the alternative, as precisely as necessary to drive specific system applications and programs (e.g., in some cases where an application only requires an intermediate level of user location precision, even if the system can generate precise location information, the system may only generate the intermediate level required by the application).

In at least some embodiments, in addition to being able to determine precise user and affordance locations, the system processor will also be capable of assessing user and resource orientations and/or relative orientations within environments and spaces. While any orientation determining technology may be used for determining user and resource orientations, in at least some embodiments orientations will be most easily determined using images of users and affordances or resources generated by cameras located in system spaces where a system processor can identify users and user features (e.g., a head, a face, a user's shoulders, a torso, etc.) and other resources and resource features in images and use the features to assess relative directions or orientations within space based on the location and direction of the camera in space. In other cases where a user is wearing a computing device that is typically worn in one juxtaposition with respect to the user's body, data generated by the worn computing device may be used to determine orientation. For instance where a user is wearing “smart” glasses or goggles (e.g., glasses with a processor, a camera, a transceiver and other components depending on all functions performed thereby) over her eyes, a glasses processor may be able to determine complete orientation of the glasses (e.g., north-south and east-west, as well as angle up or down with respect to a horizontal plane and rotation clockwise or counterclockwise about a vision trajectory in front of the glasses or goggles) which can be used as a proxy for user orientation or orientation of a user's eyes (e.g., a user's sight trajectory). In still other cases, a sensor on user glasses or goggles may track a user's eyes with respect to the glasses or goggles to further identify the user's sight trajectory relative to the glasses or goggles so that the user's sight trajectory relative to the glasses and the orientation of the glasses can be combined to identify a precise user's sight trajectory. As another instance, a processor in a “smart” badge that is typically worn on a user's chest or on a lanyard around a user's neck may likewise be able to determine user orientation which can be provided to the larger optimization system via wireless transmission.

In at least some cases identity of specific system users will be determined using aliases or digital codes that are associated with the specific system users. To this end, for instance, in at least some cases a system processor (e.g., server 128) may associate a digital alias with a specific system user where the alias can be transmitted from one or more of the user's portable computing devices (e.g., headphones 150, glasses 160, watch or other wearable device 170, phone 130, tablet 140, etc.) to access points 110a or 110b or other distributed sensor or receiver devices where the computing device receiving the alias compares the received alias to at least one stored digital alias that is correlated with the specific user's identity. When the received and stored aliases match, the system uses the correlated user's identity as the user identity.

In particularly advantageous systems, to increase system security and the level of user privacy, a system processor or computer will generate and store a user alias set that includes a large number (e.g., 10,000) of digital user aliases at one time for a specific system user and will transmit all of those aliases to the user's portable computing device to be stored on that device as a user's alias set. Then, when the user's portable device is near a system access point or other receiver device, the user's portable device will randomly select one of the digital aliases from the user's alias set and transmit that digital alias to the access point to be delivered to the system processor. The alias receiving processor compares the received alias to the stored aliases and again, when the received and stored aliases match, the system uses the user identity correlated with the stored matching alias as the user's identity.

In cases where the portable device and system computer store a large number of digital aliases for each user, in at least some cases the aliases will be one time use expiring aliases to enhance system security. To this end, for instance, when a portable device selects one user alias from the stored alias set for a user to transmit to the system computer, the alias may only be transmitted for 30 seconds or some other similar short duration after which the alias is discarded and removed from the portable user's device memory so that that alias in the set is not used again for that user. In addition, once the system computer receiving the alias matches the received alias with one of the stored aliases for the user, the system computer may also delete that alias from its stored alias set for that user so that it is no longer correlated with the user's identity, at least in the short term.

At the end of the 30 second period, the user's portable device may randomly access a second of the digital aliases stored on the portable device and may transmit that alias to the system computer via access points or other wireless receiver devices. Here, as in the case of the first alias, the second alias may only be transmitted for the next 30 seconds after which it is discarded. Here, the receiving system computer again correlates the received second alias with one of the aliases stored in the set for the user to again identify the specific user identity. Again, after using the second alias for user identification, the second alias is discarded by the system computer. This process of selecting an alias to transmit to the system computer for 30 seconds and then discarding that alias and selecting a next alias for transmission continues.

Once the number of unused aliases in a set that is associated with a specific user drops below some threshold level (e.g., 2,000 in the case of a full set of 10,000), the system computer may be programmed to automatically generate a new random set of 10,000 aliases for the specific user that are correlated with the user's identity and stored by the system computer and that are transmitted to the user's portable device. Upon receiving the new set of correlated aliases, the user's portable device discards the remaining 2,000 aliases from the initial set of 10,000 and stores the new 10,000 aliases for random selection and transmission to the system computer for identifying purposes.

In the alternative, once the number of unused aliases in a set drops to below a threshold number, the system computer may automatically regenerate a supplemental random set of aliases for the specific user that are added to the unused aliases in the correlated list and may transmit the new aliases to the user's portable device to be added to the list of unused aliases maintained on that device. Once the alias lists are supplemented, the portable device randomly selects one alias from the supplemented list for transmission and comparison to the supplemented list maintained by the system computer for identifying the correlated user.

Any type of data transmission technology may be used to transmit any of the system data types wirelessly including but not limited to Bluetooth, NFC, RF, IR or any other types.

The system hardware components that are distributed throughout system space in homes, the employee enterprise, transport vehicles and in other spaces include, among other things, various types of sensors and user interfaces including input and output capabilities. In FIG. 1A, exemplary input/output and sensor devices include two different types of interface portals including a display portal 120 and an audio portal 122. Here, the idea is that in most spaces, instead of completely wiring the space to support many different sensors, input devices and output devices and then linking those devices together to form a cohesive network, users will prefer integrated sensor/input/output device assemblies that can perform many different functions without the need for a user to link up or associate the separate system components. In particularly advantageous embodiments the portals and other communication devices may be wireless.

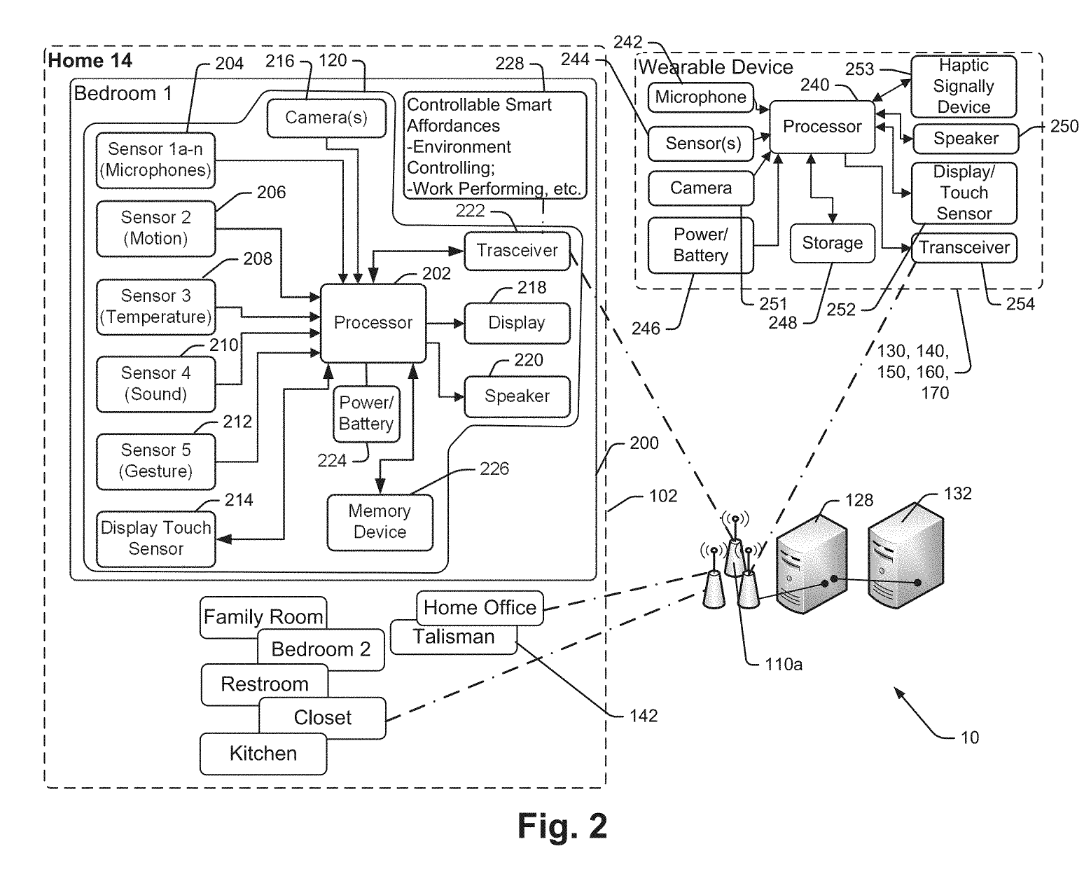

Referring still to FIG. 1A, in the case of the exemplary display type portal 120, the portal may include a cylindrical base housing structure 121 that supports a display screen 218 in a generally upright fashion and that includes at least one and in most cases several speakers 220 housed within the housing 121. Referring also to FIG. 2, portal 120 also includes a portal processor 202, a plurality of sensor devices, a power source or battery 224, a memory device 226 and a transceiver 222 or other data communication component like an Ethernet port, cable port, etc. As shown, the exemplary sensor devices include but are not limited to microphones 204, a motion sensor 206, a temperature sensor 208, a pressure sensor 210, a gesture sensor 212, one or more cameras 216 and a touch sensor 214 that is integrated into display 218 (e.g., the display may be touch sensitive). Other sensor types contemplated but not illustrated include, among others, an air quality sensor, a humidity sensor, a barometric pressure sensor or any other typed of ambient or environment sensor. Any technology suitable for providing sensors of different types may be used to construct any of the sensors including, for instance, radar, ultrasonic, light or other sensor technologies. Each of the sensor devices is linked to processor 202 and provides sensed or collected data of various types. In at least some cases the display screen on portal 120 will be touch sensitive so that a user can input information into the system via selection of on screen icons and hyperlink text phrases or other graphical icons presented thereon. In other cases portal 120 may include at least a subset of dedicated hardware buttons ascribed to specific functions and features.

Processor 202 may be programmed to receive verbal commands and input from a user via microphones 204. To this end, in at least some cases processor 202 will be programmed to persistently “listen” for one or more simple to remember specific trigger words or phrase uttered by a person in the vicinity of the portal 120. Upon detecting a trigger word, processor 120 may receive and process next words uttered (e.g., follow on utterances) by the user to determine if those words comprise a recognized command, a query, simple voiced data entry, etc. Hereinafter, unless indicated otherwise, it will be assumed that for at least general triggering, the system will monitor for the phrase “Wake voice sensor”.

A camera or cameras 216 integrated into portal 120 may operate as sensors and input devices (e.g., to detect gestures or the like by a user). As in the case of the microphone and processor persistently monitoring for a trigger phrase, the cameras may cooperate with the processor to persistently monitor a space within a field of view (FOV) of the camera to identify one or more specific gesture triggers to cause the processor to receive follow on gestures or uttered words received by the microphones that operate as portal or system commands, queries, data entry, etc. For instance, a quick swirl of a user's finger vertically in the air within the camera field of view may operate as a trigger gesture to commence a follow on gesture input. In some cases the processor may be programmed to mix different trigger types and follow on action types. For instance, in some cases the processor may be triggered by a gesture and then receive follow on input in the form of annunciated words or the like. As another instance, the processor may be triggered to monitor for follow on gestures after an annunciated trigger phrase is recognized.

The output in response to any detected trigger signal of any type may start with a confirmation signal of some type that the processor has been triggered to monitor for additional information and then, in some cases, presentation of additional information in response to follow on input from the user. For instance, if a user annunciates a trigger word that the portal processor detects, the processor may generate a beep or illuminate a light device on the portal to confirm that the portal stands ready to receive follow on words as commands, user input information, etc.

While portal 120 may be configured to receive many different types of user input, it has been recognized that audio input has many advantages over other types of input. First, almost all system users understand and know how to use at least one spoken language and therefore, unlike gestures where many would need to be learned in order to increase the number of different inputs to a useful number, users effectively come equipped with a large set of words with generally consistent meanings that can be used to distinguish distinct inputs.

Second, while different users have different voice characteristics (e.g., tone, pitch, volume, etc.), processors are very good at normalizing for different voice characteristics so that they can distil out specific words from user utterances despite the nuances of specific voices. In contrast, unless gestures are extremely simple so that everyone that makes a gesture essentially makes it in a substantially similar fashion, processors are not good at normalizing gestures to eliminate the effects of user specific nuances.

Third, while gesture type inputs need to be performed within a camera FOV and typically with a user in a specific orientation (e.g., facing the camera FOV and within a short range of the camera), typically the only constraint on audio input is that volume needs to be high enough that system microphones can receive the sounds that comprise annunciated words. Thus, for instance, a user can be facing away from a microphone or in any other direction and be on the opposite side of a room from a system microphone and, if spoken words are loud enough, the microphone can pick up those words and use them to drive various applications.

Referring still to FIG. 2, the portal transceiver 222 enables the portal processor to communicate wirelessly to other system devices and through the access points 110a, 110b, etc. to system processors for two way communication and control purposes. While a wireless transceiver is optimal in most cases, portals may be wired into intranets and then linked to the internet or some other communication network in at least some embodiments.

Referring again to FIG. 2, processor 202 stores software programs in memory 226 for managing data collection and manipulation and in most cases will transfer at least some collected data or data derived from collected data on to other system processors for further processing. Memory 226 may store a lot of information including various application programs and collected and derived data, especially in cases where local processor 202 is extremely capable so that it can perform rapid processing of data and other information to provide at least some services locally. In other cases memory 226 may be minimal where the portal is linked via the Internet or some other network to a cloud based server and storage system for running applications and storing collected and derived data remotely.

The portal processor 202 also drives the portal information output devices including speakers 220 (e.g., via sounds, synthesized voice signals, etc.) and display 218 to provide information and system control options to a user. Just as audio is an optimal type of system input in many cases, audio will also be an optimal type of output as it is well understood by most system users and can be perceived by a user in any location and orientation (e.g., without requiring a user to view content on a display screen) if the volume is high enough.

In at least some other cases, in addition to driving the portal display screen and the speakers with content or information useful for a system user, portal 132 may operate as a gateway or router to transfer data and instructions between one or more of the system processors and other controllable affordances and resources within an environment near or proximate the portal 120. To this end, many affordances within the spaces used by people are now equipped with their own processors, actuators, at least minimal memory and transceivers (typically but not necessarily wireless) so that they can receive commands from and transmit data to other system processors and can use commands to control affordance actuators to modify conditions and operating states of associated affordances. For instance, a light device may be equipped with a processor, an actuator (e.g., light control circuitry to control intensity, temperature, lighting effect, etc.) and a transceiver so that the light device can receive control commands and use those commands to control lighting effects. As indicated above, an affordance that includes a processor, a transceiver and one or more actuators is referred to as a “smart affordance”.

As another instance of a smart affordance, a coffee maker may be equipped with a processor, a transceiver and an actuator where the coffee maker is controllable by one or several other system processors (e.g., the system server) to turn on and off and control other operating characteristics of the maker. In the case of some smart affordances like a coffee maker, the maker processor will also include sensors for sensing affordance conditions and will be able to report back to other system processors as conditions change. For instance, just prior to completion of brewing coffee, a coffee maker may sense the brewing state and send a confirmation message to a processor that manages the coffee maker so that a user can be notified that the coffee is ready to be consumed.

As other instances, other smart affordances include but are not limited to environment controlling affordances such as HVAC systems and individual HVAC components (e.g., fans, heaters, humidifiers, duct valves, etc.), shades, curtains, spatially adjustable furniture such as task chairs, height adjustable work and support surfaces (e.g., height adjustable tables, workstations, credenzas, foot rests, keyboard supports, forearm supports, etc.), beds, recliners, lounge chairs, work performing affordances such as ovens, stoves, refrigerators, washing and drying machines, vehicle controllers (e.g., to start a user's car, to warm or cool a vehicles passenger compartment), food and medication dispensers, etc. In FIG. 2, controllable smart affordances are schematically represented by block 228.

Referring again to FIG. 1A, audio portal 122 may be similar to display portal 120 described above except that it does not include a display screen for input and output. Because there is no display, in the case of portal 122, all information other than basic information which can be conveyed visually via control of portal light devices or the like is provided to a user via audio and, in most cases, via a synthesized voice signal. Similarly, except for basic input which may be provided via hardware buttons or the like of the portal housing, input to portal 122 will primarily will include utterances verbalized by a user that are obtained via portal microphones.

In at least some cases standalone sensor, output or input devices may be provided within user spaces that are integrated into the overall system 10. For instance, standalone cameras 112a, 112b are contemplated where the cameras obtain images and wirelessly or otherwise provide those images via access points and/or portal assemblies to one of the system servers for analysis. Although not shown, other standalone input and output devices that may be integrated into the optimization system include large emissive surfaces that operate as input devices as well as information output devices and speaker/audio devices and/or microphone devices for receiving sounds and presenting audio content to a user and task chairs 139 (see FIG. 1A) that include processors, communication transceivers and sensors as well as haptic, audible and other output devices. As indicated above, the phrase “smart communication device” is used in this disclosure to refer to device assemblies primarily used for communication purposes that include a processor and some combination of sensor devices, input devices, output devices, a battery or power source and typically a wireless transceiver.

In at least some cases it is contemplated that the optimization system 10 may leverage off smart communication devices that system users already have in their homes or that are starting to be adopted for home use such as, for instance, some of the smart speaker devices that use sound to communicate with users in a fashion similar to that described above with respect to portal 120. While many people are familiar with using smart speaker type communication devices for word searching functions, these types of speakers are useful for many other functions such as uttering phrases for buying products and services, scheduling appointments, placing and receiving phone calls, etc. In addition to leveraging off smart speaker communication devices, the system may also leverage off other smart communication devices that people are already using for other purposes such as for instance, smart TVs, smart emissive surfaces integrated into other affordances (e.g., refrigerators, ovens, etc.), smart watches and bracelets, smart headphones, smart glasses or goggles, smart phones, smart pad type devices, etc., where each of the smart devices already includes input and output and at least some sensing capabilities.

In at least some embodiments portal assemblies 120 and 122 and other standalone smart communication devices may be controlled by a system processor to operate in a federated fashion where multiple devices operate together to receive user input, sense various user and environmental conditions and to provide output to a user. For instance, where one display type portal 122 and three sound based portals 122 are located in a single user space (e.g., see the exemplary home office space in FIG. 1A including four portals total), the four portals may automatically configure to cooperate to provide synchronized sound or multi-channel sound output to a user in that space. Similarly, the four speakers may cooperate to receive user utterances to be processed as commands, queries, data inputs, etc. Furthermore, where there are several display screens in a space capable of providing various types of information to a system user, the system may automatically select one of the displays or a small subset of the displays to present information to a user in the space based on user location, sight trajectory, etc., where the selected display(s) is selected based on which display is most likely to get the user's attention.

When a user is not located in one of her home, an employer's enterprise space or her vehicle, in at least some cases portable sensor, input and output devices may be used to obtain various types of information usable to feed resource optimization algorithms that generate information types to support a user within space. For instance, referring yet again to FIGS. 1A and 2, a user may wear a small dimensioned computing device 170 (e.g., a smart watch) on her wrist where the device includes, among other things, a processor 240, input devices like a microphone 242, a touch sensitive display screen 252 and a camera 251, sensor devices 244, a battery 246, a memory 248, output devices like display 252, speakers 250, haptic signaling device 253 and a wireless transceiver 254. Processor 340 is linked to all of the other portable computing device components for receiving input and sensing user and other conditions and parameters, for running programs stored in the memory 248, for providing audio, visual and haptic output to the user and for linking to the larger overall optimization system 10. As data is collected via device 170, the data or data derived from the collected data may be transmitted to system servers for archiving, further processing, to drive additional system applications including optimization algorithms, etc.

Referring again to FIG. 2, while the wearable device 170 is shown as including at least one sensor 244, in some cases a portable computing device will not include a sensor and in other cases the device will include many different sensor devices. Exemplary sensor devices may include environment characteristic sensors, location sensors and biometric sensors of different types. For instance, an environment characteristic sensor may sense light intensity and light temperature, ambient temperature, humidity, barometric pressure, air quality, etc. A location sensor may be able to obtain information from a user's environment useable by processor 240 to determine or calculate the user's location or that can be transmitted to a system server for use in determining the user's location. Processor 240 may also be able to calculate user orientation using gyroscopes or other orientation determining components.

Biometric sensors may take many different forms and detect many different biometric conditions or other conditions of a user. Here biometric conditions include data indicating an instantaneous physiological condition of the user such as, for instance, the user's temperature, heart rate, blood pressure, rate of perspiration, fidgetiness, eye dilation, blood sugar level, hydration, etc. while other user conditions that may be detected include posture, rate and nature of user movements, flexibility, level of sedentariness, etc.

Different smart portable devices will include different subsets of the wearable device components shown in FIG. 2 or, in some cases, at least different manifestations of the wearable device components. For instance, headphones 150 typically would not include a display screen and instead most if not all input and output would be audible or haptic (e.g., vibrate as output or include one or more touch selectable buttons as input). As another instance, glasses or goggles will often include some type of emissive surface, either opaque or at least somewhat semi-transparent, built into a user's field of view as the user looks through the smart device assembly and may or may not include microphones as a type of user input.

In most cases portable smart devices and stationary sensor, input and output devices and subsystems will operate together to obtain information and user input and to provide output to a user in a holistic manner where system processors routinely and persistently (e.g., at all times except for specifically exempted times) identify sensor, input and output devices located proximate a user at the user's current location and automatically select optimized device sets given user locations, circumstances and user preferences. For instance, if a large high definition flat panel emissive surface is present in a user's closet at home, the system may opt to automatically present content to the user on that surface as opposed to on a phone or other portable computing device display screen which is small and relatively difficult to view. When a user moves from a first location to a second location where first and second different sensor, input and output device sets are located in the two locations, respectively, the system processors may simply automatically hand off sensing and output functions from the first device set associated with the first location to the second device set associated with the second location.

As another instance, when in a closet, audio data collected via one or more microphones may be used to determine that the user is in the closet and therefore to determine user location but when the user enters a kitchen, even though microphones may be located in the kitchen, instead of using microphone sensed sounds, images from a camera in the kitchen may be used to assess specific user location in the kitchen (e.g., sitting in third kitchen table chair facing east) as images are often better than sound for determining specific user locations.

Again, in at least some embodiments smart computing devices that users already use for many other purposes such as smart watch devices, smart phone devices, glasses, goggles, pad type devices, etc., may be leveraged in the optimization systems described herein. In this respect, existing smart portable devices may each run an optimization system application to support user input functions, sensing functions and user information output functions needed to facilitate optimization and to communicate via wireless transmission with system servers and processors.

While the system is described here as one where portable computing devices are used to collect user data and input and to provide output to a user when the user is remote from any of her home, employer enterprise or transport vehicle, it should be appreciated that in many cases stationary sensor, input and output devices similar to or at least functionally akin to those described herein may also be provided in other more public spaces for collecting user data and input and presenting content, suggestions, alerts, reminders, prompts and guidance to a user as well as for informing a user of automatic activities performed by the system on behalf of the user. Thus, for instance, it is contemplated that sensor, input and output devices akin to the devices described herein in the context of the user's home 102 may also be located within a store visited by a user, within an airport lounge, within a hallway or a building lobby, etc.

Where sensor devices are located in public areas or other areas where a user is not routinely associated with the areas, most user's will not be associated with the sensors or computing systems in those areas upon entering the areas. In at least some cases it is contemplated that store owners and operators/managers of public spaces who use sensors and cameras to collect various types of data (e.g., images, sound, location, biometrics, user attention to specific products and services (e.g., did a person in a store try on a specific sweater), etc.) for their own purposes may provide at least a subset of that data to an optimization system that can then be used as additional seed data to drive optimization algorithms. For instance, what a user is doing in a store at a specific instant in time may affect the user's ability to travel to a meeting location a few minutes later. Where the optimization system can ascertain user location and activity in a store, the system would be able to provide timely alerts to the user to depart for a meeting to avoid being tardy. In addition, if the user is likely going to be tardy, the system may provide warnings to other meeting invitees that a user is likely going to be late for the meeting.

In cases where another entity manages a space and data collected therein, one problem with accessing data from systems managed by the other entity is how to establish communication between the entity's computing system and the optimization system that provides services to the user (e.g., the user's optimization system 10). In at least some cases it is contemplated that when a user enters a space managed by another entity, cameras or other sensor types may automatically obtain information usable to attempt to ascertain the user's identity. If the user's identity can be determined, the managed space system may automatically link to the user's optimization system 10 to provide sensed data and other information thereto. Here, for instance, a store's server may store maps of user faces along with user identifying information and optimization system identifiers and may compare aspects of a user's face derived from camera images to determine user identity which is then used to associate a user with the user's specific optimization system 10.

In other cases it is contemplated that a store may maintain information that associates specific user's faces or another sensible biometric identifier with an indicator of a specific optimization system 10 that serves the user without storing specific user identity (e.g., name, SS#, etc.). For instance, for five hundred different customers in a store, one hundred each may be associated with one of five different optimization systems and their face maps, not their specific user identities, may be associated with their specific optimization systems 100. Here, upon recognizing a user's face as opposed to the user's identity, the store system may link to the optimization system that serves the user and either provide the face map or images used to generate the map so that the optimization system itself can then associate data received from the store system with the specific user served by the optimization system.

In other cases where a user carries a portable smart device, the portable smart device may automatically associate with a store system and automatically indicate the optimization system that serves the user so that collected data can be sent by the store system to the right optimization system. Here, the portable smart device may also either provide user specific identity to the store system which can be forwarded to the user's optimization system 10 or may provide an identity indicator (e.g., a digital alias that is associated with user identity within the optimization system as described above) that cannot be used by the store system to identify a specific user but that can be forwarded on from the store system to the user's optimization system computer or server for use by that system to identify the specific user in the store.

In still other cases where a user carries a portable smart device, the portable device may anonymously associate with a store system automatically so that images, data and other information collected by the store system can be transmitted to the user's portable smart device. As store generated data is received by the smart device, that data is either consumed as seed data by application programs run on the smart device or it is transmitted to one of the system servers for further processing or both. Here, the user's portable device controls transmission and use of the store generated data.

In addition to providing store generated data or other data collected by public space systems to a user's optimization system, that data may be used to provide additional substantially real time services to the user. For instance, the store generated data may be used to recognize user interest in specific products, specific lifestyles, etc., and may result in presentation of different in store or public space advertisements. Here, even if the store system does not know a user's specific identity, the system can track specific users as they move through the store space looking at products and persistently build up an instore profile for that person which can be used to present user specific advertisements and other services. To provide in store advertisements, the system may simply track users in a store space and when the user is near an information output device, the system may present a customized advertisement to the user. Thus, for example, if a user views and tries of a pair of jeans and then moves to a different part of a store, the system may recognize that the user tried on the jeans and may track user location to the different part of the store and may then present an advertisement for the jeans along with a coupon or the like. As another example, when a user tries on a sweater, the system may automatically recognize which sweater is tried on and may present a tutorial on the origin of the sweater, the quality of materials used to create the sweater, etc., in an effort to sell the user on sweater quality.

When a user is between locations where stationary sensing, input and output devices are located, again, portable worn or carried devices may take over all of the input and output functions of the system. Here, the handoff between interface devices will be automatic from one set of devices to another so that data collection and output to the user persists to the extent possible over time without requiring any user authorization or affirmative action. In at least some cases a user will be able to override the system so that only one or the other of the stationary devices and the portable devices handle system input and output or so that at least a subset of devices only operate under certain circumstances to collect information and input or to provide output to a user.

Referring yet again to FIGS. 1A and 2, in the present example Barb Blue's exemplary home 102 includes, among many other things, structure that defines various rooms and other spaces including, among others, a kitchen, a first bed room 200, a rest room, a closet, a home office and “other space” which is intended to represent all other space within the home 102 (e.g., other bedrooms, other closets, other rest rooms, hallways, etc.). In addition, the home includes sensing, input and output devices of various types as described above and hereafter. Again, in at least embodiments, sensors, input and output devices will be located ubiquitously throughout all or many spaces in a user's home. Similarly, sensor and input and output devices are shown located throughout a user's employer's enterprise facilities 12 (see also FIG. 1B) and at least one sensor, input and output device 180 is shown in the user's main transportation vehicle 106. Again, for the purposes of this disclosure it will be assumed that Barb Blue uses one or more of the portable smart devices 130, 140, 150, 160 or 170 as an interface device and that device will use integrated sensors to sense various conditions and parameters when the user is not located in a space that includes stationary or space dedicated sensors, input and output devices or at least to supplement functions of fixed or dedicated interface and sensing devices.

Referring to FIGS. 1A and 1B, Barb's employer's enterprise facilities are illustrated in some detail in FIG. 1B. The enterprise 12 includes, among other things, a plurality of campuses (represented as campuses 1, 2, 3 . . . N) where each campus includes one or a plurality of separate buildings and, in at least some cases, the real estate that the buildings reside on. In FIG. 1B, exemplary campus 1 is shown to include first through N buildings where the first exemplary building 104, like Barb's home, includes walls and other structures that define separate subspaces within the building 104 including, for instance, conference rooms, a cafeteria, workout facilities, lobby spaces A through N, other spaces, workstation and office spaces, etc. As shown, various sensor, input and output affordances 300, 302 are located throughout the first building 104 including visual portals 120b and audible portals akin to those described above, cameras 112b, access points 110b, speakers, microphones and other types of devices. As in the case of FIG. 1A, each of the sensors, input and output devices in FIG. 1B are either hardwired or wirelessly linked to one or more system servers or computers 32 for receiving data and presenting output to system users within the building.

Referring still to FIG. 1B, in at least some cases each lobby shown may include a large flat panel screen or display system arranged for easy visual observation by system user's entering and/or existing an associated space (e.g., a conference center, the cafeteria, etc.). Here, it is contemplated that the large lobby display systems may each include a display screen that is touch sensitive or, in the alternative, simply emissive (e.g., not touch sensitive) and may also include speakers or other audible output devices, one or more microphones, one or more cameras and one or more other types of sensor devices (e.g., biometric sensors, ambient sensors, etc.).

When a system user approaches one of the lobby display systems, a system computer may ascertain the user's identity and many different types of information related to the user and may present some type of informational service to the user upon approach. For instance, as shown in FIG. 1B, the display system may present a visual greeting to Bard upon approach as well as instructions related to her current status, upcoming engagements, location of her next scheduled activity, etc.

Referring still to FIG. 1B, an exemplary user's workstation 16 in the first building 104 is shown that includes a chair 139, a bench assembly including a privacy screen 22, a screen mounted display screen 20 and a camera 18. The station 16 may also include other components such as a microphone and other sensor input and output devices. For instance, a directional microphone with a cone shaped field of listening that includes a space adjacent a rear edge of a station worktop may be tuned to receive user voice commands from a user annunciating commands within the field cone. Commands may include, for instance, a voice command to change worktop height from a current position to a standing position. Similarly, reminders to change height or to perform other activities may be generated via a directional speaker aiming a voice reminder signal within the illustrated audio cone so that it is only hearable or appreciably hearable within the cone. Other station devices may include biometric, activity and/or environmental sensors, speakers and other input and output devices and/or actuators within the workstation table assembly, within the task chair 139 located at the station or within other structure about the station location (e.g., in a ceiling, a floor, an adjacent wall structure, etc.).

While only the first building on the first campus is shown in any detail in FIG. 1B, it should be appreciated that each of the enterprise buildings on each of the enterprise campuses would be similarly afforded with sensors, input device and output devices. Similarly, in at least some cases where real estate exists between buildings on the same campus, sensors, input devices and output devices may be located throughout that intervening space for performing suitable functions and processes consistent with this disclosure.

While the exemplary optimization system 10 is described herein in the context of an overall space system that covers a user's home, employer's enterprise space, the user's vehicle and all other places in between, it should be appreciated that the system can be used for advantage in any of those spaces or subsets of those spaces in at least some embodiments without being used in other spaces. For instance, in at least some cases it is contemplated that an optimization system may only operate within the employer enterprise and not in other spaces remote therefrom (e.g., not in the user's home). As another instance, an optimization system may only operate in a user's home and not in spaces remote therefrom. In still other cases first and second different optimization systems may operate in a user's home and the employer's enterprise, respectively, where there is no communication between the two systems or there may be minimal communications between the two systems so that any personal user information is distilled from communications between the two systems.

In still other cases it may be that all personal user information is maintained by a system server or within a user's account that is completely controlled by the user and not the user's employer or some other third party so that, while input and output can be received from any location suitably afforded, there is no personal information stored in any account other than those controlled by a user.

While the location detecting system described above may be able to identify user and resource location on a physical room by room basis in some cases or more granularly to within a yard or even a foot of a user's actual location in space, in some cases it is contemplated that user location may be determined based on relative distance from a specific item within a space. For instance, in at least some applications a user may specify that when near (within 10 feet) a specific item in her home, her location should not be used by the optimization system for any purpose other than personal purposes. Thus, in this case, the system may not use the user's location at her home at all to feed other user's optimization algorithms. In other cases, Barb Blue may only want her home location used by the optimization system when she is near a specific item. Many other location based rules may be associated with specific items at a user's home, in her workspace or anywhere else. Herein, unless indicated otherwise, an item to which specific location based rules may be attached will be referred to as a “location talisman”.

In FIG. 1A, an exemplary talisman is shown at 142 where the talisman has an association field 144 there around. The talisman may be any object regardless of interface capabilities or, in some cases, may include a complete interface. For instance, a talisman may include a simple small statue movable by a user within space to different locations where the statue is recognizable via analysis of data collected by other system sensor devices. For example, the statue may be identifiable in camera images so that its location within space can be determined. As another instance, a talisman may include one of the display portals 120. Where a talisman includes an output device of some type, either initially upon Barb Blue's association with the talisman or any time Barb Blue is associated with the talisman, the talisman may provide an output signal confirming association and that the system is tracking Barb's location, collecting data, etc. For instance, during user-talisman association, the system may illuminate an LED light device on the talisman to indicate association.

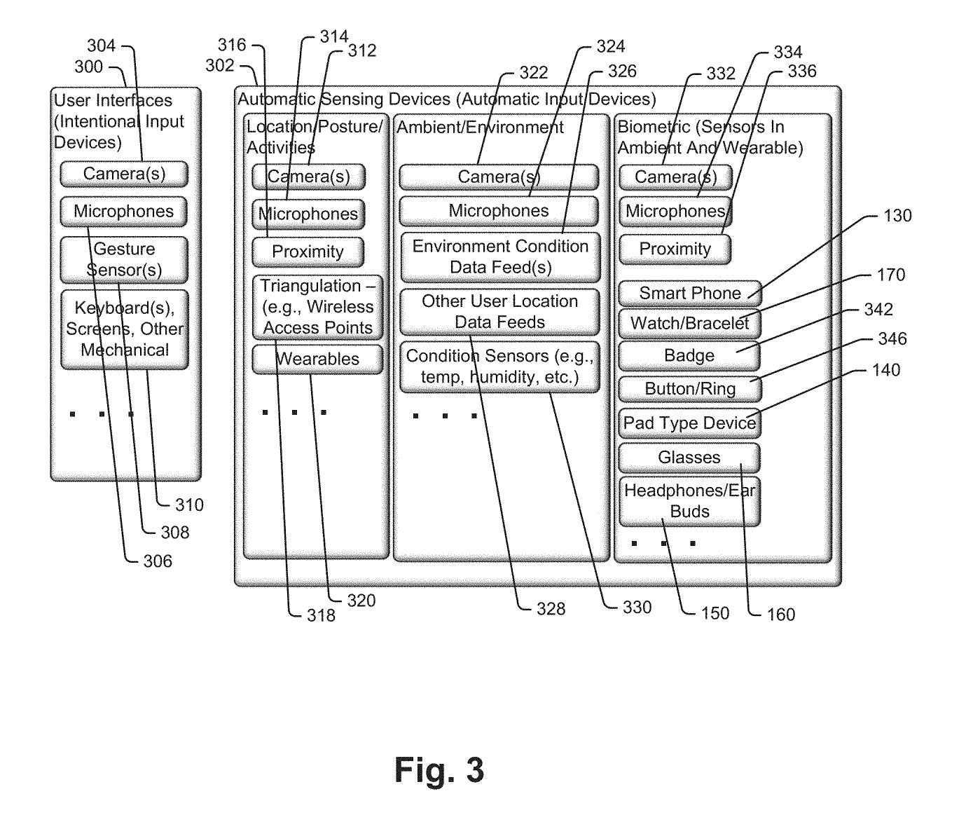

Referring now to FIG. 3, a schematic illustrates exemplary optimization system input types and lists exemplary hardware types that are suitable for obtaining the input data. At a high level, input types can be grouped into two different buckets including intentional user inputs which are typically the result of some intentional action on the part of a system user and automatic sensed inputs which are sensed irrespective of what a user is doing within a space. Devices 300 for receiving intentional user inputs include but are not limited to cameras 304, microphones 306, gesture sensors 308 and mechanical input devices like keyboards 310, mouse controllers, touch sensitive screens, etc.

Devices 302 for generating automatic sensed inputs include various sensor types which can further be bucketed into three different categories including sensors for detecting location, posture and user activities, sensors for detecting ambient/environment conditions and biometric sensors, both stationary and wearable. Exemplary location, posture and activities information may indicate that a specific user is located in her bedroom or in her vehicle at a specific location or at a workstation at her place of work, the current posture of the user and that the user is currently in a focused flow state or is exercising. Exemplary sensor types for collecting location, posture and activity information include cameras 312, microphones 314, proximity sensors 316, access points for receiving data 318 and wearable devices 320 (e.g., smart watch, phone or badge devices, smart glasses, etc.).

A second type of information that may be sensed or detected via sensor devices includes ambient or environment related information. For instance, information of this type may include temperature, lighting characteristics and effects (e.g., intensity, color, etc.), humidity, airflow characteristics, audio characteristics, spatial characteristics (e.g., size of an occupied room, ceiling level characteristic, etc.). Exemplary sensor types for ambient and environment characteristic sensing include cameras 322, microphones 324 and condition sensors like temperature, humidity and airflow sensors. Other exemplary sensor types for sensing ambient and environmental characteristics include environment condition feeds 326 (e.g., data from a database that describes ambient and environment characteristics of specific spaces). For instance, if a user can be located at a specific workstation within a specific location of an employer's facility, data or information describing ambient and environmental aspects of that specific location may be accessed and used as an input to optimization algorithms or other system processes or methods. Other types of environmental sensors includes a data feed 328 that indicates other system user location characteristics (e.g., the characteristics of other user environments or ambient spaces) and simple condition sensors 330.

A third type of information that may be sensed or detected via sensor devices includes biometric data related to system users. Sensed biometric user data may take many different forms including but not limited to heart rate, weight, blood pressure, temperature, flexibility, fidgetiness, level of perspiration, sleeping characteristics like REM sleep cycle number, sleep cycle duration, muscle and or tendon strain, tension, pressure or other skeletal muscular characteristics, bodily dimensions (e.g. arm length, leg length, torso dimensions, etc.), etc. As shown in FIG. 3, some biometric sensors may be positioned within the ambient while other biometric sensors may be integrated into wearable or user carried devices. To this end, ambient biometric sensors may include cameras 332, microphones 334 and proximity sensors 336. In addition, ambient biometric sensors may also include temperature, perspiration, movement and other types of sensor devices that are built into or integrated into environmental affordances that a user may touch or otherwise interact with so that biometric values can be detected. For instance, biometric sensors may be built into task chairs used by system users to sense weight, temperature and restlessness among other things. As another instance, biometric sensors may be integrated into a user's bed or sofa for sensing different biometric parameters. Carried (e.g., worn) biometric sensors may be built into a user's smart phone 130, a smart watch or bracelet 170, a badge 342, a button or a ring 346, into smart user glasses or goggles 160, into headphones or ear buds 150 or into a microphone 354.

In at least some embodiments one sensor device may be programmed to perform many different input and data collection tasks. For instance, see that each of cameras and microphones are indicated as interface devices as well as sensor devices in FIG. 3 for receiving various information types. In this case, one camera and one microphone may generate data suitable for many required input and sensing functionalities associated with the camera.

In at least some embodiments where different image types are required for different functions, it is contemplated that a system camera may sequentially generate different image types at frequencies that are needed to support each input and sensing requirement. For instance, a single camera may take a normal light image followed by an infrared image followed by some other type of image in a round robin fashion to generate images for many different data input and sensing requirements. In other cases the term “camera” may be used to refer to a multi-camera assembly including separate cameras for generating different image types. In FIG. 3 one microphone may be used to collect input data as well as other sensed data for many different sensing and optimization functions.

Referring once again to FIGS. 1A and 1B, the sensing, input and output devices located throughout different spaces are used to track multiple users in space and to provide services to multiple users where the system 10 runs separate and in some cases at least some combined optimization algorithms for each of the users associated with the system. Thus, for instance, where five people in one family live in the FIG. 1A home 102, the system may operate to run optimization algorithms for each of those people and one or more combined algorithms that take into account optimization factors for all five of the family members at the same time. Similarly, where two hundred people work at the same work facility, the system may operate to run optimization algorithms for each of those people and other optimization algorithms for different groups of those 500 people. Here, the combined group of people may be treated like a single individual, albeit where many more optimization factors and even similar factors for group individuals are accounted for when assessing conditions and identifying suitable system controls, recommendations and prescriptions.

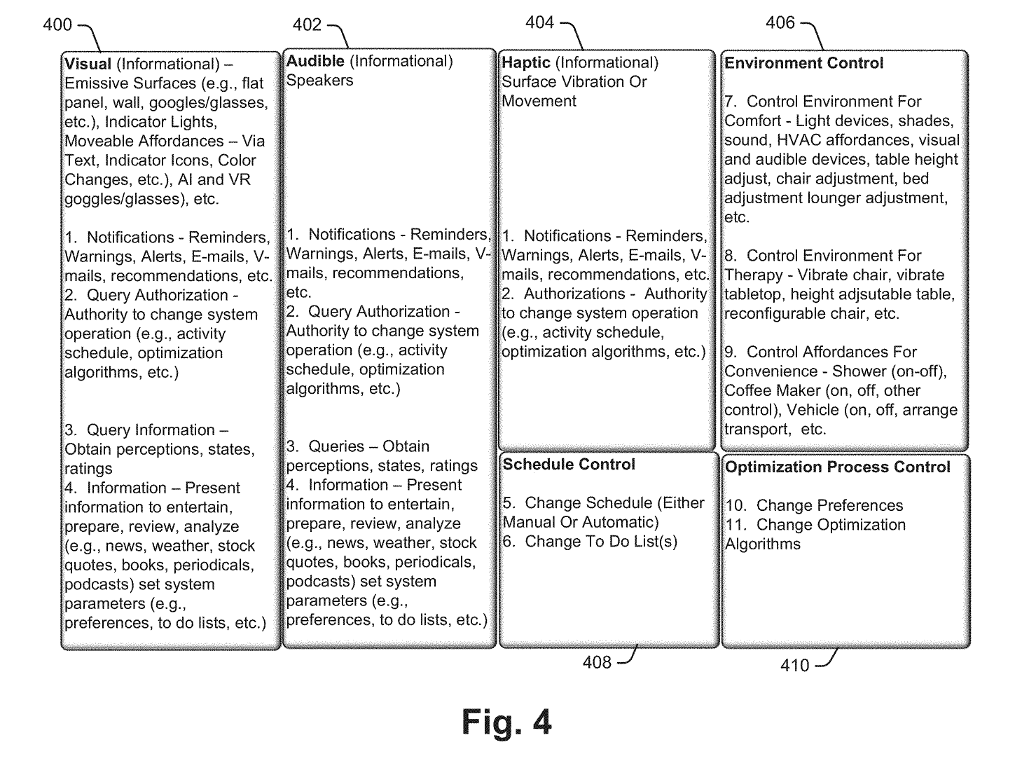

Referring now to FIG. 4, a schematic illustrates six primary optimization system output types including visual 400, audible 402, haptic 404, environment control 406, schedule control 408 and optimization process control 410. As described above, the phrase “output type” refers to a way in which specific information or system output is experienced by a user. For instance, speakers deliver information via sound that is experienced via hearing while a display screen delivers information on a screen that is experienced via sight and a haptic output device signals via movement of some affordance component which is experienced via touch and therefore each of visual, audible and haptic is a different output type. As the label implies, the environment control output type includes output signals or information that is used to change some aspect of a user's environment. The schedule control output type includes output used to change various aspects of a user's schedule and/or system resource schedules. The optimization process control output type includes output that drives changes to the optimization system itself which, in most cases, comprises changes to one or more optimization algorithms or optimization factor weightings that control various other system outputs.

While the six primary output types shown in FIG. 4 are distinguished by how a user experiences those outputs, the phrase “information type” is used in this disclosure to characterize output information that is presented to a user based on a primary function associated with the output information. For instance, a visual notification (e.g., a text warning, illuminated signaling light device, etc.) which has the primary function of notifying a user of something may comprise a first information type while a visual query (e.g., a question presented to a user via text on a display screen) seeking a user's perception of some recent activity has the primary function to collect information from a user may comprise a second information type.

FIG. 4 shows four primary functions that may be associated with different system output information provided to a user including (1) notification, (2) querying to seek authorization, (3) querying to seek information, and (4) information providing. The first primary function, the notification function, include any type of information presentation intended to notify a user of something. For instance, exemplary notifications may remind a user to leave for a meeting in a conference room 10 minutes prior to the start of the meeting, may indicate that a user received an e-mail, a voice mail or some other communication type, may notify a user that a morning meeting has been moved to an afternoon time slot on her schedule, may remind a user to change posture, may notify a user that another person that the user wants to meet with is scheduled to be in her vicinity during some specific time interval in the future, etc. In the case of a notification, the system is simply presenting information to a user without any expectation or even capability for the user responds.

The second primary function, the query to seek authorization function, enables the system to seek user authorization to change the user's environment, to change a user's schedule or to modify optimization algorithms in some way that the system perceives as optimal. For instance, the system may identify that rescheduling a morning meeting during an afternoon time slot would be optimal given a complete set of optimization factors and may seek authorization to change the user's meeting schedule to optimize accordingly. As another instance, the system may detect that a user's level of focus or flow is routinely high during morning meetings after the user exercises the prior evening and may seek authorization from the user to prioritize exercise any evening prior to early important meetings which would result in optimization algorithm changes.

The third primary function, the query to collect information function, presents some type of prompt to a user seeking some type of information from the user. Exemplary instances of queries to collect information include a periodic request that a user rate a recent experience, a query seeking a user's perception of current user conditions, a query to a user to indicate stress level or any other user perception, a query for a user to confirm a high stress state when the system determines based on biometric data that a user is likely highly stressed.

The fourth primary function, the information presentation function, simply presents information of different types to a user for entertainment, preparation, review or any other function. For instance, the system may present a video or audio podcast to a user on some topic of interest. As another instance, the system may serve up news stories via video, audio, text or some combination thereof. As one other instance, the system may present notes from a prior meeting with a team that a user is scheduled to conference with the next day.

While four primary information types and associated functions are described in this disclosure, the described information types and functions are not exhaustive and the system may support many other information types and functions.

Some information types are best presented to a user via one or more of a subset of the haptic, visual or audible output types. To this end, see again FIG. 4 that shows that each of visual and audible output types are well suited for handling notifications, queries for authorization, queries for information collection and information presentation (e.g., the first through fourth information type functions) while the haptic output type is only suitable for notifications and queries for authorization. Thus, while a news article (e.g., presented information) may be visually or audibly presented to a user, haptic presentation of a news article simply makes no sense. Similarly, while a query for a user to confirm a preference can easily be presented visually or audibly, it is difficult to see how such a query could be presented haptically.

Referring again to FIG. 4, unlike the visual, audible and haptic output types 400, 402 and 404, respectively, that present information to a user for consideration and pursuant to one of the four primary functions including notification, querying for authorization, querying for information and information presentation, the schedule, environment and optimization process control output types generate system control signals that can be categorized based on a function to be performed by the output control signals. The exemplary system includes seven different types of control signals including (1) change schedule control signals, (2) change to-do list(s) control signals, (3) control signals for controlling a user's environment for comfort, (4) control signals for controlling a user's environment for therapy, (5) control signals for controlling affordances associated with a user for convenience, (6) control signals to change user preferences, and (7) control signals to change use specific system optimization algorithms. While seven primary control signal types are described here, the listed types are not exhaustive and the system may support many other control signal types.

The first primary control signal type includes control signals to change a user's schedule. For instance, the system may recognize that a user's morning meeting should be moved to an afternoon time slot or that a user is simply exhausted by the time she arrives home at night so that a social activity is no longer optimal and may automatically generate data to drive system scheduling software to change the user's schedule accordingly.

The second primary control signal type includes signals to change a user's to-do list of activities or meetings that are to be fit into the user's schedule. This function covers both activities that need to be performed (e.g., meeting that must be scheduled in the next month) as well as activities that the user aspires to participate in (e.g., schedule meeting with employee X anytime that we are both not busy and in the same facility for at least 30 minutes).

The third primary control signal type includes signals that control affordances to increase a user's comfort or optimally support a user's activities. For instance, at times the system may control light devices to increase light intensity, decrease light intensity, change light color, etc., in ways that are optimized for current user activities. As another instance, the system may control actuators on a task chair to automatically adjust chair configuration in a way that reduces overall stress on a system user's body. Other affordances that may be controlled for comfort include HVAC components and assemblies, visual and audible devices like displays and speakers and other adjustable furniture pieces like beds, lounge chairs, etc. Here speaker output may include sounds, music, noise cancellation effects or any other effect that does not include presentation of any of the four information types described in relation to the audible output type 402 above.

The fourth primary control signal type includes signals that control affordances to perform therapeutic machinations for a user. For instance, the system may generate outputs that control task chair heating elements or vibrators or the like to apply therapy to a user's back, forearms, etc.

The fifth primary control signal type includes signals that control affordances to automate tasks that would typically require user initiation. For instance, the system may generate outputs that control a coffee maker in the morning to start brewing coffee a few minutes after a user wakes up or gets out of bed, may generate outputs that control a user's shower, a washing machine or drying machine or any other home or office appliance, a user's vehicle or other modes of transportation, etc.

The sixth primary control signal type includes signals that are used to modify a user's preferences. For instance, if the system recognizes that a user routinely works out every Tuesday and Thursday evening, the system may automatically generate data specifying a preference for Tuesday and Thursday evening workouts. As another instance, if the system recognizes that a user is routinely unable to focus in morning meetings after the user stays up past midnight during prior evenings, the system may automatically generate data specifying a preference for the user to either go to bed prior to midnight or to avoid morning meetings when the user is up past midnight.

The seventh primary control signal type includes signals used to modify system algorithms. For instance, over time, the system may recognize that while an initial algorithm accounts for user fatigue in addition to many other factors, the fatigue factor is never dispositive in a user's decisions on Mondays. In this case, the system may eliminate or substantially reduce weighting of the fatigue factor in the algorithm when applied on Mondays. As another example, the system may recognize that whenever it is sunny outside, a user's overall ability to focus and energy level is generally maximized which enables the user to work effectively for a longer period of time after lunch. In this case, the system may automatically adjust one or more optimization algorithms to take advantage of the user's increased focus and energy levels on sunny days.

In at least some cases different system outputs are generated in sequences to accomplish different system operations. For instance, where the system needs user authorization to change a user's schedule to optimize time use, the system may generate one or more of a visual, audible or haptic query to seek authorization and then, once a user authorizes a change, the system may transmit a control command to scheduling software to modify the user's schedule per the user's authorization. In addition, if the user's authorization for similar changes is routinely given (e.g., 5 consecutive times), the system may also generate control signals to change optimization algorithms so that the system automatically makes similar schedule changes in the future.

The eleven information types and control output types described in relation to FIG. 4 are each prescriptive in the sense that each is generated to either optimally supports a user within a system environment or to modify the system in ways to better support the user within the system environment. For this reason, unless indicated otherwise, the eleven FIG. 4 output types will be collectively referred to as “system prescriptions” or “prescriptive outputs” and referenced via label 562.

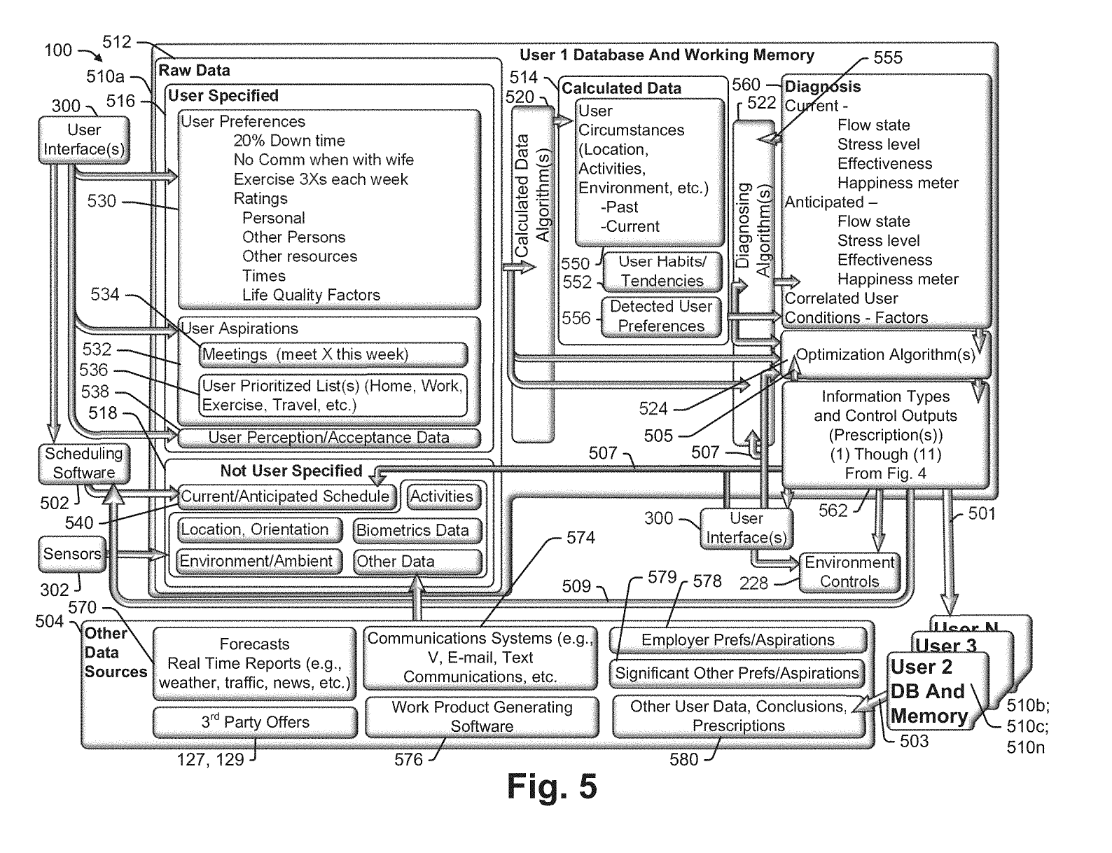

Referring now to FIG. 5, a schematic diagram is presented that illustrates parts of the exemplary optimization system 10 of FIG. 1A that is consistent with at least some embodiments of the present disclosure. FIG. 5 shows system components including user interfaces 300 (e.g. input and output devices), sensors 302, user databases and working memories 510a through 510n (hereinafter “user memories”), other data sources 502, 504 (e.g., sources in addition to user interfaces and sensors) and environment controls 228. The user interfaces, sensors and other data sources provide various types of raw data (e.g., unprocessed) and information to the user memories that store received data and use the data for various purposes. Various user memory algorithms process the received data generating other information types including calculated data (e.g. data derived from or calculated using raw data), diagnosis (e.g., conclusions that can be drawn from calculated and raw data) and ultimately various types of system prescriptions (e.g., the eleven information types and control output types described above with respect to FIG. 4).

Referring still to FIG. 5, the user memories 510a through 510n are shown as independent databases and working memories in the interest of simplifying this explanation. However, it should be appreciated that the user memories may be and in many cases would be implemented as a single database and working memory system where data and algorithms for all system users are combined. In addition, while user interfaces 300, sensors 302, other data sources 502 and 504 and environment controls 228 are shown in relation to the first user memory 510a, those system components or at least subsets thereof may serve several system users at different times or simultaneously while others of those components may be dedicated to specific users. For instance, a large emissive surface interface or camera system that is fixed in a public space may serve several system users sequentially or simultaneously while a wrist worn smart watch interface and sensing assembly may be dedicated to a single system user.

In at least some embodiments each user database and working memory (e.g., 510a) may operate independent of the other user databases and working memories (e.g., 510b through 510n) to support a first user associated therewith. In other cases, as indicated by arrows 501 and 503, each user memory may communicate with other user memories so that the system optimizes for all system users or at least users that are associated with common user groups. For instance, in most cases when it comes to scheduling among various users, optimal time slots for scheduling will depend on current schedules, preferences, locations and other factors of all users that are invited to a meeting or other activity to be scheduled.

In FIG. 5, only first user memory 510a is shown in detail. The other user memories 510b through 510n may include all of the first user memory features or at least subsets thereof in at least some embodiments. User memory 510a stores raw data received from user interfaces 300, sensors 302 and other sources 502 and 504 at 512, calculated data at 514, diagnosis at 560 and prescriptive outputs at 562. In addition, memory 510a also includes algorithms that manipulate user memory 510a data in various ways. A first algorithm type 520 referred to calculated data algorithms, uses raw data 512 to generate various types of calculated data 514. The second algorithm type 522 referred to as diagnosing algorithms, processes calculated data and, in at least some cases, a subset of the raw data 512, to recognize or identify various diagnosis 560. The third algorithm type 524 referred to as optimization algorithms, processes the diagnosis as well as at least subsets of the raw data and calculated data in at least some cases to generate the prescriptive outputs 562 (see again FIG. 4).

Referring still to FIG. 5, user interfaces 300 are for receiving data and information deliberately input by a user via any type of interface input device (see also and again 300 in FIG. 3). Here, deliberate means that the user intentionally performs some activity to enter data or information into the system and should be contrasted with other data and information which is automatically generated by the system independent of any intentional activity by the user. For instance, to deliberately input data to the system, a user may enter data via a keyboard, via selection of options on a graphical user interface on a display screen, via voice commands and other utterances, via gestures within the field of view of a camera device or other gesture sensing device, etc. The exemplary intentional user input data and information may include any type of raw data 512 that a user can enter via any type of input device where the data can be used either as a direct optimization factor or to drive system algorithms that generate calculated data or diagnosis.

One important type of raw user input data includes user preferences 530. In this disclosure, the term “preference” refers to the degree to which a user likes or dislikes someone or something (e.g., an activity, an event, an affordance, a space, an environmental condition, a set of circumstances, etc.). In the case of any user preference, there are at least two types of data required to define the preference including a “preference subject” and a “preference selection”. The preference subject is the “something” that the user sentiment applies to. For instance, a preference subject may be a user's working location when weather conditions are likely to slow down traffic substantially, the time when user should be polled for her perception of her stress level, or the maximum number of meetings to have on Mondays. The preference selection is an indication of a user's inclination regarding the preference subject. For instance, when traffic is likely to be heavy, the user's preference selection may be to work at home, regarding stress perception, the user's preference selection may be that the system query the user just after a high level stress period subsides based on sensed biometric data, and the user's preference selection for maximum number of meetings on Mondays may be three. Another use preference may be that the user should only be notified of e-mails, voice mails, texts and other communications when traveling (e.g., walking or driving) from one location to another to ensure that the user is never distracted by those types of communications while primarily engaged in some other activity. Yet another preference may be that the user only receive notifications when alone, when not in a focused state, etc. Many other preference subjects and selection options are contemplated.

It should be recognized that user preferences typically are not absolute and instead operate as weighting optimization factors in system algorithms so that system outputs are generally, but not always, in line with a user's preferences. In most cases where system outputs are not consistent with a user's preference, the incongruity will be the result of system algorithms applying multiple system rules and user preferences at the same time where a first preference is inconsistent with a second preference or a system rule so that the first preference is dominated by the second or the rule. For example, where a user's first preference is to work at home when traffic is expected to be heavy and the user's second preference is to have in person meetings with her manager every other Tuesday morning, the in person meeting preference may dominate the work location preference so that the user is encouraged to travel to an in person meeting location on a Tuesday morning even when traffic is expected to be heavy.

In addition to binary preferences (e.g., specific circumstances result in a specific preference (e.g., strong if-then relationships between circumstances and preferences)), in at least some cases, in addition to being characterized by preference subject and preference selection, one or more preferences may also be characterized by a “preference rating” which indicates the strength of a user's specific preference. Here, the rating may, for instance, be based on a range scale of 1 to 10 with ten being the strongest preference. The idea here is that users feel differently about different preferences and the system should accommodate those sentiments. For instance, a user may rate a preference for in person meetings with her manager a 10 and her work location preference based on anticipated traffic a five out of ten, meaning that the in person meeting preference would be weighted more heavily in system algorithms than the work location preference.

User preferences may be extremely simple or may be multi-factor preferences which tend to be relatively complex. A simple preference may be that a user wants at least 20% of his time at work to be rejuvenation time to allow the user to regenerate throughout the day between meetings. Another instance may be that the user should not be disturbed by e-mails, texts, voice calls, etc., whenever she is within 10 feet of her spouse. Other exemplary simple preferences may be to exercise three times a week, not have more than two back to back meetings, have at least 15 minutes of downtime between meetings, to sleep at least 7 hours every evening.

More complex multifactor preferences may include the following, (i) be notified of a next meeting with plenty of time to travel to the location of the meeting given average travel times between a current location the next meeting location, (ii) have no activities scheduled for the first hour of time in the office any day where the user did not leave the office prior to 6 PM, (iii) have no group meetings scheduled for Thursday afternoons when there is a meeting scheduled on the following Friday prior to 10 AM, (iv) to exercise on Tuesdays and Thursdays if it is raining outside, (v) to sleep at least 8 hours each evening following an evening when a user only slept 6 or less hours, (vi) to get up at 5 AM every morning other than Friday if the user fell asleep prior to 10 PM the prior evening and if the user experienced at least 2 deep REM stages of sleep, (vii) to not drive in the snow unless there is a high importance meeting, (viii) to work at home on any Friday when it is sunny and a spouse is also at home, to eat at a specific restaurant when eating Mexican food with a specific other person, (ix) to use a specific workstation when in a specific place of work while it is sunny outside, (x) to use a specific conference room when participating in a telepresence session with more than two other remote attendees, (xi) to occupy a workstation that is outside the main flow of traffic through a workspace during a morning work session, (xii) to only be specifically locatable by work colleagues when located within a home office after 8 PM and prior to midnight, (xiii) to never have more than 4 meetings in any one 8 hour period more than two days in a row, (xiv) to sleep in for an additional 30 minutes when the weather is inclement and the user does not have any high importance meetings until after noon, (xv) to order a specific type of caffeine drink at a specific café while traveling to a specific workplace prior to 10 AM on Wednesday mornings, etc.

In addition to expressing different resource preferences, a user may express different environmental or ambient condition preferences. For instance, a user may express a preference on a 1 to 10 scale for natural light, light intensity generally, audio noise level, visual noise level, proximity to a refreshment alcove or restroom, etc., at different times of day or when at different facilities, at different locations within a facility, etc. Again, ambient or environmental preferences may also be expressed in a simple binary fashion.

In addition, a user may express different event or activity type preferences. For example, a user may express a high preference value on a 1 to 10 scale for communications with her family members (e.g., when a call from a family member comes in, the call ranks that as a high priority). As another example, a user may express a high preference for an exercise activity and a relatively lower yet still high preference to listen to a specific series of podcasts while expressing a low preference for administrative meetings.

One other special type of user preference may include a preference for more or less guidance from the optimization system. For instance, a user may simply not want advice or recommendations from the system at all prior to 8 AM so that the user is not whipsawed between different daily options early in the morning while waking up but may want a full slate of system recommendations while travelling from home to work or from work to home. In this case, one user preference may allow the user to dial up or down system guidance/recommendations at different times during the user's day. Unless indicated otherwise this adjustable system preference feature will be referred to as the system activity level adjustment. In some cases the system activity level adjustment may be set in the database for different times of different days during a user's week so that system activity level can be automatically changed on a time basis only. In other cases the system activity level adjustment may be based on instantaneous user activity (e.g., travelling, sleeping, in a flow state, on a call with another person, etc.) so that the system is programmed to only perform certain activities when the user is busy with specific tasks.

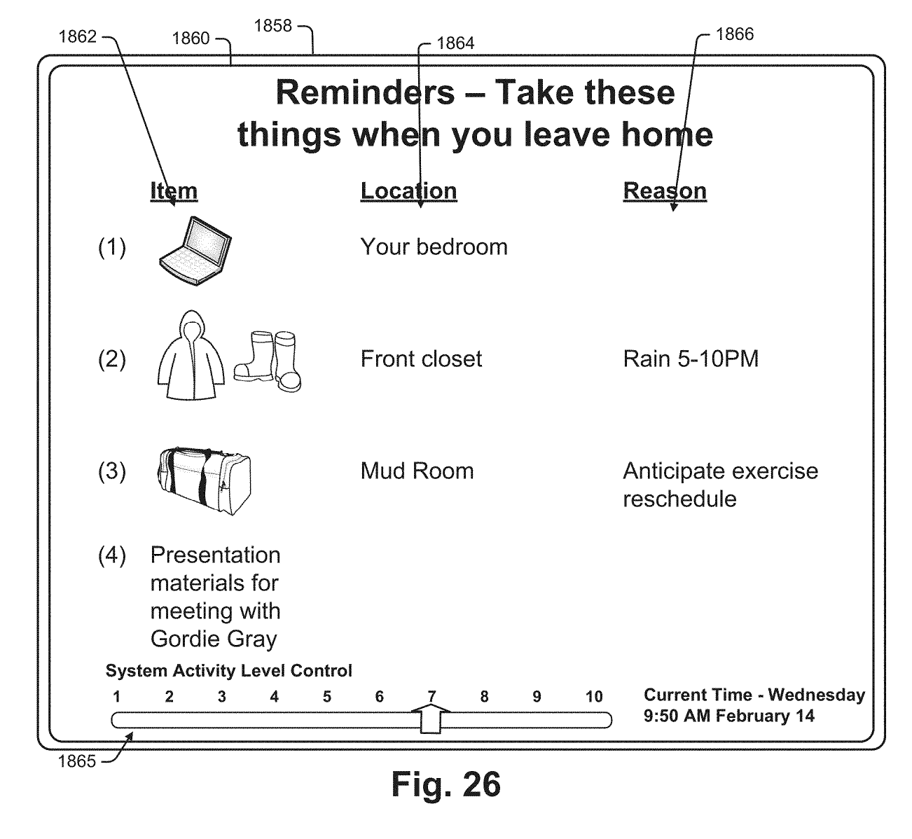

In other cases the system may have default time and/or activity based activity level adjustments but the user may be afforded an opportunity to adjust system activity level at any time to increase or decrease that level per instantaneous user preference. To this end, see for instance the interface 1860 presented in FIG. 26 where a system activity level control 1864 is shown that a user can use to change the activity level of the system. The exemplary activity level control 1865 includes a 1-10 scale and a pointer icon (shown set at the 7 level) that a user can touch and drag along the scale to adjust current and/or future system activity level. In some cases as a user moves the pointer icon along the scale, the system may automatically modify the information presented on a display screen to reflect the currently selected level of system activity so that the user has a sense of how the selection would change the nature of the currently presented information. Thus, for instance, in FIG. 26, as the pointer icon is slid to a higher number, more content may be presented on the illustrated interface 1860 consistent with more system activity and, as the icon is slid to a lower number, content on the interface 1860 may be removed in a manner consistent with less system activity. While the system activity level control 1865 is shown in FIG. 26 it is contemplated that that type of controller or others akin thereto may be provided either routinely or upon user request (e.g., utterance of a command like “present system activity control level”).

Referring still to FIG. 5, in addition to user preferences, raw data specified by a user via a user input interface 300 may include user aspirations 532 which indicate specific activities that a user would like to or aspires to participate in. For instance, a user may maintain a prioritized list 536 of chores or tasks to perform around her home that, while not scheduled, are things that need to be done at some point. Here, it is contemplated that a user's chore list will be maintained in the raw data set and used to suggest “fill in” activities or to automatically schedule activities that make sense based on a user's schedule, optimization algorithms and other factors. Here, where chore list items are prioritized, the optimization algorithms may take into account the priorities of different chores as well as other factors when suggesting fill in activities. Other prioritized lists may exist for work, exercise, social events, travel options, or any other category of activities or events.

Another type of aspiration 532 that a user may specify that may stand on its own as a list includes specific meetings 534 with specific people or types of people. For instance, a user may desire to meet with three specific employees and one non-specific HR employee. Here, in at least some cases, a simple list of the three specific employees and the non-specific HR employee may be enough for system processors to attempt to identify times in the near future when meetings can be set up that are at least optimized for the user and, in some cases, may also be optimized for the other employees.

In at least some cases user aspirations may persist in the sense that a user intends to repeat the activities associated therewith whenever possible. For instance, a home list may include 30 minutes of yoga as an exercise type that the user would like to participate in whenever possible. As another instance, a second user may simply be specified on the meeting list 434 for a first user meaning that whenever the second user is scheduled to be collocated and available when the first user's optimization algorithms indicate that a meeting would fit well, the meeting should be set up or at least suggested to one or both of the first and second users.

In the case of persistent user aspirations (e.g., persistent tasks, meetings, etc.), the system may have built in hysteresis so that if a persistent aspiration is fulfilled one day (e.g., a meeting occurs), the system may not reschedule or re-suggest another instance of the same aspirational activity for another two weeks even if other optimization factor requirements are met. In a similar fashion, if a persistent aspirational activity has not occurred in a long time (e.g., 2 months) because all optimization factor requirements have not been met, the optimization algorithms may automatically adjust to have less stringent factor requirements so that an instance of the aspirational activity can be advised or automatically scheduled.

In other cases one or more or even all user aspirational activities may each have associated time ranges. For instance, a user may specify that she wants to have a meeting with another person within two weeks. Here, the system may initially apply optimization algorithms to the next two weeks and do at least one of two things. First, if only one or a small set of schedule options meet the optimization factor requirements, the system may present those options to the user for selection and at least tentative scheduling. In this case, the scheduling would be tentative in that it could be changed subsequently if a change were consistent with optimization algorithms. Second, if there are a large number of schedule options that meet the optimization factor requirements, the system may simply log the meeting as an aspiration to be accomplished in the next 2 weeks and then fill the meeting into a user's schedule whenever it makes sense on a more real time basis. By logging the meeting as an aspiration as opposed to a firmly scheduled meeting, the system leaves the user's schedule more open for accommodating other meetings and other activities for which optimal time slots may be less available. This concept of logging activities for time ranges as opposed to specific periods will be referred to hereinafter as “floating activities” and will be described in more detail hereafter.

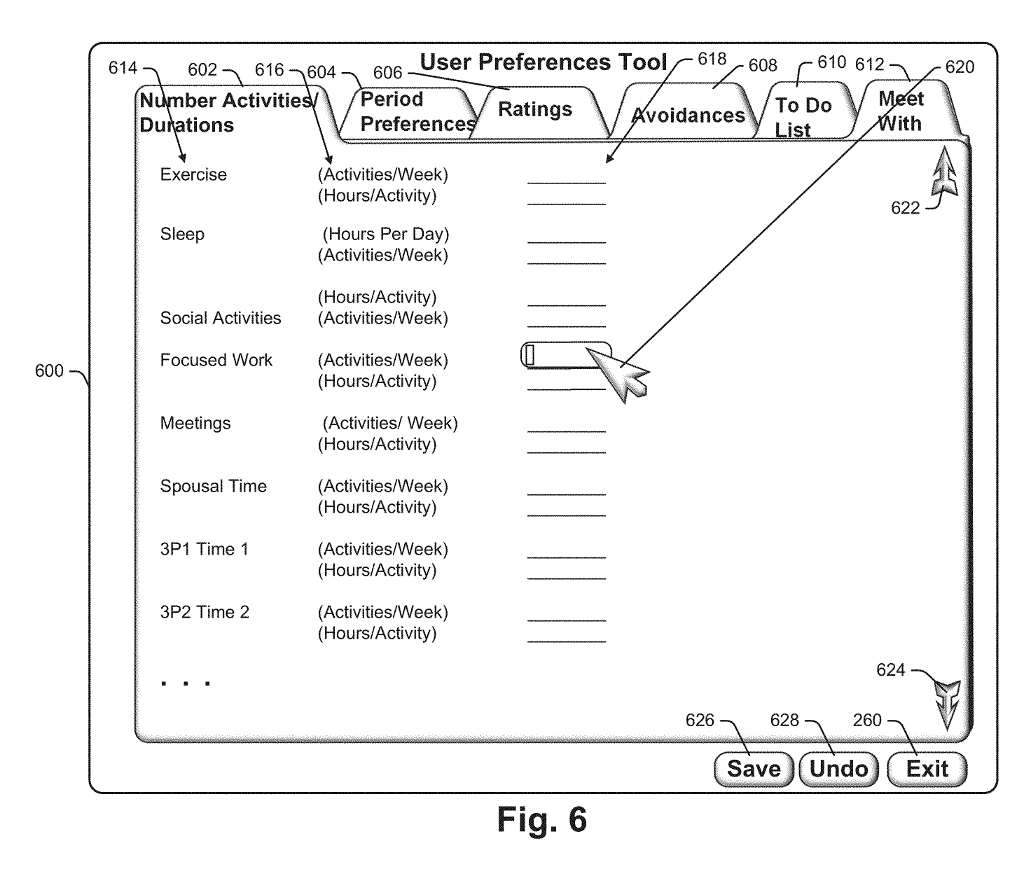

Referring now to FIGS. 6 through 10, an exemplary graphical user interface 600 that may be presented to a user on any suitable emissive surface (e.g., the display on laptop 126 in FIG. 1A) linked to the optimization system 10 for entering user preferences and aspirations is shown. In the exemplary system, six preference and aspiration tabs are presented to a user for entering different preference and aspiration data. The six preference and aspiration tabs include a “Number Activities/Duration” tab 602, a “Period Preferences” tab 604, a “Ratings” tab 606, an “Avoidances” tab 608, a “To-Do List” tab 610 and a “Meeting With” tab 612. The interface and preference/aspiration options are only exemplary and many other preference and aspiration settings may be included in other systems. For instance, none of the illustrated tabs allow a user to select preferred characteristics of user space including natural light preferences, temperature preferences, a preference related to degree of visual distraction in a specific location, etc., each of which may be supported in some systems.

Each of FIGS. 6 through 10 shows a different set of tools and representations for specifying user preferences and lists. Any combination of the tools and comparable representations may be presented via any one of the screenshots for setting preferences and making lists.

FIG. 6 shows a screenshot of the interface when the Number Activities/Duration tab 602 is selected. The FIG. 6 screenshot includes navigation and graphical user input tools and features that are common to all of the screenshots shown including an on screen mouse controlled cursor 620 for moving about the screen and selecting hyperlink and functional icons presented in the screenshots, scrolling arrows 622 and 624 for accessing additional interface content that does not fit on a current interface representation as well as “Save”, “Undo” and “Exit” icons 626, 628 and 630, respectively, for saving current preferences and aspirations, undoing a most recent medication to preference and aspiration options and existing the preferences and aspirations interface, respectively.

Referring still to FIG. 6, the screenshot includes a list of activities in column 614, settable characteristics of each activity in column 616 and a column of fields at 618 that includes a separate field for each of the settable characteristics in column 614. The exemplary activities column includes, among other activities, exercise, sleep, social activities, focused work, meetings, etc. Here, it is contemplated that the system will be preprogrammed with a long list of user activities supported by the system so that the user can simply scroll down to activities that the user has preferences for and specify her preferences. In most cases a user may select only a subset of activities for which to indicate preferences and which activities are defined by preferences may be completely left up to the user's discretion. In other cases it may be that system algorithms require a user to indicate preferences for at least a specific subset of activities. In at least some cases the order of activities in list column 614 will be based on a predetermined relative importance scale so that activities where most users have preferences are near the top of the list.

The activity characteristics column 616 includes a separate list of characteristics for each of the activities in column 614. In the illustrated example, column 616 only includes two characteristics including “Activities/Week” and “Hours/Activity”. A user can select a field in column 618 corresponding to a specific activity and characteristics combination in columns 614 and 616 via pointer 620 and can enter a value for each selected field. In other cases it is contemplated that other activity characteristics may be presented in column 616 for each of the activities in column 614. For instance, in the case of the exercise activity, other activity characteristics in column 616 may include an intensity characteristic, a rejuvenation duration characteristic, etc.

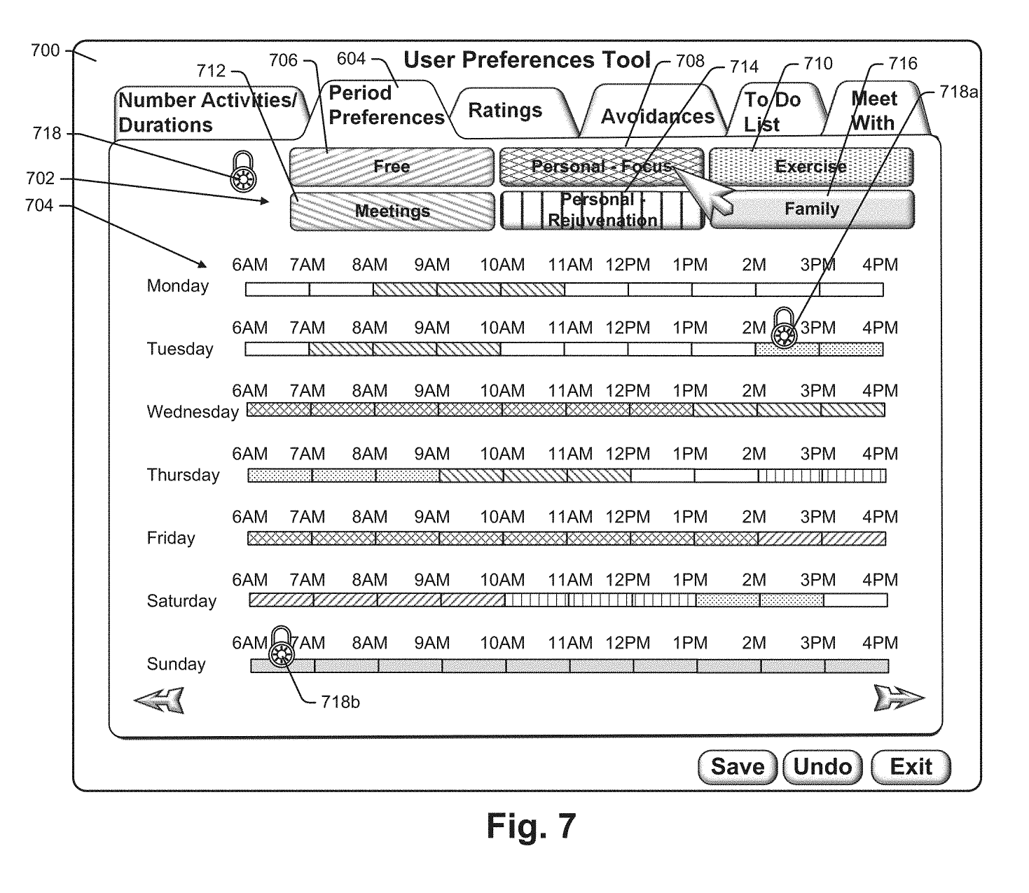

FIG. 7 shows a screenshot 700 of the interface when the Period Preferences tab 604 is selected. Screenshot 700 includes a list of time descriptors 702 and a preference schedule at 704. Here, a user can associate different time descriptors with different periods on the preference schedule 704 to specify user preferences for activities during specific weekly recurring time blocks. To this end, the exemplary time descriptors include a “Free” descriptor 706 associated with free or unscheduled time for a user, a “Personal-Focus” descriptor 708 indicating that the user prefers that associated time slots be reserved if possible for personal focused activities, an “exercise” descriptor 710 indicating that the user prefers that associated time slots be reserved for exercise activities, a “Meetings” descriptor 712 indicating that the user prefers that associated time slots be reserved for meetings, a “Personal—Rejuvenation” descriptor 714 indicating that the user prefers that associated time slots be reserved for personal rejuvenation and a “Family” descriptor 716 indicating that the user prefers that associated time slots be reserved for family activities. Many other activity descriptors are contemplated and, as in the case of the activities list in FIG. 6, a predefined extended list of descriptors may be presented to a user for selection.

While the time descriptors in FIG. 7 are each expressed as an activity type, in at least some cases at least a subset of the descriptors may be restrictive or limiting. For instance, one descriptor may indicate “No E-mails” and may be selectable to express a user preference that the user not be notified of e-mails during an associated period. As another instance, another restrictive descriptor may include “No Meetings” and be selectable to express a user preference that no meetings be scheduled for the user during an associated period. Here, if the no meetings restriction is the only descriptor associated with a time slot, the system would allow any non-meeting activity (e.g., family, exercise, rejuvenation, etc.) to be schedule for the user during the time slot.

Referring still to FIG. 7, once a user selects a descriptor type from the list 702, the user may use the pointer icon to select one or more time slots from the preference schedule 704 to associate a descriptor preference with the slot(s). In FIG. 7 each of the descriptors 706 through 714 is shown differently cross hatched to indicate different colors. As a user selects time slots to associate with time descriptors, the time slots may be color coded to indicate the associations. Thus, for instance, it can be seen that the time period between 8 and 11 AM on Mondays is cross hatched left down to right to match the meetings descriptor 712 hatching to indicate that the user has expressed a preference for meetings to be scheduled during that time period.

Referring still to FIG. 7, the time slot and descriptor associations only indicate user preferences and not absolute rules. In some cases it is contemplated that a user may be able to specify absolute rules for time use. To this end, see in FIG. 7 that a lock icon 718 is shown adjacent the time descriptor options 712. Here, after a user associates a time slot with a time descriptor, it is contemplated that the user may select lock icon 718 and then reselect the time slot in the preference schedule to create an absolute rule as opposed to a simple preference. When a timeslot is locked, a lock icon appears at a location spatially associated with the slit. For instance, in FIG. 7, see exemplary lock icons 718a and 718b associated with time slots on Tuesday and Sunday, respectively.

In at least some cases it is contemplated that two or more time descriptors may be associated with the tame time slot where the two descriptors are not contrary to each other. For instance, a user may select personal focus and no e-mail descriptors for a single time slot so that two preferences apply to the associated slot. In some cases three or more preferences may be associated with a single time slot.

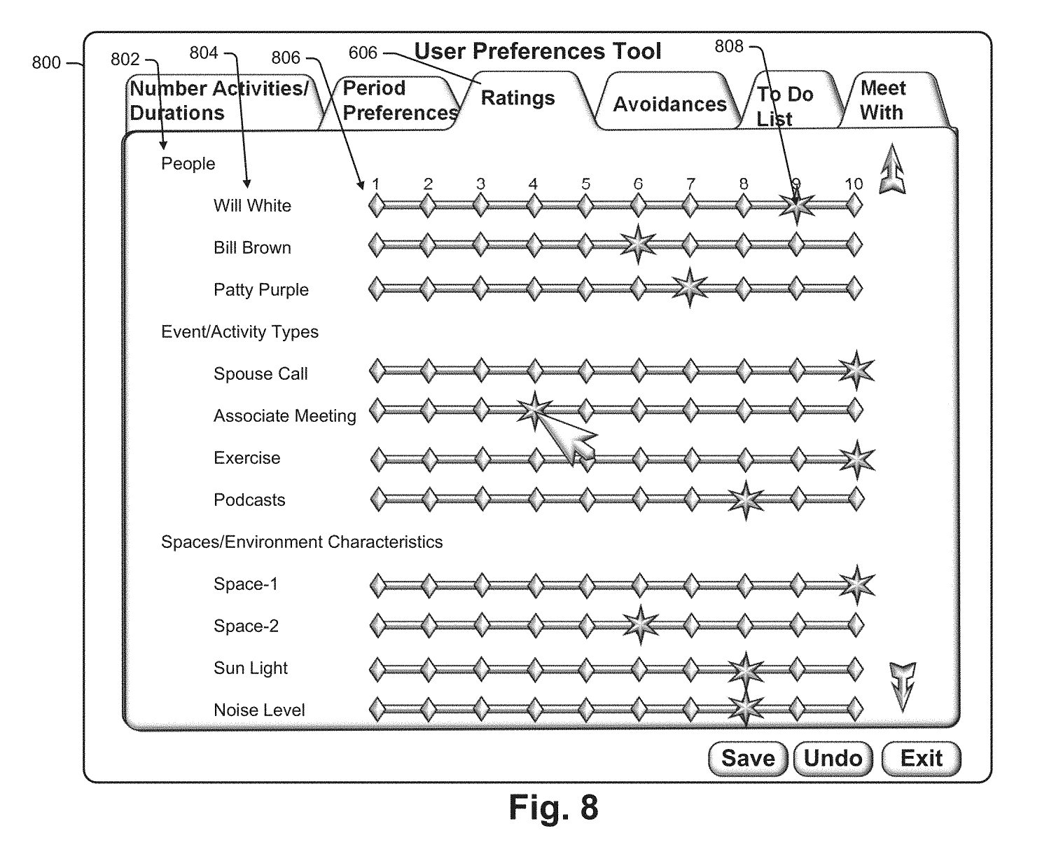

FIG. 8 shows a screenshot 800 presented to a user when the ratings tab 604 is selected. Screenshot 800 includes a list of things for which a user can specify ratings in a left hand column with different instances of each of the things in a second column 804 as well a separate rating selection scales 806 for each of the instances of the things rated. The exemplary things to rate include people, event/activity types, spaces/environment characteristics, etc. Again, other things to rate may be accessible via the scroll arrows to the left of the screenshot. A list of specific people is presented under the “People” category at 804. The list presented includes people the user already ranked and while not shown, the screenshot would include some tool for searching for other system users to add to the list. The scales 806 include a separate scale for each person in column 804 and a selector icon 808 that a user can move to different scale values to change user ratings. The illustrated scale has 1 through 10 values where a 10 would comprise a high ranking and a 1 a low ranking.

In at least some cases the people ranking on scales 806 affects how much a ranked person's optimization is considered when optimizing for the user that make the ranking selection. For instance, if a first user ranks Will White high on the scale 806, the first user's optimization algorithms would optimize for Will White as well as the first user when generating prescriptive outputs for the first user.

In other cases the people raking on scale 806 may affect other factors like, for instance, workstation suggestions, meeting suggestions, etc. For instance, again, where Will White is ranked high on the scale 806, the system may consider Will White's location when identifying an optimal workstation to suggest to the first user or may be more prone to suggest meetings with Will White when the first user has free time and is located in the same facility as Will White.

A list of specific events and activity types is presented under the “Events/Activity Types” category at 804. The list presented includes spousal call, associate meeting, exercise and podcasts and, again, the scales at 806 allow a user to rate each event and activity type on a 1 to 10 scale to indicate the importance of each, effectively indicating how each type instance should be weighted when factored into the optimization algorithms. A list of spaces and environment characteristics is presented in column 804 where each list entry includes a 1 to 10 scale. Again, here, a user can select different ratings for each of the list entries which affects weightings to be applied in the optimization algorithms.

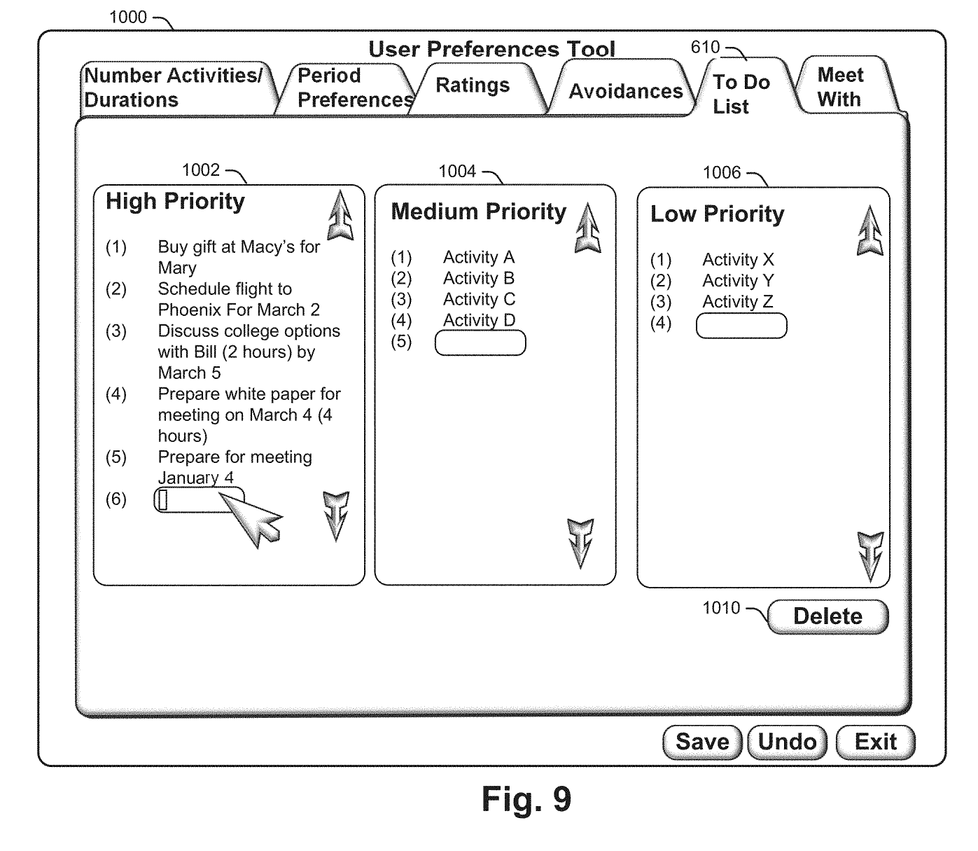

FIG. 9 shows a screenshot 1000 presented when the “To-Do List” tab 610 is selected that includes tools for creating to-do lists and prioritizing different activities. The screenshot includes three different to-do lists including a high priority list 1002, a medium priority list 1004 and a low priority list 1006. A user can select items on any of the lists and then select a delete icon 1010 to remove an item from the list. Additional items can be added in a field at the end of each of the lists. In at least some cases list items will simply indicate the items without more. In other cases temporal aspects of the item may be indicated. For instance, a user may include a date in the item description. In these cases it is contemplated that the system may identify a date in any list item and then set that date as a date by which the item should be completed. In other cases when an item includes a date, the system may query a user for the nature of the date (e.g., date by which to complete, date on which to delete the item automatically from the list, etc.). In other cases an item description may include an expected duration of time the user anticipates is required to complete the item. To this end see the exemplary forth item description in list 1002 that reads “Prepare for white paper for meeting on March 4 (4 hours)”. In this case, the system would identify the 4 hour anticipated period and a completion date prior to March 4 (e.g., March 2). Other list entry qualifiers are contemplated which could be identified by a system processor.

The idea with the items on the FIG. 9 lists is that the system will identify times on a user's schedule that are free and will suggest list entries that are optimal given optimization factors. As a user accepts suggestions and completes list entry activities, the entries may be removed from the list automatically by the system. Although not shown, completed entries may be archived for access by a user subsequently.

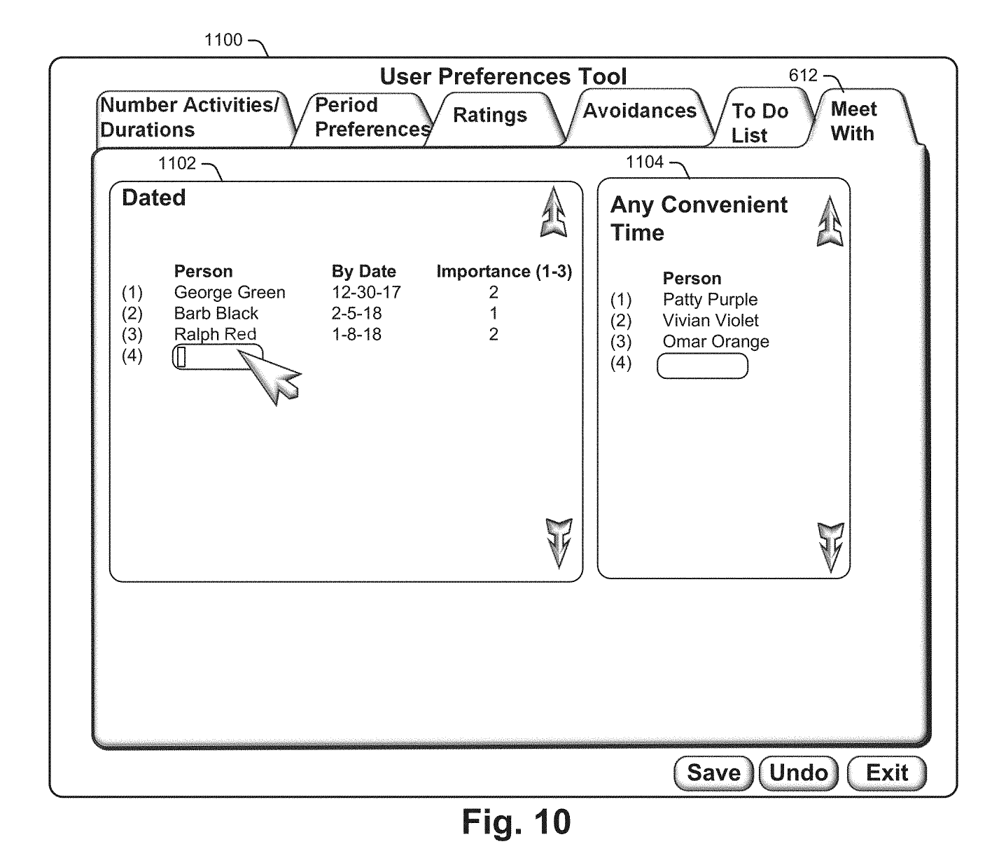

FIG. 10 shows a screenshot 1100 presented when the “Meet With” tab 612 is selected that includes tools for specifying aspirational meetings and meeting priorities. The screenshot includes two different meeting lists including a “Dated” list 1102 and an “Any Convenient Time” list 1104. The dated list includes a list of meetings that need to occur prior to specific dates while list 1104 includes people a user generally wants to meet with. List 1102 also includes a priority indication for each of the list meetings which can be used to weight each of the meetings based on importance when the system is considering optimal time use for a user. A use can delete items from each list, move items between the lists and add new items to either list.

Referring again to FIGS. 6 through 10, it should be appreciated that a large number of user preferences and lists are contemplated and that some users may find the preference and list specifying requirements burdensome. The specifying burden would be exacerbated in cases where even more detailed preferences are optimally specified by users which will often be the case.

In at least some embodiments it is contemplated that instead of or as a supplement to the manual preference and list specifying process described above, the system may be programed to periodically present preference setting options to a user so that preferences and lists can be kept up to date with minimal user effort. Here, in addition to reducing user effort to specify preferences, this dynamic preference setting feature is advantageous because it can help a user identify specific preferences that the user may have difficulty perceiving on her own. For instance, the system may track all resources that a person encounters or interacts with during the course of a week and, for resources that are not currently rated or for which preferences are not already specified, every Saturday morning, the system may present rating or preference setting tools akin to those described in FIGS. 6 through 10, for entering user preferences. For example, where a user encounters an unrated person that is not associated with a current preference indication, the system may present a screenshot similar to FIG. 8 where the user can rate the unrated other user. As another example, the system may recognize that a user routinely cancels exercise activities on days when she has four or more meetings scheduled for the same day. Here, the system may be programmed to notice persistent correlations between activities and a user's responses and may seek affirmation of a new preference from the user related to not scheduling exercise sessions on days when the user has four or more meetings scheduled.

In the case of a dynamic preference setting feature, it is contemplated that the system may have an inertial characteristic which limits the setting feature so that a user is only queried about a new preference subject once subject encounters pass some threshold level. For instance, the system may not query a user to rate an unrated person until the user's encounter numbers and encounter durations exceed some threshold level (e.g., at least five encounters of at least 5 minutes each) or some threshold level within a threshold period of time (e.g., a 30 day period). As another instance, the system may not query a user about a preference to avoid exercise periods on days with four or more meetings scheduled until the user cancels exercise sessions at least four out of five previous times under the same circumstances.

In still other cases it is contemplated that a user may be able to trigger an instantaneous preference specifying process at essentially any time that the user has access to a system linked interface. For instance, in the case of one of the display portals 120 in FIG. 1A, a user may utter the trigger phrase “Wake voice” causing the portal processor to monitor for a next user utterance. The user may then utter “Set preference” or some other intuitive and easily recognizable command causing the portal processor to initiate a preference setting process wherein screenshots like one or more of those in FIGS. 6 through 10 are presented to a user for preference and/or rating specification.

In at least some cases it is contemplated that when the system initiates the preference setting process based on receiving a user trigger signal, the system may automatically identify all or at least a subset of recent activities, encountered people, or resources used by the initiating user and may provide a list of those options for preference entry. Thus, for instance, if a user left a meeting with first and second other users just prior to initiating a preference setting process, the system may identify the other two users, the meeting location and one or more other aspects related to the meeting (e.g., meeting topics, the type of chair the user used during the meeting, other conference space affordances like a specific type of content sharing configuration, etc.) and present each for rating or preference entry during the process. Here, instead of requiring the user to specify preference subject, the system attempts to automatically identify the subject and provide preference and rating options for selection. In addition to helping a user identify preferable options, this feature helps ensure that a user's preferences are expressed in a way that is useable by the system algorithms.

In other cases preferences may be expressed verbally. For instance, in embodiments where an audio based portal 122 initiates a preference setting process in response to a trigger command and uttered phrase, the system may audibly query the user by synthesizing a voice to ask “What would you like to set a preference for?”. The user's uttered response would then be examined to identify a preference subject and then would query the user for some type of preference rating. In cases where the system enables a user to quickly and intuitively specify preferences, the idea is that users will be more accurate and even honest about preferences if the user can enter those preferences immediately or shortly after the user experiences or encounters the preference subject.

It has been recognized that while a lot of data about user conditions and states can be generated via sensors or derived from sensor data, all people are different and in some cases user conditions derived from sensor data simply do not reflect a user's perceptions of her own conditions. It has also been recognized that there are many user conditions that a system simply cannot or can only imperfectly identify based on sensed data. For instance, level of happiness, level of sadness, level of engagement in some activity, level of focus, level of effectiveness, level of efficiency, etc., are all conditions that are difficult to accurately identify based on sensed data.

In at least some embodiments the optimization system will receive or seek a user's instantaneous perceptions about her instantaneous condition(s) either periodically or on command. In some cases it is contemplated that sensor data will be used to calculate or identify user conditions, in parallel with receiving a user's perceptions and one or both of the user's calculated conditions and user perceived conditions may be used to drive system algorithms and/or to tweak algorithms based on disparities between the two.

In this disclosure, the term “preference” refers to whether a user likes or dislikes someone or something (e.g., a specific activity, a specific event, an affordance, a space, an environmental condition, a set of circumstances, etc.). In contrast, the term “perception” is used in this disclosure to refer to a user's instantaneous condition(s). For example, while a first user may express an extremely positive preference for a specific second person, she may perceive that on a 1 to 10 effectiveness scale, she (e.g., the first user) rates her effectiveness a 3 during a meeting with the first person. Here, the 3 effectiveness rating is independent of the high preference rating for the second person. Perception ratings are important because they can be used by the system at times to identify causes of the user's condition(s) and then the system can either avoid circumstances that resulted in poor conditions or steer the user toward circumstances correlated with good conditions in the past.

Referring again to FIG. 5, user interfaces 300 are also used, in at least some embodiments, to input user perceptions 538. In the case of any user perception, there are two types of data required to define the perception including “user sentiment(s)” and a “perception subject”. A user sentiment is an indication of how the user feels or what the user thinks about something and may, for instance, be expressed as good, bad, happy, focused, tired, engaged, lethargic, etc., or on a sliding scale (e.g., 1 to 10 with ten very good and 1 bad), positive or negative, etc. The perception subject is the “something” that the user sentiment applies to. Thus, for instance, the perception subject may be an entire day or week, a prior hour period, a prior meeting, a specific aspect of a prior meeting (e.g., effectiveness, focus, engagement, value of use of time, etc.) a prior exercise activity, food just eaten, a trip through snow to work, sleep quality, a person that a user encounters either regularly or sporadically, etc.

In some cases the system will query a user on perceptions and may, as part of a query, define a perception subject for the user to tee up a simple answer. For instance, in at least some cases it is contemplated that the system will periodically query a user for the user's instantaneous perception of some specific activity, occurrence, the user's state or user's perceived conditions. As one example, at the end of each workday the system may query a user “Rate your day on a scale from 1 to 10 with a 10 being great?” Here, the expectation would be that the user utters or otherwise inputs a number in the range from 1 to 10 or a phrase including a number in that range via an input device or system sensor and then the system distills out the entered number and stores that number as an indicator of the user's perception.

In some cases the system may generate more specific queries to elicit user perceptions. For instance, at the end of the day, the system may pose a series of questions such as, “Were you hurried today?”, “Were you stressed more than normal today?”, “Were you happy today?”, “Were you satisfied with your social activities today?”, “Were you alert today?”, etc. In some cases the questions will be developed to elicit simple yes and no answers. In other cases at least some of the questions may be more open ended so that a user can answer in phrases and sentences and the system may use artificial intelligence to recognize the meanings of responses. It is contemplated that one preference a user will set or specify may be when to be queries for user perceptions.

While the system may query a user for perceptions at specific times (e.g., end of the day, when a user wakes up in the morning, etc.), the system may also use current user conditions or activities as triggers for when to query the user for perceptions in a dynamic fashion. For instance, if a user just completed a specific activity and has a few minutes prior to a next scheduled activity, the system may query the user for perceptions related to the completed activity (e.g., “Do you think you were alert during your previous meeting?”, “Do you think you were fully engaged during your previous meeting?”, etc.). As another instance, if sensed biometric data during a prior two hour period is consistent with a high stress state, the system may query the user as to how she feels, current disposition, etc. Thus, in these cases, the system is monitoring the user's activities as well as the user's conditions and is selecting perception query times as well as perception queries based on recent user activities, the user's current activities and the user's detected conditions.

In at least some cases it is contemplated that the system will facilitate perception input whenever a user desires. For instance, in the case of an audio input portal (see again 122 in FIG. 1A), after a use audibly triggers the portal to monitor for commands, the user may utter a perception input phrase such as “My perceptions” causing the portal to monitor for a verbal indication of the user's perceptions. Here, the user perception indication may take many different forms including a simple “Like” or “Dislike” utterance to indicate perception of a prior activity in a binary fashion. In other cases, the perception indication may be on a 1 to 10 scale or may support more complex phrase entry where a system processor uses artificial intelligence to discern the meaning of the user input. To elicit both user sentiment and perception subject, in response to the “My perceptions” utterance, the system may pose a first query “Perception of what?” and then, after a perception subject is uttered and recognized, the system may pose a second query “Rate your perception on a scale of 1 to 10” or something akin thereto.

Over time it is contemplated that the system will learn about each specific system user and, eventually, the system will be able to discern user perceptions for specific users based on user conditions, recent prior activities and even on future scheduled activities. For instance, if the system queries a user five separate times about five separate extended durations of stress as detected by biometric sensors and the user responds each time that she felt great, the system may be programmed to learn from the user's perceptions and to determine that the user likely is unaffected by periodic extended durations of stress. In cases where the system learns user perceptions, the system may automatically stop querying the user for perceptions in at least a subset of cases or, in the alternative, may query the user less about perceptions in those cases. For instance, again, where a user feels great at the end of each of five high stress periods, the system may be programmed to only query the user every tenth consecutive high stress period about perceptions and, if an unexpected answer is received, may then restart querying about perception whenever any trigger event occurs.

In at least some cases the system may use the user's perception values as seed data for system algorithms that control the user's future activities (e.g., next day activities). For instance, where the user uttered “2” to characterize her day (e.g., a relatively low value indicating a relatively difficult day), the system may examine the user's next day and identify one or more schedule adjustments to enable the user to sleep later the next morning or to schedule an exercise activity for the next morning. Here, the use's perceptions operate as optimization factors in the optimization algorithms.

In other cases the system may automatically use user perception data to modify optimization algorithms themselves. For instance, where a specific user thrives on periodic extended periods of stress, instead of using an extended stress period as an indicator of a negative user state or condition, an optimization algorithm may be modified so that at least periodic extended stress periods are considered positive user state indicators. In this regard, for instance, instead of an optimization algorithm tending to spread out three meetings over a two day period for a user, the algorithm may favor grouping meetings together to use time more efficiently and free up other extended periods of a user's schedule for other activities despite the likelihood of high user stress during the grouped meeting time slots.

In cases where a user indicates a general perception like “happy” or “focused” or “distracted” or “good” or “bad”, etc., the system may be programmed to analyze all or a subset of temporally proximate user circumstances to discern the probable cause or causes of the user's perception. For instance, in a simple case where a user indicates that she is stressed, the system may automatically identify that the user just completed three back to back meetings and “recognize” that the user's stress is likely related to the back to back meetings without any intervening break. As another simple examiner, if a user indicates “distracted”, the system may first recognize that the user just left an 8 AM meeting and associate the perception with that meeting and, second, consider the user's sleep characteristics the prior evening, the fact that the user's commute was an hour longer than expected, etc., to identify likely causes for the user's distracted state.

In addition to examining prior user activities or conditions (e.g., a snow storm during a commute) to identify causes of user perceptions, the system may also examine current or future activities, conditions, etc. Regarding current conditions and activities, if a user is currently happy, the user's perception is often related to current conditions or activities and therefore identifying current activities and conditions makes sense. Regarding future conditions and activities, often times a user's current mood or state is affected by the schedule and commitments that they face in the near future. For example, a user that has two important back to back presentations may be extremely stressed an hour before the presentations commence. As another instance, a user that has an exercise activity scheduled for the early afternoon may feel less anxiety all day knowing that she is cutting out early to enjoy strenuous exercise as part of a revitalization process.

It is contemplated that when a system allows users to specify preferences, there may be conflicts between the preferences expressed by first and second different users. For instance, a first user may express a preference to use workstations that are remote from the location of a specific second user while the second user expresses a preference to always be located in the general vicinity of the first user. Where first and second users express conflicting preferences, all other things being equal, the preference that is consistent with more privacy may always trump the preference that is less private. For instance, in the first and second user example considered here, the first user's preference to use workstations remote from the second user may always trump the second user's preference to be in the general vicinity of the first user.

In other cases employee policy may always cause the less private preference to trump the more private preference. For instance, an employer may want to strongly foster team work or collaboration and in that case more intermingling of employees may form the basis for an overall system rule that results in less, not more privacy. In some cases conflicting preferences may be resolved based on other factors. For instance, in the morning prior to noon the system may be programmed to opt for more private preferences over less private and in the afternoon the system may opt for less private over more private. Other factors may drive other rules for resolving disparate or conflicting user preferences. The important thing here is that the system servers or computers be programmed with some type of preference conflicting rule set driven by suitable and well defined factors (e.g., privacy policies, employee cultural factors, time, current or anticipated user activities, employee organization charts (e.g., a first user to which a second user reports may have her preferences trump those of the second user), etc.), or combinations of factors.

Referring again to FIG. 5, in addition to being used to enter raw data into the user database, interfaces 300 are usable to access scheduling software 502 enabling a user to schedule meetings, activities and other events at specific times where the user schedule 540 is stored in the user database 510a or is otherwise accessible by at least a subset of the system algorithms 520, 522, 524. Here, as in the case of most scheduling software, it is contemplated that a user will be able to view a current schedule including scheduled activities and meetings as well as open time slots that are not currently scheduled. In addition, however, it is contemplate that scheduling software 502 will have several advantageous features which enable smarter scheduling that is driven at least in part in some embodiments by user specific optimization algorithms and sensed data and information related to the user. For instance, in at least some cases, based on optimization algorithms, the system will identify only a subset of open time slots to suggest for scheduling another activity to make sure that a user is not overbooked in a way that runs afoul of user specified preferences.

In some cases the system may facilitate entry of anticipated meeting characteristics which are then used to identify a sub-set of open time slots for a specific meeting that a user wants to schedule that best align with high optimization algorithm scores for the specific user. For instance, the software may query the user about a time range (e.g., within the next 2 weeks) for an activity as well as for a user's role in the activity to be scheduled. Regarding the user's role, the system may present options like (1) leader; (2) key participant; and (3) informational participant only. Based on the user's activity role, the system may automatically select only options that are optimal during the time range given the user's role. For instance, where a user is just an informational participant and has no leadership or key participation role, the system may provide ten time slot options for a meeting but may present only two optimal time slot options (e.g., options that meet a certain level of optimality), at least initially, if the user is a meeting leader. For instance, in a simple case where a user prefers not to have more than one meeting a day where the user is in a leadership role and also does not like to participate in leadership roles prior to noon, the system may only suggest two open time slots that are consistent with these two user preferences and only those two time slots would be suggested.

As another instance, the software may query the user about meeting invitees when a meeting is to be set up and the system may then search for optimal times for a meeting based on the invitee list. For instance, where a first user is attempting to schedule a meeting with second, third and fourth other users and the first user identifies the other three users, the system may automatically attempt to identify next times when all four attendees will be collocated in the same facility and available as a baseline for filtering out a small set of time slots that best work for meetings. Other first user preferences may be applied to the small set of first filter time slot results to rank those slots based on optimality. A subset or all of the ranked time slot options may be presented to the user for scheduling purposes.

In at least some cases the scheduling software 502 may also be used to schedule activities for a user or modify a user's scheduled activities independent of any direct user input in at least two ways. First, in some cases other system users that have access to the scheduling software 502 may be able to schedule activities for a user or modify currently scheduled activities. Here, as in the case of a user controlling her own schedule, when a second user attempts to change a first user's schedule, the system may automatically provide only optimized schedule options or may at least apply a hierarchy to schedule options to help guide the second user to optimize scheduling. For instance, if a second user is attempting to schedule an activity for the first user, the system would apply the first user's optimization algorithms to the activity to be scheduled. Again, in at least some cases, the system may query the scheduler for anticipated meeting characteristics which would then be used as seed data for driving the optimization algorithms.

In cases where schedule time slots for specific activities are ranked according to relative optimality, in at least some cases at least a subset of highly ranked options may be selectable to automatically schedule the activities without requiring a confirmation by a user associated with the schedule while other lower ranked slots require the user associated with the schedule to accept the option prior to scheduling. Thus, for instance, where ten time slots are available for scheduling a specific activity, only three highly optimal slots may be available for scheduling without user acceptance while the other seven require user acceptance prior to scheduling.

The second way the system may modify a user's scheduled activities independent of any direct user input is via automatic modifications by a system processor, typically in response to optimization algorithm outputs. For instance, while a user is sleeping, the user's condition (e.g., extremely tired) and weather or other conditions may result in a situation where an early morning meeting for a user simply should not occur or where a different time slot for the meeting would be much more optimal for the user and, in that case, the system may automatically modify the user's schedule to move the early morning meeting to a different, more optimal time slot and so that the user can sleep in to regenerate. Many other automatic schedule modifications are contemplated and, in FIG. 5, automatic scheduling is generally represented in block 562.

Referring again to FIG. 5, sensors 302 provide input to the user database and optimization algorithms 410. Again, the sensors 302 may take many different forms (see again FIG. 3) and the data generated thereby will either be directly related to or usable to discern or calculate at least four different general types of information useful for driving system optimization algorithms including (1) user location/orientation, (2) current user activities, (3) user environment/ambient and (4) user biometric data. These types of sensed or calculated data operate as one subset of optimization factors for the optimization algorithms that ultimately drive services for a system user.

Referring to FIG. 5, other sources 504 of data that form the basis of optimization factors include but are not limited to data and information from third party service providers (see 127 and 129 in FIG. 1A; e.g., notification of a sale event, notification of a product release, etc.) or software application programs such as, for instance, weather forecast applications and services 570, traffic reporting applications and services, news feed applications and services, other content providing applications and services (e.g., music, video/audio programming of all types (e.g., shows, podcasts, videos, etc.)), and input from various communication systems 574 like voice mail services, e-mail services, text communication services, etc.

In addition, software 576 (e.g., word processing software, spreadsheet software, CAD and CAM software programs, collaboration software, etc.) that a system user employs to generate work product may also provide additional data that operates as one or more optimization factors. For instance, volume of work product within a given period may be one proxy for user focus or participation level. In cases where work product quality is measured in some way, that quality measurement may be provided to the optimization system and used as another factor. For instance, where a high quality product is produced in a short period of time, the user was likely highly focused and engaged during the product generation period. Other conclusions can be drawn from lesser quality work product. The degree of collaboration and engagement among team members may be provided by collaboration software as another optimization factor. Many other work product based optimization factors are contemplated as system inputs.

In addition to system user's having personal preferences and aspirations, employers may also have specific preferences and aspirations for individual employees and/or specific groups of employees. These employer preferences and aspirations 578 will, in at least some embodiments, form the basis for additional optimization factors. Another preferences and aspirations information source, in at least some cases, will include preferences and/or aspirations 579 of significant others for a user such as, for instance, preferences and aspirations for a user's spouse, child, close friends, boss, other key employees and acquaintances. Here, it is contemplated that where another person is a second system user, a first user may grant the second system user authority to specify at least a subset of preferences and/or aspirations that are specifically associated with the first user. For instance, a spouse may specify a preference that her husband not turn up the volume on a bathroom television above a certain level prior to 8 AM. A boss may specify an aspiration to grab lunch with the first user at least once every month.

Where another person is not a user of the system, in at least some cases, a user may be able to grant the other person access to a website or other software program designed to obtain preferences and aspirations from the other person to be applied for the user. The weight given to other user or employer preferences and aspirations may be controllable and, in at least some cases, the effects of those preferences and aspirations on optimization algorithms may be completely disabled by a user.

Referring yet again to FIG. 5, one other source of data and information to drive a user's optimization algorithms includes other system user data, diagnosis and prescriptions 580. In this regard, for instance, where a second user's optimization system determines that a currently scheduled meeting between the second user and the first user associated with memory 510a is no longer optimal, that information may be used by the first user's algorithms to assess if the meeting could be changed on the first user's schedule in a way to better optimize for the second user while still achieving some threshold level of optimality for the first user. As in the case of other user preferences and aspirations 578 and 579, in at least some cases a first user can determine if and how much other user data, conclusions and prescriptions affect the first user's optimization algorithms.

Referring again to FIG. 5, the raw data 512 received from the user interface(s) 300, scheduling software 502, sensors 302 and other sources 504 is all maintained and updated, in most cases, on a real time basis or, at least, as needed by the system algorithms. As shown in FIG. 5, several different classes of algorithms are contemplated including a first set of algorithms 520 that use the raw data 512 to generate calculated data 514, a second set that uses the calculated data and, in at least some cases, a subset of the raw data, to generate conclusions 560 and a third set 524 used to generate various types of system output including notifications, queries for authorization, queries for information and information presentation as well as control signals for (1) managing/changing schedules, (2) managing/changing to-do list(s), (3) controlling a user's environment for comfort, (4) controlling a user's environment for therapy, (5) controlling affordances associated with a user for convenience, (6) changing a user's preferences, and (7) changing specific system optimization algorithms 562.

One exemplary type of calculated data includes user circumstances 550. User circumstances include, among other things, user location, user activities, user environment and user conditions. Location may be determined in many different ways depending upon system sensor types at different locations and the types of data generated by the sensors. Similarly, user activities and environmental characteristics and current parameters may be determined in many different ways depending on data types collected by the system sensors. While some sensors will directly generate user condition data such as, for instance, in the case of a wrist based heartrate or temperature sensor, in other cases sensor data will be processed to detect user conditions. For instance, an algorithm may be able to process high definition camera images (e.g., sensor data) to detect a user's heartrate.

Referring still to FIG. 5, user circumstances in most cases will be time based so that each circumstance is associated with a specific point in time. In at least some cases circumstance data will be stored for various periods or times including past long term, past recent term and a current time. The past recent term may correspond to a few hours, a current day, the last three days, a week, etc., and is intended to cover a period during which user circumstances will generally have a direct impact on a user's current conditions while past long term is may include a long term dataset that persists over time (e.g., several years). For instance, past recent term circumstances may include sleep activity and other activities, locations and environments and user conditions over the last five days which cumulatively directly impacts a user's current ability to engage others, stress level, etc. Longer term user circumstances may include sleep activity, other activities a user participated in, user locations and environment and user conditions over the past several years and is generally used by optimization algorithms to develop algorithm changes based on detected correlations and causations between user circumstances and conditions as will be explained in greater detail hereafter.

A second exemplary type of calculated data includes user habits and tendencies 552. In this regard, based on a first user's locations over time, reminders provided to the user and the first user's schedule, the system may determine that as a first general rule of thumb, the first user waits 5 minutes after being reminded of a meeting to leave the user's workstation (e.g., the user's average “launch” time is 5 minutes). Here, the user's typical launch time delay may be needed for the user to extricate herself from network activities, gather materials needed for a next activity, respond to communications prior to departing, etc.

A second rule of thumb may be that a user persistently has to interrupt optimal flow states at the ends of personal focus periods that are less than one hour long which results in substantial inefficiencies. Here, recognizing the persistent flow interruption events, the system may automatically adjust optimization algorithms so that personal focus periods less than one hour in duration are always followed by relatively optional activities. In this regard, optional activities may include activities that do not involve other persons or require other relatively important or scarce resources. The idea here is that a user in flow near the end of a personal focus period could simply continue their flow state into a next period if optimal. In some cases the system may automatically continue the personal focus period without interrupting the user until the flow state ceases, running into a following scheduled activity period when the following activity is optional.

A third rule of thumb may be that when the first user travels from the location of the first user's workstation to a specific conference room for a meeting, the first user typically requires 17 minutes to travel (e.g., “travel” time). A fourth rule of thumb based on camera images and biometric data may be that on average, the first user requires 7 minutes to settle (e.g., “settle” time) into a new meeting space after arrival. Each of the first through fourth rules of thumb may be modified based on a large set of other factors such as what the first user is doing when a reminder is presented to the user, if the first user is alone or with other people when a reminder is received, who the first user is with when a reminder is received, time of day, recent first user activities (e.g., has the first user recently used the rest room, recently obtained a refreshment, etc.), etc. Some of the habits and tendencies may be directly correlated with user circumstances stored at 552 as described above. For instance, a user's launch time may be longer when the system determines that the user is more tired than usual.

For a second system user, the average launch, travel and settle times and how different factors affect those times may be completely different based on raw collected data calculations. Once calculated, the average user specific times are stored as user habits and/or tendencies which can then be used to drive optimization algorithms where user guidance is customized to specific users. Many other user habits and tendencies are contemplated including, for instance, duration of typical break, number of rest room visits in the morning, in the afternoon, etc., duration of rest room visits, number of trips to a refreshment alcove in a given period and durations of those trips, propensity to engage others while traveling from one location to another, propensity to engage in the morning, propensity to engage in the afternoon, etc.

A third exemplary type of calculated data includes detected user preferences 556. A detected preference is similar to a user specified preference except that, instead of a user specifying the preference, the system automatically identifies the preference based on user activities and, in at least some cases, user perceptions 538 or user biometrics. For instance, if a user routinely schedules exercise activities every Tuesday and Thursday afternoon and either Saturday or Sunday morning, algorithms 520 may automatically determine that the user has a preference to exercise three times a week, once each on Tuesday and Thursday afternoons and once on either Saturday or Sunday. As another instance, whenever a user is with a family member, the user may not respond to work communications. Here, the system may recognize that when the user is with a family member, the user prefers not to field communications related to work activities. Many other detected user preferences are contemplated.

In some cases the system may automatically determine a user's condition and may correlate that condition with a set of circumstances in an attempt to identify unspecified user preferences. For instance, if the system recognizes that a user achieves a high level flow state routinely after a specific first sequence of activities, the system may automatically label the first activity sequence as a detected user preference without any user input. The idea here is that the detected preference can then be used to modify optimization algorithms to guide the user toward positive conditions and states. Thus, for instance, if a sequence of activities routinely results in a high and prolonged user flow state, the system may automatically adjust so that it is attempting to schedule similar activity sequences in the future.

In at least some cases when the system automatically detects user preferences, those preferences 556 are stored in the user's database and are automatically used to drive additional algorithms 522. In other cases, when a new user preference is detected, the system may present the detected preference to a user to seek confirmation that the user wants the new preference to affect optimization algorithms for the user. In this case, if a user indicates that she does not want a detected preference to influence optimization algorithms, while the system would not use the preference as input to the algorithms, the preference may be persistently stored for other purposes.

Referring yet again to FIG. 5, calculated data 514 and, in at least some cases, a subset of the raw data 512 is fed to the diagnosing algorithms 522 which calculate user diagnosis 560 including both current and anticipated conditions. Exemplary user conditions may include, for instance, instantaneous flow state, stress level, level of engagement, level of effectiveness, level of happiness, energy level, or any other condition that is derived or calculated from other raw or even calculated data. For instance, one algorithm 522 may use microphone and camera data to assess a user's current flow state as well as a user's instantaneous level of engagement while another algorithm uses biometric data from other sensors to determine a user's current stress level. Anticipated user conditions or diagnosis may include at least a subset of the user's current conditions including, for instance, anticipated flow state, anticipated stress level, anticipated effectiveness, etc. Factors for assessing anticipated user conditions include, in at least some cases, prior user activities, current user activities, current user diagnosis, current raw data, currently scheduled future user activities, etc.

In addition to generating diagnosis, algorithms 522 may also enable a processor to correlate current and anticipated user conditions and diagnosis with different sets of optimization factors. For instance, at least a subset of the algorithms 522 may examine factors and user conditions to identify persistent or repeating correlations that are not dictated by current algorithms 522 and those correlated user conditions and factors are then stored along with the other conclusions. For example, the system may use calculated and raw data including user perception input 538 to determine that the user has difficulty focusing every afternoon that follows an evening on which the user was up past 11:30 PM. In this case, the system would correlate being up past 11:30 PM (e.g., a factor) with poor focus (e.g., a diagnosis) the next afternoon. As another more complex example, the system may use calculated and raw data including user perception to determine that a user's stress level remains low any day after the user exercised the night before for at least 30 minutes, got to bed by 10 PM and slept soundly for at least 6.2 hours with at least two REM sleep cycles of 90 minutes each. Many other condition and factor correlations may be generated and stored over time.

The correlated user conditions and factors may be used automatically or after user affirmation (e.g., presentation to and acceptance by a user) as new condition conclusion algorithms 522 or to replace other conclusion algorithms 522 if new correlations are more accurate or more efficient for some reason (e.g., require less data input, are based on more robust raw input data, etc.) as indicated by feedback arrow 555.

Referring to FIG. 5, the current and anticipated condition conclusions and the correlated conditions and factors are used to drive the optimization algorithms 524 which generate algorithm outputs 562 (e.g., control and scheduling modifications and/or suggestions as well as the algorithm modifications and/or suggestions). In addition, in at least some cases, at least a subset of raw data 512 and the calculated data 514 is provided to the optimization algorithms and used to generate the algorithm outputs 562. The optimization algorithm outputs 562 are communicated to one or more user interfaces 300 and/or one or more environment controls 228.

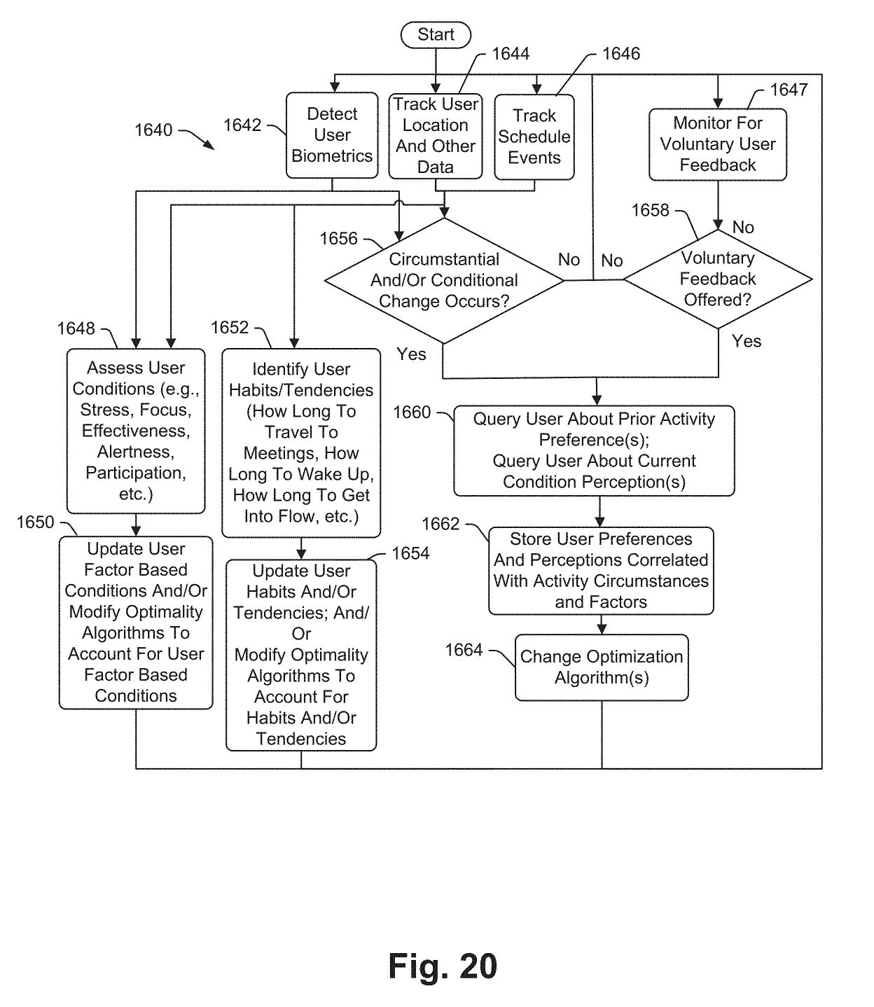

Referring now to FIG. 20, a process 1640 for augmenting a system user's efforts to specify user preferences and perceptions as well as for automatically correlating factors with user conditions and identifying user habits and tendencies is illustrated. At block 1642, a system processor and system sensors detect user biometrics that can then be used to identify current dynamic user conditions like, for instance, stress, focus level, alertness, etc., at block 1648. The system processor also tracks user location and other data at block 1644 and a user's scheduled events at block 1646. The user's biometrics, location, schedule events or activities and other data are all used by the processor to recognize and track user circumstances and/or conditions and to assess when the user's circumstances or conditions appreciably change at block 1656. Where a user's circumstances or conditions do not change, control passes back up to blocks 1642, 1644 and 1646 where the monitoring process continues to cycle.

Referring still to FIG. 20, once a circumstance or condition of a user that is being tracked by the system processor changes, control passes down to block 1660 where the processor queries the user about perceptions and preferences related to recent activities and current conditions. For instance, in a case where a user just completed a two hour meeting with five previously unrated and 2 previously rated people, the processor may automatically query the user for preferences of ratings for each of the five unrated people and to confirm preferences for the two previously rated people. In addition, the processor may query the user about one or more aspects of the two hour meeting like, if the user thought the meeting was too short or too long or if the meeting was effective, or if the meeting was engaging, or if the meeting space was good or bad, if the meeting affordances worked well, etc. Moreover, the processor may query the user about the user's perceived conditions. For instance, the system may query the user to rate her focus during the meeting, rate her effectiveness, her engagement, her stress level, etc. At block 1662 the processor correlates the user input with circumstances and the contributing factors. At block 1664 the processor changes optimization algorithms based on the new user preferences and perceptions after which control passes back up to blocks 1642, 1644 and 1646.

Referring still to FIG. 20, at block 1647 the processor monitors user input devices for voluntary user preferences and/or perceptions. For instance, the system may monitor audible utterances by a user to detect a trigger phrase like “Set preference” or “Set perception” after which the user would utter a phrase or word indicating a preference or a perception. Once the trigger phrase is recognized, in some cases the system may query the user for a perception or preference subject and a sentiment. When a user inputs a preference or perception, control passes to block 1660 again where the process described above continues to cycle.

Referring yet again to FIG. 20, the biometrics, location and other data and the schedule events are also used at block 1652 to identify user habits and tendencies which are then stored in the user's database as updated user habits and tendencies and may also be used to modify at least some optimization algorithms at block 1654. The biometrics, location and other data and the schedule events are also used at block 1648 to assess user conditions which are then used to update the correlated factors and user conditions in the user database as well as the optimization algorithms at block 1650.

Smart Scheduling

It has been recognized that all of a user's time is not equal. For instance, from an effectiveness or engagement perspective, an hour on Monday morning after a restful weekend is often more valuable than an hour on Friday evening near the end of the day and the week when a user may be exhausted and unable to focus at a high level. As another instance, from the perspective of effectiveness or engagement, an hour on a first Tuesday morning after four long meetings on Monday may be less valuable than an hour on a second Tuesday morning following a Monday of personal focus time.

It has also been recognized that while a first hour may have more value than a second hour when used for a specific activity, there is some activity that is most optimally performed during each hour. For instance, while it may not be optimal for a user to spend an hour on a Friday evening on a personal focused activity, it may be optimal for the user exercise during the Friday evening hour to rejuvenate or achieve some other health goal.

It has further been recognized that even for a single activity type, user requirements can vary widely. For instance, the expectations and demands on a user are very different if the user is a presenter or simply an audience member at a meeting. A presenter typically has greater stress and exerts more energy than a participant and therefore, for optimality, a presenter should be in a different mental and perhaps even physical state than an audience member. As another instance, an optimal user state will be different if the user is walking during an exercise period or is participating in high performance aerobic exercise that requires substantial and persistent effort.

There are several aspects of the smart scheduling concepts that are particularly unique. First, in at least some cases the optimization system is designed to obtain at least some information that characterizes a user's role in an activity to be scheduled and/or related to optimal user conditions for any activity to schedule and the system uses that additional information to identify and suggest optimal unscheduled time slots for specific activities to be scheduled. Thus, where a user is to be a meeting presenter, a user may respond to one or a series of system questions indicating that the user needs to be highly engaged, energetic and focused during the meeting and that the user expects to have a relatively high degree of stress. Here, while a slot that immediately follows two other meetings may not be identified in the optimal slot subset based on the user's expressed optimal conditions, another slot that has two preceding hours of scheduled exercise or rejuvenation or personal focus time may be identified and offered as an option. In the case of scheduling a high performance exercise session, a user may indicate a requirement for high level of physical exertion and energy so that the system would then identify only time slots where the user will likely be able to exert herself fully.

While the system may collect specific optimal user conditions for an activity from a user (e.g., high focus, high engagement, high energy, etc.), in some cases the system may simply associate specific optimal user conditions with specific user roles or anticipated activity undertakings. For instance, where a user specifies that she will present at a meeting, the system may automatically associate a higher stress with the meeting and a requirement that the user should optimally be in condition to be focused and engaged and be able to exert substantial energy. Where a user specifies that she is going to participate in a high impact aerobic workout, the system may automatically determine specific user conditions for optimality and then identify time slots where it is anticipated that the user will meet the optimal conditions.

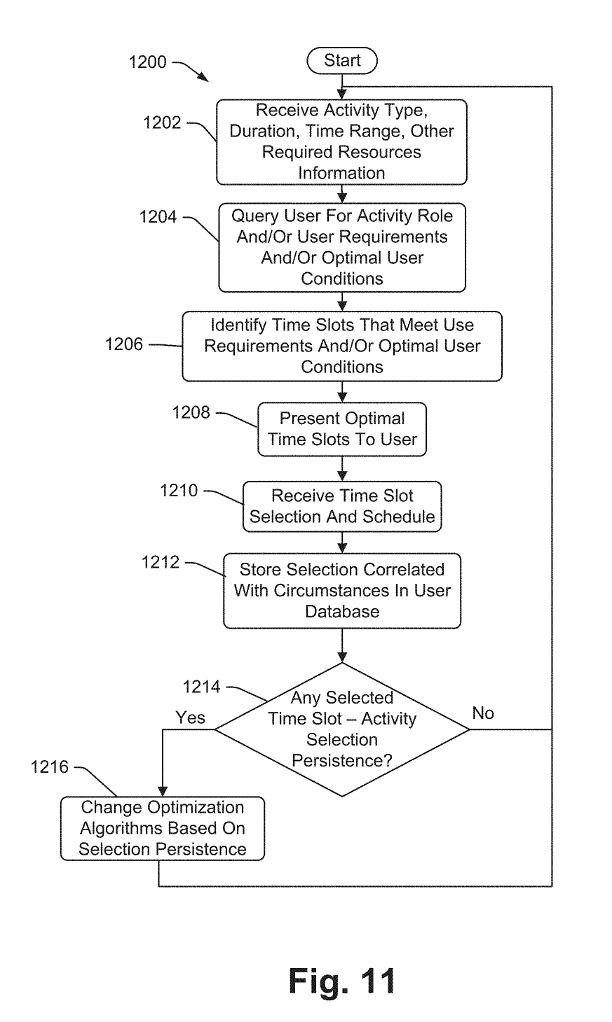

Referring now to FIG. 11, a process 1200 that is consistent with the smart scheduling system described above is illustrated. At process step 1202, the system presents user interfaces to a user designed to allow a user to schedule an activity. Here the interfaces may take many different forms including audio, visual or a combination of both audio and visual or other forms. Information received from the user at step 1202 includes, for instance, an activity type, an anticipated duration, a time range in which the activity should be scheduled and completed (e.g., prior to February 5), and some type of listing of required resources for the activity. Here the resource listing may include a simple list of other people to be invited to participate in the activity. In other cases the resource list may indicate specific affordances (e.g., s content sharing system in a conference space, a specific piece of exercise equipment, etc.) required for the activity. Hereafter it will be assumed that the activity type is a meeting that needs to take place prior to February 5, anticipated duration is one hour, that the first user, Barb Blue, is inviting second through sixth users to the meeting and that Barb Blue requires an electronic content sharing system.

After Barb Blue specifies activity information per block 1202, the system queries Barb for additional user role, user requirements and/or optimal user conditions at block 1204. Here it is presumed Barb indicates that she will assume a presenter role at the meeting. In addition to obtaining the role of the user that is initiating the meeting at block 1204, the system may also query Barb for anticipated roles or requirements or conditions for each of the other three invitees. Here, for instance, Barb may indicate that the second user is also expected to be a presenter while the third through sixth users are only expected to attend the meeting for informational purposes.

Where Barb specifies presenter for her role, the system may automatically identify optimal user conditions for Barb for the meeting that include high focus, high engagement and high energy. For the third user that is designated an attendee and not a presenter, optimal conditions would be less stringent in most cases as that user may be less focused, less engaged and less energetic and still perform his meeting role.

At block 1206 a system processor running the scheduling software application 302 applies scheduling rules to the activity characteristics as well as the optimal conditions of all of the invited users to identify optimal time slots to suggest for the meeting. Identified time slots are presented to Barb at block 1208 and the user makes a selection at block 1210 which is stored at block 1212. Presenting time slots to a user may include simply presenting all time slots that meet optimality requirements in the same fashion without distinguishing any of those slots from any other optimized slots. In other cases identified slots may be ranked so that a most optimum slot or subset of slots (e.g., 3) are presented in one way and others are presented in a second visually distinguished way so that a user can see various options and which are most optimal from Barb's perspective as reflected in the Barb's optimization algorithms.

A second important aspect of at least some embodiments of the smart scheduling concept is that the optimization algorithms are modified or changed automatically or suggestions for how to change those algorithms are presented to a system user automatically when a user persistently makes the same scheduling choices given similar circumstances. To this end, it has been recognized that scheduling options presented to a user can, over time, align better and better with user preferences as reflected in user scheduling decisions. For instance, where a user persistently avoids selecting identified Monday morning time slots for meetings or persistently avoids scheduling exercise periods during Friday afternoon time slots, the system may automatically stop offering those slots to the user when similar circumstances exist in the future. As another instance, where a user persistently selects a one hour exercise session within a 3 hour Tuesday afternoon range every time a larger set of time slot options are presented, the system may automatically offer Tuesday afternoon time slots for exercise sessions to be scheduled as a primary set of slot options without offering other times or while offering other times as secondary options. Here, the system effectively detects persistent user preferences and changes the system algorithms to stop presenting time slot options that are inconsistent with the detected preferences. As in all cases where algorithms are changed, here the algorithms may be automatically changed as described above or changes may be presented to a user for the user to confirm a preference to change the algorithm.

Referring again to FIG. 11 and specifically again to block 1212, after Barb Blue's time slot selection has been stored, system control may pass to block 1214 where the system examines the selected time slot and prior time slot selections by Barb made in similar circumstances in an attempt to identify any persistent selection pattern. Here, some threshold level of persistence would have to occur prior to pattern recognition (e.g., the same selection in substantially similar to identical circumstances occurs at least the last 5 times the circumstances or similar circumstances occur).

If no persistent selection pattern is identified control simply passes back up to block 1202 where the system continues to monitor for another activity identifying sub-process. Once a persistent selection pattern is recognized, control passes to block 1216 where a system processor may change the optimization algorithms to reflect the persistent pattern. In some cases the algorithm changes may result in rules that simply preclude options to present some time slots for some activity types while in other cases algorithm changes may simply reweight optimization factors so some slots previously identified as options may only be presented as secondary options if a user rejects all options in a primary time slot set.

In at least some cases it is contemplated that a user's time slot selections for specific activities and circumstances will become so persistent that when a user initiates a process to schedule an activity, the system simply schedules the activity for a specific time slot or one of a subset of specific time slots that are highly optimal without requiring more. For instance, in some cases it is contemplated that once an audio sensor is triggered to listen for a user utterance regarding scheduling an activity, the user may simply utter a phrase like “Schedule a one hour meeting with Will White to discuss quarterly sales”. In response, the system may simply identify an optimized time slot for the user and Will White and schedule the meeting without requiring user slot selection. In some cases when a meeting is scheduled in this fashion, the system may report back via synthesized voice that the meeting has been scheduled along with the date and time of the scheduled slot.

In some embodiments a system processor may be programmed to routinely analyze dynamically changing resource (e.g., user time and other affordance) schedules to maintain scheduling flexibility and optimize in other ways. For instance, a general rule of thumb may be that any time one or more time slots is open on a system user's schedule in the near future (e.g., next 24 hours, next 8 hours, any time prior to an already scheduled activity, etc.), the system will attempt to schedule some optimized activity for the user. While activities to schedule may be limited to aspirational user activities (e.g., to-do list tasks, aspirational meetings, etc., as at 532 in FIG. 5), in other cases it is contemplated that any currently scheduled activity may also be considered for filling an open near future time slot. In this regard, several advantages are associated with rescheduling an already scheduled activity for an earlier time slot. First, moving a scheduled activity to an earlier time slot frees the originally scheduled time slot to accommodate other activities for which the original time slot may be optimal. Second, moving a scheduled activity to an earlier time slot necessarily has the effect of expediting completion of that activity which can increase user productivity appreciably. Third, when specific activities need to be sequenced in a specific order (e.g., activity A has to be complete prior to activity B being initiated), moving a next activity in a sequence to an earlier time slot has the effect of opening up earlier possible time slots for subsequent activities in the sequence. For instance, if a group of employees need to have a series of three meetings that need to occur in a first, second and third sequence, when the first meeting occurs has a direct effect on when the second and third meetings can occur and when the second meeting can occur has a direct effect on the earliest time that the third meeting can occur. By completing the first meeting as early as possible, there is a compounding effect on the total period needed to complete all three meetings.

It has been recognized that, in at least some cases, people participating in activities need to perform some type of preparation prior to participation. For instance, first and second system users that intend to present first and second presentations, respectively, to four other meeting attendees may each need preparation time to prepare their presentations prior to the meeting time. As a related instance, third and fourth invitees to the meeting may want to review meeting materials for at least some time prior to participating in the meeting. In this case, restrictions may be placed on which scheduled activities can be rescheduled for earlier time slots. For instance, in the above example, the meeting that the first and second users and third and fourth invitees need to prepare for cannot be rescheduled in a time slot prior to preparation time slots for each of the first and second presenting users and third and fourth reviewing invitees. For this reason, in at least some embodiments, when users schedule activities, a system processor will be programmed to solicit meeting preparation requirements from each attendee, will schedule preparation time slots for each attendee that anticipates a need to prepare and will restrict earlier rescheduling of already scheduled activities to time slots that follow preparation sequence requirements.

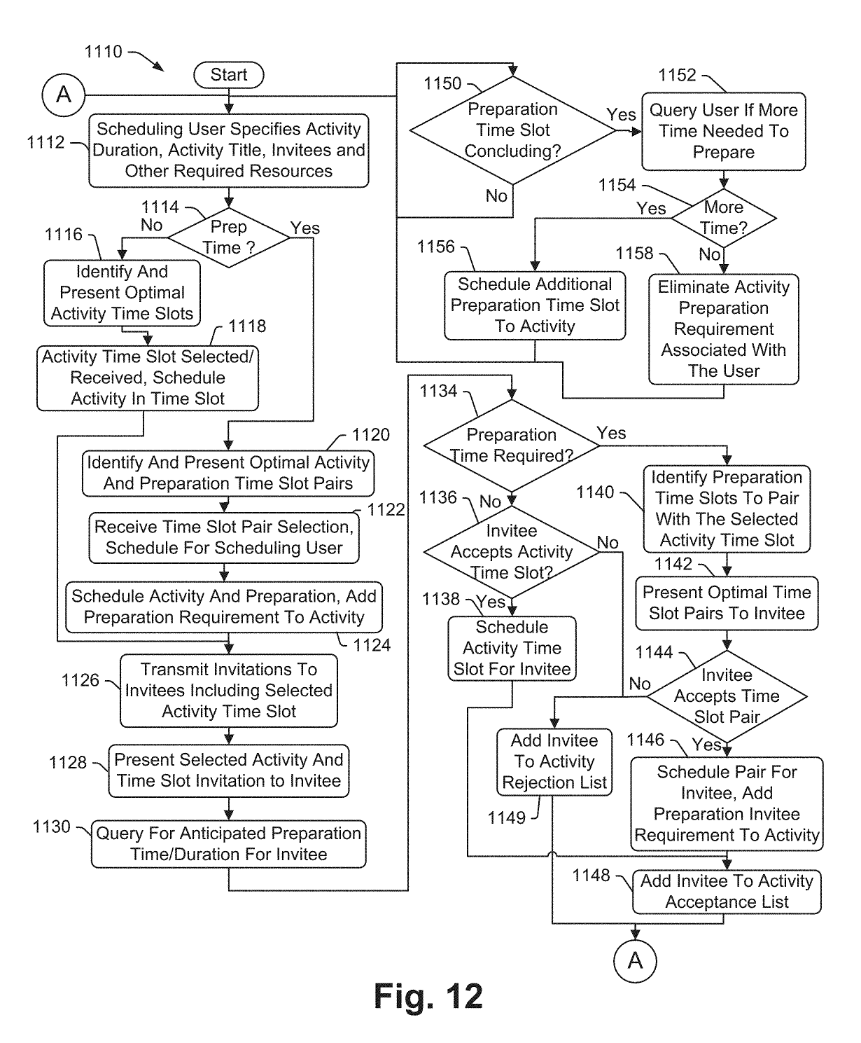

Referring now to FIG. 12, an exemplary process 1110 for specifying preparation times for activities, scheduling preparation and associated activity time slots and applying rescheduling restrictions to scheduled activities is illustrated. Staring at block 1112, the first system user Barb Blue (hereinafter “the scheduling user”) that want to schedule a previously unscheduled activity accesses scheduling software via one of the system interfaces devices and enters activity specifying information including an anticipated activity duration, an activity title (e.g., “Meeting with Gordie Gray”), a list of other system users to be invited to participate in the activity and other required resources (e.g., a conference space, an exercise studio, other affordances, etc.). At decision block 1114, a system processor queries the scheduling user to determine if the scheduling user anticipates requiring any preparation time prior to the activity specified at block 1112. If the scheduling user does not anticipate needing preparation time prior to the activity, control passes to block 1116 where the processor identifies and presents optimal time slots for the specified activity. At block 1118, the specifying user selects an optimal time slot for the activity and the user's schedule is updated to reflect that the activity has been scheduled for the selected time slot. Control then passes to block 1126 as illustrated.

Referring again to block 1114, if the scheduling user indicates that she anticipates needing preparation time for the activity, the processor queries the user for an anticipated preparation duration (e.g., 2 hours to prepare and practice a presentation) after which control passes to block 1120. At block 1220, the processor identifies and presents optimal activity and preparation time slot pair options to the scheduling user. Here, each time slot pair includes an activity time slot as well as at least one preparation time slot prior to the activity time slot that is associated with the activity time slot. At block 1122 the processor receives a selected time slot pair from the scheduling user and at block 1124 the selected pair is used to schedule the activity and associated preparations in the associated time slots. In addition, at block 1124, a restriction is added to the scheduled activity which associates the scheduled user's preparation requirement with the activity. Here, the user's preparation requirement will operate to restrict rescheduling of the associated activity to a time slot prior to the user's preparation time slot to ensure that the user has time to prepare prior to the occurrence of the activity. After block 1124, control passes down to block 1126.

At block 1126, in the case of activities where other system users are invited to participate (e.g., in a meeting), electronic invitations are transmitted to each of the invitees including the activity time slot that was selected by the scheduling user. At block 1128, the activity and time slot invitation is presented to the invitee and at block 1130, the processor queries the invitee to determine if the invitee anticipates requiring preparation time to get ready for the activity. At decision block 1134, if the invitee indicates that she will not require preparation time, control passes to block 1136 where the processor monitors for acceptance of the invitation. If the invitee does not accept the invitation at block 1136, control passes to block 1149 where the invitee is added to a rejection list for the activity and, in at least some cases, a notification is transmitted to the scheduling user indicating that the invitation was rejected. After block 1149 control passed back up to block 1112 where the process described herein continues to cycle. Referring still to FIG. 12, at block 1136, if the invitee accepts the invitation, control passes to block 1138 where the activity is scheduled for the invitee and, in at least some cases, a notification is transmitted to the scheduling user indicating that the invitation was accepted. At block 1148, the invitee is added to an activity acceptance list for the scheduled activity after which control again passes back up to block 1112.

Referring still to FIG. 12, if the user indicates that she wants a preparation period of a certain duration prior to the meeting at block 1134, control passes to block 1140 where the system processor identifies preparation time slots to pair with the selected activity time slot as a time slot pair and the slot pair is presented to the invitee at block 1142. At block 1144, the processor monitors for the invitee to select one of the slot pairs. If the invitee rejects the slot pairs, control passes to block 1149 where, as described above, the invitee is added to a rejection list for the activity and, in at least some cases, a notification is transmitted to the scheduling user indicating that the invitation was rejected. At block 1144, if the invitee accepts one of the slot pairs, control passes to block 1146 where the processor schedules a preparation period and the activity for the invitee in the selected slot pair. In addition, at block 1146, a restriction is added to the scheduled activity which associates the invitee's preparation requirement with the activity. At block 1148 the invitee is added to the activity acceptance list and then control passes back up to block 1112.

Referring still to FIG. 12, the sub-process shown at 1150 through 1158 is performed in parallel with the FIG. 12 process already described above. At block 1150 a system processor tracks scheduled preparation periods to determine when one of those periods is nearing an end time. Once a preparation period end time is near, control passes to block 1152 where the processor queries an associated user to determine if more preparation time is needed for the associated activity. At block 1154, is the user has completed preparing for the activity, control passes to block 1158 where the activity preparation requirement for the specific user is eliminated after which control passes back up to block 1150. At block 1154, if the user anticipates requiring more preparation time, control passes to block 1156 where the processor guides the user through scheduling another preparation period during a time slot prior to the associated activity. After block 1156 control again passes back up to block 1150 as illustrated.

Thus, it should be appreciated that the process 1110 allows any activity invitee to schedule one or more preparation periods prior to an activity and tracks preparation periods to remove those as restrictions on rescheduling of activities during earlier time slots once preparations are complete. Subsequent to activity and preparation period scheduling per the FIG. 12 process, when an earlier time slot opens up that could accommodate the activity, in at least some embodiments that time slot will not be considered optimal any time at least one associated preparation period (e.g., the scheduling user's preparation period or any invitee's preparation period) has not been completed. In effect, preparation restrictions render any time slot prior to one of those periods non-optimal and therefore the slot is ignored as an earlier rescheduling option for the specific activity. Here, available time slots after the final preparation period associated with an activity may still be selected as rescheduling slots for the activity.

In at least some cases it is contemplated that a system user may participate in some activity during an available (e.g., unscheduled) time slot or even during a general activity type time slot (e.g., a personal focus time slot as opposed to a preparation or specific activity time slot) that satisfies a later scheduled activity or preparation requirement. For instance, in a case where a user has a 3 PM exercise session scheduled and a 10 AM morning time slot opens up which she simply uses as an exercise period (e.g., she uses an elliptical machine for a workout), the 10 AM session may satisfy the 3 PM activity. In this case, to free up the 3 PM slot for some other activity, the user should indicate that the 10 AM session has replaced the 3 PM session. As another instance, in a case where a user has a 10 AM Tuesday morning preparation time slot for a later scheduled meeting and an 8 AM Monday morning time slot opens up which she simply uses to prepare for the later scheduled meeting, the 8 AM Monday preparation may satisfy the 10 AM Tuesday preparation requirement. In this case, to free up the 10 AM slot on Tuesday for some other activity, the user should indicate that the 8 AM session has replaced the 10 AM session.

One way to associate impromptu activities with scheduled activities to indicate scheduled activities that have been completed is to present one or more user queries near the end of each scheduled period when there is any uncertainty related to what the user was doing during the impromptu or general type activity time slot. For instance, near the end of an impromptu activity time slot, a system processor may identify all scheduled activities related to preparations for other activities and present a list of the preparation activities for the user to select from to indicate which one or ones the user may have performed. One user selectable option here would be “none”, selected to indicate that the impromptu activity was unrelated to any of the preparation type activities. In this case, if the user selects one of the preparation activities and confirms that the activity has been completed, the processor may cancel the completed activity from a subsequent time slot in the schedule to free up that time slot for other activities.

As another instance, near the end of an impromptu activity time slot, the processor may identify temporally near scheduled activities (e.g., all activities scheduled for the user during the next 12 hour period) as well as a list of aspirational activities on the user's to-do list and present a list of those activities to the user for selection to indicate if any of those activities has been completed. Again, one user selectable option here would be “none”, selected to indicate that the impromptu activity was unrelated to any of the temporally near scheduled activities. In this case, if the user selects one of the near scheduled or aspirational list activities and confirms that the activity has been completed, the processor cancels the completed activity from a subsequent time slot in the schedule to free up that time slot for other activities or removes the activity from the to-do list.

Floating User Time Scheduling

Most resource scheduling systems allow a user to select dates and times for specific activities and then indicate activities on graphical schedule interfaces where each activity corresponds to a block of time on a date and during a time associated therewith. Here, time slots are typically indicated as filled, available or tentatively filled (e.g., where a user has been invited to participate in an activity but has not yet accepted). Similarly, space and other resource scheduling systems typically include booked, available and, in some cases, tentatively booked designations. In these cases when a user wants to schedule a resource, the user views the graphical schedule to identify available time slots and then selects an available slot for resource scheduling.

One problem with this type of resource scheduling is that it is typically done over time where the decision to schedule or not schedule an activity is usually based on time slot availability and, at most, other activities scheduled or not (e.g., available slots) for temporally proximate time slots (e.g., the hour before and the hour after an available time slot). The result is often that activity scheduling is not given much thought and therefore is disconnected from any type of resource optimization consideration. For instance, a first system user that wants to schedule a 30 minute meeting with a second system user may simply send an invite to the second user for a time slot on a Thursday three weeks in the future where the slot is only selected because it was available on both user's schedules and where any of hundreds of other available time slots would have been just as optimal.

In this example, by scheduling the meeting for a specific time slot, activity scheduling for that day is restricted by the scheduled meeting in several ways. First, a scheduled time slot operates as a temporal restriction at the beginning time and the end time of the time slot so that other activities are temporally limited thereby.

Second, there is a spatial aspect to any scheduled activity that also restricts. In this regard, if a meeting is scheduled to occur in a specific conference room in a specific facility, the meeting location operates as a spatial restriction at the beginning time and the end time of the time slot so that the possibility of scheduling other activities temporally proximate the meeting are spatially limited. In other words, if the meeting is scheduled for location A, at least some types of other activities before and after the meeting would have to be at locations proximate location A in order to avoid inefficient use of time.

Third, optimization algorithms consider many different factors when identifying optimal time slots for specific activities. For instance a user's strong preference may be to not have a second hour long meeting immediately follow a first hour long meeting. In this case, where a first hour long meeting is scheduled for a specific time slot, the combination of the scheduled meeting and the user's strong preference to not have two consecutive one hour meetings would render at least some periods prior to and after the first one hour meeting non-optimal for any type of second one hour meeting. For example, the first scheduled meeting may render one half hour prior to and one half hour subsequent to the first meeting time slot non-optimal for a second meeting. Application of many more optimization algorithm activities to be scheduled considering already scheduled activities exacerbates the task of identifying optimal time slots for each activity.

While one haphazardly scheduled meeting is somewhat restrictive, where many meetings and other activities are scheduled in a similar fashion, user schedule restriction becomes a real efficiency and optimization problem for several reasons. First, after multiple activities are haphazardly scheduled, if another activity subsequently needs to be scheduled where only a few highly optimal slots would have been possible (e.g., given invitee time commitments, preferences, habits, tendencies, etc.) independent of the scheduled time slots, scheduled time slots substantially limit scheduling options and may in fact prohibit any optimal time slot option for specific activities during long periods of time.

Second, in many cases after an activity is scheduled a user does not contemplate the activity again until it is too late to easily cancel or change the activity to a different time slot. For instance, where a first user schedules a meeting with a second or more users, the first user may be reluctant to cancel or move the meeting even if the scheduled time slot becomes inconvenient or even if the meeting is no longer advantageous. Here, not only is user time wasted but in many cases valuable conference or other facility space and other affordances are needlessly tied up and unavailable for use by others.

Third, early scheduling of activities often results in non-optimal use of resources as all activities that a user will want to complete cannot even be identified when early scheduling occurs. Thus, for instance, if a user schedules a specific activity for a time slot three weeks from the current time, the user may ultimately participate in 300 different activities (e.g., an average or 15 activities a day) in the three week period. In an ideal situation, the user could know all 300 activities the user is going to participate in prior to the three week period and could schedule all of those activities in a way which optimizes the user's next three week period. Unfortunately there is no way to know all 300 activities a user will participate in prior to those activities occurring. Thus, for instance, one day into the three week period a new important meeting may be scheduled that a user needs to attend. Three days into the week the user may have an opportunity to participate in a seminar, have a doctor appointment open up or be required to attend a meeting with a child's teachers. In these cases, on the fly flexibility, not restriction, is needed to enable optimal activity scheduling.

According to the floating scheduling aspect of the present disclosure, when a user wants to schedule an activity, the user may be given the option to either schedule the activity or add the activity to a “floating list” of activities to be scheduled on a floating basis. Here, in at least some cases whether or not an activity is manually scheduled or added to the floating list will be completely at the system user's discretion.

In other cases, the system may allow activities to be scheduled as opposed to being added to the floating list only if the number of optimal time slots for the activity is below some threshold number. For instance, when a user specifies an activity to be scheduled, there may be 100 optimal time slots and, in that case, the system may automatically place the activity on the floating list. In contrast, if there are only 4 optimal time slots for an activity, the system may require a user to select one of the optimal time slots to make sure that the activity is accommodated on the user's schedule.

In still other cases, after a user specifies an activity to be scheduled, the system may automatically determine whether or not to schedule or float the activity and, if the activity is to be scheduled, may automatically select one optimal time slot for the activity and may automatically schedule the activity during that time slot. In this case, a user may never initially select an activity time slot directly and the system would instead simply automatically schedule activities in an optimized fashion. Here, a user would still retain the ability to change a scheduled activity time slot.

When the system automatically optimizes activity scheduling, an activity may be added to the floating list to be scheduled at a latest time possible that is consistent with various rules and system optimization algorithms. Here the rules and algorithms are selected to strike a balance between optimized activity scheduling and a user's need to know her schedule at least some time prior to scheduled activities occurring. Thus, while activity scheduling should ideally occur immediately before any activity is to occur when schedule optimization is considered in a vacuum, in reality where users often have to plan or prepare for specific activities, that type of system would make no sense and instead, in most embodiments, at least some types of activities need to be scheduled at least some threshold period of time prior to their occurrences.

The threshold scheduling period of time prior to occurrence of an activity may be different for different types of activities. For instance, an optimization algorithm may require that any floating list meeting with another person needs to be automatically scheduled at least 24 hours in advance of the meeting occurrence while any exercise session can be scheduled right up to a time that gives a user enough time to travel to and prepare for the session. As another instance, in cases where a user has to prepare for an activity and therefore the system needs to schedule one or more preparation periods prior to the activity period, the sequence of periods may need to be scheduled earlier than if the activity were to be scheduled independent of a preparation requirement.

In at least some embodiments a hierarchy of activity types may be defined where activities on any hierarchical tier are scheduled generally prior to activities on lower tiers. For instance, in a simple case, on weekdays (e.g., Monday through Friday), a top hierarchical tier may include meeting activities followed by second, third, fourth and fifth tiers including personal focus activities, family activities, exercise activities and then all other activities, respectively. Here, the top tier meeting activities would be scheduled first followed by personal focus activities and so on. On weekend days, the hierarchy may be different and include a top tier of family activities followed by social activities, and so on.

Another exemplary embodiment may include the following tiers of activities and tasks for ordered scheduling.
(1) Activities that are time sensitive.
(2) Work related activities with other people.
(3) Activities with family members.
(4) Non-work related activities with people other than family
members.
(5) Activities requiring scarce non-user time resources.
(6) Fill-in activities.
(7) Unspecified extracurricular activities.
(8) Fill-in/impromptu tasks.
(9) Secondary activities.

In the hierarchical list above, fill-in activities are activities that typically require at least some threshold amount of time (e.g., 30 minutes or more) that can typically be performed with very short notice when a time slot can optimally accommodate the activity. For instance, assuming Barb Blue has proper exercise attire, if a next time slot is available for an exercise session, the system may direct Barb to exercise shortly prior to the start of that time slot. As another instance, if Barb has to prepare materials for a future activity, the system may direct Barb at the beginning of a time slot to occupy a nearby workstation to prepare that material without prior notice.

Unspecified extracurricular activities include activities that are generally considered good for a person's physical and/or mental health but that the person has not specifically specified to be scheduled. For instance, one rule may be that after a person's biometrics indicate that she has been in a prolonged high stress situation, if possible, she should do something to rejuvenate herself like take a 20 minute walk, meditate, read a book for pleasure, call a friend, etc. Here, the system may identify user conditions that warrant extracurricular activities automatically and may suggest or automatically fill in at least some activities when optimal given current user conditions. These types of rejuvenation activities may also be prospectively scheduled given anticipated user conditions based on user schedules and other data that indicates how the user responds to different sequences of activities.

A fill-in/impromptu task is similar to a fill-in activity, albeit typically requiring a much shorter and in some cases variable time periods. For instance, retrieving a medication prescription from a pharmacy as a user is driving by the pharmacy typically takes only a few minutes but could take longer if a prescription filing line is long. Here, again, the task can be suggested or automatically added to a user's schedule with minimal notice and therefore may only be suggested when extremely convenient and therefore optimal.

A secondary activity is an activity that can typically be performed in parallel with some other higher level activity in the hierarchical list. For instance, while Barb Blue is driving, walking or otherwise travelling from one place to another or while exercising, relaxing, etc., secondary activities may include listening to music, listening to a podcast, listening to a news feed, listening to voice mails or audible representations of e-mails or texts, listening to an audio book or magazine, listening to prior meeting discussions or audible representations of materials to study for an upcoming meeting, etc. While many secondary activities will be audible, some secondary activities may be visual (e.g., Barb Blue may read a book or view a document while travelling on a subway). Some of these activities will be from a user's aspirational to-do list. The idea here is that some activities do not require a user's full attention and therefore two activities, a primary activity and a secondary activity, can be performed at the same time when optimal.

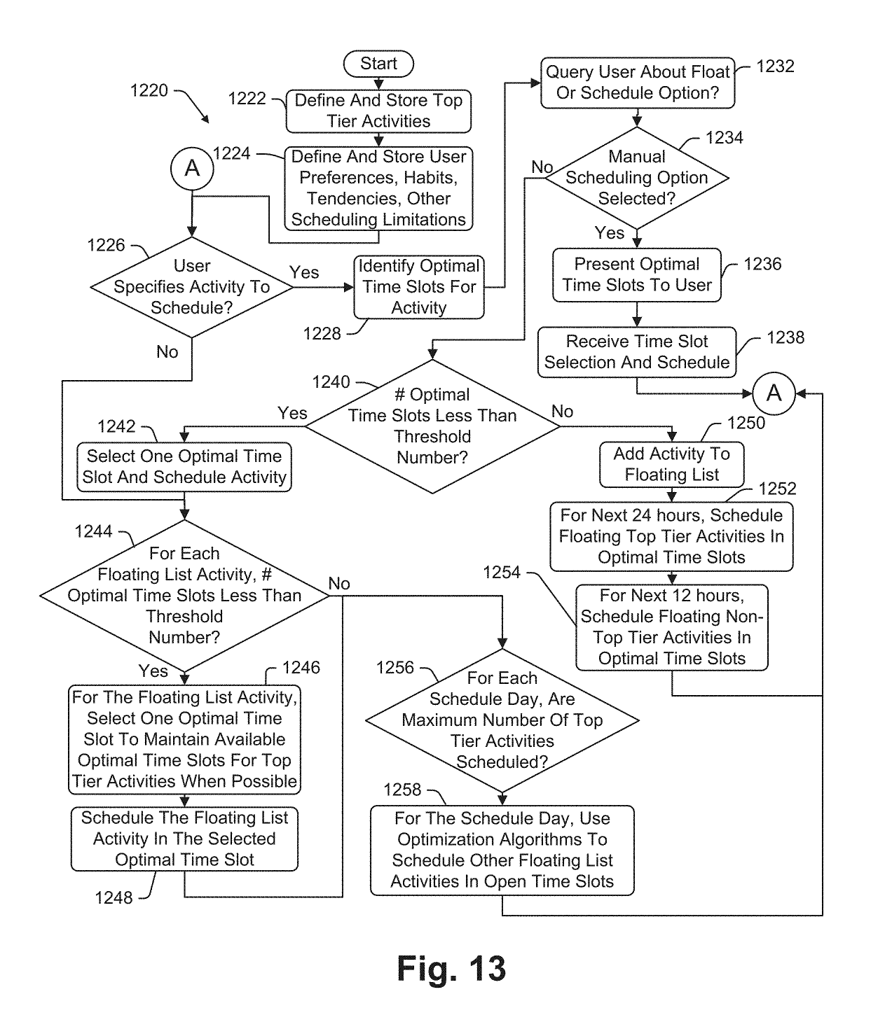

Referring now to FIG. 13, a process 1220 that is consistent with at least some aspects of a floating scheduling system is shown. Here, it is presumed that the system includes only two tiers of activities including a top activity tier corresponding to work meetings and a second tier that includes all other activities. The illustrated process 1220 provides a user option to either manually select a time slot for activity scheduling or have the system automatically schedule the activity on the user's schedule on a floating basis only when necessary so that the user's time is optimally employed. In general, when an activity is added to a floating list, among other things, a user specifies a time range (e.g., next week, next four weeks, etc.) in which the activity should be completed, the system identifies a set of optimal time slots (e.g., where each slot is above some threshold level of optimality for the activity) for the activity within the specified time range and schedules activities from the floating list whenever one or more of three circumstances exists including (1) where the number of optimal available time slots for the activity is less than some threshold number; (2) for any day period, where a maximum number of higher tier activities have already been scheduled and time slots are still available during that day period; and (3) where time slots in a relatively short near next period are still available.

Regarding the first circumstance, where the number of optimal available time slots for the activity is less than some threshold number, as other activities are either manually or automatically scheduled and as the completion period for a floating activity gets shorter, the number of optimal time slots for the floating activity will decrease toward zero. To ensure that a floating activity is scheduled to be completed prior to the completion date, the system automatically adds the floating activity to one of the last optimal slots for that activity.

Regarding the second circumstance where, for any day period, a maximum number of higher tier activities have already been scheduled and time slots are still available during that day period, the idea is that no more top tier activities can be scheduled for the day and therefore it makes sense to fill in other non-top tier activities. Here, available intermittent time slots among scheduled first tier activities may be filled with other floating activities immediately upon the maximum number of top tier activities being scheduled for a day or, in the alternative, this filling process may occur 24 hours or some other specified period prior to the day period to leave the intermittent time slots open later to maintain a high level of scheduling flexibility.

Regarding the third circumstance where time slots in a relatively short near next period are still available, the closer time gets to any specific period without an activity being scheduled for a time slot, the less likely it is that the slot will be filled. Thus, for instance, where a large time slot remains open on a user's schedule to accommodate any top tier meeting to be scheduled, if the current time is within one day of the large open time slot, the likelihood of filling that slot with a meeting becomes less. In this case, once within a short near term period, the system may be programmed to fill in time slots reserved for top tier activities with non-top tier activities. In cases where there are more than two tiers of activities, the system may triage from one tier to the next on a daily basis to fill in activities as prior tier maximums are scheduled. The short near term period may be any duration including an hour, a day, two days, a week, etc.

Even within activity tiers it is contemplated that some activities will be more optimal for specific time slots than others and therefore, activities may persist on a floating list for some time in at least some cases where the maximum numbers of higher tier activities have been scheduled for a day so that the time slots for intra-tier activities can be assigned in the most optimal fashion. For instance, where the maximum number of top tier activities that can be accommodated on a first day are already scheduled, the non-top tier activities on a floating list may continue to float until 12 hours prior to the first day so that other non-top tier activities that may be more optimal for intervening available periods that may be specified in the future can be accommodated.

Referring again to FIG. 13, at block 1222 top tier activities are defined and stored. In the present example it will be assumed that work meetings with a duration or one or more hours are top tier activities and that all other activities are non-top tier. At block 1224 user preferences, habits, tendencies and other scheduling limitations are specified and stored in a user database 510a (see again FIG. 5).

At decision block 1226 a system processor monitors for a user to initiate a scheduling activity. Here, scheduling initiation may include using any type of user interface to enter activity specifying information including a computer, a portable smart device, a fixed smart device, touch input, audio input, etc. Activity specification may include activity type, anticipated duration, time range in which to schedule the activity, other required resource information, user role of optimal user conditions for participating in the activity, etc. Unless indicated otherwise hereafter, the phrase “possible activity period” will be used to refer to a specified time range in which an activity should be performed and would include an earliest commencement time and a latest completion time. For instance, a user may specify that she wants to participate in an exercise session any time between 8 AM on Tuesday morning and 6 PM on Thursday evening. As another instance, a earliest start time may indicate two weeks from today and a latest completion time may indicate four weeks from today to specify that a meeting activity should be scheduled during a time slot within a range between two and four weeks from today.

At block 1226, once a user specifies an activity, system control passes to block 1228 where a processor applies the optimization algorithms to the specified activity to identify a set of optimal time slots for accommodating the activity. Where an activity involves only a single user, the algorithms only consider factors specific to that single user as well as schedules associated with resources required for the activity. In cases where an activity involves the scheduling user plus at least one other invitee or participant, the algorithms will account for factors (e.g., preferences, habits, tendencies, aspirations, etc.) for each of the invitees or participants in at least some embodiments. In other embodiments, some invitees may be primary and others secondary and in that case factor weightings would be different for the different attendees when selecting optimal time slots.

At block 1234, the system queries the user if the user wants the system to automatically schedule the activity per the floating schedule feature or if the user wants to manually select a slot to schedule the activity. If the user decided to manually select a time slot for the activity, control passes to block 1236 where the optimal time slots are presented to the user. At block 1238 the user selects one of the optimal time slots causing the system to schedule the activity in the selected time slot after which control passes back up to block 1226 where the system monitors for another scheduling initiation action by the user.

In at least some cases it is contemplated that a system user may manually override the scheduling options and select a non-optimal time slot for scheduling some activity. Here, while the system may allow non-optimal manual scheduling, in at least some cases it is contemplated that that system will automatically provide a warning and an indication as to why non-optimal manual scheduling options are simply not optimal prior to the user completing the scheduling activity. Similarly, where other people are invited to either the first or second meetings, the system may also provide notifications to each or at least a subset of those invitees indicating that the scheduler's schedule may present a conflict which could affect overall meeting timeliness. For instance if a user schedules a second meeting immediately after a first meeting where first and second spaces associated with the first and second meetings are separated by a 15 minute walk, the system may, upon scheduling of the back to back meetings, present a warning to the scheduling user indicating that if the user does not depart the first meeting until the end of the scheduled slot, the user will simply be late for the second meeting 15 minutes away and may present warnings to other invitees to each of the first and second meetings indicating that the scheduling user has a schedule that may cause her to leave the first meeting early or arrive at the second meeting late.

Referring still to FIG. 13, at block 1226, if a user does not initiate a scheduling action, control passes down to block 1244 where a system processor continually tracks activities on the floating list to determine when the number of optimal time slots for each of the list activities drops below a threshold number. In some cases the threshold number may be two while in other cases it may be a greater number. Here, the idea is that if the number of optimal time slots for any activity drops to a small number, the activity should be scheduled to ensure that the activity is performed during the associated time range.

Where the number of optimal time slots for a floating activity is still greater than the threshold level, control passes to block 1256 wherein the system determines, for the current day and any following days, if the maximum number of top tier activities for that day are already scheduled. For example, if a first user has specified a preference to not have more than three one hour or more meetings on any given work day, and three meetings have been scheduled on a next Monday, the processor would determine that the maximum number of top tier activities has been scheduled for that Monday. In this case, control passes to block 1258 where the processor uses the optimization algorithms to schedule non-top tier floating list activities in the open time slots on the following Monday in an optimal fashion after which control passes back up to block 1226. If the maximum number of top tier activities has not been scheduled for a day, control passes from block 1256 back up to block 1226 where the process continues to cycle.

Referring again to block 1234 in FIG. 13, if a user elects to have the system automatically optimally schedule the activity, control passes to decision block 1240. At block 1240, a processor determines if the number of optimal time slots for the activity is less than a relatively small threshold number. Where the number of optimal time slots is greater than the threshold number control passes to block 1250 where the activity is added to the floating list of activities to be scheduled. Next, at block 1252, the processor considers the next 24 hours and, for any top tier activity on the floating list, selects an optimal time slot for the activity. Here, where there are two or more top tier activities on the list, the processor applies the optimization algorithms to identify which activities are slotted during the different time slots. At block 1254, the processor considers the next 12 hours and, for any open time slot, selects some non-top tier activity to be scheduled in the slot. Here, as in the case of the top tier activities, the processor applies optimization algorithms to the non-top tier activities on the floating list in order to identify which activities are slotted in the open slots. After block 1254 control passes back up to block 1226 where the process continues to cycle.

Referring still to FIG. 13 and specifically again to block 1240, if the number of optimal time slots for the activity is less than the threshold number, control passes to block 1242 where the sub-process described above automatically occurs so that one of the slots is automatically selected to ensure that the activity is completed within the specified time range.

In at least some embodiments when an activity is added to a floating schedule list, it is contemplated that notice of the floating activity will be provided to all users that are affected by the floating activity including the user that specified the activity and, for instance, other invitees. Where other users are invited to participate in a floating activity, the notifications may allow each user to accept or reject the invitation. Rejected invitations are noted and in at least some cases may result in cancellation of associated activities on the floating list (e.g., in cases where all other invitees reject an invitation). Where at least one second invitee accepts an invitation while at least one invitee rejects the invitation, the system may re-identify optimal time slots to eliminate the effects on time slot options of factors related to invitees who rejected the invitation. Here, in most cases, it is expected that any invitation rejection would result in more optimal time slots as less factors would need to be considered. Accepted invitations cause activities to float on the floating lists for all of the accepting invitees as well as the user that initiated the activity scheduling action.

In at least some cases it is contemplated that any time a floating activity is automatically scheduled in a specific time slot, a notification may be presented to each affected system user. For instance, where a first user invites second and third users to a meeting and both accept, when the activity is scheduled subsequently, notices of the actual meeting time slot are sent to the first, second and third users. A scheduled activity notice may allow a user to access her overall schedule via a hyperlink or the like to see how the scheduled activity fits in with other activities temporally proximate and may enable a user to reject the scheduled time slot causing the activity to be kicked back into the floating list for subsequent rescheduling.

In at least some cases, instead of providing a separate notice of each automatically scheduled activity to a user, a single notice may be presented to the user at some other time interval so that the user can consider a plurality of automatically scheduled activities at any time. For instance, twenty minutes before a user is scheduled to leave her office at the end of the day she may receive a notice for the next day indicating newly scheduled activities from the floating list so that she can prepare to participate in those activities.

In at least some cases it is contemplated that a user will be able to access a graphical representation of her schedule as well as her floating list of activities to be scheduled. Where a floating list is viewed, it is contemplated that the activities on the list may be subdivided by tiers (e.g., top tier, non-top tier, etc.). Within any floating activity tier, the activities may be ordered based on completion date or any other optimization factor such as, for instance, activity type, invitees to the activity, user preferences, user tendencies, etc. For instance, when ordered based on completion date, a first activity on a floating list may be the activity with the nearest completion date, the second activity on the list may be the activity with the second nearest completion date, etc.

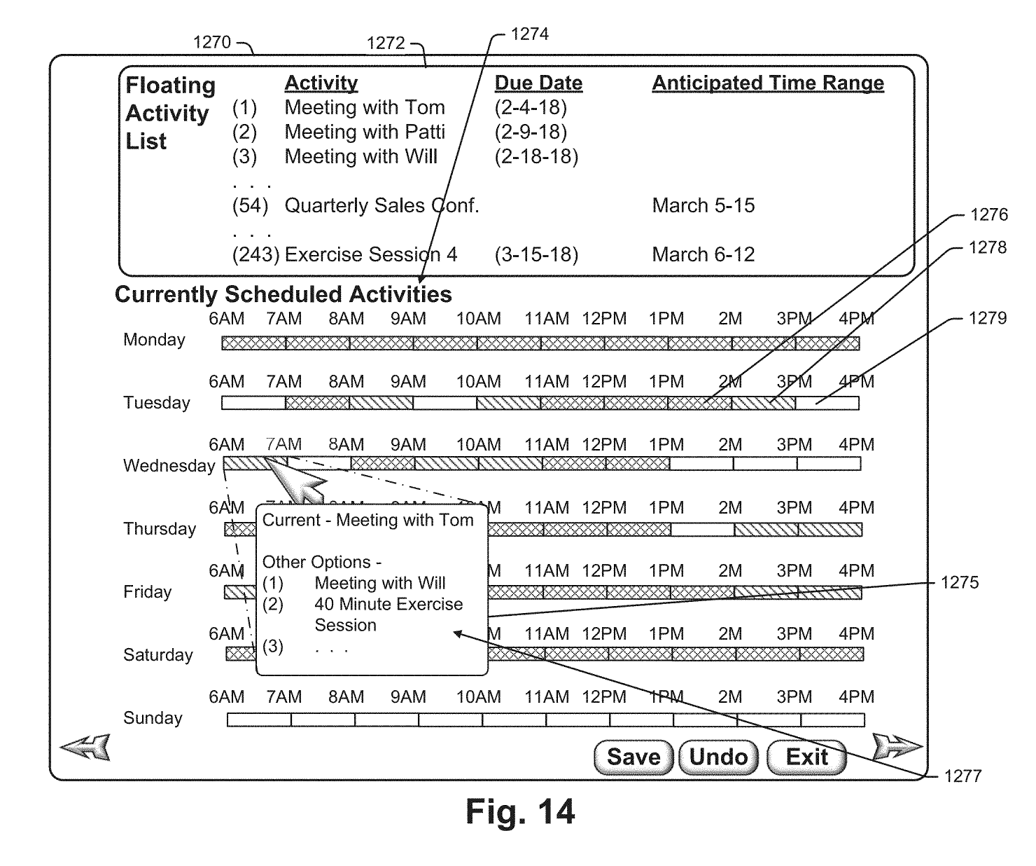

Completion dates may be presented to the user for each activity so that the user has a sense of when the activity needs to be completed. In this regard see FIG. 14 that shows an exemplary user interface screen shot 1270 including a floating list field 1272 and a currently scheduled activities representation 1274. The list in field 1274 orders floating activities by date. The currently scheduled activities representation includes a time line for each day of a week where time slots on each line are highlighted or otherwise visually distinguished in one of three ways. Double diagonal cross hatching 1276 indicates that an activity is currently scheduled for an associated time slot while blank time slots indicate that the time slot is currently available (e.g., not scheduled). Left down to right cross hatching 1278 indicates that based on all the scheduled activities, floating activities, user preferences and other optimization factors, if nothing else changes, one of the floating activities would be scheduled for the associated time slot. Thus, the single cross hatched representations can operate along with the scheduled slots to give a user a visual sense of a tentative optimized schedule, including the floating activities. Non-hatched slots 1279 indicate available time slots that are not yet scheduled and that are not currently required to optimally fulfill floating activities.

In at least some cases when a user moves a selection icon over any one of the time slots in representation 1274, an activity currently associated with the selected slot may be indicated. To this end, see, for instance, the drop down field 1275 in FIG. 14 where the field indicates that a meeting with Tom is currently associated with the selected 6 to 7 AM time slot on Wednesday. In the illustrated example, the meeting with Tom is on the floating list 1272 and therefore is only tentatively associated with the slot and may change as other activities are scheduled and floated. In the case of a scheduled activity, the scheduled activity would be indicated in the drop down field. In addition to indicating an associated activity, the drop down field may also list other activities that may be swapped in for the currently associated activity if the user desires. For instance, in FIG. 14 other currently floated activities that the user can select to swap in for the meeting with Tom are listed at 1277.

In at least some cases it is contemplated that while activities may float as describes above, the system may automatically estimate a time range in which activities will likely occur so that a user has a high level general sense of how specific activities fit into their overall schedule even prior to scheduling activities for specific time slots. For instance, see again FIG. 14 where anticipated time ranges are associated with two of the floating list activities indicating that a quarterly sales conference is anticipated, based on all current optimization factors, to occur within a time range between March 5 and March 15 and a fourth exercise session is anticipated to occur within a time range between March 6 and March 12.

Floating Non-Time Resource Scheduling

Just as there are problems with existing user time scheduling systems, there are similar problems with other resource scheduling systems related to space and facility affordances (e.g., workstations, communication equipment, exercise assemblies, etc.). For instance, existing space and other resource scheduling systems have at least three problems. First, when a meeting is initially scheduled, often times a scheduler (e.g., the user that initiates a scheduling activity) will specify a space that ultimately is larger than needed for the meeting. In this regard, in many cases a scheduler's anticipated space needs are unclear when initially reserving a space for a meeting. For instance, a scheduler may know that she wants to invite at least three other people to a meeting but may also be contemplating inviting fourth and fifth other persons. Here, to accommodate any possible needs, the user may book an eight person space (e.g., assuming that there are no 6 person conference spaces) when in fact a 4 person space may be sufficient. Even if a scheduler invites five other people to a meeting, two or more may not accept the invitation so that if an eight person space is reserved, the space is more than ultimately required. Moreover, even if all five invitees accept a meeting, two or more may subsequently decide to participate remotely via telepresence so that the eight person space again would not be necessary.

Second, even if a scheduler initially correctly anticipates space and other affordance needs, those needs can change right up a time just prior to meeting commencement. For instance, two invitees that accepted a meeting may not show up for the meeting or may attend via telepresence at the last minute. Again, scheduled space may be more than requires. While overbooking space and other resource needs in any specific instance may seem trivial, when overbooking is persistent and often, the result is that space and resources that could support other meetings and uses are unavailable and space and affordance assets are wasted.

Third, where a space or affordance scheduling system requires user's to select specific times for using specific spaces and resources when initially reserving, selection of time slots for resource use operates as another restriction on time schedules for every invitee that accepts a meeting invitation. As explained above, any early restrictive scheduling of user time limits the ability of the floating user time scheduling system to remain flexible.

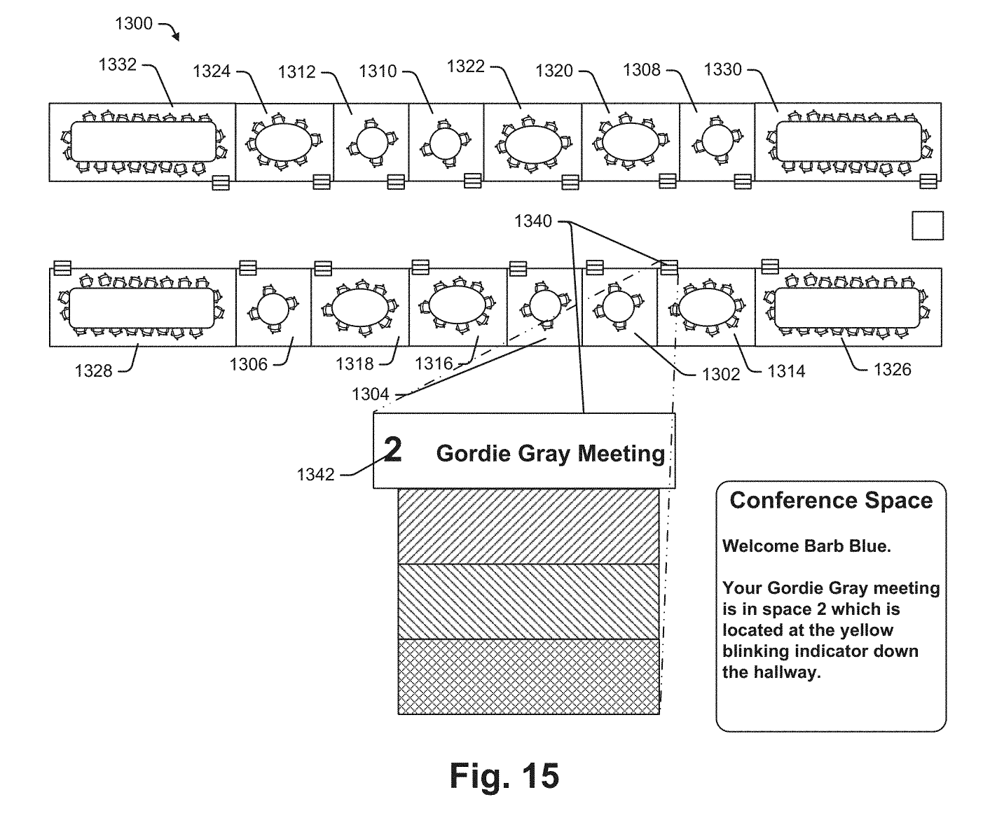

Just as user activities can be floated by a scheduling system to be added to a user's schedule as late as possible to optimize a user's time resource, other space and resource use requests can also be floated in a similar fashion to optimize resource use. In this regard, see the top plan view of an exemplary conference center 1300 illustrated in FIG. 15 that includes three differently sized meeting spaces including six four person spaces 1302, 1304, 1306, 1308, 1310 and 1312, six eight person spaces 1314, 1316, 1318, 1320, 1322 and 1324 and four twenty person spaces 1326, 1328, 1330 and 1332, for a total of 16 conference spaces.

Here, instead of requiring a user to select a specific resource and time slot when requesting a space for a meeting, it is contemplated that the system may enable the user to specify a much more general request enabling the system to at least initially float the request until the meeting has to be scheduled to maintain optimality. For instance, a user may simply indicate an anticipated meeting duration, meeting invitees and the day or some other period longer than the anticipated meeting duration (e.g., a morning, an afternoon, a week, etc.) within which the meeting should be concluded. The period within which a meeting should be concluded will be referred to hereinafter as a “possible use period” unless indicated otherwise and typically will be a period longer than an anticipated duration of the associated meeting. For instance, while an anticipated meeting duration may be one hour, a possible use period may include an entire morning period from 7 AM until noon, a full day period, a week long period, etc.

In FIG. 15, the six four person meeting spaces, six eight person meeting spaces and four twenty person meeting spaces are interleaved with each other along left and right sides of a hallway with an order including, along the left side of the hallway, a first twenty person meeting space 1326, followed by a first eight person meeting space 1314, followed by first and second four person meeting spaces 1302 and 1304, followed by third and fourth eight person meeting spaces 1316 and 1318, followed by a third fourth person meeting space 1306, followed by a second twenty person meeting space 1328 and, along the right side of the hallway, a third twenty person meeting space 1330, followed by a fourth four person meeting space 1308, followed by fourth and fifth eight person meeting spaces 1320 and 1322, followed by fifth and sixth four person meeting spaces 1310 and 1312, followed by a sixth eight person meeting space 1324 followed by a fourth twenty person meeting space 1332.

Once a user specifies a first meeting duration, meeting invitees and the possible use period, the system can place the resource request on a floating list and monitor the list requests and available time slots for meeting spaces that can accommodate the meeting. Until the number of meeting requests on the floating list for spaces that can accommodate the first meeting request during any sub-period of the possible use period equals the number of spaces that can accommodate the first meeting request plus one, all of the requests can continue to float.

In at least some embodiments, once the number of meeting requests on the floating list for spaces that can accommodate the first meeting request during any sub-period of the possible use period is equal to the number of spaces that can accommodate the first meeting request plus one, the system may simply automatically schedule two of the space requests based on system optimization algorithms. For instance, in the case where there are four twenty person meeting spaces in a conference center, once a floating list includes five meeting requests for a twenty person meeting space on a specific morning, it would be possible that all five meetings could overlap which would cause a misalignment of space with user needs.

To avoid space and need misalignment, once the fifth twenty person meeting space request is received, the system may select first and second of the five requests and automatically schedule the associated meetings in optimal time slots. For instance, assume that a first of the five meetings is automatically scheduled for an 8 AM to 9 AM time slot and a second of the meetings is automatically scheduled for an 11 AM to noon time slot. In this case, because only three other twenty person space requests remain on the list, even if every one of those meetings were to occur during the 8 AM to 9 AM time slot or during the 11 AM to noon time slot, all of those meetings could be accommodated. Here, the remaining three space requests on the floating list may be scheduled at any time during the 7 AM to noon period. When the first and second meetings are scheduled, while they need to be associated with specific time slots, the specific one of the four twenty person meeting spaces to be used for the meeting does not have to be identified as any of those spaces will be sufficient. By not associating specific scheduled meetings with specific meeting spaces, ability to schedule specific spaces for specific meetings based on the optimization algorithms remains flexible.

In has been recognized that in almost all cases all floating space requests for specific space types and possible use periods will not result in all associated meetings overlapping. For instance, in the example above where a floating space request list includes five requests during a possible use period for twenty person meeting spaces, it is highly unlikely that all five eventual meetings will overlap. For at least this reason, in at least some cases it is contemplated that the number of space requests for a specific space type during a possible use period may have to be greater than the number of that space type plus one. For example, the number of floating space requests in the above example may have to exceed the number of a specific space type plus two or three.

In addition, where other space types in addition to an optimal space type may accommodate space needs, automatic scheduling of floating space requests may also be delayed until the additional space options are exhausted. For instance, in the above example where there are six four person meeting spaces and six eight person meeting spaces, when a seventh four person meeting space requests is added to the floating list, if there is still at least one eight person meeting space available during a possible use period, that eight person space may be earmarked for use to support the seventh four person meeting so that all of the space requests can continue to flat. Here, if another meeting request is received for an eight person space and the eight person space earmarked for the seventh four person meeting is required for the eight person space, the system may automatically earmark the eight person space for the new eight person request and simultaneously automatically optimally schedule two of the four person meetings for time slots within the possible use period to avoid space and need misalignment.

In cases where anticipated space requirements for any floating space request change for any reason, those changes may cause a system processor to automatically modify the associated floating space request. For instance, two of six invitees to a meeting either reject an invite or, after initially accepting the invitation, decide to back out of the meeting, those actions may result in a floating space request change so that the request is for a four person space as opposed to an eight person space.

In embodiments where space requests float up until and thorough a possible use period, any of the meetings corresponding to the floating space requests can occur at any time during the possible use period. For instance, assume that a possible use period includes the period between 7 AM and noon on a Monday morning. Here, any floating meeting during the 7 AM to noon period may occur whenever invitees want the meeting to occur in at least some cases. Thus, three users may simply walk up to the conference center and take an optimally sized meeting space in order to commence their meeting. Once a meeting commences, the meeting is removed from the floating list and is associated with the current time slot and meeting space.

In at least some cases it is contemplate that users may be able to use meeting spaces impromptu without requiring pre-scheduling or a pre-request. For instance, two people that want to use a meeting space at the conference center may simply arrive at the center unannounced and, if a suitable space is available and not tentatively needed for floating space requests, may use that space for a meeting. Her, in at least some cases, when users indicate a previously unannounced impromptu space requirement, the system may identify suitable available space as well as floating space requests for the current possible use period to identify any possible space and need incongruities (e.g., a possible need for more space than is available) and, in some cases, may simply reject the previously unannounced space request if space cannot meet needs. In other cases, the system may check on likelihood that meetings associated with the floating requests will occur in the next hour or some other duration and, if meeting likelihood is low for one or more of the floating requests, may assume that the meeting associated with the floating request will not occur in the next hour and may automatically allow the impromptu meeting to occur in one of the spaces. For instance, if no invitees to a specific meeting that is associated with a floating space request are near the conference center when the impromptu meeting is to occur, the impromptu meeting may be accommodated.

In some cases it is contemplated that users may simply walk into at least some unoccupied meeting spaces and, upon occupying a space, may be associated therewith for at least some duration of time (e.g., the next 30 minutes). Here, in some cases the system may seek an indication from the user of anticipated duration of time the space will be required by the user. For instance, the system may generate an audible synthesized voice to confirm user and space association and to query “How long do you anticipate using this space?” In this case, the user may utter the phrase “One hour” to reserve the space for the next hour.

Systems already exist that include visual indicators mounted outside meeting spaces where the indicators change color to indicate different space scheduling and occupancy conditions. For instance, see again FIG. 15 where simplified and exemplary space use indicators, one labelled 1340, are located outside each of the meeting spaces that make up the conference center 1300. Exemplary indicator 1340 is shown with three separately illuminating indicator sections including left up to right hatching, left down to right hatching and double diagonal hatching to indicate green, yellow and red colors, respectively. Here, when a space is not instantaneously scheduled for use, the system may illuminate the green section to indicate availability of the space, when a space is currently scheduled for use, the system may illuminate the red section to indicate the currently scheduled state and the yellow section may be controlled to indicate some other state. The exemplary indicator device also includes a digital readout 1342 on which a meeting title may be presented once a meeting space is assigned to a specific meeting. In addition to the separate space indicators adjacent each meeting space, an entry emissive surface 1305 is provided at an egress to space 1300 for providing space assignment information to system users as they arrive at space 1300.

In embodiments where meeting space requests are floated during possible use periods, space scheduling indicators outside specific meeting spaces may be controlled to fill meeting spaces in a specific and dynamic optimal order. For instance, where entry to the conference space is at the right end of the conference space 1300 as illustrated in FIG. 15, the system may automatically guide users toward the right most meeting space that meets anticipated space requirements to fill up the meeting spaces from right to left. In this case, for instance, when Barb Blue arrives a conference space 1300 for a scheduled (e.g., not floated and not impromptu) 6 person meeting prior to occupancy of any of the meeting spaces, the system may automatically greet Barb via surface 1305 and provide a notification indicating the meeting space assigned to Barb's meeting. In addition, the system may flash the yellow indicator section of the indicator device associated with the right most 8 person space 1314 as presented in FIG. 15 to guide that user to space 1314. Moreover, the system may automatically present the meeting title of the meeting that barb is scheduled to attend on the digital screen 1342 as shown to confirm for the user which space to occupy.

If a second person arrives at center 1300 that accepted an invite to another meeting that requires an eight person meeting space next, assuming that person is not also associated with another floating meeting in the same possible use period, the second person would be greeted via surface 1305 and automatically guided toward the second right most eight person space 1320, the digital indicator screen would be controlled to indicate the second user's meeting and the meeting would be removed from the floating list and added to the schedule. Again, here, the user may be guided by a blinking yellow indicator section outside meeting space 1320. In this example, if the second person had arrived prior to Barb Blue, the second person would have been guided to the rightmost eight person space 1314 and later arriving Barb Blue would have been guided to the second rightmost space 1320.

In the above example, even if the system guides first arriving Barb Blue to a specific meeting space for a meeting, in at least some embodiments it is contemplated that if Barb enters a different meeting space that is suitable for the meeting and that is not required for some other floating or scheduled meeting, the system may automatically assign the meeting that Barb is attending to the space that she entered. Thus, for instance, assume that Barb enters eight person meeting space 1324 despite being guided toward space 1314. In this case, because space 1324 can accommodate the meeting Barb is supposed to attend, space 1314 would be freed up for a different meeting and space 1324 would be scheduled for the meeting and the indicator outside space 1324 would be controlled to indicate scheduled and occupied by illuminating the red indicator section. Similarly, if Barb were to enter twenty person space 1330 that is not needed for some other larger meeting and because Barb's meeting can be accommodated in the larger space, the larger space 1330 would be automatically associated with Barb's meeting and scheduling and notifications would be modified accordingly.

If a third person arrives at center 1300 next for an impromptu meeting (e.g., a meeting neither scheduled nor floated0, once that third person performs some action to request a space and then indicates the anticipated number of meeting attendees, the system will assign a suitable meeting space and associate that space with the user and the impromptu meeting. Again, in at least some cases a user may initiate a space request by simply entering a space, causing the system to query the user for the anticipated number of attendees and, if the space is suitable, the meeting will be scheduled for that space. If the space is too small or otherwise unsuitable for the meeting, the system may encourage the user to move to a larger or differently afforded space via one of the system output devices. In some cases, the user just occupying the space will cause association and scheduling for a current time slot without any other action required by the user. In this case the association would occur automatically if the occupied space is not required for some other scheduled activity.

In some embodiments the system processors may be programmed to float space requests during possible use periods until only one optimal time slot in the period exists for the specific request. Here, instead of automatically scheduling at least some floating requests when any type of conflicting space and use time may occur, the system may wait until there is only one optimal time slot left for any floated space request to start scheduling associated meetings.

In still other cases, the system may be set up to float meetings when possible up until a threshold period prior to a possible use period and then automatically schedule meetings for the conference center spaces. For instance, in some cases, 12 hours prior to any time slot on a schedule, the system may automatically schedule any floating space requests to provide scheduling certainty to users about their imminent or near time scheduled activities. In some cases only certain floating requests may be scheduled at the threshold period time. For instance, in the case of the eight tier hierarchy of activities and tasks described above, all activities in the top four tiers (e.g., (1) activities that are time sensitive; (2) work related activities with other people; (3) activities with family members and (4) Non-work related activities with people other than family members) may be automatically scheduled at the threshold time and other activities may continue to float to maintain as much flexibility in user and resource schedules as possible. In addition, in this case, the system may schedule the top four tier activities in a hierarchical fashion with the first tier scheduled first, followed by the second tier, and so on, to make sure top priority activities are accommodated in optimal slots followed by lesser priority activities and to allow at least some short amount of time for affected users (e.g., invitees) to reject specific time slots for high priority activities prior to scheduling the lower priority activities. For instance, at the threshold time a highest priority activity may be scheduled and notifications sent to all invitees with an option to accept to reject the scheduled slot. Here, if one or a threshold number of invitees reject the time slot, the system may offer other optimized time slots until one is accepted by a threshold number of invitees. In this case, the option to reject a time slot may only remain open for a short period (e.g., one hour) so that the system can move on and schedule lower priority activities in an optimal fashion.

It should be appreciated that the more specific a user can be about the possible use period for a space requirement, the more flexible the system can be regarding how long the system can float space requests. Thus, for instance, if all users were able to at least specify if a meeting is anticipated to occur in the morning or in the afternoon, many more additional space requests could be floated for longer periods without running into space and need incongruities.

While the floating non-time scheduling concept is described above and in more detail hereafter in relation to meeting space, it should be appreciated that the concept and the discussion here is applicable to any other non-time resource. For instance, in cases where user workstations are used by many different users at different times in a “hotelling” fashion, users may request a workstation during a possible use period and the system may float the request until the optimal stations for the user are down to one or some small number after which the system may automatically schedule a specific optimal station for the user to use. As another instance, exercise equipment, telepresence or other communication systems, etc., may all be requested and the requests floated until actual scheduling is necessary.

While the floating non-time resource scheduling concept may be used independent of the floating time scheduling concept in at least some embodiments, when the two concepts are used in parallel, several important and valuable synergies result. For instance, as meeting invitee schedules firm up, fewer and fewer time slots for a meeting will be optimal and therefore the possible use periods for a meeting space will automatically be paired back until only one or a small set are available and then space use will be automatically scheduled or at least suggested to meeting attendees for acceptance.

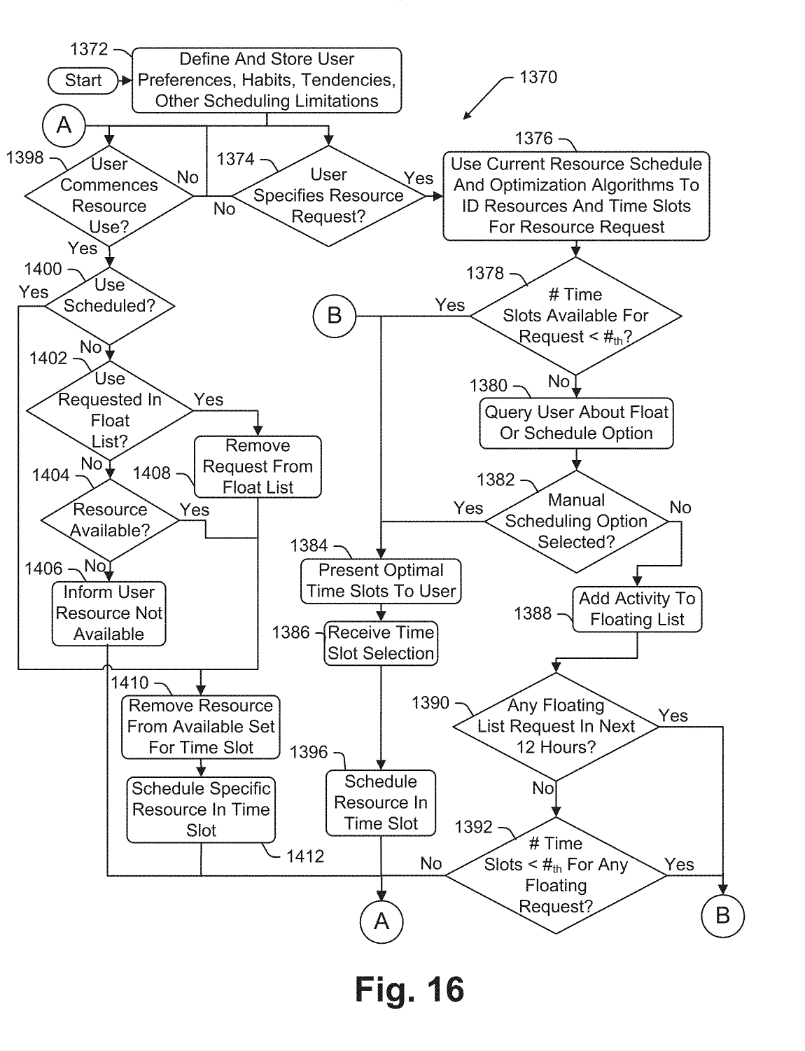

Referring now to FIG. 16, an exemplary process 1370 is illustrated that is consistent with at least some embodiments of the floating non-time resource scheduling concept. At block 1372, user preferences, habits, tendencies and other optimization algorithm factors are received, generated, calculated or otherwise obtained and are stored in a system database. After block 1372, the process divides into two parallel paths of operation that, in at least some embodiments, proceed simultaneously. The first operation path that starts with decision block 1374 enables a user to specify a resource request to be scheduled and the second part that starts with decision block 1398 enables a user to simply start using a resource in an impromptu fashion when available.

Referring still to FIG. 16, at block 1374, a system user uses one of the interface input devices to request use of a specific resource. At block 1374, if no resource is specified, control continually loops back to block 1374. Here, the resource may be, for instance, a meeting space, a telepresence subassembly, a workstation, a piece of exercise equipment, or any other resource in limited supply that can be reserved for use during specific time slots. For instance, Barb Blue may specify that she needs a meeting space for six people for 2 hours next week where the space is equipped with a telepresence system that enables remote linking to at least one other remote invitees as well as the identities of invitees to the meeting. Once a request is specified, control passes to block 1376 where a system processor uses current resource and user schedules and optimization algorithms to identify optimal resource and optimal time slots that can satisfy the request.

At decision block 1378, the processor determines if the number of time slots available for the resource is greater than a small threshold number #th and, if the number of available slots is less than the threshold number, control passes to block 1384. In at least some embodiments at block 1384 the system presents the small subset of optimal time slots to the system user for selection and, once a selection is received at block 1386, the resource request is scheduled at block 1396. Here, because there are only a small number of possible optimal time slots available that can fulfill the user's request, the system automatically encourages the user to select one slot for the resource use to ensure availability. In other cases when the number of optimal time slots is small upon resource request entry, the system may automatically select one of the optimal time slots without further user input and schedule the resource accordingly.

In at least some embodiments, consistent with the description above, when there are several resources that can fulfill a user's request, the system may schedule a resource time slot at 1396 without scheduling a specific one of the resources. For instance, in the case of meeting space and the conference center illustrated in FIG. 15 that includes six eight person meeting spaces, any of the eight person meeting spaces as well as each of the four 20 person meeting spaces could be used to fulfill a user request for an eight person space. So long as at least one of the eight or 20 person spaces is available during a specific time slot, the slot can be scheduled independent of specifying which of the spaces is associated with a specific meeting.

By not associating specific resources with specific scheduled time slots when multiple resources can fill requests, the system remains flexible to optimally accommodate subsequent requests or modifications to existing floated requests that may only be fillable by a smaller subset of the resources. For instance, assume that the four 20 person conference spaces in FIG. 15 are differently afforded where two of those spaces includes telepresence systems and the other two do not. In this case, if two 15 person meetings that do not currently require telepresence systems and one 15 person meeting that does require a telepresence system are floated, when a fourth 15 person meeting space is requested, because all of the prior three meetings are floating, if the fourth meeting requires a telepresence system, one of the two 20 person spaces with telepresence can be assigned to the fourth meeting without any conflict with the other meetings.

Referring again to FIG. 16 and specifically to block 1378, if the number of available optimal time slots for a resource request is greater than the threshold number, control passes to block 1380 where the system queries the user to determine if the user wants to schedule the request for a specific time slot or if the user wants the system to float the request so that resource use can be optimized automatically. The user selects either manual scheduling or a resource float option at block 1382. Where the user selects the manual scheduling option (e.g., so the user can select a specific time slot for resource use), control passes to block 1384 and then to 1386 where optimal time slot options are presented to the user and a selection is received. Once a user selects a time slot option, control passes to block 1396 where the resource is scheduled for the selected time slot.

Referring again to block 1382 in FIG. 16, if a user elects to float the resource request, control passes to block 1388 where the specified request is added to the floating list. Continuing, at decision block 1390, the system processor determines if any of the floating list requests has a possible use period that expires in the next 12 hours. Here, in at least some embodiments, the idea is that at some time within a possible use period floating list requests need to be fulfilled. The 12 hour period is only exemplary and any other period (e.g., 1 hour, one week, one month, etc.) may be used. If the possible use period for a floating list request expires within the next 12 hours, control passes to block 1384 where the user is presented optimal time slots for the request, a user selection is received at block 1386 and the resource is scheduled for a specific time slot at block 1396. Again, in an alternative system, when the possible use period for a floating list request expires within the next 12 hours, the system may automatically identify an optimal time slot and schedule the resource without user selection.

At block 1390, for each floating list request, if the possible use period extends longer than the next 12 hours, control passes to block 1392 where the system processor determines if the number of optimal time slots still available is less than a small threshold number and, if the number of optimal slots is less than the threshold number, control again passes to block 1384 where request scheduling proceeds. If the number of optimal slots for a specific request is greater than the threshold number, control passes back up to decision blocks 1398 and 1374.

In addition to intentionally using a system interface input device to specify a request for specific resource use, in at least some embodiments it is contemplated that the system may be able to ascertain a user's desire to schedule a resource in real time from detected user activities. For instance, in the case of a meeting space, if a user occupies an available space, the system may be programmed to recognize occupancy and, based on the occupancy, may conclude that the user intends to use the space and may automatically schedule the space use for at least some minimal period of time. As another instance, if a user starts using an elliptical exercise machine of other equipment, the system may recognize that use and schedule the machine for use by the user for at least some minimal period.

Referring again to FIG. 16 and specifically block 1398, a system processor monitors resource use by system users and, once resource use and user identity are detected, control passes to decision block 1400. At block 1400, the system determines if the resource use was previously scheduled (e.g., via the process path starting at 1374). If the resource was previously scheduled, control passes to block 1410 where the resource is removed from the available set for the current time slot and for a duration corresponding to the scheduled resource request (e.g., if the request was for two hours, the specific resource is associated with the specific request for the next two hours). After block 1410, the processor schedules the specific resource (e.g., one of the specific six eight person meeting spaces) to fulfill the request and control passes back up to blocks 1398 and 1374 where the process continues to cycle.

Referring still to FIG. 16, at block 1400 if a user's use of a resource was not previously scheduled, control passes to block 1402 where the processor determines if the use is requested in a resource request float list. Where the use is consistent with one of the floating requests, at block 1408 the associated request is removed from the float list and control passes to blocks 1410 and 1412 where the resource being used is automatically removed from the available set and is scheduled for a current time slot associated with the floating request after which control passes back up in the process so the process continues to cycle.

At block 1402, if the request was neither previously scheduled or on a float list, control passes to block 1404 where the processor determines if the resource being used is available for use or is scheduled to be used by another person. Here, the determination of available or not may be instantaneous or may be based on at least some limited ongoing duration so that if the resource is scheduled for use by another or needed to support floating resource requests by another within the limited duration, the system will identify the resource as unavailable. If a user uses a resource that is not available, the system may present some indication that the resource is not available (see block 1406) to the user (e.g., audible or visual warning that the user should not use the resource as it is reserved for someone else). After block 1406 control passes back up to blocks 1398 and 1374 where the process continues to cycle.

In some cases warnings that resources are not available may include some alternative resource option(s) to encourage the user to select a different resource. In other cases the warning may commence a scheduling activity as at block 1374 to query the user for resource needs and present the user with other suitable options in real time. If, at block 1404, the resource is available for use by the user, control passes to block 1410 where the resource is removed from the available set for at least some minimal time slot duration and to block 1412 where the resource is scheduled for the time slot for use by the user.

While not shown in FIG. 16, it is contemplated that any time a system processor performs any automatic function or process step, the system may present at least a notification to effected system users. For instance, in embodiments where floating list resource requests are automatically scheduled without requiring any user input (e.g., where blocks 1384, 1386 and 1396 in FIG. 16 are replaced by automatic floating request scheduling), a notification of any automated scheduling of a resource pursuant to the floating request may be sent to each user associated therewith. As another instance, when a user starts using a resource in an impromptu fashion that has not been previously scheduled or floated on a float list, a processor may present a notification to a user when the resource schedule is amended to schedule the resource for use by the system user. Here, the notification may be presented on a stationary emissive surface in the occupied space, via a worn computing device which audible or visual output capabilities or in any other fashion.

In other cases, any time a system processor performs any automatic function or process step, the system may present a confirmation notification and query to the user specifying the automatic function or step and enabling the user to reject or modify the automatic function or step. For instance, if a user occupies an available meeting space in an impromptu fashion, the system may provide a notification that the space is being assigned to the user for use for the next 30 minutes and querying the user if the user want to change the duration of the space assignment or to reject the assignment. Here, the user may accept the 30 minute assignment, reject the association or amend the assignment duration.

In complex systems that are consistent with at least some aspects of the present disclosure, many different user and resource schedules need to operate in unison to optimize system resources in a holistic fashion. Here, for any user, while activities and resource requests that affect the user's schedule may float and each may be associated with a different possible activity period or possible use period, those possible periods will dynamically change as the user and other users schedule other activities and generate resource requests.

In at least some embodiments it is contemplated that as possible activity and possible use periods dynamically change, those changes will be reflected in floating activity and resource request lists. Thus, for instance, where a user initially species that she wants to exercise for one hour sometime within a possible activity period range between 8 AM on Tuesday morning and 6 PM on Thursday evening, by Monday at 10 AM, it may be that other scheduled and floating activities for the user restrict the exercise session down to sometime between 8 AM and 11 AM on Wednesday morning. In this case, the floating list activity field 1272 in FIG. 14 may be amended to reflect the shortened possible activity period and anticipated time range for the exercise session.

In some cases when a possible use or possible activity period is modified, a notification may be presented to all system users associated with the use or activity. For instance, if the possible activity period for a specific meeting between four people was initially specified as between March 1 and March 15, if subsequent other scheduled and floating activities for the users and scheduled resource use and floating resource requests restrict the possible activity period down to the afternoon of March 13, a notification of the reduced possible activity period may be sent to each of the four meeting invitees. This type of notice is intended to give system users a better understanding of when activities will likely be slotted on their schedules despite the fact that specific time slots have yet to be assigned.

Automated Dynamic Schedule

Many people schedule most of their activities well in advance of associated execution times. While early scheduling and planning is often a good idea that helps a person understand her commitments, in most cases early scheduling is done in a vacuum where many factors that affect optimality of activity schedules are unknown. Even in cases where a system aides a user in selecting activity time slots based on optimization algorithms, those algorithms cannot take into account unforeseeable optimization factors like instantaneous future user conditions, unexpected or surprising events (e.g., an automobile accident, a surprise party, etc.) and activities (e.g., a meeting with a manager). As a simple example, a first person may schedule an important 8 AM Wednesday morning meeting with colleagues four weeks prior to the scheduled time unaware that she will be awake at 2 AM on Tuesday evening prior to the scheduled time dealing with some unforeseen event and that her sleep on Tuesday evening will be agitated. Here, based on her habits and tendencies, it may be highly likely that her ability to fully participate in the meeting Wednesday morning will be substantially degraded given her lack of sleep Tuesday night. In the press of time and because of the difficulty associated with trying to reschedule a meeting shortly before it is scheduled to occur, people often simply do not perceive their current conditions and meekly press on to get through their daily activities. In these cases, rescheduling is often the last option considered given the burden involved and instead, effort is spent trying to rush to sleep with the primary goal being to arrive on time and simply survive activities as opposed to adding and receiving value.

As another example, an unexpected meeting squeezed between two other meetings on a person's schedule on a day when she already has many other meetings and activities may set her up for a stressful day and e lethargic afternoon when she is supposed to lead an important meeting. Here, the specter of arriving late, being exhausted and having to perform may increase the user's stress to the point where leading a meeting will be difficult at best.

As yet one more example, a person may schedule an exercise session for 4 PM on Thursday afternoon but, based on activities that occur on Thursday prior to the session, the person may simply not be in an optimal state to participate. Again, in many cases a person may be completely unaware of her current state and how it affects optimality of session participation. In fact, the person may be under the wrong impression that participating in the exercise session despite current state will be advantageous when in fact it is highly likely it will be detrimental. Again, rescheduling is often not considered as the person simply reacts to stay on schedule.

It has been recognized that the optimization system described above can augment a user's ability to dynamically change the user's schedule to optimize for user states and many optimization factors. To this end, the system may monitor user states, past activities and future commitments as well as other factors to constantly assess optimality of scheduled (and in some cases floating) activities and may at least automatically suggest possible changes to the user when the increase in optimality is above at least some threshold level. For instance, in the above example where a user is awake at 2 AM the night prior to an important 8 AM Tuesday morning meeting, the system may automatically determine that the user's condition on Tuesday morning will adversely affect her ability to participate in the meeting and may automatically examine her schedule and other meeting invitee schedules to identify a more optimal time slot on Tuesday afternoon to accommodate the meeting. In this case, the system may present a notification to the user as the user is preparing to sleep suggesting the Tuesday afternoon time slot for a rescheduled meeting along with a simple way to accept the change (e.g., an on screen selectable “Accept” icon or the like). Thus, here, the system may automatically identify and suggest optimal scheduling options and reduce the effort needed to reschedule enabling the user to sleep in on Tuesday morning. In this case it is contemplated that, even if a user is not in an optimal state for some activity, based on alternative scheduling options, the system may determine that a scheduled activity should proceed. For instance, in the above example, if the Tuesday morning meeting cannot be schedule for 2 weeks, the system may simply allow the user's Tuesday morning meeting to proceed. In this case, given all factors, the system would simply have determined that the Tuesday morning meeting is optimal.

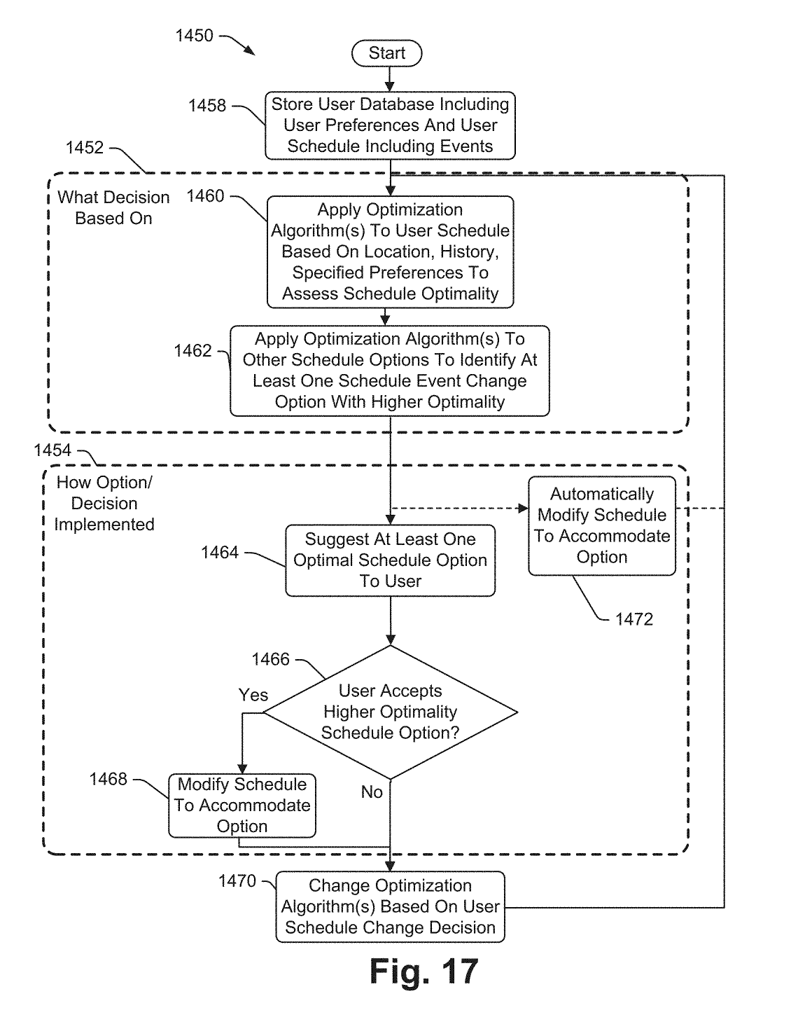

Referring now to FIG. 17, a process 1450 for dynamically changing a user's schedule is illustrated that includes three separate sub-processes 1452, 1454 and 1470 related to what factors are considered for optimization, how an optimization decision is implemented and optimization algorithm modifications, respectively. At a first block 1458, user data including user preferences, habits, tendencies, etc. and user schedules including events and activities are stored in the user database. At block 1460 a system processor applies optimization algorithms to the user's schedule based on user location, history, specified preferences, habits, tendencies, etc. to assess schedule optimality for each activity on the user's schedule. At block 1462, the system processor applies at least a subset of the optimization algorithms to other schedule options to identify at least one schedule activity change option with a higher optimality and, in at least some cases, where the difference in optimality between a current scheduled activity and the other option is above some threshold level.

Continuing, at block 1464, the system processor suggests at least one schedule change to the user where the change is more optimal than an existing scheduled activity. Again, the change notification may include an interface enabling the user to select the change suggestion. At block 1466, if the user accepts the suggested schedule change, control passes to block 1468 where the user's schedule is modified to accommodate the selected change option. After block 1468 or if the user rejects the change suggestion at block 1466, control passes to block 1470.

Any time a user accepts or rejects a schedule change suggestion, the system can learn from the user's choice and can modify optimization algorithms accordingly. For instance, if a user routinely accepts the same or similar types of suggestions, algorithms may be automatically modified so that those suggestions are rendered more optimal. Where a user routinely rejects similar suggestion types, algorithms may be modified so that those types of suggestions are rendered less optimal and therefore are issued less frequently or not at all. At block 1470 user acceptance or rejection of suggested schedule changes are used to modify optimization algorithms after which control passes back up to block 1460 where the process continues to cycle.

Referring again to FIG. 17, after block 1462, system control may pass to block 1472 where a user's schedule may be automatically modified based on one or more optimized schedule options. While not shown in FIG. 17, it is contemplated that as patterns in a user's acceptance of suggested changes form and are used to modify the optimization algorithms at 1670, at some point the algorithms may result in schedule changes that were once suggested being automated. For instance, if a user accepts five consecutive suggestions to reschedule exercise activities based on exhaustion, the system may automate rescheduling of exercise activities any time a user is exhausted.

In at least some embodiments where a system processor suggests schedule changes, the system may be programmed to only suggest changes at certain times that are convenient or optimal. For instance, if a user is in a current high level flow state while drafting a document, the system may wait to provide a rescheduling suggestion to the user after the flow state ends. As another instance, change suggestions to a use's morning schedule may only be provided to a user when the user wakes up in the morning or, in some cases, if the user wakes up at night between REM sleep cycles, etc.

In some cases the system may limit the number of rescheduling notifications to a user so as not to inundate the user with possible changes to consider. For instance, the system may restrict the maximum number of schedule change suggestions to three within a 24 hour period where each of the three suggestions have to result in at least a minimal increase in optimality and where only the three suggestions associated with the maximum increase in optimality are presented to the user.

In some cases it is contemplated that the system may implement rules that restrict rescheduling options to specific periods. For instance, in some cases activity rescheduling suggestions may be limited to options that occur prior to a currently scheduled time slot for the associated activity. Thus, where a meeting is currently scheduled for Tuesday morning at 8 AM, this rule would only allow the meeting to be rescheduled for a time prior to Tuesday at 8 AM. As another instance, activity rescheduling suggestions may be limited to within two days of a currently scheduled time slot for an associated activity. Here, it is recognized that many scheduled activities are time sensitive and have to be completed at least generally around the time they are scheduled and therefore rescheduling at a substantially earlier time or substantially later time may result in either premature activity or tardy activity. As still one other instance, the system may be restricted to suggesting schedule changes a minimum of 6 hours prior to current schedule time slots to avoid a case where a schedule change is made too close to an activities original time slot which could cause user confusion.

In at least some embodiments it is contemplated that at least some identified optimal schedule changes may be automatically implemented instead of suggested. For instance, where a user's morning activities are personal and are not associated with other users (e.g., the activities do not involve other users), the system may simply implement morning changes for a user if those changes are substantially more optimal than scheduled morning activities. For example, if a processor recognizes that a user is going to be exhausted in the morning, the system may automatically cancel the user's morning exercise session and reschedule that session for an available and optimal afternoon time slot without requiring user affirmation. Here, while not seeking permission to change the user's schedule, the system may still provide notice to the user when a schedule change is being made and allow the user to cancel the change if desired.

In other cases where a schedule change will affect other user schedules, the system may account to at least some degree for optimization for all users affected by a schedule change when considering which changes to automatically make or suggest. For instance, if a meeting scheduled to occur a next morning where six users are to attend the meeting is to be rescheduled, in addition to identifying a commonly available time slot for all six users for rescheduling, a system processor may take into account preferences, habits, tendencies and other factors related to each of the six invitees in order to assess optimal scheduling changes.

In cases where the system suggests or automatically makes scheduling changes, in at least some cases one factor considered when determining whether or not to make or suggest a schedule change may be whether or not the time slot assigned to a specific activity has already been changed in the past. Here, the idea is that once an activity time slot has been changed once, a system user may object to the time slot being changed again, and again, as time goes on. The number of allowed times an activity time slot may be altered may be one or any other small number and may be either preset by a system designer or, in some cases, may comprise one of the user preferences.

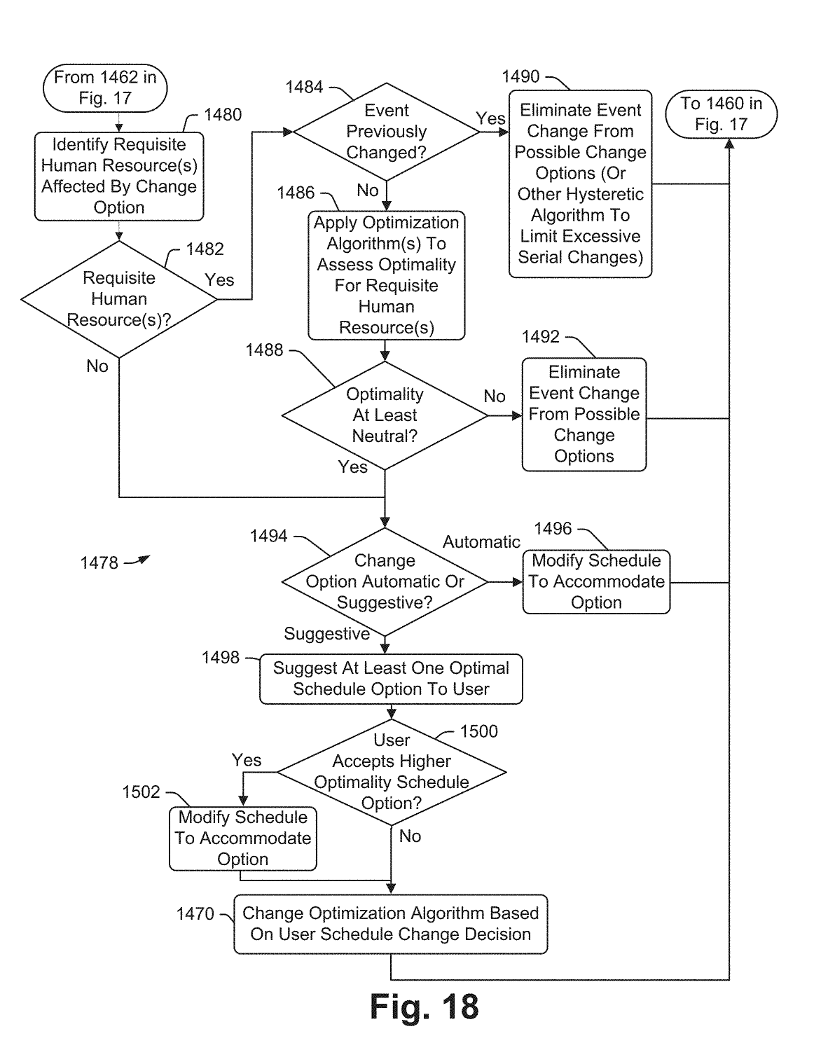

Referring now to FIG. 18, a flow chart illustrates a sub-process 1478 that may be substituted for a portion of the FIG. 17 process is illustrated where optimization factors include, among others, whether or not an activity has already been rescheduled at least once and whether or not schedules of people other than a user associated with the process will be affected by a schedule change is illustrated. Referring also to FIG. 17, after block 1462, control passes to block 1480 where a system processor identifies any human resources that would be affected by a rescheduling activity. Where no one else's schedule will be affected, control passes to block 1494 which is described below. If at least one other person's schedule would be affected by a possible rescheduling activity, control passes to block 1484 where a system processor determines if the activity associated with a possible rescheduling activity has been previously rescheduled. If the activity has been previously scheduled, control passes to block 1490 where the change is eliminated as a possible change after which control passes back up to block 1460 in FIG. 17. Other hysteretic algorithms for limiting excessive serial activity changes are also contemplated at block 1490.

Referring again to block 1484 in FIG. 18, where an activity has not been previously rescheduled control passes to block 1486 where optimization algorithms for each of the people affected by a schedule change are performed to assess optimality for each person. At block 1488 the system processor determines if the optimality for each of the people affected by a change is at least neutral (e.g., that the optimality of a change is approximately similar to the optimality of an originally scheduled activity for each affected person). If the optimality is less than neutral for one or a subset of the people affected, control passes to block 1492 where the rescheduling activity is eliminated as a possibility after which control passes back to block 1460 in FIG. 17.

Referring again to block 1488, if the optimality for each affected person is essentially unchanged or better when a scheduling change is made, control passes to block 1494 where the system processor determines if the change is to be made automatically or is to be suggested to the user. If the change is to be made automatically, control passes to block 1496 where the scheduling change is implemented for all affected users as well as resources required for the activity and then control passes back to block 1460 in FIG. 17.

Referring again to block 1494, if the change is to be suggested to a user, control passes to block 1498 where the system presents the change option to the user via one of the system interface devices. At decision block 1500 the processor monitors for user input to accept or reject the suggested schedule change. If the user accepts the change, control passes to block 1502 where schedules of all people and resources associated with the change are modified and then control passes to block 1470. If the user rejects the suggested change, control passes to directly to block 1470. As in FIG. 17, at block 1470 optimization algorithms are modified to reflect the user's acceptance or rejection of the change option at block 1500 after which control again passes back up to block 1460 in FIG. 17.

In at least some cases it is contemplated that if the system recognizes that one or more people associated with an activity rescheduling option would be adversely affected by the option, the system may perform some other sub-process other than simply dismissing the option outright. For instance, the system may present the option as a suggestion to a user along with a warning indicating that the option would adversely affect one or more of the other activity invitees. In this case, the user receiving the notification and suggestion could make an informed decision as to the ultimate effect a rescheduling action may have (e.g., whether or not key invitees would likely attend). As another instance, where optimality for one or more persons affected by a rescheduling would drop, prior to presenting the option to a user associated with process 1478, the option may be presented to the one or more persons associated with the dropping optimality. Here, if the persons associated with the dropping optimality indicate that they would still participate in the activity even if the schedule change were made, the system processor may either automatically make the change or present the change option as a suggestion to the user associated with process 1478.

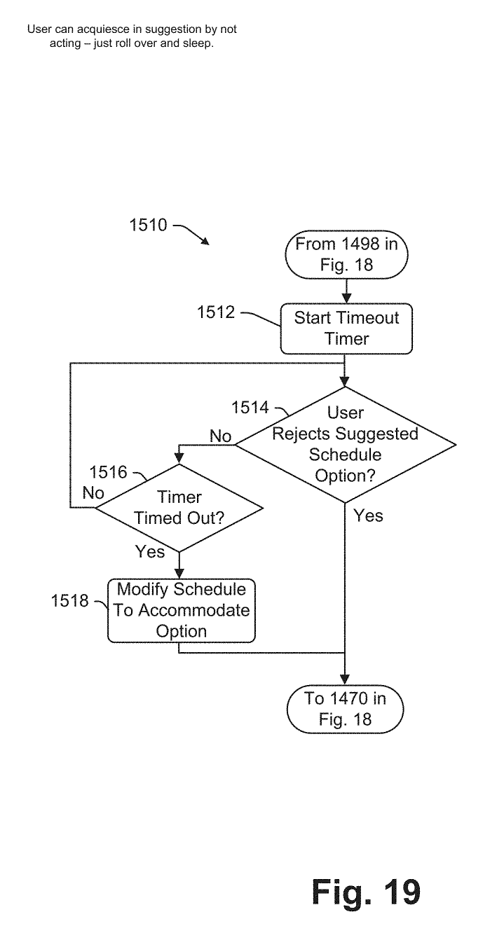

In at least some cases when a schedule change suggestion is presented to a user, the suggestion may include an option to cancel or reject the suggestion where, if the suggestion is not affirmatively rejected within some threshold period of time, the suggestion is automatically implemented. To this end, a sub-process 1510 that may be substituted for a portion of the process shown in FIG. 18 is illustrated. In FIG. 18, after at least one optimal schedule change option is presented to a user at block 1498, control may pass to block 1512 in FIG. 19. At block 1512, the processor starts a timeout timer to count out a period during which the user has to reject the suggestion or else the suggestion will be automatically implemented. At block 1514, if the user rejects the suggested schedule modification control passes back to block 1470 in FIG. 18. At block 1514, control passes to and cycles through block 1516 while the user does not reject the suggestion. At block 1516, once the timeout timer times out (e.g., 30 seconds, 1 minute, etc.), control passes to block 1518 where the schedule is modified consistent with the suggestion.

While FIG. 17 above indicates that several factors are considered when assessing schedule and scheduling option optimality, it should be appreciated that any of the factors described above with respect to FIG. 5 or many other factors may figure into one or more optimization algorithms. Consistent with FIG. 5 above, other factors may include but are not limited to:

User Location(s);

User biometrics (heartrate, perspiration, blood pressure, weight, height, body-fat index, etc.);

User ambulatory characteristics (posture, rate of walking, rate of climbing steps, blink rate, eye dilation, quality of movement, etc.);

User calculated characteristics—Flow state, stress level, durations of different flow and stress levels, engagement level, alertness level, etc.;

Environment—traffic, temperature, precipitation, natural lighting, etc.;

Time periods (how long does a person have prior to next scheduled activity);

Recent user activities;

Other scheduled user activities;

A colleague's biometrics, recent activities, time periods, etc.;

User habits/tendencies;

Third party offers (e.g., podcasts, news feeds, etc.); and

User preferences, desires or aspirations;

Priorities and hierarchical levels of activities and tasks, etc.

Many scheduled activities may result in non-optimal use of time and, as explained above, optimality of specific scheduled activities often changes over time and as the time slot associated with the activity is approached. While many rescheduling activities that result in better resource use may be possible, in most cases people simply will not want to be inundated with rescheduling suggestions which would be burdensome to consider or automated schedule changes which may cause confusion. According to one other aspect of at least some embodiments of the present disclosure, instead of routinely presenting any rescheduling suggestion that makes sense any time the suggestion is identified, in at least some cases the system may present a small subset of highly optimal rescheduling options at specific times for consideration. For instance, every Saturday morning a system processor may examine a user's next week schedule to identify a small number (e.g., three to five) highly optimal rescheduling suggestions and may present those suggestions to the user for consideration and selection to implement. As another instance, three highly optimal rescheduling suggestions may be presented to a user every morning for a current day, for a next day, etc. Here, some reasoning (e.g., reduced stress, weather will not be optimal for some outdoor activity, manager will be available tomorrow but not today, etc.) for the suggested rescheduling options may be presented along with each of the three options.

In at least some cases, in addition to seeking non-optimally scheduled activities, the system will automatically identify activities to optimally fill-in available time slots on a user's schedule. In this regard, for instance, the system may automatically recognize that a user would benefit from a 30 minute brisk walk between two afternoon meetings and may automatically schedule or at least suggest that activity to the user. Here, if the system suggests an immediate unscheduled activity to a user, the system may monitor how the user responds to the suggestion and, based thereon, may operate to schedule the activity for the remainder of a time slot for the user. For instance, if the system suggests that a user initiate a 30 minute brisk walk and the user stands up and initiates a walk, the system may recognize that the user responded positively to the suggestion and schedule the next 30 minute time slot as personal rejuvenation or exercise or some activity descriptor to that effect.

In addition to specifying various optimization factors to be considered when determining how best to schedule activities and tasks for a specific user, in at least some embodiments it is contemplated that a user will also be able to specify certain activity options to be suggested to other system users at times optimal for the specific user where the other user has to initiate the activity. For instance, Barb Blue in the present example may have a strong preference to talk to any of 5 family members whenever she is travelling from one location to another on a trop anticipated to take at least 30 minutes and while she is listening to music. Here, Barb may specify a preference that a system processor automatically generate and transmit a notification (e.g., e-mail, V-mail, etc.) to one or more of the five preferred family members indicating that she is available to talk whenever traveling on an anticipated 30 or more minute trip while listening to music. Then, whenever the combination of specified factors occurs, notifications may be sent to family members while Barb is travelling so that they know that her preferred time to communicate is occurring. As another instance, collocation notifications may be generated and sent to three of Barb's closest colleagues automatically whenever she is in the same facility they are in and when other circumstances occur, leaving it up to those colleagues to determine if ion person contact should be initiated. In this way, without every bothering Barb, various desirable communications may be initiated under circumstances that Barb considered optimal.

### Operational Examples

The systems described above can support system users and user groups in many different ways to optimize, augment and enhance as well as help system users to optimize, augment and enhance many different types of activities and user experiences throughout a day, week and even longer periods of time. One way to understand the value of the exemplary optimization system is to consider how an exemplary system can guide, augment and enhance experiences over time. To this end, hereafter we describe an exemplary day in the life of an individual system user. While many different services and augmentations are described in this specification, the services and augmentations described hereafter are not exhaustive and many others may be facilitated by the optimization system. It should also be appreciated that in many cases we describe various options for how different services and augmentations may be provided and that, unless indicated otherwise, all combinations of different services, augmentations and aspects of the different services are contemplated.

b. Day in the Life of a System User

This example will explore services, augmentations and enhancements associated with the first system user, Barb Blue, described above, over a 26 hour period starting at 8 PM on a Tuesday evening and running through 10 PM on Wednesday evening. At one or more times during the 26 hour period, Barb's services, augmentations and enhancements are at least somewhat influenced by information associated with other system users where the other user information operates as one or more system optimization factors considered in optimization algorithms. For instance, when a meeting is scheduled or rescheduled for Barb Blue and other system users, one factor in determining when to schedule or reschedule the meeting may include, at a minimum, when other meeting invitees are available to participate in the meeting. In more complex cases a system processor will take into account other invitee scheduling preferences, other invitee anticipated conditions, other invitee anticipated roles in the meeting, etc., when determining when to best schedule or reschedule a meeting. Thus, while this example is described from the perspective of first user Barb Blue, it has at least some implications related to optimization for all system users and for an organization (e.g., an employer, a family, a group of related people, etc.) of people as a whole.

In the present example it will be assumed that Barb has scheduled a 10-30 minute period every evening at around 8 PM for reflection on her day and on her future (e.g., the next day, the next week, etc.) schedule. During this reflection period, Barb is committed to reviewing a prior 24 hour period and perhaps other prior periods of time as well as aspects of her schedule the following day, week, etc. In at least some embodiments it is contemplated that the optimization system will include one or more types of retrospective tools for reviewing and understanding a user's prior experiences and for learning from those experiences to better use resources including the user's time in the future.

In many cases understanding prior experiences will include consideration of at least some detailed information and therefore, in many cases, the prospective tools will include information presentation via a display screen or the like which is a good way to comprehend detailed information. To present detailed information in a relatively easily digestible manner, in at least some embodiments the prospective tools will include graphical representations of the information. To aid in understanding prior experiences, the system may augment a view of a user's prior activities over some period of time to add additional information related to detected or recognized environmental conditions as well as user conditions so that a user can better understand cause and effect between their activities and environment and the user's conditions.

In at least some embodiments the optimization system may also include one or more types of prospective tools for considering and understanding various anticipated aspects of some future period in the user's life. For instance, in some cases the system will augment a view of a user's prospective schedule to add additional information related to anticipated environmental conditions as well as anticipated user conditions based on scheduled activities and anticipated other information (e.g., a weather forecast, a traffic forecast, etc.).

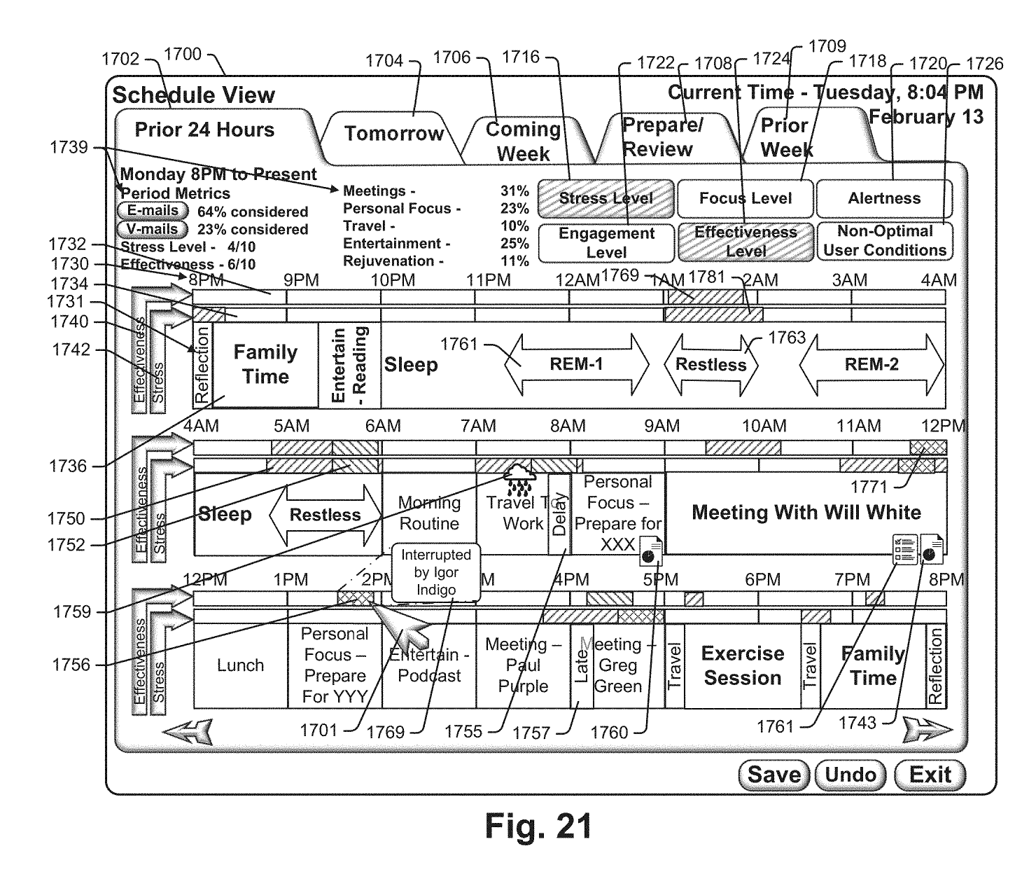

Referring now to FIG. 21, an exemplary screen shot 1700 of a scheduling application view that may be presented via any emissive surface type system interface is illustrated that includes a plurality of virtual file tabs 1702 through 1709 including a first retrospective view tabs 1702, two prospective view tabs 1704 and 1706, a prepare/review tab 1708 and a prior week retrospective view tab 1709. While not shown other view tabs are contemplated that correspond to other retrospective and prospective periods. The tabs can be selected via a user controlled virtual selection icon 1701 or in some other fashion (e.g., via touch). FIG. 21 shows the interface after the retrospective view tab 1702 has been selected and corresponds to a prior 24 hour period from a current time at which the tab is selected by Barb Blue. Thus, in the illustrated example where a current time is 8:04 PM on Tuesday, the prior 24 hour period includes a duration from 8:04 PM on Monday to the current time. The exemplary retrospective view includes a time line 1730 from 8 PM on Monday evening to the current time, 8 PM on Tuesday.

In the illustrated example, a retrospective activities information set is presented at 1731 below time line 1730. The activities information set indicates activity types and durations o time slots of each activity that Barb participated in during the prior 24 hour period that is represented by the time line. For instance, a reflection period is shown at 8 PM on Monday evening followed by a period of family time at 1736, a period of reading for entertainment, and so on. Here, it should be appreciated that in at least some embodiments the activities information set may be very different than the activities that were scheduled for the presented periods prior to those periods occurring as the activities information set reflects actual activities that occurred and not necessarily the prescheduled activities for different time slots. While not shown, it is contemplated that the prospective view may also show the scheduled activities for the time slots so that a user can see deviations therefrom as well as some gauge that indicates the extent to which the user's actual activities align with her prior scheduled activities for the presented period.

Referring still to FIG. 21, the exemplary activity information set 1731, in at least some cases, may also include “commentary” on the user's activities. For instance, one comment shown as an overlay over a “Travel To Work” activity includes the comment “Delay” 1755 indicating that the travel activity took longer than was initially anticipated for some reason. As another instance, a second comment shown as an overlay over a “Meeting Greg Green” activity includes the comment “Late” 1757 indicating that Barb arrived late for that activity. Other exemplary commentary instances include sub-period indicia labelled to characterize sub-periods of longer activity durations. For instance, in FIG. 21, actual REM sleep cycles and periods of restlessness are shown at 1761 and 1763, respectively, to characterize Barb's sleep activities based on sensed biometric and other data. Many other comments are contemplated where each comment is somehow spatially associated with a specific one of the presented activities.

Referring still to FIG. 21, the retrospective view also includes two exemplary user condition information sets 1732 and 1734 that extend along the timeline 1730 just above the activities information set. The first condition set 1732 indicates Barb's effectiveness condition as indicated by label 1740 and includes color coded effectiveness indicator bars aligned with different portions of the time line 1730 to indicate how effective Barb was during each of the time slots and an associated activity. Here, effectiveness will mean different things based on which activity the condition is associated with. For instance, in the case of a personal focus activity, effectiveness may be a measure of the level of focus achieved by a user and duration of that focus level as a percentage of the time slot duration dedicated to the activity while effectiveness in the context of sleep activity may be a measure of the number and duration of REM cycles as well as restlessness that a user experiences during a time slot dedicated to sleep.

In the example shown in FIG. 21, effectiveness indicator bars are either blank (e.g., shown as white), left up to right cross hatched indicating a green color, left down to right cross hatched indicating a yellow color or double cross hatched indicating a red color. In the example, it is assumed that a white bar indicates a high level of effectiveness in an associated activity, green indicates an average effectiveness, yellow indicates less than average effectiveness and red indicates a complete lack of effectiveness. Thus, for instance, while sleeping Barb's effectiveness between 1 and 2 AM was only average (see 1769) and at the end of a three hour meeting with Will White between about 11:40 and noon, Barb was completely ineffective (see bar 1771). Here, the effectiveness determination may be based on Barb's expressed perception at specific times during the retrospective time duration. For instance, at the end of Barb's Will White meeting a system processor may query Barb about her perceived level of effectiveness and she may indicate that she was ineffective during the last 20 minutes of the meeting. In the alternative, the effectiveness determination may be based on processors algorithms that automatically discern barb's effectiveness level based on sensed biometrics, camera images and microphone recordings as well as other detected information.

The second condition set 1734 indicates Barb's stress condition as indicated by label 1742 and also includes color coded effectiveness indicator bars aligned with different portions of the time line 1730 to indicate Barb's level of stress during each of the time slots and in relation to activities she participated in. In the example, it is assumed that a white stress bar indicates a normal level of stress, green indicates a first elevated level of stress, yellow indicates a second elevated level of stress greater than the first, and red indicates a high stress level. Thus, for instance, while sleeping Barb experiences first and second levels of stress starting at around 5 AM and 5:30 AM as indicated by labels 1750 and 1752, respectively.

In at least some cases it is contemplated that a user may be able to select one or more conditions like stress and effectiveness that are tracked by the system. To this end see that the screen shot in FIG. 21 includes several selectable user condition icons at 1716, 1718, 1720, 1722, 1724 and 1726. In the view shown, the stress and effectiveness icons 1716 and 1724 are shown highlighted to indicate that each of those conditions has been selected which is consistent with indicia at 1740 and 1742. Other exemplary conditions tracked by the system include focus level, alertness, engagement level and non-optimal user conditions. If Barb Blue selects one of the other condition icons, one of the information sets 1732 or 1734 may be replaced with condition bars associated with the selected condition or, in some cases, a third information set may be graphically added to the effectiveness and stress sets that are illustrated.

In some cases a processor may analyze all of the tracked user conditions and assess the most abnormal condition sets during the presented period and may automatically present condition information sets (e.g., 732, 734) for any condition where the abnormality is greater than some threshold level. Thus, for instance, if a user's alertness and engagement levels are abnormal to an extent greater than associated threshold levels while other user conditions are generally in a normal range, the system may automatically present alertness and engagement condition sets to the user when the user accesses the retrospective view as shown in FIG. 21.

Referring still to FIG. 21, while shown as clearly distinct bars in the interest of illustrating clear distinctions between conditions, the condition indications in sets 732 and 734 may be expressed in different ways that include more subtle levels of distinction in at least some embodiments. For instance, in the case of stress, user stress levels typically do not change in abrupt fashion and instead change more gradually over time. In this case, instead of presenting separate white, green, yellow and red bars to indicate stress level, in at least some cases it is contemplated that the stress condition representations will fade from one color or visually distinct representation to another to show gradual changes that better represent reality.

Referring still to FIG. 21, in at least some embodiments the system will enable a user to select any one of the condition bars or a location on one of the conditions sets to access information related to what was happening at a corresponding time that may be the cause of the condition. Here, at times when a user's condition is within a normal range (e.g., during a white bar stress period), there may be no additional information related to possible causes of the user's instantaneous condition. However, in cases where the user's condition is outside a normal range, in many cases a system processor analyzing sensed information in the context of how a specific user has typically responded to similar circumstances can determine a likely or highly plausible cause for the user's instantaneous condition which can be stored and subsequently accessed. In FIG. 21, selection icon 701 is shown hovering over low effectiveness bar 756 which causes a pop up window or field 1769 to open where a processor presents a likely reason for the user's instantaneous high level of ineffectiveness. In the present example, presented reason indicates that Barb Blue was likely ineffective during an associated portion of a personal focus period because a colleague interrupted her during that sub-period. In some cases the system will not be able to ascertain a likely cause of a user's abnormal condition. In some cases a “likely cause” indicator icon may be presented with each abnormal bar to indicate any time the system determines a likely cause of the abnormality to help a user discern which abnormal bars are associated with likely causes and which are not.

In at least some cases environmental indicators may also be presented on the retrospective view to indicate at least some aspect of the environment the user experienced at specific times. For instance, see the rain indicia shown at 1759 in FIG. 21 that corresponds to Barb's 7 AM commute to work. Here, the system may be programmed to recognize when a specific environmental condition has affected a user's activities and may only indicate that condition when it affects the user's activities or conditions so that the view does not become inundated with irrelevant environmental conditions. In addition, whenever something unexpected occurs that disrupts a user's activities (e.g., delays, late arrival, etc.) or whenever a user's condition (e.g., effectiveness, stress level, etc.) is abnormal, the system may automatically attempt to identify an environmental condition that may be related to the disruption or the abnormal condition and may present an indicator that is spatially associated on the view with the disruption as a likely cause or contributing factor.

Referring still to FIG. 21, when Barb reviews the retrospective view illustrated, Barb can see how her conditions temporally align with her activities as well as environmental conditions and should be able to gain insights into how her activities and environment affect her conditions at specific instances in time and over time. For instance, restlessness at 1763 correlates with less effective rest and an increase in Barb's stress as indicated at 1769 and 1781. As another instance, Barb's tardiness at 1757 correlates with her increased stress and reduced effectiveness as indicated.

FIG. 21 shows one retrospective view of Barb Blue's prior activities, conditions and other temporally related information. Other retrospective views are contemplated such as, for instance, a view that only indicates correlations between abnormal user conditions (e.g., high stress, reduced alertness, etc.) and environmental conditions and an activity or sequence of activities. As another instance, the system may be programmed to recognize incongruities between Barb's scheduled activities and actual activities as well as abnormal user conditions that where in some way affected by the user's scheduling or other choices (e.g., a choice to delay leaving for a meeting that results in tardiness, higher stress, minimal level of participation, etc.) and may only report deviations from scheduled activities and abnormal conditions and associated user choices for consideration.

Referring still to FIG. 21, the retrospective view also includes several exemplary period metrics 1739 that correspond to the 24 hour period illustrated. The exemplary period metrics 1739 include indicators related to the percent of e-mails received during the presented period that the user at least considered (e.g., viewed, listened to in the case of an audio e-mail representation, etc.) as well as the percent of voice mails the user considered during the presented period. In the example, the e-mails and v-mails information includes user selectable icons which enable the user to access those communications in order to get caught up on considering those during the user's end of day reflection period if desired.

The exemplary period metrics also include indications of overall user conditions during the period including, in the illustrated case, overall scores for user effectiveness and stress level over the presented 24 hour period. Again, other user conditions are contemplated. The metrics further include percentages of the total presented period that are spent participating in activities of several different general types. For instance, the metrics indicate percentage of time in meetings, in personal focus, traveling, participating in entertaining activities, rejuvenating, etc. In other cases the activity participation metric may indicate hours and minutes in each of the activities, a ratio indicating activity times to goals, or some other calculated goal related metric. For instance where a user's goal is to spend at least 15% of her day rejuvenating and she only spends 11% as indicated in FIG. 21, a goal related metric may indicate that the user fell short of her goal by 27% (e.g., 100*(1−11/15)). Goal oriented indications may be color coded like green indicating that a goal is met and red indicating that the goal has not been achieved. Many other period metrics are contemplated.

Retrospective view 1700 further includes two exemplary content indicators 1760 and 1743 indicating content generated during associated activities. For instance, in the case of indicator 1743 that is spatially associated with the Will White meeting, the related content may include meeting noted, one or more documents prepared during the meeting, audio or video recordings generated during the meeting, a meeting agenda, etc. Here, it is contemplated that each content icon 1760, 1743 may be selected to access the content associated therewith for review, editing, storage, or to forward to someone else.

View 1700 further includes one exemplary to-do list indicator 1761 indicating that a to-do list was generated during an associated activity. For instance, in the case of indicator 1761 that is spatially associated with the Will White meeting, a related to-do list may include four items that meeting attendees agreed need to be completed. Again, it is contemplated that icon 1761 may be selected to access the to-do list for review. Ideally, Barb opens up the to-do list during evening reflection and makes some plan to address activities on that list (e.g., complete the activities, assign the activities to someone else, schedule time slots to complete each activity, float the activities on a floating list to be scheduled, cancel the activities or simply add the activities to an aspirational to-do list to be used as fill-in tasks). When a to-do list activity associated with one of the list indicators 1761 is dealt with in some fashion, that activity can be removed from the list and once all activities have been removed from the list, the icon 1761 may be eliminated.

In some cases whenever an activity is added to a to-do associated with a content icon 1743, that activity may also be automatically added to a user's overall larger to-do list or aspirational to-do list. Here, a system user accessing the larger to-do list would have a higher level view of all activities to perform that are not yet scheduled or otherwise disposed of. In this case the larger to-do list may include dozens of activities related to several prior activities that need to be completed and, in at least some cases, it is contemplated that the system may allow a user to select any one of the larger list activities to access a 24 hour period screen shot as shown in FIG. 21 associated with the selected activity to provide context for the user regarding the selected activity.

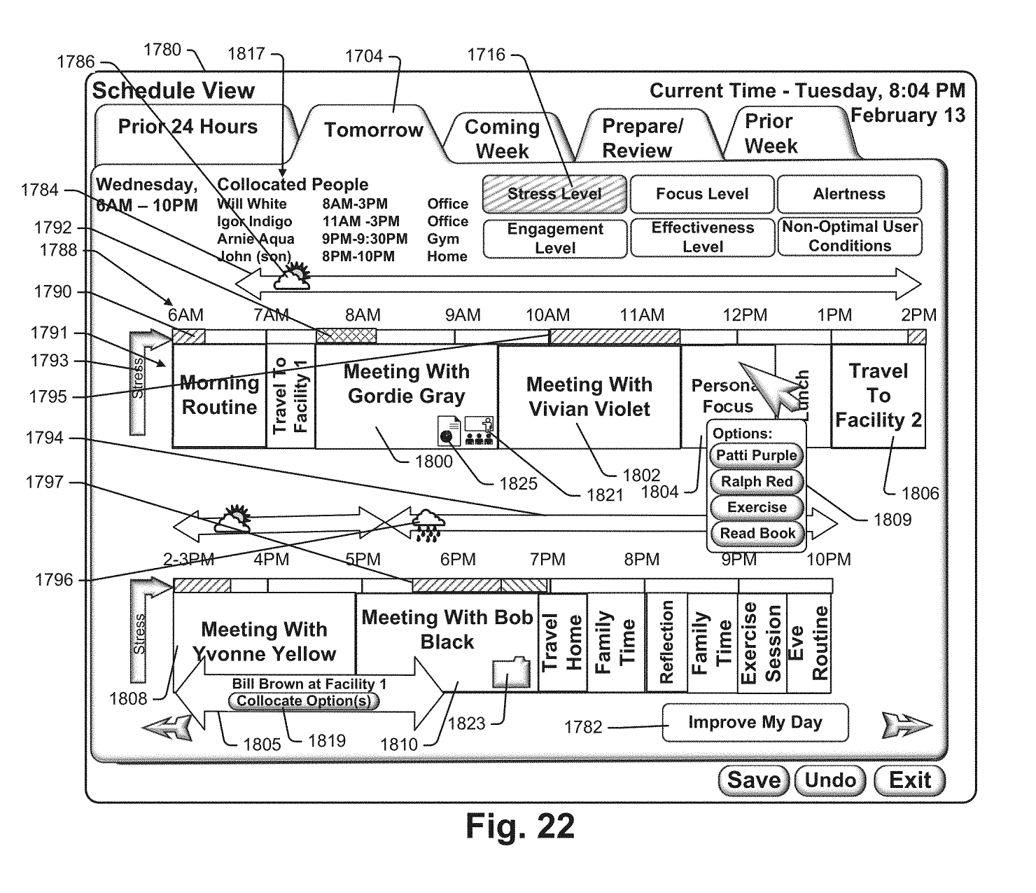

Referring still to FIG. 21, when the prospective “Tomorrow” tab 1704 is selected to access a prospective view corresponding to Barb Blue's next day, the view shown in FIG. 22 may be presented. In FIG. 22, the day period shown extends from 6 AM the following morning to 10 PM and corresponds to the scheduled duration that the user is supposed to be awake the following day or at least to the period during which the user is not scheduled to be asleep or at least attempting to sleep. The view in FIG. 22 is similar to the FIG. 21 retrospective view including an anticipated activity information set at 1791 and a stress condition information set 1793 and anticipated environmental conditions including a condition indicator (see 1786 and 1796) as well as period durations (see 1784 and 1794) for each of the environmental condition indicators. Here, the activity information provides a complete script for the illustrated period aligned with a time line 1788. The stress condition information set 1790 includes condition indicating bars similar to the condition indicating bars described above with respect to FIG. 21 where the bars are aligned with the time line and anticipated activities.

In FIG. 22, because the slotted activities are prospective, the activities have yet to occur and therefore the stress conditions and environment conditions are only anticipated. While the activities are scheduled, the stress and other user conditions are surmised from the user's schedule and the factors and correlated user conditions (see last element in the Diagnosis dataset 560 in FIG. 5) for the first user that develop over time as describe above. For instance, it may be that the first user's stress level is almost always abnormally high when the user has a meeting first thing in the morning after traveling from her home to her office and therefore one of the correlated factor and condition sets may result in the system anticipating that the user will experience abnormally high stress during at least the beginning of her first meeting with Gordie Gray at 8 AM as indicated by the red (e.g., double cross hatched) bar at 1792.

As another instance, Barb's stress level may routinely increase above normal whenever she has more than 2 and one half hours of back to back meetings. In this case, another of the correlated factor and condition sets may result in the system anticipating that the user will experience abnormal stress starting around two and one half hours into consecutive meeting time slots as indicated by the green stress bars that start at points 1795 and 1797, respectively. Many other factor and condition sets are contemplated for ascertaining different user conditions from scheduled activities and other anticipated circumstances such as, for instance the anticipated weather, a user's habits and tendencies (e.g., is a user routinely late for meetings, does a user settle into meetings quickly or need additional time to start engaging, does the user get caught in impromptu discussions while at her work station or while traveling through a work facility, does the user's stress level decrease rapidly under certain circumstances, etc.). As in the case of the FIG. 21 view, the FIG. 22 view gives a user the option to select any of several different user conditions to access information sets in the form of color coded bars that indicate instantaneous user conditions. Again, in at least some embodiments the user can select two or more of the condition option icons to stack up two or more condition information sets to see how anticipated activities and other anticipated factors (e.g., habits, tendencies, etc.) will affect user conditions. Again, in at least some cases a system processor may ascertain which tracked user conditions are anticipated to be most abnormal or more abnormal than an associated threshold level and may automatically present only the most abnormal condition sets or the sets that meet the threshold requirements for the user to consider.

In at least some embodiments it is contemplated that the system will include additional prospective information about anticipated factors that a user may want to consider when considering how to use her time during future time slots. For instance, in at least some cases where a user has personal relationships with other people, the user may at least contemplate locations and/or availability of those other people when considering future activities. For example, where Barb always likes to be at her employer's work facility whenever a specific first executive is in the facility, the system may automatically indicate via a schedule view akin to the FIG. 22 view any time the first executive will be in the facility. As another example, Barb may make decisions on whether to run errands or go directly home after work at least in part based on when family members are anticipated to be home in the evening. In these cases, it is contemplated that Barb may specify a list of other system users that Barb wants to track at different times to know when they are scheduled to be located at specific locations within specific time periods or when the user will or could be collocated with those people and the system may automatically present other user location information to Barb that is consistent with the specified list. To this end, see the collocated information presented at 1817 in FIG. 22 indicating anticipated collocation periods for two work colleagues, one friend from the gym and Barb Blue's son.

In FIG. 22, the collocation information is based on Barb's current schedule as well as current schedules for the other people identified in the collocation information. In other cases, the system may indicate other user's scheduled and anticipated locations that are different than Barb's scheduled locations so that Barb can contemplate readjusting her scheduled locations if desired to increase the likelihood that Barb will be collocated with other users if desired. For instance, again, in a case where Barb likes to be in the general area of her manager or boss and that opportunity only rarely occurs, even if Barb is scheduled to be somewhere else or is contemplating being somewhere else when her boss is in a nearby facility, Barb may choose to rejigger her schedule to be present and collocated with her boss. To this end, see indicator 1805 in FIG. 22 that indicates that Bill Brown will be at facility 1 while Barb is at facility 2. Here, Barb has the option to rejigger her schedule if possible to be present and working at the first facility while Bill Brown is located there. In the illustrated view, a “Collocate Option(s)” icon 1819 is presented with the indicator 1805 which is selectable to have the processor present options for rescheduling Barb's schedule in an optimal fashion that results in collocation of Barb and Bill in the first facility.

While FIG. 22 is described as being presented to Barb Blue during an intentional reflection period after Barb selects a prospective schedule view option, in at least some cases it is contemplated that when a possibility of collocation or some other preferred set of circumstances exists, a system processor may automatically generate and transmit a notification to Barb to indicate the possibility. Here, the notification may include a hyperlink icon or the like enabling Barb to access a prospective view like the FIG. 22 view where Barb can then select the collocate option(s) icon 1819 to access possible rescheduling options. Thus, instead of having to consider rescheduling the evening prior to some possible preferred set of circumstances, Barb can be presented rescheduling options immediately upon the possibility being created (e.g., immediately upon Bill Brown scheduling to be located in the first facility location).

In the case of suggesting collocation when it is not actually scheduled, the system processor will track user locations and will be programmed with distances between locations. For instance, where first and second facilities are only 10 miles away or are within a 10 minute walk of each other on an employer's campus, the system processor may identify possible collocation when two people are scheduled to be at the two facilities but when the facilities are 200 miles apart, possible collocation would not be recognized in most cases.

In some cases the system will provide tools for Barb to consider other options for specific prospectively scheduled activities. For example, where Barb has specified several different aspirational meetings or a to-do list of activities the user wants to complete, the system may offer a list of other activity options that are possible for any scheduled activity. For instance, see in FIG. 22 that when a user selects the personal focus activity 1804, the system opens a pull down menu 1809 that includes a list of other options that may be swapped in for the personal focus activity. Here, it is contemplate that the list will only include possible and optimized options in at least some cases. For instance, meetings with Patti Purple and Ralph Red may only be suggested as activity options if each of those people will be at least generally collocated with Barb during the activity 1804 time slot and if each are available on their schedules. As another instance, if it is anticipated that Barb will be substantially exhausted during the time slot for activity 1804, the system may not present an exercise option. The options in FIG. 22 are presented as selectable icons which, when selected, cause the selected activity to be scheduled or at least tentatively scheduled if other people have to accept the activity (e.g., Patti Purple may have to accept a meeting invite for the activity swap to occur).

When a system processor has access to all of Barb's optimization factors, factor-condition correspondences and user schedules, in at least some embodiments it is contemplated that the processor may continually run different scenarios to identify ways to optimize user conditions without appreciably adversely affecting when things get done. For instance, referring again to FIG. 22, assume that Barb's meeting with Gordie Gray is more important than the meeting with Vivian Violet. In this case, if the relative importance of the two meetings is captured in the user's database (e.g., Gordie Gray is identified as more important than Vivian Violet because of working relationship with Barb Blue) and if each of Gordie Gray and Vivian Violet's schedules permit rescheduling on Wednesday morning, the processor may identify that meetings 1800 and 1802 could be swapped so that Barb's anticipated stress from traveling to the first work facility (see bar 1792) occurs at the beginning of Vivian Violet's meeting instead of at the beginning of the Gordie Gray meeting. As another instance, because Barb's stress level routinely rises two and one half hours into back to back meetings, the system may automatically identify instances where Barb is scheduled to participate in more than 2 and one half hours of consecutive meetings and may identify other options for related activities that eliminate long consecutive meeting durations.

Referring still to FIG. 22, prospective view 1780 also includes a user selectable “Improve My Day” icon 1782 near the bottom of the view. When icon 1782 is selected, where at least one scheduling change exists that could minimize undesirable user conditions, the system may present the scheduling change for consideration by Barb. In some cases where two or more advantageous scheduling changes are possible, the system may identify each of the advantageous scheduling changes or may identify a small subset of changes that are most optimal (e.g., 3 top changes out of 20 possible).

As in the case of FIG. 21, in at least some cases it is contemplated that Barb will be able to select any one of the condition indicating bars to identify likely causes of her anticipated conditions. For instance, hovering over high stress bar 1792 would open up a window or field akin to field 1769 in FIG. 21 which would indicate that Barb's stress is anticipated to be high because of the travel activity that precedes the Gordie Gray meeting.

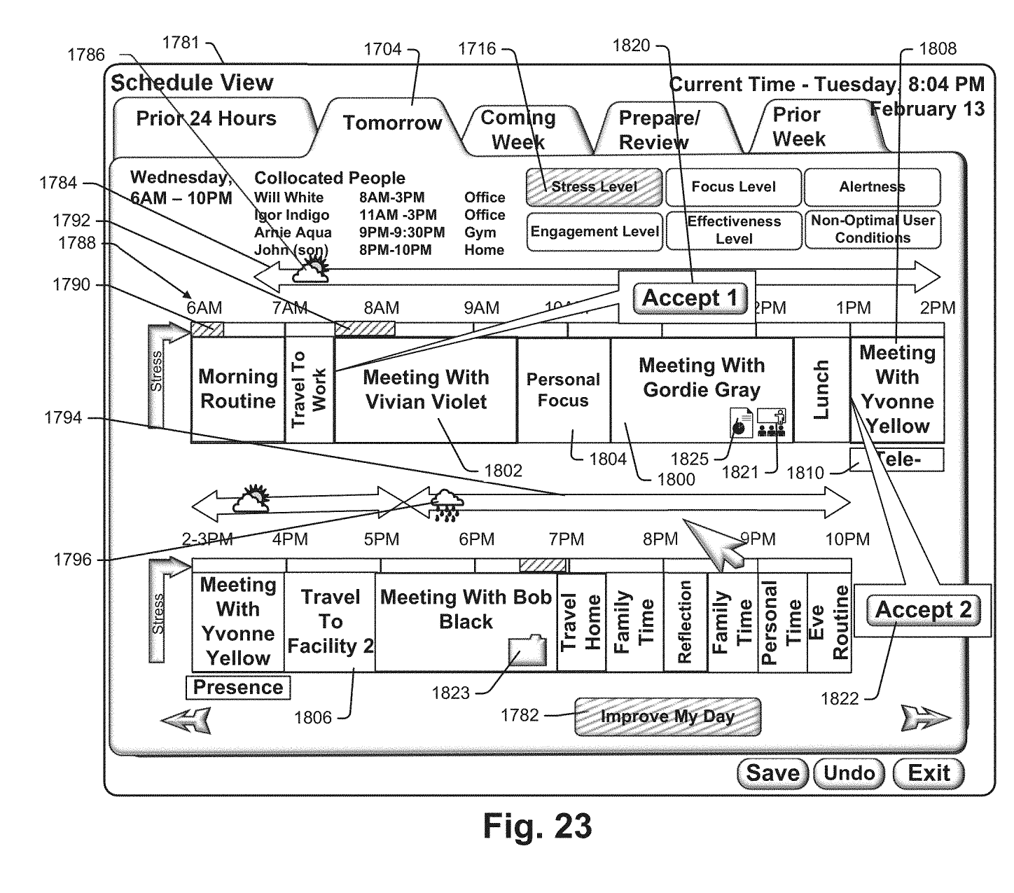

Referring again to FIG. 22, when the user selects icon 1782, a system processor may present the prospective view 1781 shown in FIG. 23. In FIG. 23, as shown, the Gordie Gray meeting 1800 has been removed from its original time slot between 8 AM and 9:30 AM back to a time slot just before lunch while the Vivian Violet meeting 1802 and the personal focus period 1804 that was supposed to occur just before lunch have been slid forward to fill the original Gordie Gray slot. By moving the Vivian Violet meeting forward along with the personal focus period, the Gray meeting is moved back to a time slot when the stress associated with traveling to work should no longer be a factor. In addition, these schedule changes would mean that Barb has a personal focus period between consecutive morning meetings which should reduce or eliminate Barb's abnormal stress related to more than two and one half hours of consecution meetings. Moreover, the personal focus period just prior to the Gordie Gray meeting should give Barb more time to make sure she is prepared for that meeting and the lunch period after the Gordie Gray meeting should allow Barb to extend that meeting if optimal into the lunch period without adversely affecting other user's schedules.

Similarly, comparing FIGS. 22 and 23, the suggested modified schedule in FIG. 23 shows that the system is suggesting that the scheduled travel to a second facility 1806 be postponed until after Barb's first afternoon meeting 1808 to split up a three hour period of consecutive afternoon meetings and therefore to avoid additional user stress. In addition, the system indicates at 1810 that a telepresence system is available for at least the first meeting with Yvonne Yellow. These two simple changes can, based on a comparison of the stress information set represented by the time line bars, reduce Barb's stress appreciably.

In FIG. 23, acceptance icons 1820 and 1822 are presented spatially or otherwise associated with each presented schedule change, which can be selected to implement any desired schedule change. Thus, Barb may opt to select icon 1820 to accept the schedule change that is associated therewith and may select icon 1822 to accept the schedule change that is associated therewith.

In some cases it may make sense to suggest changes that move activities from one day to a different day and, in that case, the proscriptive view may present schedule and related information for two or more days. In some cases where there are two or more possible optimizing changes, the system may present one change at a time where any activity that is moved from one time slot to another is indicated on the view so that the user can consider each suggested change separately.

In cases where a schedule change will affect other user schedules, conditions, etc., the system may automatically query all users affected by a suggested change for confirmation prior to implementing the schedule change. In some cases where other users would be affected by a schedule change, the system may seek acquiescence from one or more of the other users prior to suggesting the change to Barb. In some cases prior acquiescence may only be sought from users that have specific relatively important activity roles like, for instance, a meeting presenter, an exercise coach, etc. and not from other users with other roles like someone attending a meeting simply for informational purposes.

In at least some cases activity qualifying icons may be spatially associated with associated activities on the prospective view that allow a user to quickly assess the user's role in the activity and to access any preparation materials or other information that is associated with the activity. For instance, in FIG. 22, a “presenter” icon 1821 is shown within the Gordie Gray meeting slot 1800 to indicate that the user has a presenting role in the Gordie Gray meeting. As another instance, one “content file” icon 1823 is shown within the Bob Black meeting slots 1810, indicating that meeting content for the associated meeting has been posted and stored in a content database which is currently accessible by the user to prepare for the upcoming meeting. Here, the meeting content may include any type of media posted by any meeting invitee including Barb or other invitees. For instance, content may include a document, a video, an audio file, a software application, etc. As one other instance, a “presentation file” icon 1825 is shown within the Gordie Gray meeting slot 1800, indicating that a presentation that Barb intends to present at the associated meeting is posted. Here, the presentation may be in a final form or a draft form or the icon 1825 may simply be associated with a placeholder indicating that Barb intends to prepare and associate presentation content with the meeting. Where icon 1825 is a placeholder or is associated with a presentation that is not in final form, the icon 1825 may be clearly visually distinguished so that Barb Blue recognizes that more work has to be done to prepare the presentation.

Many other types of activity qualification icons are contemplated including, for instance, an exercise icon corresponding to an exercise routine associated with a scheduled exercise activity, ticket icons associated with a play, concert or other social activity, a meeting status icon corresponding to a list of invitees and attendees that have accepted a meeting invitation, invitees that have rejected the invitation and invitees that have not responded, etc.

In the case of qualifying icons associated with activity content, in at least some cases Barb will be able to select that icon to automatically access the content associated therewith. For instance, again, in FIG. 22, if a user selects presentation file icon 1825, a document or other record (e.g., video, audio, other media type) associated with that icon and meeting may be opened for viewing. In other cases where several documents or records are associated with a meeting or other activity, upon icon selection, a list of hyperlinks to each of the associated records may be presented where, selection of a link presents the associated content to Barb.

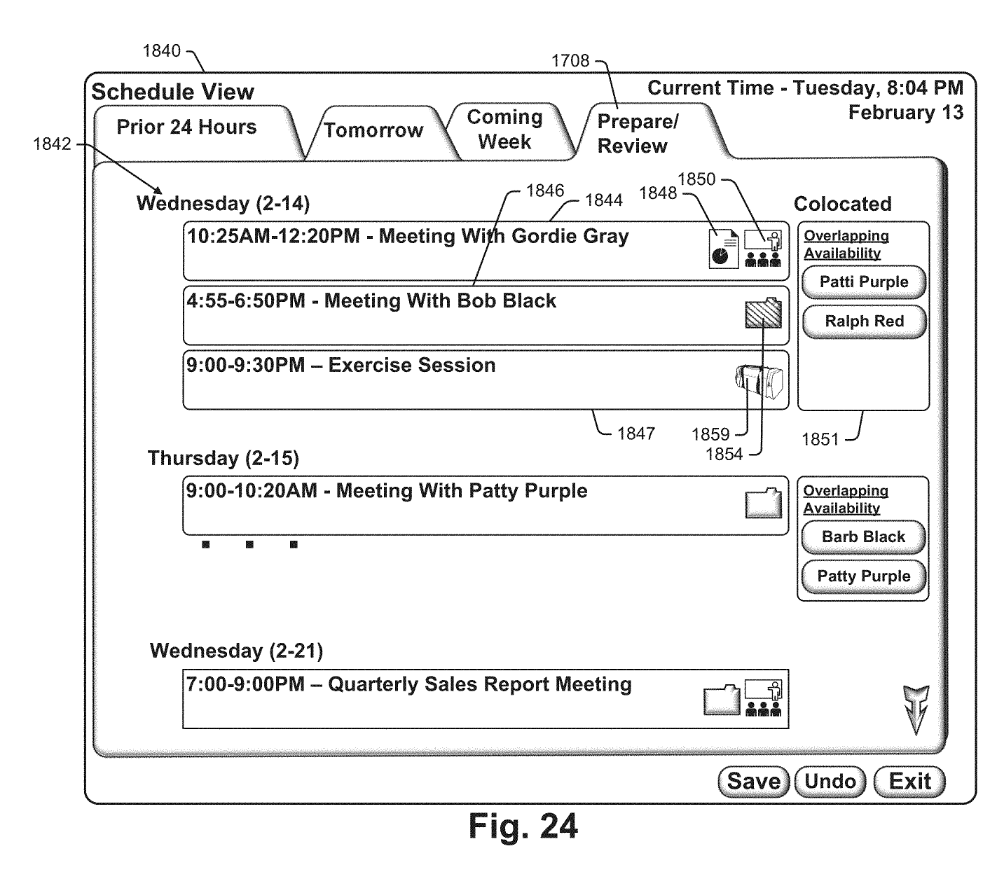

Referring now to FIG. 24, another screen shot 1840 that is presented when prepare/review tab 1708 is selected where the view includes a chronological list 1842 of upcoming activities for Barb where each listed activity has at least some content associated therewith that the user can either review to prepare for an associated activity or that the user needs to prepare for the activity is shown. For instance, consistent with the FIG. 23 view, the Wednesday entry includes fields 1844 and 1846 corresponding to the Gordie Gray and Bob Black meeting time slots where a presentation icon 1848 and a presenter icon 1850 are associated with the Gordie Gray meeting and a content file icon 1854 is associated with the Bob Black meeting. The presentation and content icons can be selected to access associated content and information. Other screen shot 1840 entries correspond to other future days so that Barb can quickly ascertain which activities have content and preparation requirements associated therewith.

Referring still to FIG. 24, in addition to including meeting entries that indicate information to be reviewed and/or prepared, other preparation entries may include other things that a user should prepare or activities to participate in order to get ready for her next day or next few days. To this end, field 1847 corresponds to Barb's exercise session scheduled for 9 PM the following day and is qualified by a duffle bag icon 1859 which is presented as a reminder to Barb to prepare and pack a bag with exercise equipment (e.g., exercise clothing, shoes, a wireless earphone set, a water bottle, etc.) prior to turning in for the evening. The idea here is that the preparation and review interface can motivate or encourage a user to do things prior to turning in that will make the following day and specifically the next morning easier on the user. In addition to reminding Barb to prepare an exercise bag, the system may automatically encourage Barb to prepare other items and affordances to support her next day activities such as, for instance, a coffee machine (e.g., fill water, coffee, etc.), a lunch, a briefcase with things that will be needed for other scheduled next day activities, a purse, luggage and specific types of clothing if the user is traveling the next day, etc. Many of these activities are less burdensome to complete at night than in the morning and therefore encouraging these activities at night can lead to better sleep and faster and more efficient morning routines. Prospective collocation indications are presented at 1851.

Continuing with the day in the life of Barb Blue example, throughout the 28 hour period, the optimization system applies optimization algorithms to all optimization factors that are available to generate one, all, or a subset of the FIG. 4 information types and control outputs that are synchronized in a manner that optimizes Barb's use of time and other resources. To this end, after Barb has reviewed a next day schedule and any other information the user wants to access related thereto or to other upcoming activities as part of a reflection and preparation process at 8 PM on Tuesday evening, the user may participate in or perform other scheduled or non-scheduled activities while a system processor collects data from system sensors and applies algorithms to the sensed data and the other stored first user data to identify system outputs (e.g., output information and control outputs as in FIG. 4) to support the user's activities.

As an example, assume that Barb has identified ten different favorite personal media feeds including first and second on demand streaming series, first and second news feed services, two streaming podcast programs, two digital magazines, one music service and one digital book. Also assume that Barb and her family members have specified a list of favorite family activities including exercising, playing cards, watching specific types of movies, talking about current events, etc. In addition, assume that the last time the family watched a movie together they only watched the first half of movie XYZ and that the last time Barb had a personal time period, Barb only listened to the first half of a podcast ABC. Further assume that after her Tuesday evening 8 PM reflection period, Barb's schedule includes 40 minutes of family time ending at 9 PM followed by a next personal time period and sleep.

In the above example, a few minutes (e.g., 20 minutes) prior to the 40 minute family time period, a system processor using sensed biometric data may recognize that Barb is physically exhausted. The processor may also recognize that when Barb is physically exhausted, of the list of favorite family activities, Barb prefers to watch a movie as opposed to exercise or card playing. In this case, the system may automatically offer the second half of movie XYZ to Barb and other proximate family members (e.g., members that are at or near home) for viewing during the family time period.

In the above example, if at least one of the family members accepts the offer, just prior to the start time associated with the 40 minute family period on Tuesday evening, the system may automatically manage environment controls to optimize conditions in a family media room for experiencing the movie and may queue up the second half of the movie. For instance, just prior to the family period start time, the processor may control window shades, lighting and other affordances to optimize the media room environment for movie viewing. In other cases, the system may only adjust environment affordances once one or at least two family members arrive within the media room or after at least one of the members sits down on a lounge chair within the space. If Barb is in the media room and at least one other family member that accepted the invitation is not, the system may automatically present tracking information to Barb indicating the whereabouts of the other member and an estimated time of arrival within the media room. In addition, the system may automatically send an audible or visual message to a tardy family member indicating that Barb is present and waiting to start the movie. In other cases the system may automatically start the movie and adjust media room affordances at the beginning of the family time period if at least one user is present in the media room at that time or just after at least one user occupies the media room after the start time.

In the above example, as an alternative, because Barb is physically exhausted after her reflection period on Tuesday evening, the system may provide other possibly more optimal options for Barb's evening time. For instance, based Barb's current exhausted condition, the processor may automatically recognize that Barb should have additional sleep and therefore may identify an alternative evening schedule where either the family time period or the personal time period is eliminated so that Barb can get to sleep earlier than scheduled.

In the alternative the system may identify an alternative evening schedule where one or both of the scheduled family time and personal time periods are shortened. Here, other scheduling options may be automatically presented as suggestions to Barb via any of the output interface devices. For instance, the system may generate the following audible suggestion for Barb. “You appear to be exhausted and a bit more sleep might be useful. Would you like some schedule change suggestions that would enable you to get more sleep tonight?” Here, the system may monitor audible responses from Barb and if Barb answers “yes” or otherwise affirmatively, the system may suggest “If you skip the family period tonight you can get to bed 40 minutes earlier. Would you like to skip the family period tonight?” If Barb rejects the suggestion (e.g., verbally answers “No”), the processor may verbally present another rescheduling option. Here, if Barb accepts one of the suggested rescheduling options, the processor would automatically adjust Barb's schedule for the rest of the evening. Again, in at least some embodiments when Barb accepts the schedule change, the act of accepting will be stored in Barb's database and may be used to modify one or more of the optimization factors or algorithms to customize system operation more precisely for Barb in the future.

In the above example, if Barb is at her home just prior to the Tuesday night family time period and no other family member is near her home, a system processor would recognize that fact and, in preparation for the family time period, may be programmed to operate in different ways. For instance, because no other family members are proximate Barb as the family time period start time draws near, the processor may recognize that in person family time will not occur at the scheduled time and may, therefore, automatically swap Barb's family time and personal time at the end of the night so that the personal time period occurs first and the family time period is moved back to the time slot just prior to sleep. Here, in at least some cases when the family and personal time periods are swapped, a notification may be presented to Barb and any other family member that is affected by the swapping action.

In an alternative embodiment, when no other family member is near Barb as the family time slot draws near, the processor may simply cancel the family time period and fill in some other activity like a longer personal time period, a phone call with a colleague that is on a to-do list if the call is also at least somewhat optimal for the colleague, etc. Again, here, several factors would be taken into consideration when identifying a fill in activity to automatically schedule or suggest.

In yet another alternative embodiment, when no other family member is near Barb as the family time draws near, the processor may recognize an opportunity for family activity including a telepresence call between Barb and a second family member that is travelling and located at some location remote from Barb. In this case, based on the second member's schedule, current activities, conditions, preferences, location, etc. as well as Barb's information, the system may automatically offer a telepresence call to one or both Barb and the second member. If the call is accepted, the system may, again, automatically control home affordances as well as remote environment affordances at the second member's location to enhance the user experiences.

In the above example, if Barb is not physically exhausted at the end to the reflection period, the system may automatically suggest that Barb and other proximate family members participate in an exercise session or play cards or participate in some other favorite activity that requires relatively more energy than watching a movie during the family period. If no family members are available or proximate Barb, the system may identify other activities scheduled for future time slots that can be swapped into the family time period. For instance, if Barb has an exercise session scheduled for the following day, the processor may suggest that the user exercise during the family time period so that the session the following day can be eliminated.

At or near the end of the family time period, the processor again performs a triage process related to the personal time period to identify a specific personal activity to automatically start or to suggest for Barb's following personal time period. Again, consistent with the above assumptions, the processor may identify one or a small subset of Barb's favorite personal activities to suggest or automatically commence where the one or subset are based on the optimization algorithms as applied to instantaneous optimization factors. For instance, if Barb is again instantaneously exhausted as the personal time period approaches and the user's expressed preference is to watch a streaming video program series as opposed to reading or listening to a podcast or the like, the processor may automatically suggest one of the first and second on demand streaming series to fill Barb's personal time period. Another option for an exhausted user near the end of her day, again, may be to skip the personal period and simply get to bed earlier.

Still one other scheduling option for a personal time slot near the end of Barb's day may be to identify another scheduled future activity that could be moved into the personal time slot to free up a future slot when possible. For instance, referring again to FIG. 23, in the present example Barb has an exercise session scheduled for that last time slot prior to her evening routine to get ready for bed on the next day. Here, the system may present the scheduled Wednesday exercise session as a Tuesday evening personal time period option which, if selected, would free up the last Wednesday time slot for other activities (e.g., a longer family time or some other optimized personal activity).

Once Barb's evening routine time slot starts on Tuesday evening, the system automatically starts supporting Barb to complete routine tasks. For instance, a system processor may automatically start to play relaxing music for Barb as a reminder or indicator that it is time to prepare to sleep. In addition, if the user prefers a shower prior to sleeping, the system may automatically start a shower as a user moves toward her bedroom, adjust restroom temperature, water temperature and other bathing parameters automatically. Once the user turns off the shower, the system may automatically adjust bedroom affordances to control conditions to meet a user's pre-specified preferences (e.g., cool, warm, silent, white noisy, dark, dimly lit, etc.) so that when the user enters the bedroom space. At first when the user arrives in the bedroom, the conditions may be optimized to help the user get into bed and continue a wind down process where the relaxing music and enough light to navigate in the space are continued and both the light and music may be phased out either when the user gets into bed or shortly thereafter.

Regarding sleep, in many cases people have a misperception of their preferred conditions. For instance, many people like to get into a warm bed and therefore believe that they like to sleep in warm environments. In reality, while many people do like to get into a warm bed, those same people heat up over time while sleeping and their actual sleep is negatively affected at times as they wake up or stir to remove a layer of covers to regulate their sleep temperature. Once covers are removed and a person cools off, they often replace a layer of covers once they feel cool. This process is often repeated several times throughout a night which interrupts sleep and even during sleep, the sleep is restless and not as effective at rejuvenating the person.

In at least some embodiments it is contemplated that at least a subset of system sensor devices will be provided to monitor user sleep activities, sleep events and conditions so that the system can detect a user's real dynamic sleeping conditions, compare those to environmental conditions and, in at least some cases, either automatically adjust the environmental conditions to control the user's conditions to optimize for sleep or make preference change suggestions to the user when awake so that the user authorizes new preferences that are sleep optimized for subsequent sleep cycles. In this regard, for instance, where a user likes a warm bed at first and then suffers a series of hot and cold body temperature fluctuations that negatively affect the user's rest, a system processor may automatically track a user's temperature while sleeping and, when the user's temperature rises, the system may control an HVAC bedroom system (or some other type of heating system) to cool the sleeping space. Similarly, if the user's temperature cools, the HVAC system may be controlled to automatically warm the user's sleeping space. In this way the user's temperature fluctuations may be avoided so that overall effectiveness of the user's sleep can be increased appreciably.

In at least some cases sleep effectiveness and quality determinations may be based solely on detected conditions while a user is sleeping. For instance, sleep effectiveness may be based on a combination of factors like duration of overall sleep period, number of REM cycles of sleep detected, duration of each REM sleep cycle, user temperature, user movement types and frequency as well as many other detected user conditions and sleep parameters.

In other cases sleep effectiveness may be based at least in part on user conditions during one or more periods subsequent to sleep periods. For instance, because the system includes sensors that can detect user conditions and behaviors after the user wakes up and starts to move around, the system can use user condition data immediately after the user wakes to determine user conditions, many of which can be used as a proxy for sleep quality and effectiveness. Here, for instance, in a typical case, if a user slept 8 hours and wakes un-alert and lethargic, the user's conditions may be a strong indication that the prior evenings sleep was ineffective and low quality. In that case, a processor may examine the user's sleep conditions and simultaneous environmental conditions to identify correlations and how environmental changes can affect user conditions and sleep quality. In at least some embodiments it is contemplated that the system will learn how best to support a specific user over time by adjusting environmental conditions, assessing effects on sleep quality and effectiveness, and readjusting until optimal user customized conditions are identified.

In at least some cases the algorithms will also take into account other factors that may affect a user's sleep quality like, for instance, user conditions prior to sleep activities and user commitments subsequent to sleep activities. For instance, where a user experiences an extremely long period of stress prior to a sleep period, it may be foreseeable that the user will not sleep well. As another instance, if a user is the presenter at three important meetings the day after a nighttime sleep period, it may be foreseeable that the user's sleep could likewise be restless. For this reason, as in the case of most optimization algorithms contemplated throughout this disclosure, the algorithms for assessing sleep activity will be hysteretic so that most environment condition control changes occur only after clear patterns of environment conditions-user conditions-sleep quality are established. Thus, for instance, it may be that conditions related to a specific sleep quality pattern have to occur at least 5 out of 6 consecutive times for a system processor to use the pattern to change sleep optimization algorithms.

In addition to monitoring sleep events, user conditions during sleep and sleep quality to change optimization algorithms and optimally control a user's sleep environment, in at least some embodiments a system processor also monitor those parameters to determine if next day activities should be manipulated in any way to optimize user time and use of other system resources and affordances. To this end, in a simple example, referring again to FIG. 23, assume that Barb Blue's Wednesday schedule is as indicated in the prospective view so that an initial target wake time is 6 AM. Assume that a system processor monitoring Barb's conditions while sleeping on Tuesday evening recognizes near the end of the sleep period that Barb's sleep quality has been agitated all night and that Barb is in the middle of her first REM sleep cycle. Also assume that all of Barb's scheduled activities prior to the Gordie Gray meeting at 10:30 AM are either relatively unimportant or can be rescheduled relatively easily in a different subsequent optimized time slot. In this case, a system processor may automatically reshuffle Barb's morning activities prior to the 10:30 AM meeting so that Barb can sleep and, at a minimum, complete her instantaneous REM cycle without interruption. Where meetings and other activities are automatically reshuffled, notices are automatically sent to other system users affected by the rescheduling activities. In addition, resources affected by the rescheduling are also released for other use or scheduled for use accordingly.

In the present example, if the first REM cycle is completed relatively quickly and it is still probable (e.g., likely given Barb's known sleep patterns (e.g. average time between consecutive REM cycles, duration of REM cycles) and time left prior to a target wake time) for Barb to start and complete a second REM cycle prior to having to wake up to prepare for and travel to the Gordie Gray meeting (e.g., prior to a new target wake time), the system may select a later target wake time based on various factors (e.g., weather conditions, traffic conditions, etc.) that affords Barb sufficient time to travel to the Gordie Gray meeting so that Barb can obtain additional needed sleep. While Barb sleeps past the original target wake time and the system recognizes, based on Barb's detected conditions and the end time of the first REM cycle that it is highly unlikely that Barb will enter and complete a second REM cycle, the system may recalculate and identify an earlier target wake time to allow Barb to accomplish at least some other activity(s) prior to the Gordie Gray meeting. For instance, referring again to FIG. 23, if Vivian Violet is available for a telepresence meeting at 8:45 AM instead of the prior scheduled 8 AM meeting, the system may automatically schedule a telepresence call with Vivian for 8:45 AM if Barb is to be woken up prior to 8 AM.

In addition to considering Barb's sleep quality and quantity when determining a wake time for the user, the system processor may also use other factors like, for instance, current and anticipated weather conditions and traffic, to identify an optimal wake time. For instance, if an unexpected ice storm occurs overnight and it is anticipated that roads will be extremely icy, the processor may recognize that condition and that it will likely take Barb more time to get to work and may, therefore, automatically schedule an earlier target wake time. Here, the processor may be programmed to consider anticipated weather and traffic conditions in conjunction with Barb's sleep quality to determine when to wake Barb. For instance, in a case where Barb's sleep quality has been very good and Barb has had at least two restful REM cycles during a sleep period, the system may be more prone to waking Barb early based on traffic and weather concerns than if the user had poor quality and/or minimal sleep.

Another factor the system may consider when determining Barb's target wake time may be early morning conditions and circumstances related to other system users. For instance, referring again to FIG. 23 see that Barb's earliest meeting is with Vivian Violet. Where Vivian is a system user, a system processor may recognize that Vivian did not sleep well last night and therefore will be in poor condition for the 7:30 AM meeting. Here, instead of automatically changing Vivian's schedule to let her sleep, the processor may simply post Vivian's condition for other processors or optimization algorithms to consider and, if Barb is also not well rested near her scheduled target wake time, the combination of both Barb and Vivian not being rested, may cause the system to reschedule the meeting for both users to a different optimal time slot if one exists.

While Barb is sleeping, the system monitors for movement and, specifically, to determine if Barb gets up for some reason such as, to use the rest room. If Barb gets up, the system may automatically adjust lighting and other environmental parameters to provide at least some dim light to aid Barb in seeing her environment. If Barb travels toward her restroom, the system may automatically turn on a dim light in that space to light Barb's way. When Barb leaves the rest room and returns to bed, the system may automatically dim and then turn off the lights.

Whenever Barb wakes up during a sleep session, the system may monitor for any gesture or verbal trigger from Barb to activate a listening application to listen for commands from Barb. In some cases the fact that Barb woke may be used as the trigger signal for the system to listen for user commands. Here, for instance, when Barb wakes, Barb may be thinking about something that Barb has to remember to do the next day and may utter “To-do list—Add buy tickets”. A processor converts the verbal command to text, recognizes Barb's intention to add the task to her to-do list and then adds the task to the list. The system may automatically provide a simple audible confirmation that the task has been added to the list.

As Barb's target or modified wake time approaches, a system processor may control a set of environmental affordances to perform various functions including (1) waking Barb by the target wake time, (2) notifying Barb of any automated or suggested schedule changes as well as seeking authorization for rescheduling of activities in at least some cases based on other user's optimization algorithms, (3) supporting Barb as she works through her morning routine, (4) preparing Barb for any activities scheduled for her day and (5) entertaining Barb. Regarding the waking function, the processor may control any environmental condition or a combination thereof to wake Barb in a peaceful manner where that is the optimal way to wake her. For instance, the system may generate an audible signal in the form of a beep, a buzz, playing relaxing music, etc. Because the system monitors user conditions while sleeping, the system can determine when Barb wakes up and therefore, the audible signal may be modified based on whether or not the signal has caused Barb to wake. For instance, the signal may include a contemplative music loop that starts out at a relatively low volume which is increased over a 2 minute period until Barb wakes and then, after Barb is awake, the volume may be reduced again to maintain the woken state. Once the volume is reduced, the volume can again be ramped up slowly over a few minute period and the nature of the loop may be automatically changed to increase the energy level and transition Barb out of bed.

At the same time or separate from the audible signal, the system may automatically increase illumination intensity, change illumination color, etc., within Barb's sleeping space to help transition Barb to a woken state. A few minutes before Barb gets out of bed, the processor may control an HVAC system to warm Barb's bedroom to a comfortable temperature. Other waking signals may include haptic signals delivered via a worn device (e.g., a smart watch or bracelet) or via some other space affordance like, for instance a vibration device integrated into the Barb's bed.

Once Barb is sufficiently awake and while still in bed, a system processor may greet Barb via an audible and/or visual salutation and may present various types of information to Barb for consideration. For instance, where Barb's schedule has been automatically modified while Barb slept, the processor may generate an audible synthesized voice signal to notify Barb of the schedule change. For example, in the present case if the Vivian Violet meeting has been rescheduled to a later time slot, the processor may audibly indicate “You slept in, your meeting at 7:30 AM with Vivian Violet has been rescheduled for a time slot on Friday so your first meeting is with Gordie Gray at 10:30 AM. You will be on time for the meeting with Gordie if you choose to travel to Facility 1.” Other automatic activity schedule changes may be presented to Barb. This type of information may also be presented visually via one or more emissive surfaces in Barb's sleeping space (e.g., a pad, a fixed large panel display, a smart phone display, etc.).

In cases where rescheduling requires user authorization from Barb, the system may present options enabling Barb to accept or reject rescheduling suggestions. Hear, for instance, after a reschedule suggestion is presented to Barb, the user may verbally respond “Yes” or “No” or something to that affect to authorize rescheduling.

In at least some cases it is contemplated that while a user is sleeping, if at least some types of scheduled activities for a next day would optimally be rescheduled, a processor may monitor user sleep and, if the user is in a light sleep state (e.g., between REM cycles), the processor may wake the user and present the rescheduling option to the user mid-evening, so that rescheduling can occur while the user sleeps and with user authorization. Here, because the user is woken while in a light sleep state, the act of waking should be relatively unobjectionable, especially in a case where the system is seeking authorization to reschedule some morning activity to allow the user to sleep in if optimal.

Once Barb wakes and gets out of bed to start her morning routine, the system processor controls other affordances like her shower, lights in her closet and other parts of her bedroom, window shades and curtains, her coffee maker, a clothes warmer, speakers and emissive surfaces, etc., to support her morning routine with just in time services. For instance, 3 minutes prior to an anticipated time that Barb will enter her shower stall, the system may start her shower and adjust temperature to her preferred shower temperature, 5 minutes prior to an anticipated time that Barb enters her kitchen, the coffee maker may start brewing coffee, etc. As another instance as Barb works through morning routine activities, the system may present an audible podcast that Barb has on her to-do list as a secondary activity via speakers in the Barb's home as Barb moves from space to space.

During any morning routine, instantaneous activities increase or decrease the likelihood that Barb will be able to concentrate and focus on information. For instance, most people's focus level is very different when getting dressed or when sitting down and eating a breakfast. In at least some cases a system processor will monitor instantaneous user activities and present information designed to help a user prepare for her day's activities only when the user is likely to be in a state or circumstances that are favorable to focus. For instance, when the user is dressing, the processor may generate high energy music, present audible representations of e-mails, voice mails and other digital messaging forms as secondary activities and, in contrast, when the user sits down to eat, the system may present meeting materials for Barb's meeting with Gordie Gray to support a secondary activity so that the user can review information to present while able to best focus.

Other activity preparing information requiring a heightened state of focus may include an overview of Barb's schedule akin to the view shown in FIG. 23, indications of schedule pressures and anticipated user conditions (again as shown in exemplary form in FIG. 23), weather and traffic information, information indicating other available reschedule options, etc. Here, as described above, in at least some cases a system user will be able to provide feedback to the system indicating what she liked and did not like about the morning system support and, over time, the system will recognize optimal affordance control to enhance or simplify the user's mornings.

In cases where Barb has several meetings or other activities scheduled for the day where one or more have associated information, an interface akin to the FIG. 24 interface may be presented to the user during a morning focus period where the interface includes selectable icons (e.g., 1848, 1854) for accessing the activity content for morning review. Here, any newly posted content to an activity file that Barb has yet to access may be visually indicated in some fashion. For instance, see in FIG. 24 that file icon 1854 is shown left down to right hatched indicating a green color which may be reserved as a signal that new information has been added to that file. Where no new information has been added since barb last accessed the file, the file representation may not be visually presented in a different manner.

In at least some embodiments a processor will consider real time user condition and other factors when determining how to support Barb at all times during her morning routine. For instance, instead of simply automatically presenting a schedule interface akin to the interface shown in FIG. 24 when Barb sits down to have breakfast, the processor may only present that type of an interface if Barb is in a substantially rested state. Again, if Barb is exhausted, the system processor may opt for a less focus demanding activity like listening to a podcast, listening to music, etc., and may automatically control information presentation in an optimal fashion.

As the scheduled time to leave a Barb's home to travel to work draws near, a system processor may open Barb's garage door, start Barb's vehicle, move the vehicle out of the garage and onto a driveway, turn on vehicle heaters to warm up the vehicle interior and may provide a subtle reminder to Barb indicating when Barb needs to leave for work in order to arrive on time and settle in for her first meeting or other activity commitment.

In addition, the system may automatically identify items or materials that Barb should take with her when departing for work. For instance, if Barb uses a smart phone, laptop, tablet type computing device or some other type of portable computing device, the system may automatically generate a reminder to Barb to confirm that Barb has that device packed and ready to go to work. Here, in cases where a smart computing device is on and active and where a system processor can track location of that device, the system may automatically recognize that Barb has already packed or is carrying or wearing the portable computing device and may not present the reminder. In cases where the system can track portable computing device location, the system may automatically identify that Barb's device is not being carried, worn or otherwise is packed to travel with her and may present a reminder to locate and take the device where the reminder indicates device location. In fact, part of a reminder in this case may include activation of an audible or visual signaling device on the portable computing device as a beacon to help Barb locate her device.

As another instance, a system processor may recognize nasty weather conditions and present a reminder to Barb to pack a winter coat, a cap and boots or nice weather and remind the Barb to pack a light weight jacket. The system may recognize that the day will be sunny and remind the user to take her sunglasses with her when she departs. In some cases the system may remind Barb to pack or retrieve a lunch or to take a morning coffee along if that is a preference or a habit.

In at least some embodiments it is contemplated that, for at least some items, a user may attach an RF or other type of passive or active ID device to the item so that item locations can be tracked by system sensors, access points and the like in a manner similar to the smart device tracking process described above. Many different types of RF ID tags are available on the market today and any of those devices and tracking systems may be integrated into the optimization system contemplated here. While any item may be tagged for location tracking, it is contemplated that a user may only tag certain items that the user routinely uses and carries, wears or otherwise takes with her when she leaves some specific location like her home, office, etc. For instance, Barb may place an RF ID tag in a winter coat, on snow boots, in a purse and/or on a briefcase or on a lunch box or container so that locations of those items can be routinely tracked and used to notify Barb of their locations or remind Barb to take those items along when departing for some other location. Unless indicated otherwise, items that a user routinely uses and that travel with a user will be referred to hereinafter as “traveling items”.

In at least some cases Barb will not be reminded of “traveling items” all the time and instead will only be presented a reminder when a user is scheduled to depart a current location to travel to a remote location at some near time (e.g., in the next 5 minutes) or as the user approaches a location egress (e.g., a home door, etc.) and only for items that the user will likely need while away per her current schedule or foreseeable schedule changes. For instance, if Barb is scheduled to leave her home in 3 minutes and opens a door to her garage and if inclement winter weather is anticipated, a processor may audibly or visually remind Barb to remember her winter coat if the system cannot ascertain (e.g., via RF ID tags) that Barb is carrying her coat.

In at least some cases it is contemplated that a user will intentionally specify different items the system should remind the user about when the user is leaving specific locations. For instance, a user may specify a preference to be reminded to take her phone, laptop, a jacket of some type, a briefcase, an exercise bag and her sun glasses every time she is leaving home and is scheduled to travel to a place of work on any day between Monday and Friday. As another instance, the user may specify a preference to be reminded to take an exercise bag any time she is leaving home and is scheduled for an exercise session or it is anticipated that the user may want to exercise prior to coming back home.

In other cases, if at least a small subset of travelling items are tagged so their locations can be tracked, a system processor may automatically learn which items a user routinely travels with when specific environmental conditions exist or when specific activities are scheduled and may automatically start to remind the user in the future to obtain those items when similar circumstances occur or are scheduled or anticipated. Here, again, if the system recognizes a pattern, the system may query the user to confirm that pattern and then use the confirmed pattern to drive an optimized reminder system. For instance, if Barb Blue routinely packs a tagged duffle bag every day that she works out and then uses items from that bag to get ready to work out, the system may automatically recognize the bag as a workout affordance and then routinely remind Barb on days when exercise is scheduled to retrieve and take the bag along.

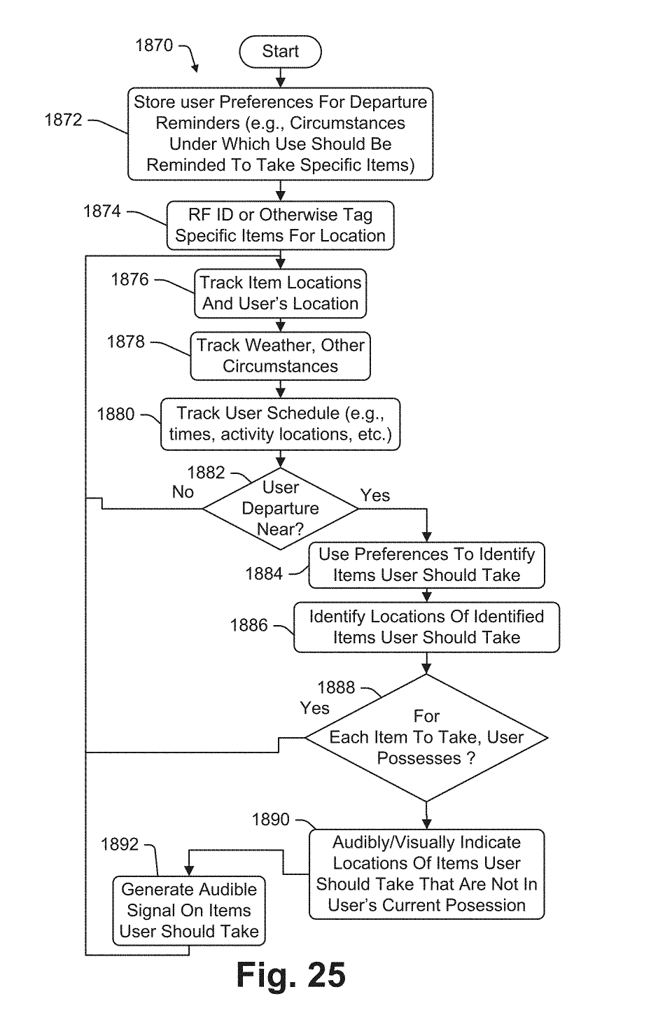

Referring now to FIG. 25, a process 1870 that is consistent with at least some aspects of the present disclosure starts at block 1872 where user preferences for departure reminders are specified by a user. Here, there may be different departure reminder preferences for different locations, different times and different circumstances and both user and environmental conditions including both current and anticipated conditions. For instance, there may be different departure reminder preferences for a user's home, a user's workstation at work and a user's place of work (e.g., a larger employer's facility). As another instance, there may be different departure reminder preferences for different days for a user's home (e.g., a workday as opposed to a Sunday). Many other preference circumstance and condition sets are contemplated.

At block 1874 RF or other tags are applied to or integrated into items to enable location tracking. Here, the user can determine which items are tagged and a general rule of thumb may be to tag any item that the user routinely takes with her when she leaves a space. For instance, in the case of a home, a user may want to tag a purse, a briefcase, glasses, sun glasses, luggage, an exercise duffle bag, a wallet, etc. In combination, blocks 1872 and 1874 may require a user to associate a specific tag with a specific item type and the circumstances under which the user wants to be reminded to take the item along (e.g., an umbrella and a rain coat when rain is anticipated, an exercise bag when exercise is anticipated or scheduled, etc.).

Referring still to FIG. 25, at block 1876 a system processor tracks item and user locations and at block 1878 the processor tracks weather and other circumstances that operate as factors when determining which items the user should take with her when she leaves a location. At block 1880 the system processor further tracks the user's schedule to determine when a move toward a space egress is likely associated with departure. At block 1882, the processor determines if the user is in the process of or near departing a current space. At block 1884, if the user is not departing a space or near departing, control passes back up to block 1876 where the process described above continues to cycle. If the user is about to depart the space (e.g., is moving toward an egress and is scheduled to travel to a remote location in the near future), the processor control passes to block 1884 where the processor uses the user's preferences to identify items that the user should take with her when she leaves her current space.

At block 1886 the processor identifies the locations of the items the user should take along and at block 1888, for each item that the user should take, the processor determines if the user already possesses that item. Here, for instance, if an item location tracks a user's location as the user moves about, the processor may recognize that the user is carrying or wearing the tracked item in which case the user is possesses that item. If the user possesses an item, for that item control passes back up to block 1876 where the process continues to cycle as described above. Where the user does not possess one of the items, control passes to block 1890 where the system processor generates a reminder for the user to retrieve the item to take with her when she leaves. Here, the reminder may be audible (e.g., annunciation of a specific reminder to the item) or visual (e.g., a message presented on a display screen). In addition to presenting a reminder to the user proximate the user's current location, in cases where the item to retrieve has the ability to generate a sound, the system processor may control the item to do so to help the user locate that item. For instance, a smart phone may beep or ring to help a user identify its location (see block 1892). After block 1892, control passes back up to block 1876 where the process described above continues to cycle.

While described as happening just prior to a user departing a space, the departure reminder notification may be presented earlier or later than the user's departure time. For instance, travelling item reminders may be presented to a user when the user initially wakes in the morning, or some period (e.g., 15-20 minutes) prior to a scheduled departure time for the user. As another instance, travelling item reminders may be presented to a user when the user is about to leave a sub-space in which the item is located even if the user is not leaving a larger space for some time that includes the sub-space for some time. For instance, if Barb's rain boots are located in her bedroom closet and rain is anticipated, when Barb is leaving her closet in the morning, the system processor may generate a notification instructing Barb to consider taking her boots with her as rain is anticipated in the forecast.

As another instance, a travelling item reminder may be presented to Barb just after Barb leaves a specific space so that Barb can return to that space relatively quickly to retrieve a forgotten item. For instance, when Barb leaves her home and gets into her vehicle (see again 106 in FIG. 1A), a reminder may be presented to Barb to retrieve any item that Barb is supposed to take along but does not currently possess.

Referring now to FIG. 26, a screen shot 1860 that may be presented on an interface output display 1858 as Barb is leaving her home to travel to her employer's facility at 9:50 AM on Wednesday morning is shown. Here, it is contemplated that a system processor would know Barb's exact location as she approaches an exit door to her home and that Barb is scheduled to depart shortly and therefore would surmise that as she moves toward the exit, the departure time is imminent. The exemplary departure reminder view 1860 includes a list 1862 of items Barb should take with her that she does not currently possess (e.g., is not wearing or carrying or currently taking along in some other fashion). The list includes graphical entries including a laptop image, a rain coat, boots and a duffle bag image. The list also includes text describing presentation materials for the meeting with Gordie Gray.

In this disclosure it is contemplated that most informational materials will be digitally stored and accessible essentially everywhere and for those materials no reminder would be required because of the ubiquitous access so that there is no need to remember those materials if the user has access to a system interface device which should also be ubiquitous. In the case of other materials like poster boards, hard copies of presentations for handout, etc., Barb may need to remember and pack those types of physical materials when traveling.

Referring still to FIG. 26, view 1860 also includes a list of locations at 1864 that includes a current location indication of at least a subset of the items listed in column 1862. The location list indicates that Barb's laptop is in her bedroom, her rain coat and boots are in her front closet and her workout bag is in the mud room. The third column 1866 may present a condition or anticipated circumstance that justifies the user taking an associated item in the first column 1863. For instance, the justification for the rain coat and boots is that rain is anticipated from 5 PM to 10 PM while the justification for the exercise bag is that the system anticipates that an exercise activity may be scheduled prior to the user returning home on Wednesday evening.

In some cases the display 1858 may include a large flat panel display screen mounted to or adjacent the user's home exit door so that the display is at a location where content presented thereon can be easily viewed by an approaching existing user. In other cases the screen shot 1860 may be presented on Barb's portable computing device like a tablet, a smart phone, a wrist mounted smart watch display, etc. While portable and wearable device reminders are contemplated in some case, those types of portable displays are often not optimal as a user could forget or misplace an associated device and in that case the system may not be able to effectively present a departure reminder to the user. For example, if departure reminders are presented to a user via a smart watch and the user forgets that watch when departing, any watch signal may not be detectable by the user leaving her home.

In some cases a system processor may triage the departure reminder process, attempting to remind Barb via one output device and switching to second and third output devices when prior attempted devices are unsuccessful. For instance, a smart watch may be a first departure reminder option, a large flat panel display near an exit door may be a second reminder option and a display screen 108 mounted in Barb's vehicle may operate as a third reminder display option. If Barb acknowledges a reminder without retrieving a travelling item associated therewith, the reminders may automatically stop for that item.

Upon entering her vehicle, Barb may be greeted again with an audible or visual salutation and Barb's vehicle seat, mirror, lighting and HVAC systems and other affordances may be automatically adjusted to customize for Barb's preferences if not already so adjusted. Prior to leaving Barb's driveway, a system processor may perform several functions. First, the processor may calculate the estimated time of arrival at the first work facility that Barb is scheduled to travel to given traffic, weather, distance of travel, legal speed limits, the specific user's driving habit and tendencies, etc. Next, if the Barb's estimated time of arrival is at least some threshold period prior to her first scheduled activity, the processor may attempt to identify one or more of Barb's to-do list tasks or aspirational tasks or preferential activities that could be completed on the way to the work facility while still enabling Barb to arrive at the facility in time to prepare for a first activity commitment given weather, traffic and other factors. Hereinafter, unless indicated otherwise, to-do list, preferential or aspirational tasks that may be completed in route while traveling will be referred to hereinafter simply as “in route tasks”.

For instance, where Barb routinely stops at a favorite coffee house on her way to work to pick up a favorite beverage, the processor may obtain posted information related to an order fulfillment time at the coffee house. As another instance, where Barb has been waiting for a prescription to be filled, the processor may identify that the prescription is ready for pickup and that a current pickup period is less than one minute. The processor may calculate drink and prescription pickup times and recognize that Barb can complete both drink pickup and prescription pickup tasks and still make it to the work facility with plenty of time to arrive for her first scheduled activity. In this set of circumstances, the system processor may offer one or both of the drink and prescription pickup in route tasks to Barb for consideration along with a confirmation that Barb can complete the presented tasks and still arrive at the work facility with time to be prepared for her earliest scheduled activity.

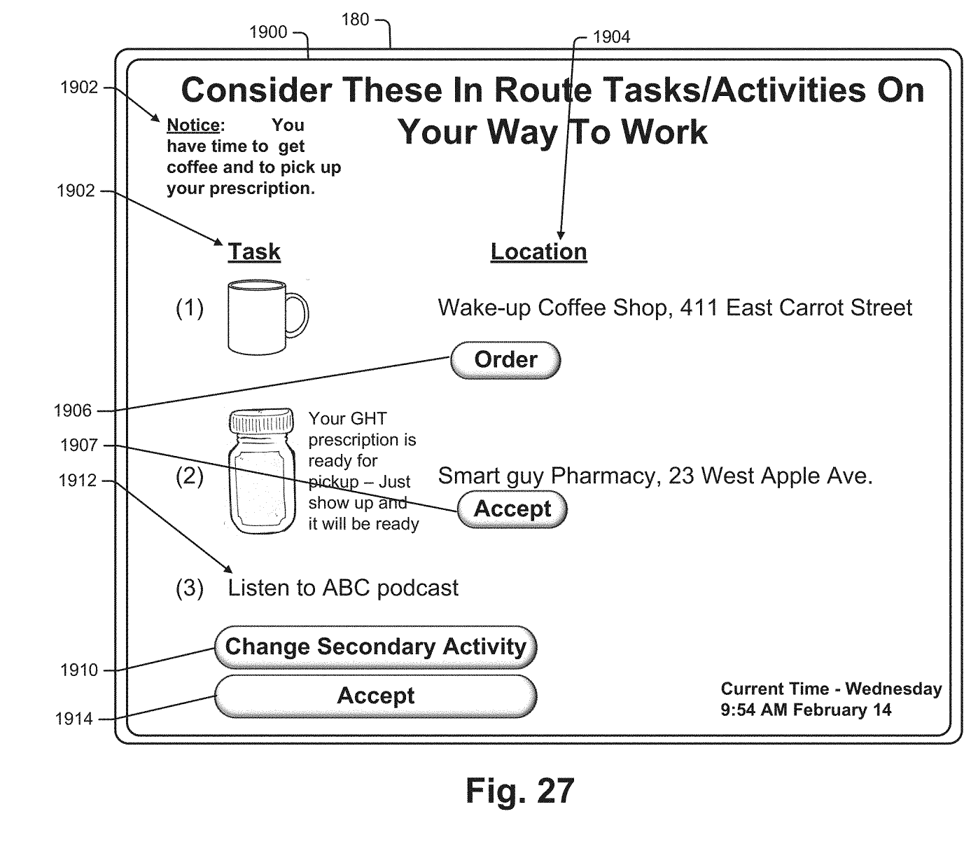

FIG. 27 shows an exemplary user interface screen shot 1900 that is presented on an emissive surface 180 mounted in Barb's vehicle that includes a list 1902 of in route tasks that may be performed on the way to the work facility and a locations column 1904 including a location associated with each of at least a subset of the list 1902 tasks. In addition, for in route tasks where the user needs to initiate the task, an activation button 1906 or selectable on screen icon is presented that can be selected by the user to initiate an associated task. For instance, the user selects icon 1906 in FIG. 27 to order her favorite drink for pickup at the coffee house on her way to work. For tasks that a user simply performs to complete like, for instance, picking up a filled prescription at a pharmacy, in at least some cases the interface 1900 may include an “Accept” icon 1907 or the like which the user can select to confirm that the user intends to complete the in route task. Here, acceptance of a task or initiating the task causes a system processor to start tracking estimated work facility arrival time assuming the user will proceed to complete the accepted and initiated tasks.

In a case where a user neglects to accept or initiate a suggested task, the system processor will continually estimate the user's time of arrival at the work facility assuming that the user is not intending to complete any of the suggested tasks. Here, the processor may be able to independently ascertain if a user performs any of the suggested tasks by monitoring user location, filled prescriptions (e.g., as indicated by a pharmacy), and other system detected information. If Barb Blue is in danger of running late for her first scheduled activity at work, the system will automatically present a warning notice to Barb via the vehicle emissive surface 180 so that Barb starts heading directly to the work facility if she is interested in being on time. In any case where Barb is likely to be late for a scheduled activity that involves one or more other system users or a specific non-time resource (e.g., a specific conference room, workstation, etc.), a system processor will automatically generate and transmit a notice to the other users or a processor that manages the other resources indicating Barb's tardy status as well as an estimated time of arrival at the location associated with the activity.

It has been recognized that most people's days include a few highly structured periods of activities interspersed among minimally structured periods where user activities are clearly defined and intentional during the structured periods and substantially less so during other periods. For instance, most people prepare thoroughly, both mentally and physically, for important planned meetings with colleagues and clients, attempting to be in an optimized state for these types of activities and often with clearly defined roles and tasks. In contrast, during periods between planned meetings or other highly structured activities, most people are unintentional about what to do and when to do it to best optimize their use of time and other resources. Instead, in many cases unstructured periods are arbitrarily filled either with the instantaneously easiest thing to do in the moment without much thought about optimization. For instance, when traveling to or from work or between activities, in addition to traveling, many people participate in some secondary activity to pass the traveling time including, for example, listening to whatever random topic is being discussed on a local radio show or talking with someone on a phone device.

While these impromptu secondary activities have some value, often they are not aligned with a user's preferences and priorities or with the user's current state or other optimization factors. For instance, most users would prefer more customized content delivery while traveling than whatever a local radio station is instantaneously presenting. As another instance, if a user is energized and alert while traveling, she may prefer developing content for an upcoming meeting as opposed to participating in a social call with a friend or colleague. One powerful aspect of the present disclosure is the optimization system's ability to help a user optimize time and resource use during typically relatively unstructured periods.

Referring again to FIG. 27, in addition to listing in route tasks that a user may choose to perform, the reminders screen shot 1900 also presents one or more default “secondary activity” suggestion(s) for the user. Secondary activities while driving or otherwise traveling may include any of several different entertainment or work related activities. For instance, work related activities may include listening to synthesized voice e-mails or text communications or listening to voice mails, listening to recordings of prior meeting discussions, listening to work related podcasts, listening to audio representations of schedules day activities, listening to audio representations of meeting agendas, calling back colleagues to follow up on meetings, prepare for upcoming events, etc. Entertainment related activities may include listening to favorite music tracks, podcasts, audio books, audio magazines, talk shows, news programs, calling friends or others, etc. In cases where a user has to drive her vehicle the secondary activities will typically be limited to audio listening types of activities as opposed to activities that require a user's vision so that the user's visual attention is not distracted while driving.

In cases where a user's mode of transportation does not require the user to engage her visual abilities, the secondary activity options may include activities that engage both a user's viewing and listening faculties. For instance, if a user travels to work on a train, a subway or in a taxi or where the user's vehicle is autonomous (e.g., driverless), secondary work related activities may include video messages, a power point or other application document from a prior meeting or that is to be considered during a future meeting, the user's prior or future schedule (e.g., see again FIGS. 21 and 23), etc., while entertainment activities may include a movie, a video news caste, other programming, books, magazines and other media that can be represented as text for reading, etc.

As in the case of most activities that are suggested to a user of the disclosed optimization system, the suggested secondary activity will be optimized given instantaneous optimization factors associated with a specific user. For instance, if a system processor recognizes that Barb's conditions (e.g., both physical and emotional) are such that she is in a state conducive to concentration and focus, the system may select a secondary activity that requires a relatively high level of focus to be effective. For example, where Barb is in a state conducive to concentration and focus, a system processor may select a work related audio recording of a prior meeting or an entertainment related audio book to suggest to Barb. As another instance, if the processor recognizes that Barb's conditions are such that Barb's ability to focus will be impaired (e.g., tired, distracted, etc.), the processor may select a secondary activity that requires less focus and that is more regenerative such as, for instance, a relaxing audio track.

Other factors for identifying one of several secondary activities to suggest to a user include all of the factors described above including, for example, user defined preferences, system identifies preferences, habits and tendencies, to-do and aspirational priorities, work related commitments and scheduled activities (e.g., does the user have to review or prepare materials for a meeting scheduled for the current day), estimated travel time, the number and nature of other tasks to be performed by the user while traveling, etc.

Referring again to FIG. 27, the exemplary suggested secondary activity includes listening to an ABC podcast as indicated at 1912. Change icon 1910 is presented adjacent the suggested secondary activity which can be selected to view other secondary activity options. Selection of icon 1910 may open a pull down menu of other secondary options for the user to choose from. Selection of “Accept” icon 1914 causes a processor to broadcast the ABC podcast that was suggested to Barb.

After Barb makes in route task and activity selections per interface screen shot 1900, as Barb leaves her driveway and progresses toward locations associated with accepted or initiated in route tasks, a system processor continually tracks Barb's location, environmental conditions (e.g., traffic, weather, etc.), estimated time to complete each in route task, as well as likely user route to work and continually estimates the Barb's time of arrival at the work facility. If conditions change and it is unlikely Barb will arrive with time to prepare for her first scheduled activity, the processor may present a notification to Barb to skip one or more of the in route tasks so that she can still arrive with time to prepare. In addition, if Barb's scheduled first activity is rescheduled by the system for some reason (e.g., another user requests rescheduling or the system reschedules automatically to optimize resources), the system automatically provides a notice to Barb that the activity was rescheduled.

In any case where Barb is late for a scheduled activity with one or more other system users, a system processor may be programmed to recognize other solutions to compensate for Barb's tardy state. For instance, if Barb is extremely late for a meeting, a processor may scour system resources to identify affordances to support Barb proximate her current location so that Barb can patch into the meeting from her current remote location. For instance, if Barb is near an available conference space that includes a telepresence setup when the user is likely to be very late for a meeting in a different location, the system processor may recognize that affordance availability and offer the conference space to Barb for the duration of the meeting. Here, if the user accepts the conference space offer, the system may automatically notify other meeting attendees that Barb will be linking into the meeting remotely and may automatically start a communication linking process so that when Barb arrives at the conference space with the telepresence setup, the telepresence link to the original meeting space is already functional.

As another instance where a user is extremely late for a meeting, a system processor may automatically present meeting materials to other meeting attendees as they arrive so that they can start the meeting in the tardy user's absence. If a meeting starts substantially prior to Barb's arrival, in at least some cases where substantive materials are generated or discussed, when appropriate, a system processor may present a paired down set of those materials in any fashion to Barb for consideration. For instance, once Barb parks her vehicle and starts walking toward the location of her first meeting, the system may present a highlight type reel of audio or audio and visual information to Barb while walking so that she can catch up with the other meeting attendees and so that her arrival is minimally if at all disruptive. In other cases when Barb arrives at the meeting space, she may be presented with a highlight reel type media stream on a fixed emissive surface and via speakers located outside the meeting space so that she can get caught up while settling down to enter the space in a non-disruptive manner.

Whether or not the system starts trying to compensate for a tardy activity invitee may be a function of the invitee's location relative to a location associated with the activity, the invitee's travel speed, etc., the nature of the activity (e.g., some activities may need to be in person), etc. For instance, if a processor recognizes that a user is likely to be 30 minutes late for a one hour meeting, the processor may start the compensation process while a user that is likely to be five minutes late would only trigger warnings and not a compensation process.

When Barb arrives at work and exits her vehicle to walk into the work facility, the secondary activity (e.g., listening to the ABC podcast) may continue if Barb has access to any suitable interface device(s). For instance, in the case of a podcast, if Barb is wearing a smart watch device that can receive and transmit the ABC podcast and has a set of wireless earphones, the system may automatically instruct the user to activate and wear the earphones to continue the podcast. Here, if the user activates the earphones the user's smart watch may commence podcast broadcasting. In the alternative, the system may not instruct the user to use the earphones and instead, if the user simply activates the earphones, the system may automatically cause the smart watch to commence podcast broadcasting to continue the secondary activity. Here, the idea is that the system processors may automatically attempt to identify optimal affordances to continue current user activities in at least some cases when those activities continue to make sense and may automatically control those affordances accordingly.

As Barb approaches an entry to the work facility on foot, system sensors may automatically recognize the user's identity and unlock or open doors to allow her to pass into the facility. In addition, when Barb enters the facility, in at least some cases, notifications may be presented to at least a subset of other system users indicating that Barb is generally located within the facility. For instance, again, where Barb's first scheduled activity involves several other invitees, notification of Barb's presence within the facility may be presented to each of the invitees. Here, the idea is that activity invitees may be more likely to arrive on time for activities if they know that other invitees will likely arrive on time as well and the likelihood of an invitee arriving on time is increased by the invitee being present within the facility. In some cases instead of notifying activity invitees each time a different invitee enters a facility, the system may track invitee locations and, when a threshold percent of activity invitees are located somewhere within the facility within some threshold time period (e.g., 10-15 minutes) prior to the activity start time, may present a notification that the meeting will likely commence on time.

Upon entering the facility or just outside the facility, Barb may encounter a large fixed emissive surface on which a personal salutation is presented along with information instructing Barb to travel to some first facility location like, for instance, a general location of a workstation that will be assigned to Barb for the day or some shorter period, the location of Barb's first meeting or other scheduled activity away from the workstation if Barb is running late, etc.

In a case where Barb arrives at the work facility well in advance of the start time of Barb's first scheduled activity, a system processor may automatically identify an optimized fill in activity to optimally occupy Barb's time prior to commencement of the first activity as well as any available affordances to support Barb while participating in the fill in activity. For instance, if Barb arrives at the work facility 45 minutes prior to her first scheduled meeting, the system may automatically recognize that Barb is in good condition to quickly enter a focused state, identify a document that Barb has recently been revising as well as an available first personal workstation near a location associated with Barb's first scheduled activity and may offer that station to Barb for use prior to the first meeting. In another case, the system may automatically determine that Barb may want to review or prepare materials for her first scheduled meeting and may offer the same station to Barb for reviewing or preparing materials. In some cases, the system processor may recognize several different high focus options for Barb and present a list of several options including 3 recently amended documents, 3 options for reviewing materials for different meeting Barb is attending that day and perhaps several other options. Here, if Barb accepts the workstation assignment, that station may be reserved for Barb and Barb may be automatically guided to the workstation location. Upon arriving at the assigned workstation, the document or meeting materials selected by Barb to be accessed may be automatically opened on an emissive surface at the workstation so that Barb can quickly delve into revisions or other preparations and into a focused state.

In the alternative, if Barb arrives 45 minutes early and a system processor recognizes that Barb is exhausted and therefore likely will not be able to quickly enter a focused state, a processor may automatically offer a second workstation or other space that is afforded for relatively more privacy than the first workstation and tee up some other content designed to help rejuvenate Barb prior to the first scheduled activity. For instance, the rejuvenating content may include a relatively quiet contemplative or relaxing music loop to encourage rest. Here, if Barb accepts the offer, when Barb arrives at the second workstation, the affordances at the second workstation may be optimized per Barb's preferences and insights associated with the overall optimization system for rejuvenation to help Barb quickly enter a rejuvenating state. For example, the second station light intensity may be low and the light color may be relaxing, any emissive surface associated with the second statin may present relaxing images or dynamic scenes, etc.

In any case where a fill in activity is suggested to Barb the system processor may also allow Barb to access and select some other fill in activity option in a manner akin to that described above with respect to icon 1910 in FIG. 27. When a fill in activity other than the optimal one or one of the optimal ones suggested by the system processor is selected, the processor automatically reserves optimized affordances and directs the user to an associated location so that user can initiate the selected activity.

At a time prior to the start time of Barb's first scheduled activity, a system processor may automatically track Barb's location and current activity and estimate the total time period required for Barb to launch from her current location, travel to the location associated with the first scheduled activity and settle down at the first activity location to enter the right state of mind for the scheduled activity. Here, for instance, if the travel time required is 5 minutes, the total launch, travel and settle times may be 15 minutes for Barb based on system detected user habits and tendencies when Barb has participated in the scheduled activity in the past. Once the total launch, travel and settle period is calculated, the processor may present a reminder to Barb to get up and travel to the activity location at a time that is prior to the first activity start time by the total time period (e.g., 15 minutes in the prior example). In addition, during the launch portion of the total time, the processor may automatically control affordances within Barb's current location in ways designed to help launch Barb. For instance, if Barb is rejuvenating at the second workstation in the above example, the system processor may automatically control second station affordances to slowly acclimate Barb to brighter and whiter light as well as to increase the volume and energy level of the rejuvenating music loop. If Barb is working on media content to present at the first meeting, the system may automatically start a countdown clock to time out the launch period so that Barb senses urgency to complete her edits and depart for the first meeting location with time to settle in prior to the meeting beginning.

It has been recognized that often times people that have not seen each other for some time may take a few minutes prior to a scheduled meeting to catch up on personal activities or other information unrelated to the topics that the meeting is supposed to be devoted to. While catching up is useful and helps build relationships, unfortunately when meeting attendees catch up with each other during a meeting, that activity is disrespectful to other meeting attendees. In some embodiments it is contemplated that whenever a system user has a meeting scheduled with one or more other invitees, a system processor may check invitee schedules and determine if any of two or more invitees are available for a short time prior to or after the schedules meeting. Where at least two invitees are available, at least based on their schedules, the system may automatically suggest a short pre-meeting or post-meeting for two or more invitees so that they can catch up with each other outside the time scheduled for the meeting. In cases where the only people invited to the meeting are the people that are likely to want to catch up with each other, because any catching up will not interfere with other invitee's time, the system may not suggest a pre or post-meeting session. In contrast, in cases where other invitees have been invited to a meeting so that any catching up between two or more invitees would interfere with the purpose associated with a scheduled activity, the system may be more likely to suggest a pre or post-meeting session. Again, as with all system preferences, as a user accepts or declines pre and post-meeting sessions in different sets of circumstances, the system processor will learn the user's preferences and may either offer more pre and post-meeting sessions or less in an automated fashion.

In the present example, if one or more other first meeting invitees are likely to be running late for the first meeting given their locations, current activities, traffic or other conditions, habits, tendencies, etc., a system processor may recognize that circumstance and adjust accordingly. For instance, if three of five other first meeting invitees are anticipated to be 10 minutes late or more, the system may automatically present a notification to Barb warning her that the three invitees will be late and, in at least some cases, which other invitees will be on time. Here, the notice may include a selectable option icon for delaying the start of the meeting by 10 minutes to allow the tardy users to arrive prior to commencement. Similar notices and delay options may also be provided to other invitees to inform or to both inform and present delay options. In cases where it is foreseeable that a substantial percentage of invitees will be delayed for a meeting or other activity, a system processor may automatically push back a meeting or other activity start time and transmit notices to at least a subset of the invitees.

If Barb arrives at a conference space associated with the Gordie Gray meeting substantially prior to the anticipated settle time prior to the scheduled start time, a system processor may, again, automatically identify a fill-in activity and proximate affordances to support that activity and may present one or more fill-in activity options to Barb. In the alternative, if Barb enters a space reserved for the Gordie Gray meeting, a processor may automatically queue up some optimized fill in activity option for Barb that uses the affordances or a subset of the affordances in the occupied space.

Once one invitee is located within the space reserved for the Gordie Gray meeting, a processor may start presenting invitee status information to that first user and others as they arrive indicating estimated times of arrival for each of the other invitees or, some type of indicator associated with when a threshold percentage of the invitees are anticipated to be present in the space. For instance, in the case of a six invitee meeting, the processor may estimate when at least 4 of the 6 invitees will be present in the conference space and may present a countdown clock for the estimated time. Here, the countdown clock value may be changed as circumstances change so that present attendees have a real time sense of when an activity is likely to commence.

In addition, once at least one invitee arrives at a location reserved for the meeting, the processor may also present notifications to other invitees still absent from the space indicating that meeting attendees have started to gather at the meeting space. Here, even if substantially prior to commencement of the scheduled meeting, the early arriver notice is presented to other invitees for two reasons. First, early arrival notices tend to encourage other activity invitees to be on time for a scheduled activity so that the activity can begin on time. Here, knowing that others are on time creates a sense of urgency to be on time. Second, the early arrival notice can encourage other invitees to arrive early in more of an impromptu manner so that pre-meeting catch up sessions can occur which build comradery and also result in better use of time during the scheduled activity.

Once at least a threshold number or percentage of invitees arrive for an activity, in at least some cases another notice may be sent to at least a subset of absent invitees. For instance, if Barb has yet to depart from a workstation for a meeting when the threshold percentage of invitees arrive at the meeting space, another notice may be sent at that time to encourage a rapid departure and hasty travel to the meeting space. In other cases where a different absent invitee is near the meeting location but not yet present, the additional notice may be foregone because of the imminent arrival of the other invitee based on location and travel speed.

During a pre-activity settlement period as well as during multi-person activity time, in addition to presenting a countdown clock or timer representation as a warning to help keep the activity on track, a system processor may track specific invitee schedules and indicate a separate anticipated or required departure time for each invitee that has to leave the activity immediately at or even before the scheduled end time. For example, assume that a second invitee, Omar Orange, has to leave the Gordie Gray meeting 35 minutes prior to the scheduled end time at 12:20 PM to make it to a different meeting. In this case, during the settlement period prior to the start of the Gordie Gray meeting, a processor may indicate Omar's departure time to notify other attendees of the restriction so that attendees can plan for Omar's departure. In some cases specific invitee time limitations may be presented a meeting is progressing or in a few minute period just prior to an attendee's departure time as a reminder to the departing attendee as well as to meeting attendees in general.

Similarly, in cases where one or more of the invitee's schedules enable those invitees to delay departure for some time after the scheduled end time of the meeting, notification of that possibility may be presented during the pre-meeting settlement period. For instance, see again FIG. 23 where Barb's schedule includes a 40 minute lunch period after the Gordie Gray meeting. In the illustrated case, assuming Barb is not scheduled to have lunch with someone else, Barb may be able to delay departure from the Gordie Gray meeting through the lunch period if needed for some reason.

In some cases, prior to posting that an attendee has arrived early at an activity location or that an activity attendee's schedule indicates that the attendee can stay after the scheduled end time of the activity, the system may automatically present a notification option to the attendee so that the attendee has the option to either post that information to others or not. For instance, if Barb Blue arrives 30 minutes early for the Gordie Gray meeting, she may want that time for some personal or focused individual activity as opposed to having one of the other meeting invitees drop by early to catch up. As another instance, while Barb may be able to stay at the meeting space subsequent to the scheduled end time, she may not want to stay and instead may want to leave that location and do something else with her time. In these cases, when presented with the option to indicate that she arrived early or that she can leave late, Barb may select an option not to notify other attendees of those circumstances.

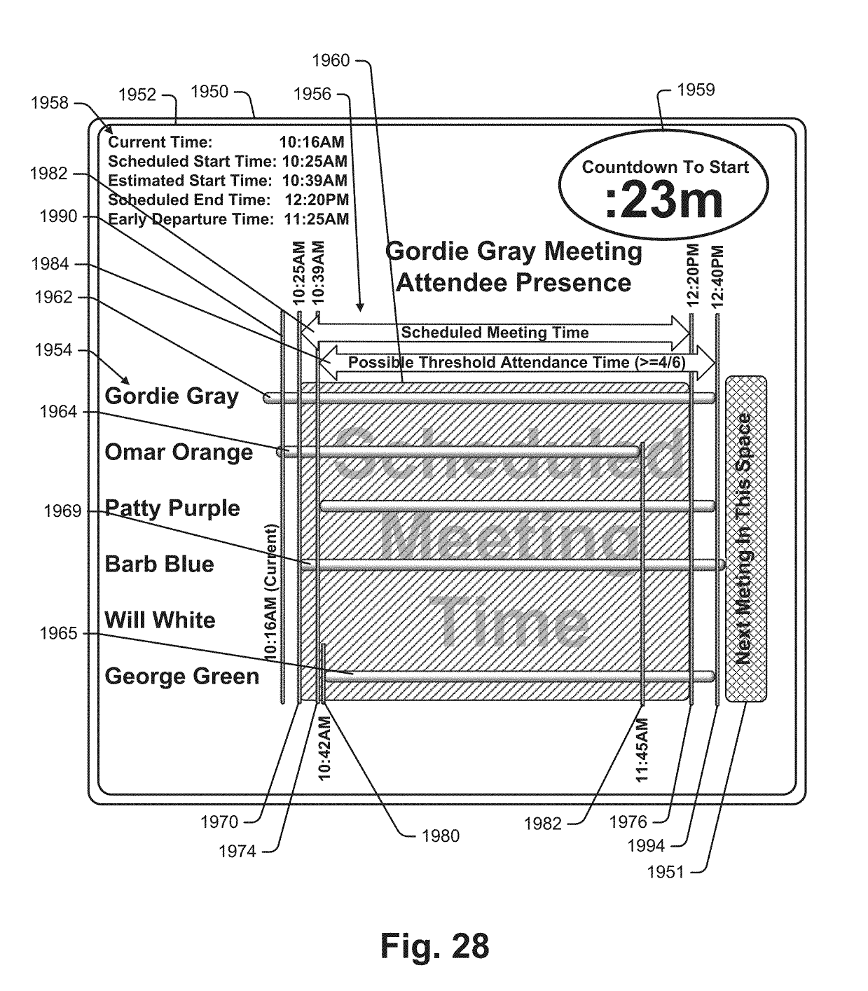

Referring now to FIG. 28, an exemplary screen shot 1952 that may be presented on an emissive surface 1952 to one, a subset or all meeting invitees prior to commencement of the Gordie Gray meeting to indicate invitees present at the location associated with the meeting as well as estimated times of arrival of other invitees at that location is illustrated. The exemplary screen shot includes an invitee list 1954, a graphical time slot representation at 1956, a time field at 1958 and a countdown timer field at 1959. Invitee list 1954 includes the name of each person that accepted a meeting invitation. Graphical representation 1956 includes a green colored block (e.g., left up to right cross hatched block) 1960 to the left of the invitee list that represents the scheduled time for the Gordie Gray meeting and start and stop bars 1974 and 1976 at opposite ends of the block 1960 indicating the scheduled start and stop times for the meeting. Representation 1956 also includes a first double headed arrow 1982 that stretches between bars 1974 and 1976 and which is labelled “Scheduled Meeting Time” to clearly indicate the scheduled meeting duration bounded by the scheduled start and stop times.

Referring still to FIG. 28, representation 1956 further includes a separate horizontal “present” bar aligned with each of the invitee user names in list 1954 except for Will White where the bar is positioned with respect to the scheduled time block 1960 to indicate user presence or anticipated user presence at the meeting location. In the illustrated example, Will White does not have a presence bar because the system recognizes that Will White will not be able to arrive at the meeting location even by the end of the scheduled meeting time or because Will rejected the meeting subsequent to acceptance. Present bar 1962 is aligned with the name Gordie Gray, bar 1964 is aligned with the name Omar Orange, bar 1969 is aligned with the name Barb Blue and bar 1965 is aligned with the name George Green to indicate when each of those invitees is present at the meeting location or when it is anticipated that the associated invitee will be present.

Referring still to FIG. 28, graphical representation 1956 further includes a vertically extending current time indicator bar 1990 that indicates a current time, which, in at least some cases, moves from right to left as time passes and which is aligned with the block 1960 to indicate a current time relative to the scheduled start and end meeting times. Gordie Gray's present bar 1962 extends to the left of current time indicator bar 1990 which means that the Gordie Gray previously arrived at the meeting location and continues to occupy that location. Similarly, Omar Orange's bar 1964 extends left of current time bar 1990 indicating that Omar Orange arrived at the meeting location prior to the current time and is also waiting for the meeting to start. Barb Blue's present bar 1969 starts at around 10:25 AM indicating that a system processor tracking Barb Blue's location, current activities, conditions, habits and tendencies (e.g., average travel time) etc., estimates that Barb will arrive at the meeting location at 10:25 AM at the scheduled start time for the meeting. Patty Purple's present bar indicates that the system estimates that Patty will arrive at the meeting location at 10:39 AM and George Green's bar show that the system estimates that George will arrive at the meeting location at 10:42 AM.

In most cases invitees that show up at a meeting are able to stay at the meeting until the scheduled end time as the optimization system helps user's schedule for full meeting periods without overlapping commitments. Nevertheless, in some instances one or more invitees will have conflicts within their schedules so that they will not be able to stay until the end of a meeting. In these cases, it is contemplated that, where possible, the system should indicate early departure times at the beginning of a meeting to put all attendees on notice of people that need to leave early.

Referring again to FIG. 28, each of the invitee present bars extends rightward to indicate a latest time that an associated invitee can participate in the meeting based on the invitee's current schedule or, in some cases, a preset user preference (e.g., an invitee may set a preference to never stay at a meeting subsequent to the scheduled end time regardless of whether or not her schedule would allow). For instance, Omar Oranges present bar 1962 ends at 11:45 AM indicating that Omar has to depart the meeting location 35 minutes prior to the scheduled end time. Similarly, each of Gordie Gray's bar, Patty Purple's bar, Barb Blue's bar and George Green's bar extend past the scheduled meeting end time at 12:20 PM indicating that each of those invitee's schedules currently enables them to stay at the Gordie George meeting for extended periods if that meeting is going well and should be continued.

While the extended present bars in FIG. 28 may be based on scheduled invitee activities, in some cases prior specified user preferences for each of the invitees may be used to ascertain which types of activities can be encroached on and by how much when other activities run long. For instance, Barb may specify a preference that only half of any lunch break can be encroached on by a prior extended activity while another user may specific that lunch breaks can never be encroached upon.

In at least some cases rules of thumb related to a threshold percentage of invitees that should be present to commence a meeting or continue an on ongoing meeting (e.g., extend a meeting past the scheduled end time) may exist or be specified in user preferences where the system may use those thresholds as at least one factor to assess when meetings should commence and end. To this end, for instance, in the current example where six people have been invited to the Gordie Gray meeting, a rule of thumb may be that the meeting should only commence once at least four of the six invitees are present at the meeting location and should only continue while four invitees remain present at the meeting. Hereinafter, unless indicated otherwise, the minimum attendee requirement for starting and continuing a meeting will be referred to hereinafter as the “minimum attendance threshold”.

In at least some cases it is contemplated that a meeting attendance screen shot presented to meeting attendees prior to the meeting start time may indicate, based on current invitee locations, travel speeds, tendencies, etc., when the minimum attendance threshold for a meeting will likely be met and, based on user schedules, preferences, etc., a latest time that the minimum attendance threshold will likely be met by the attendees. To this end, see again FIG. 28 where bar 1974 indicates the anticipated time when the minimum attendee threshold will be met and bar 1976 indicates an anticipated latest time that the minimum attendee threshold will be met for the Gordie Gray meeting. In addition, graphical representation 1956 further includes a second two headed arrow 1984 that indicates an anticipated period between bars 1974 and 1976 during which the minimum attendee threshold will likely be met. Thus, invitees viewing representation 1956 can graphically see when a meeting is likely to commence and a likely longest duration by which the meeting may be extended while still meeting the minimum attendee threshold (e.g., 4 out of 6 attendees present).

Referring still to FIG. 28, a countdown to start field 1959 is presented that includes a countdown timer value indicating a duration prior to the anticipated time when the minimum attendee threshold will be met based on invitee locations and other factors. Consistent with bar 1974 when the minimum attendee threshold will be met and the current 10:16 AM time, the timer value reads 23 minutes. A processor updates the timer value based on changing anticipated invitee arrival times and when the minimum attendee threshold is likely to be met.

Screen shot 1952 further includes a list of times at 1958 including the current time, the scheduled meeting start time, the estimated start time based on the minimum attendee threshold rule of thumb and current user locations and other factors, a scheduled end time and an early departure time indicating the earliest anticipated departure of any of the invitees based on invitee schedules and, perhaps, invitee launch times, travel times and settlement times related to subsequent activities.

Screen shot 1952 also includes a time block 1951 that indicates a next scheduled meeting for the space being used for the current meeting so that invitees can see that there is a hard stop on the duration of any extended meeting period. Here, the next meeting block 1951 may include transition periods for the current meeting attendees to clear out and next meeting attendees to arrive and get settled.

In some cases the ability to extend a meeting duration may not be presented to meeting attendees prior to or even during the first part of a meeting so that attendees are not encouraged to extend a meeting that could be completed effectively within an originally scheduled time period. In this case, the present bars for Gordie Gray, Patty Purple, Barb Blue and George Green may all at least initially end at the scheduled meeting end time 12:20 PM. In some cases, if a system processor recognizes that a meeting is progressing well (e.g., attendees remain engaged, focused, high energy, etc.) near the end of the scheduled period and that at least the minimum attendee threshold can be met by at least a subset of the attendees base on their current schedules, preferences, etc., the processor may offer a meeting extension to all or at least a subset of the attendees near the end of the scheduled meeting period.

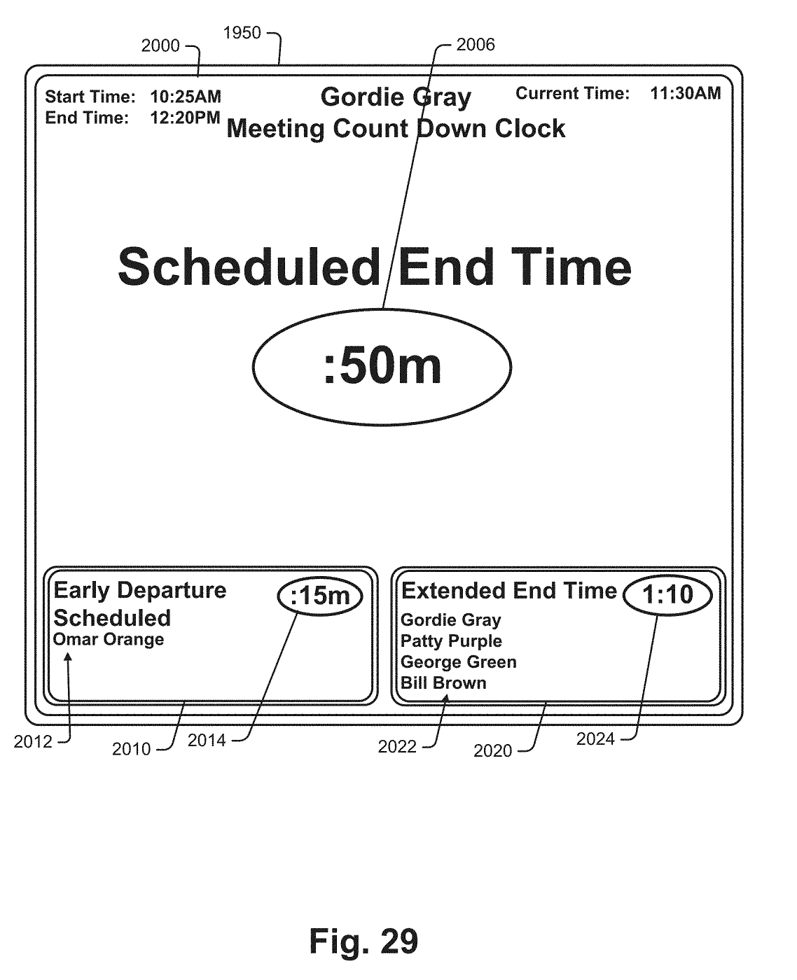

While a meeting is ongoing, a system processor may present a meeting countdown clock or timer to one, a subset or all meeting attendees so that attendees know the period until the scheduled end time of the meeting. To this end, see FIG. 29 that shows the emissive surface 1950 from FIG. 28, albeit with an ongoing meeting screen shot 2000 presented that includes, among other things, a countdown timer field 2006 that indicates that the current meeting is scheduled to end in 50 minutes. In addition, screen shot 2000 includes an early departure field 2010 and an extended end time field 2020.

Consistent with FIG. 28, the early departure field 2010 indicates that Omar Orange is scheduled to depart early and includes a separate count down timer field 2014 indicating the duration of time prior to Omar departing the meeting. Consistent with FIG. 28, the extended end time field 2020 includes a list 2022 of attendees who, based on their schedules, preferences, etc., appear to be available to stay for an extended duration after the scheduled end time for the meeting. As shown in FIG. 28, the system determines that different attendees will should be able to stay different extended durations. Consistent with the minimum attendance threshold (e.g., 4 of 6 in attendance in the present example), an end time of the extended duration is shown to be 12:40 PM as indicated by bar 1994 in FIG. 28. A count down timer to 12:40 AM is presented at 2024 in FIG. 29 to show the end time of a possible extended meeting duration.

A few minutes prior to the end of the Gordie Gray meeting, a system processor monitors meeting activities, attendee conditions and other optimization factors may assess meeting conditions and, in at least some cases, automatically ascertains if the meeting should be extended or if an extension should be offered for attendees that do not have to depart prior to or at the end of the scheduled meeting time. Thus, for instance, where four out of six attendees can extend the duration of the meeting and where attendee focus and participation levels at that time are good and where conditions of the six attendees that can extend are favorable, the system may automatically extend the meeting duration or may offer the suggestion and option to extend to one or more of the six meeting attendees. For example, if all of the four attendees that can extend are engaged, focused and contributing to the meeting, it may be optimal to continue the meeting until one or more of those attendees start to lose focus or disengage. Once the level of engagement or focus starts to wane, the processor may automatically start to conclude the meeting by indicating a revised end time.

In a case where the system recognizes that two or more attendees that can extend are still engaged and focused while others are not, the processor may suggest that the two engaged and focused attendees continue the meeting in the current meeting space while other attendees depart or the system may automatically identify some other facility space or affordance set that more optimally supports a smaller meeting continuance. Where another space or affordance set is optimal, the system may automatically suggest a move to the other space or set and, if accepted, may automatically transfer content from the original meeting room to the other space or set so that when the attendees arrive there, they can pick up where they left off to button up various meeting tasks.

At the end of the Gordie Gray meeting, a system processor may store all or a subset of information considered or generated at the meeting for subsequent access and to memorialize accomplishments. Here, the meeting information may be stored for Barb to access subsequently. Exemplary meeting material types include, for instance, documents and other media considered and/or generated, audio and/or video of the meeting activities, a record of optimization system recognitions, notifications and warnings as well as correlated user responses, a to-do list generated at the meeting, and so on.

In cases where an activity user is going to arrive late or leave early, in at least some cases it is contemplated that a system processor may provide an option to the user or to other attendees to patch the tardy attendee into the activity so that she can follow and at least somewhat participate in the meeting activities. For instance, where the tardy attendee uses a portable laptop, smart phone or other smart device, she may be able to patch into a meeting while traveling to or from the meeting space via one of those devices. In some cases the patching in will only include an audio patch while traveling so that the traveling user can hear meeting discussions and can speak to participate in those discussions. In other cases the patching in will include video as well as audio so that the traveling user can listen to, view and even participate in meeting activities. In still other cases the patching in will also include a video feed from the traveling user's portable device so that the traveling user has a real time presence within the meeting space (e.g., is presented on an emissive surface in the meeting space).

At all times and persistently, a system processor may be programmed to identify possible other optimized activities for Barb and to suggest those activities as fill-in options for open time slots. To this end, see again FIG. 10 where an exemplary set of first user meetings are specified including a meeting with Ralph Red. Referring again to FIG. 23, if, while Barb is the Gordie Gray meeting, Ralph Red is within the same facility as Barb or is generally in the same area of a campus of buildings and is unscheduled for lunch at 12:20 PM, the system processor may recognize the possibility of a lunch activity to satisfy Barb's intention to meet with Ralph. In this case, the system may present a query to one or both of Barb and ralph explaining that both are at least available on their schedules during the lunch period and that both will be in the same general area and asking if they want to set up an impromptu meeting for the lunch period. Where both invitees accept the lunch meeting, a space to accommodate the meeting may be automatically scheduled and presented to each for acceptance.

As another instance, in at least some cases it is contemplated that a system user may be able to identify a specific location in a cafeteria or the like where a group of people intend to gather during a lunch period to discuss some specific topic(s) of mutual interest. Here, where Barb Blue has expressed an interest in one or more of the mutual topics in her preferences or otherwise, the system may automatically present an invite to Barb if she remains available during her lunch period and is anticipated to be in the general vicinity of the cafeteria. Here, the mutual topic discussion may operate as a fill-in task for Barb if that type of activity is optimal given all or a subset of other factors.

Referring again to FIG. 23, during Barb's lunch period but prior to the scheduled end time, a system processor again estimates a total launch, travel and settlement time duration for Barb to locate and prepare for the Yvonne Yellow meeting and, at a time that precedes the scheduled start time for the meeting, the processor again presents a meeting reminder to Barb encouraging her to depart her location and travel to the location associated with the second meeting. In the present case, the Yvonne Yellow meeting is a telepresence meeting and therefore Barb can attend that meeting anywhere there is an available telepresence system. Thus, if a conference space including a telepresence system near Barb's lunch location is available during a time slot associated with the meeting, that space may be automatically reserved for the second meeting to reduce Barb's travel time as much as possible. Once Barb arrives at a location near the space that includes the telepresence system, a system processor may automatically initiate a communication link between the telepresence system and a similar system used by Yvonne Yellow at a different location so that the meeting can start when Barb enters the conference space.

Referring yet again to FIG. 23, all of the monitoring, calculating and optimization activities described above with respect to the Gordie Gray meeting may be performed during the Yvonne Yellow meeting. Near the end of the Yvonne Yellow meeting a processor provides reminders to the meeting attendees about next scheduled activities, if extending the meeting is advisable and possible for specific attendees and departure times for other attendees. Hereinafter it will be assumed that Barb Blue departs the Yvonne Yellow meeting at the scheduled end time to travel to a second work facility for the Bob Black meeting that starts at 4:55 PM.

Again, prior to Barb commencing travel to the second facility, a system processor may identify items Barb should remember to take along and may present a reminders screen shot akin to the screen shot 1860 shown in FIG. 26 near an exit to the first facility. Again, where items to remember are tagged and their locations are tracked, their locations may be presented to Barb to expedite the task of locating each of the items. Again, at the beginning of Barb's travel to the second facility, a system processor may calculate an anticipated arrival time at the second facility and determine if Barb has any extra time prior to the Bob Black meeting to perform other tasks along her route from the first to the second facilities and may present another screen shot akin to the shot shown in FIG. 27 to suggest possible in route tasks. Where Barb selects one or more tasks, the system may guide Barb along a route to accomplish those tasks as efficiently as possible, all the while calculating an anticipated arrival time at the second facility and, when necessary to ensuring that Barb arrives at the second facility on time for the next meeting, may make adjustments to the suggested tasks. Again, Barb may be able to accept or select a secondary activity to participate in during travel.

Next, it will be assumed that while Barb is traveling to the second facility, the Bob Black meeting is cancelled. Upon meeting cancellation, at a minimum, a notification would be transmitted to each of the meeting invitees warning each of the cancellation. In addition, for each invitee to the Bob Black meeting, the system may automatically perform optimization algorithms to identify other activities, tasks, aspirations, etc., that may be filled into the time slot associated with the cancelled meeting.

In FIG. 23, one simple thing to suggest to Barb when the Bob Black meeting is cancelled may be to travel home where Barb can participate in longer periods of family and reflection time as well as a longer exercise session in a modified version of the FIG. 23 schedule activities. Especially at the end of a day when Barb may be exhausted, simply cutting out one or more possible work related activities that are not time sensitive may be an optimized system operation.

In other cases when the Bob Black meeting is cancelled, a processor may attempt to identify any possible unscheduled or aspirational activities or meetings that can optimally fill in all or at least parts of the Bob Black time slot at the second facility or, if the user is still proximate or at least relatively close to the first facility, at the first facility. If one or more unscheduled activities are identified, the processor may either automatically select activities and/or tasks and schedule those for the user and provide a notification to the user that different activities or tasks have been scheduled.

In the alternative, the processor may identify optimized activity options and present one or several to Barb for acceptance or rejection. For instance, the system processor may identify first and second other system users at the second facility that Barb wants to meet with as well as meeting spaces at the second facility that are available to host first and second meetings with the first and second other system users and may provide invites to each of Barb and first and second other system users. Here, if invitees to the first and second meetings accept the invitations, the accepted meetings may be scheduled for each of the users. If invitees either reject the invitations or simply ignore the invitations for some threshold duration of time, the system processor may automatically identify some other activity or task to suggest to the user or may simply instruct the user to follow a route home. In some cases the invites to impromptu meeting may be presented to Barb first and to the other two users only after Barb accepts the invitation while in other cases the invites may be presented to each of the other two users and to Barb only after at least one of the other two users accepts the invite.

Once Barb starts to travel along a route toward home, a processor may identify and suggest or automatically implement still other possible in route and after arrival tasks. For instance, again, an in route task may include picking up a prescription at a pharmacy, purchasing a book or home good at a store, etc. In addition, where other people are implicated in in route and after arrival activities and tasks, authorization of those tasks can be sought from or notifications sent to the other people. For example, see again FIG. 23 where scheduled first user tasks after arrival at home include family time, reflection time and an exercise session that starts at 9 PM.

If the exercise session is with a trainer, the optimization system may determine if the trainer has an earlier available time slot so that the exercise session can be moved to an earlier time thereby freeing up the subsequently scheduled exercise period. Here, in some cases if the trainer has an earlier available slot, the exercise session may automatically be moved up to that slot and notifications presented to Barb and the trainer so that both are ready at the start of that slot. In this example where the exercise session is moved to an earlier time slot, in at least some cases, of course, the processor assesses many different optimization factors and only identifies the slot change option if it is optimal for Barb or for both Barb and the trainer. In other cases the system would send messages to each of Barb and trainer seeking authorization to move the exercise session to the earlier time slot.

In at least some cases a system processor may be programmed to always attempt to increase scheduling flexibility in the future by moving scheduled activities to earlier time slots in a hierarchical order. In at least some cases the hierarchical order may always attempt to move activities that require limited or restrained resources to earlier time slots when possible prior to moving activities that require less limited or restrained resources. For instance, any activity that only involves Barb may be considered less restrained that an activity that involves Barb and at least one other user because the second user's time represents a second limited resource. A meeting involving three people would be more restrained than one involving just Barb and one other user. As another instance, when an activity only requires one of many workstations (e.g., to support individual focused work), that activity would be relatively less restrained than an activity where Barb requires some special equipment that only exists in a single conference space.

Referring again to FIG. 23, where the Bob Black meeting is cancelled and the 9 PM exercise session is moved up to an earlier time slot prior to Barb travelling home, if Barb heads home after her earlier exercise session, Barb will arrive at home substantially earlier than the originally scheduled 7:20 PM arrival time and the only activities originally scheduled for Barb will include family time, reflection time and her evening routine to prepare for bed. Thus, assume Barb arrives at home at 6 PM, she will have four hours prior to her scheduled sleep period for the evening, the system processor may be programmed to attempt to move other scheduled activities forward in time and may do so in a hierarchical fashion as described above. For instance, again, when considering personal reflection time and family time, reflection time is personal and family time necessarily requires another family member and therefore, based on a more restrained resource moved forward rule, the processor first attempts to identify an earlier time slot for both of the family time periods or at least one of those periods. Here, the earlier time slot would have to be optimized for each of Barb and the other family members to participate in the family time period in order for the re-slotting to occur automatically or be suggested.

After the relatively constrained family time periods are either re-slotted or the system recognizes that they cannot be re-slotted, per the hierarchy, the processor would determine if the less restrained reflection time period could be rescheduled to an earlier time slot. As scheduled activities are moved forward in time so that later time slots open up, the system may automatically identify and suggest or automatically schedule other optimized activities for the open time slots.

In at least some embodiments another hierarchical optimization scheduling rule may be that already scheduled longer duration activities be rescheduled for earlier optimal time slots prior to already scheduled shorter duration activities. Thus, for instance, all other factors being equal if first and second scheduled activities have two hour and half an hour durations, respectively, if a two hour time slot prior to the time slots associated with the first and second activities becomes available, the two hour activity would be rescheduled to the available slot as opposed to the half hour activity.

In addition to specifying user roles and preparation requirements when scheduling a meeting, system users may specify other meeting parameters that affect scheduling options as well rescheduling hierarchy. For instance, in one case a processor may query a user to indicate a priority 1 through 10 for an activity being scheduled where a 10 means that the activity should be scheduled as soon as possible and independent of other scheduling factors and a 1 means that all factors should be accounted for when identifying optimal time slots. For priorities between 2 and 9, the degree to which other factors are considered would vary according to a sliding scale. Here, a 10 may also cause the processor to always attempt to move an associated activity forward in time whenever possible independent of all or at least a subset of other scheduling optimization factors.

As another instance, a user may be able to specify that an activity being scheduled should not be automatically rescheduled or suggested for rescheduling under any circumstances. In this case, to reschedule the activity, the user would have to access the scheduling software again and manually change the scheduled meeting time slot if she wants to change that slot.

Referring again to FIG. 23, on Wednesday night, Barb again participates in a reflection period during which she again accesses a retrospective view of her prior 24 hours that is akin to the FIG. 22 view, albeit corresponding to Tuesday from 8 PM to the present time as well as a prospective view as in FIG. 23, albeit corresponding to Thursday, the next day. Again, Barb can glean valuable information about how her day progressed as well as detailed information about how her next day is shaping up and insights into how she can optimize her time and other resources the next day. Barb can access content associated with the prior 24 hours of activities to the extent that such content exists by selecting content icons akin to icon 1743 shown in FIG. 21 and can access content associated with future scheduled activities via icons on the prospective view shown in FIG. 23. While reviewing content and to-do activities from the prior 24 hour period, Barb can handle the to-do activities by cancelling them, scheduling them to be handled, floating them on a schedule or assigning the activities to others.

As in many cases when someone reflects on their day in the evening and especially on to-do list activities, Barb Blue may decide to draft a series of e-mails to colleagues or other acquaintances handing off activities, buttoning up thoughts, querying about next steps, etc. While it is prudent for Barb to prepare correspondence immediately during reflective periods when things occur to her, it has been recognized that sending a correspondence near the end of the night can have an unintended alarming effect on recipients who may think that the timing equates to urgency. For this reason, in at least some cases it is contemplated that the present system may present some way for a user to indicate that a correspondence is urgent or not where, upon completing the correspondence, urgent correspondence is sent immediately while other correspondence is sent at a later delayed time if completed during some late evening time period (e.g., 7 PM through 5 AM) such as, for instance the next morning at 8 AM. For example, an e-mail package may present both a selectable “Send” icon and an “Urgent—Send” icon, where selection of the urgent send icon causes immediate transmission to a recipient along with an “Urgent” label automatically added to the e-mail “Regarding” line and selection of the send icon causes the e-mail to be delayed until 8 AM the next morning.

In at least some cases, during a daytime period (e.g., 5 AM through 7 PM), when an e-mail is designated urgent, that e-mail may be immediately delivered to a recipient upon sending while all non-urgent e-mails are subject to recipient preferences related to correspondence restrictions. For instance, if Barb Blue specifies a preference not to receive e-mails during high focus periods, the system may not deliver any non-urgent e-mails to Barb while she is highly focused until she comes out of that state but may immediately deliver urgent e-mails to her regardless of her focus state.

Referring again to FIG. 23, as in the case of Barb's Tuesday evening described above, the system continues to support Barb throughout her evening activities until she turns in for the evening at 10 PM.

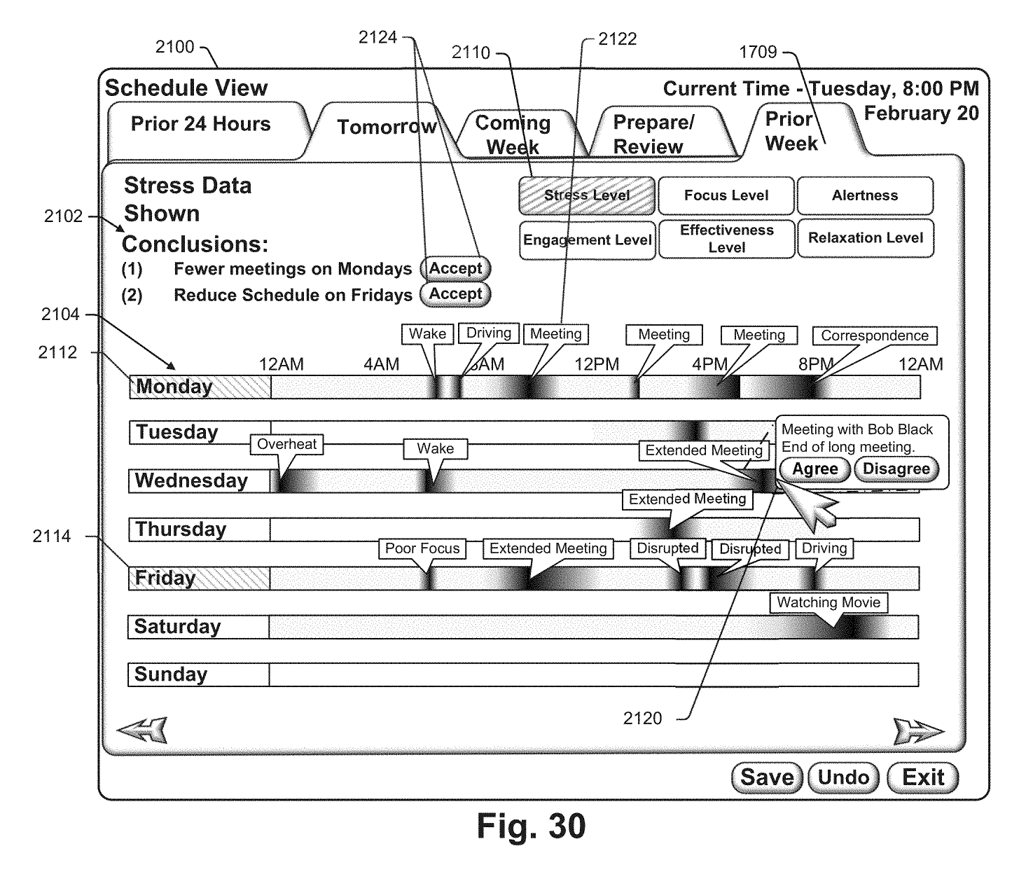

Referring now to FIG. 30, a screen shot 2100 shows a retrospective prior week view that may be presented to a user by a system processor when the prior week tab 1709 is selected. The retrospective week view includes a set of seven time lines 2104, each representing one day of the prior week through mid-night of the most recent Sunday evening. Each one of the day timelines includes a 24 hour period as marked. The view also include six user condition icons including a stress level icon 2110, a focus level icon, an alertness icon, an engagement icon, an effectiveness icon and a relaxation level icon. Each of the icons can be selected by a user to show a graphical representation of related data on the day timelines at 2104. For instance, in the illustrated example, Barb Blue selected the stress level icon 2110 which is shown highlighted (e.g., left up to right cross hatched) to persistently indicate selection. The other icons may be selected to view graphical information representing the other user conditions. In some cases, as in FIG. 23, two or more user conditions may be represented for each day so a user can see how different conditions affect each other. The graphical representation of data on the day timelines includes dark spots that indicate stress levels that are higher than normal for the user. As illustrated, Barb Blue had several periods of stress higher than normal on Monday, one of Tuesday, three on Wednesday, one on Thursday, several on Friday and one on Saturday. Clearly Barb Blue experienced more stressful periods on Monday and Friday than on the other days.

In at least some embodiments it is contemplated that a system processor may be abler to ascertain or recognize a likely set of circumstances that causes any deviation from a normal or steady state user condition and may be able to indicate the cause to the user. For instance, see the exemplary call out 2122 in FIG. 30 indicating that Barb Blue was participating in a meeting when a corresponding high stress period occurred. In FIG. 30 the call out is spatially associated with the graphical stress representation during the stressful period. Other call outs are associated with other high stress periods that indicate other causes such as an extended meeting, poor focus, disruption, etc. When a user moves the pointing icon to hover over a graphical stress representation, a pop up window 2120 opens to present more detailed information about the conditions or circumstances surrounding the stressful period. The pop up window includes user selectable “Agree” and “Disagree” icons that allow the user to confirm that the circumstances identified by the system as the cause of the high stress period are accurate from the user's perspective. Here, as the user either confirms or rejects the system identified causes, the system may take those confirmations and rejections into consideration as catalysts for changing various system algorithms and condition-factor correspondences that are stored in the database at 560 (see again FIG. 5).

Referring still to FIG. 30, the view illustrated further includes a couple conclusions at 2102 that a system processor generates based on application of artificial intelligence to the information presented at 2104 and perhaps other system information. The conclusions indicate that it would likely be optimal for Barb Blue to authorize a preference for fewer meetings on Mondays and a reduced schedule on Fridays. Each conclusion includes an associated “Accept” icon 2124 which, if selected, causes associated user preferences to be codified for the selecting user for subsequent use in optimizing overall system operation for the user. The day icons for Monday and Friday at 2112 and 2115 a highlighted or otherwise visually distinguished so that Barb can see days during which the system is suggesting other preferences.

It has been recognized that many people often use transition times between other important activities relatively inefficiently. For instance, when travelling from one meeting to another for 15 minutes, a person may do nothing of importance while travelling. While many transition times are short (e.g., only a few minutes), over the course of a day the combined duration of multiple transition times can be substantial. In some cases people intentionally use transition times as “down times” or “rejuvenation times” when they can clear their minds between other scheduled activities and, in those cases, those transition times may be well utilized. However, in many cases people do not choose to use transition times poorly and instead, they feel like they have no choice because productive secondary activities are inaccessible. In this regard, most busy people have a list of short duration activities that need to be or should be completed to button up prior meeting or personal activities in the best way possible or to prepare for upcoming meetings or activities in ways that should enable higher quality preparation and participation but there is no easy way to access resources or content needed to complete these tasks in short periods, especially when travelling from one scheduled activity to another.

For instance, the user could review and supplement work product from a most recently completed meeting and electronically file that information as appropriate, or could forward that information on to other people for consideration or comment. As another instance, a user could review an agenda for a next meeting, could listen to a podcast that is relevant to the user's next meeting, could hop on a call with an attendee from the most recently concluded meeting to wrap up a few thoughts or assign tasks if the other attendee is available, could hop on a call with another attendee that is already located in a conference space reserved for the user's next meeting, could hop on a call with another attendee scheduled to be at the next meeting that is in transit to the conference space reserved for the next meeting to discuss aspects of the next meeting prior to arrival, could field a voice mail or email while in transit, could review content related to an upcoming meeting to occur a next day, etc.

According to one aspect of the present disclosure, consistent with some of the description above, a system processor may be programmed to present a set of secondary activities to a system user any time the user is transitioning from one scheduled event or activity to another. In particularly advantageous cases, the system may automatically attempt to identify secondary activities that are related to temporally proximate primary activities. For instance, in one case, the system may automatically identify secondary activities that are related to a most recently completed meeting and/or related to a next scheduled meeting or other activity that the user is transitioning to and may provide those activities as options while in transit. Here, the system may only identify a set of possible secondary activities for the user. For instance, in a case where five other people are scheduled to attend Barb Blue's next scheduled meeting, it may be that only two of those five people are currently available (e.g., not busy) for a phone or video call at a current time. In this case, the system may only present options for contacting the two of five other people that are available during Barb's travel to a conference space reserved for the next meeting.

In some cases where a first system user requests contact with a second user, the system may present that type of request to the second user during transition times. These contact requests may be highlighted or otherwise visually distinguished in some fashion to call a user's attention to those contact options as opposed to others where no other user requested contact.

In at least some cases where the system maintains a database that correlates content with meetings or other activities, the system may automatically present options for accessing or otherwise handling content related to prior and temporally proximate future meetings and activities. For instance, any digital documents or other content files generated during a most recently concluded meeting may be presented for access by Barb during transit. As another instance, any digital documents or other content files associated with Barb's next scheduled meeting may be presented for access during transit. In at least some cases any new content including newly posted content not considered by a user may be highlighted or otherwise visually distinguished for the user to consider. Here, new content may include completely new documents or files or, in some cases, documents or files edited by some other system user.

In still other cases the system may be programmed to automatically identify other content options based on user preferences or prior or future meeting content and may offer that additional content to a user during transition. For instance, a system processor may examine content posted for Barb Blue's next meeting to identify meeting topics and may search the Internet or some other content network for additional relevant documents, files, podcasts, etc., to be presented for selection to Barb.

In at least some cases the secondary activities selected to present as options to a user during transition periods will be based on many different factors or combinations of factors. For instance, an option to review a document while travelling may only be presented if it is safe for a user to review the document given the user's mode of travel. More specifically, if the user is driving as opposed to walking or taking a train or a taxi, the system may filter out any secondary activities from the set presented as options to the user that require the user's visual sense to participate.

One other factor used to select secondary activities to suggest to a system user may be the user's instantaneous condition. For instance, if biometric sensor data and conclusions based thereon indicate that a user is completely exhausted at the beginning of a transition period, the system may automatically forego presenting secondary options to the user that are not of a rejuvenating ilk. In contrast, if biometrics indicate a user is in a condition suitable for considering content or participating in a call with another person, the system may add content and contact options to a secondary activity option list for the user. A related or similar factor when selecting secondary activities to suggest to a user may be conditions of other system users. For instance, where a second system user is travelling to a next meeting with a first user, an option to contact the second user during transit may not be presented to the first user if the second user's condition calls for rejuvenation or if the second user is currently participating in some other secondary activity that requires her attention or if the second user is in a focused flow state during her transit.

Another factor may be the anticipated transition period duration. Here, if a duration is short, only secondary options that are likely to be able to be completed during the short duration may be presented to the user. In the alternative, no secondary options may be presented during short duration transitions or only rejuvenating activities (e.g., listening to a relaxing music track) may be presented for selection. Here, in at least some cases there may be a single threshold anticipated duration or several that are used to select among secondary activity options presented to the user.

In some cases secondary activity options to present may be filtered based on the next activity to be performed by a system user. For instance, if a system user is between scheduled meetings, content related to each of those meetings as well as contact options for each available meeting attendee or invitee may be presented to the user and, in contrast, if the user's next scheduled activity is a workout, secondary activity options may be limited to options calculated to prepare the user for an intense workout (e.g., specific music options or an exercise related podcast).

As another instance, if the user is headed home after a long day, the system may automatically select at least a set of secondary activity options geared toward transitioning from work to home. For example, if a user's spouse is also a system user, the system may automatically determine if the spouse is available for a phone or video call and may present a spouse contact option to the user. If the user routinely picks up pizza from a specific restaurant every Thursday evening, the system may automatically provide an option to order food from the restaurant.

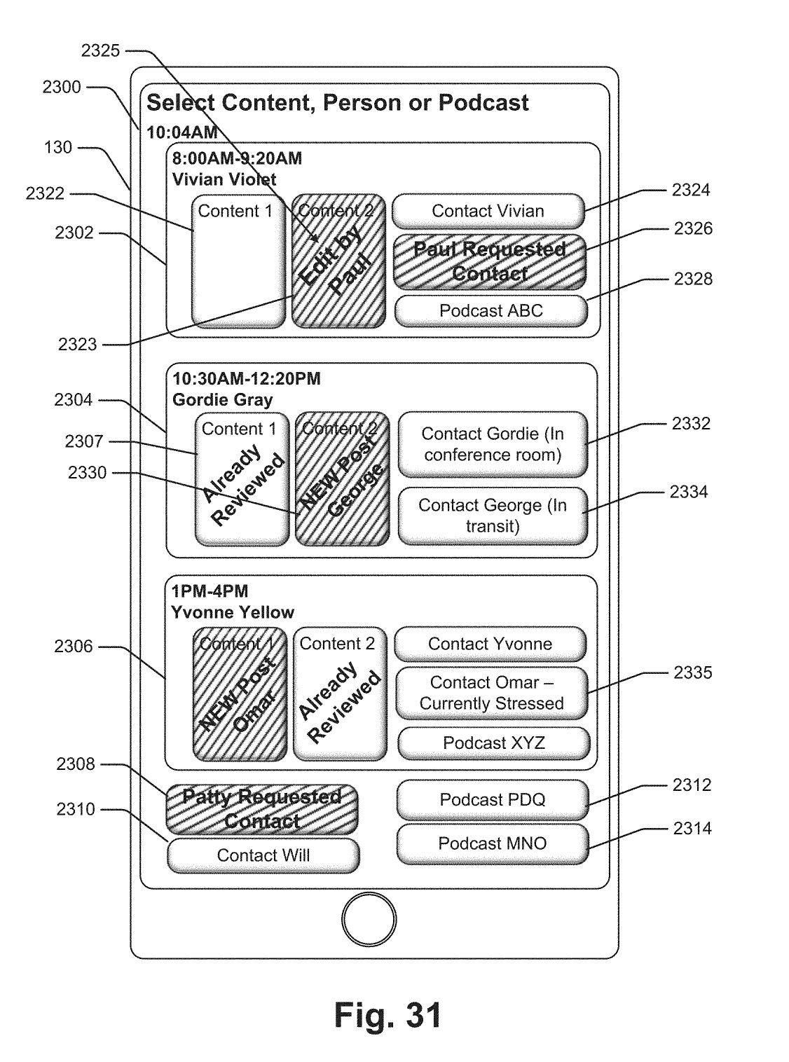

Referring now to FIG. 31, an exemplary portable smart phone device 130 is illustrated which is presenting a screen shot 2300 that may be presented to Barb Blue during a transition time between meetings. The shot 2300 includes meeting indicator fields 2302, 2304 and 2306 corresponding to Barb's most recently completed meeting and her next two scheduled meetings, respectively. Most recent meeting field 2302 includes three different types of secondary activity option including content options 2322 and 2323, contact options 2324 and 2326 and a podcast option 2328. The content options 2322 and 2323 correspond to first and second different content files labelled “Content 1” and “Content 2”, respectively, and correspond to content that was either considered or developed during the prior meeting corresponding to field 2302. Second content 2323 is visually distinguished (e.g., highlighted) as shown by the left up to right cross hatching to indicate that the content related to that option has been edited by one of the meeting attendees subsequent to the end of the meeting. A label 2325 is also applied to field 2323 that indicates why the field is visually distinguished as well as why it has been distinguished. To this end, label 2325 indicates “Edit by Paul” to indicate that Paul edited Content 2 since the end of the meeting. While not shown, each content option 2322 and 2323 may present a thumbnail representation of a first page of a document related thereto, an image of a video clip related thereto or some other graphical representation that is associated with the related content.

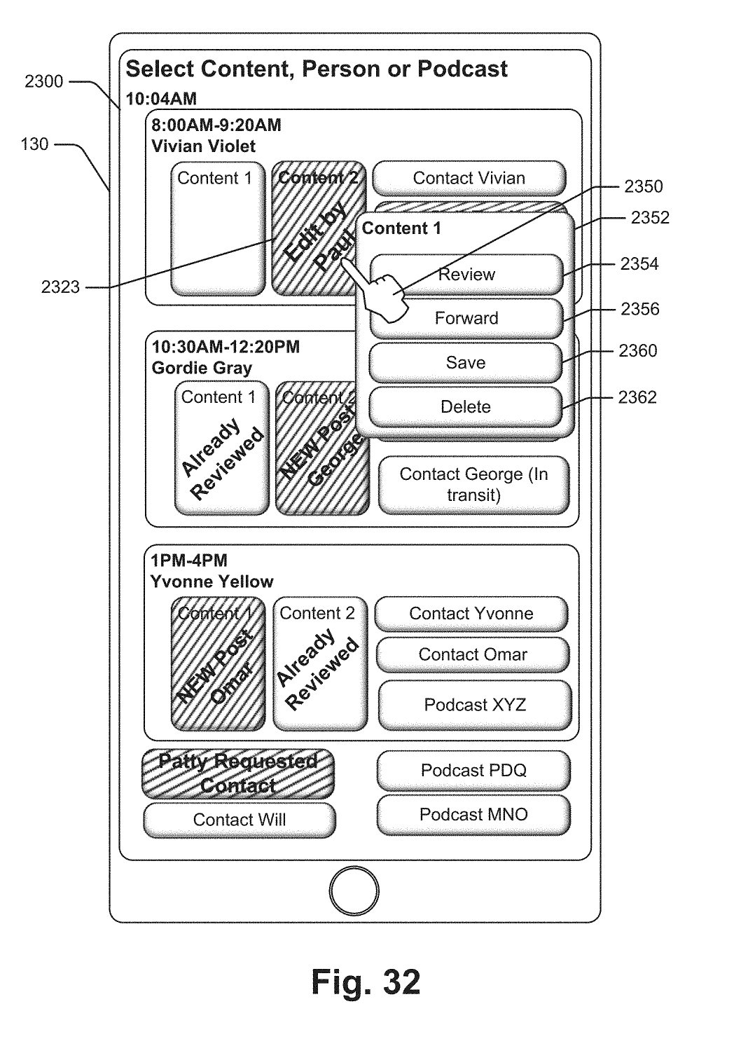

Referring to FIG. 32, if Barb selects the Content 2 field or icon 2323 as indicated by hand icon 2350, a drop down menu 2352 opens that presents options for what to do with the content associated with the icon. The exemplary options include a “Review” option 2354, a “Forward” option 2356, a “Save” option 2360 and a “Delete” option 2362. Further selection of options in menu 2352 would open other suitable control icon lists for completing related tasks. In particular, when the review icon 2354 is selected, the actual content associated with icon 2323 is opened and may be reviewed and, in at least some cases, may be editable or annotatable by Bard while in transit.

Referring again to FIG. 31, Contact icon 2324 may be selected to initiate some type of communication with Vivian Violet. Here, it is contemplated that the system may automatically identify instantaneous best communication options for Vivian given her current location and current access to communication devices. For instance, if Vivian is also in transit and not near a stationary business phone but is traveling with her cellular phone, the system may automatically present only Vivian's cell phone as a contact option. If Vivian can receive both phone calls and text currently, options for phone or text may be presented.

In FIG. 31, contact icon 2326 includes a label that indicates “Paul Requested Contact” and is highlighted to call Barb's attention to that option and to clearly indicate that Paul attempted a prior contact. Again, by selecting icon 2326, Bard should be given all options or any suitable options for contacting Paul given Paul's current capabilities.

Referring still to FIG. 31, the only contact options presented in field 2302 include options to contact Vivian or Paul. It may be that other people attended the meeting associated with field 2302 but the system may recognize that none of the other attendees are available to field real time contacts and for that reason those options are not presented to Barb in field 2302. In the alternative, the other current unavailable attendees may be listed with other non-real time contact options like text, e-mail or other options for selection by Barb.

Referring still to FIG. 31, Podcast icon 2328 provides an option for Barb to listen to a podcast that is at least somewhat related to the topics considered during the meeting associated with field 2302 or to topics related to the content associated with icons 2322 and 2323.

Referring to FIG. 31, secondary activity options akin to those described above with respect to field 2302 are presented in each of meeting fields 2304 and 2306. Content 1 and Content 2 icons 2307 and 2330 are associated with first and second different content options related to Barb's next scheduled meeting, the meeting she will next attend. “Already reviewed” and “New Post George” labels are applied to icons 2307 and 2330 indicating that Barb already reviewed Content 1 and that George posted Content 2 which has not yet been reviewed by Vivian. Contact icons 2332 and 2334 are selectable to call or otherwise forma communication link to Gordie and George, respectively. In addition, icon 2332 includes text indicating Gordie's current location and icon 2334 includes text indicating that George is in transit, to give Barb some sense of Gordie's and George's current circumstances.

Referring still to FIG. 31, contact icon 2335 for Omar who is scheduled to attend Barb's afternoon meeting includes text indicating that Omar is currently stressed. The currently stressed indication is intended to help Barb understand or empathize with Omar's current condition and may help her make a good decision about if now is the right time to attempt to contact Omar. Again, in some cases the system may automatically avoid presenting an Omar contact option when Omar is stressed but that option may still be presented with the condition indicator so Barb can make the decision.

Other secondary activity options presented via screen shot 2300 include other contact options 2308 and 2310 and other podcast options 2312 and 2314 that are not related to specific meetings.

Referring again to FIG. 31, it should be appreciated that several of the secondary activity options presented are visually distinguished by left up to right cross hatching to indicate some special status of those options over the others. Again new or edited content is highlighted as are requests to communicate received from other system users. While one type of highlighting is shown, two or more disparate highlighting or visually distinguishing effects may be used to provide other gradations of importance or ways to indicate a hierarchy between the different activity options.

Thus, the exemplary interface in FIG. 31 shows that the secondary activities options screen shot presented during transition periods includes activity options related to temporally proximate activities, presents different activity types, visually distinguishes activities based on several factors (e.g., new or edited content, whether or not a user previously considered content, who requested a contact, etc.). In some cases where an activity requires participation by another system user the system may indicate the other user's current circumstances (e.g., in transit, in a conference room and available, etc.) or conditions (e.g., stressed, in flow, calm, etc.). In some cases activity options are grouped logically by which scheduled activity, prior or subsequent, they are related to.

Another way to think about the process associated with FIG. 31 is that any time a transition period between scheduled activities occurs, a system processor will automatically determine if a trigger set of circumstances occurs during that transition period that warrants presentation of secondary activity suggestions to a system user. For instance, one trigger set circumstance may be that the anticipated transition period be longer than some threshold minimum duration of time (e.g., 1 minute, 5 minutes, etc.). Another trigger set circumstance may be that the system has stored content related to either a most recent meeting or a next scheduled meeting. Another circumstance may be related to condition of a user associated with the transition period (e.g., different secondary activities presented to the user based on different user conditions). Many other trigger set circumstances are contemplated and, in many cases, a trigger set may include two, three or more circumstances that need to occur simultaneously for a specific secondary activity to be warranted.

Thus, the trigger set of circumstances may include several different trigger sets, each associated with a different set of secondary activities. For instance, for the system to suggest secondary activities associated with a most recently concluded meeting (e.g., content handling, attendee contacts, related podcasts, etc.), one trigger set circumstance will be that information needed to drive those types of activities is stored and accessible by a system processor. Similarly, for the system to suggest secondary activities associated with a next scheduled meeting, one trigger set circumstance will be that information needed to drive those types of activities is stored and accessible by a system processor. Thus, different trigger sets of circumstances may yield different possible secondary activities and a system may combine different subsets of secondary activities associated with different trigger set circumstances to yield a combined set of secondary activities to suggest to a user.

While many of the secondary activities contemplated and described above are facilitated using a system user's portable computing device as users are often in transit during transition periods, in at least some cases it is contemplated that other system affordances or subsets of affordances may be controlled to support one or more secondary activities. For instance, where a system user has first and second consecutive meetings in the same conference space, any secondary activity that requires presentation of content to the user may take advantage of any system output devices in the vicinity of the user including, for instance, any large emissive surfaces in the conference space, speakers in the conference space, haptic signaling devices in the conference space, etc. As another instance, even when a user is travelling during a transition period, emissive surfaces, speakers and other affordances along the way may be used to facilitate secondary activities to the extent that those affordances make sense.

In at least some cases it is contemplated that at least some secondary activities may commence using a user's portable communication device (e.g., a smart phone, tablet, etc.) but that the system may automatically recognize when a user is proximate some other affordance set that can better support the secondary activities. For instance, when a user walks to and enters her vehicle to travel from one location to another while participating in a secondary activity, the system may automatically recognize a more optimal set of display screens, speakers, microphones, cameras, etc., for facilitating the secondary activity and may either automatically switch to support the secondary activity via the optimal affordance set or may present an option to the user to switch over to the optimal affordance set. Similarly, if the user is participating in a secondary activity in her vehicle using vehicle affordances and then leaves the vehicle prior to completing the activity, the system may automatically switch over and start using the user's portable computing device to continue to facilitate the activity or may present to option to continue the activity via the user's portable device. As yet one other instance, if a user uses her portable computing device to participate in a secondary activity while travelling arrives at a destination that includes a large emissive surface, speakers, microphones, a camera, etc., that are more optimal for supporting the secondary activity, the system may automatically switch over to supporting the user via the better affordance set.

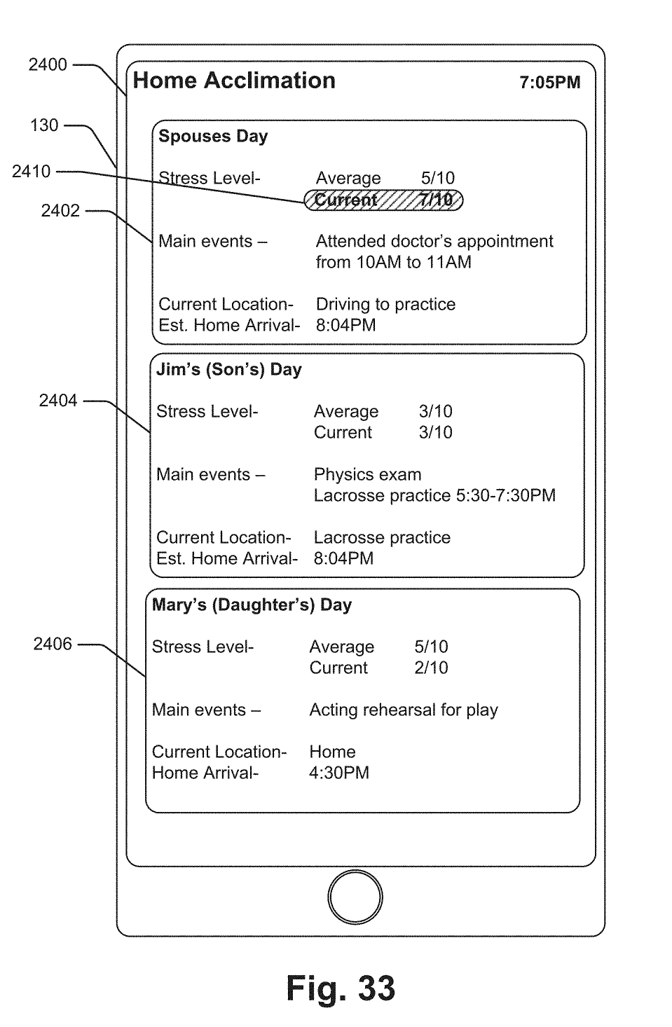

FIG. 33 illustrates a smart phone screen shot 2400 that may be presented to Barb while travelling home after a work day. As shown, the exemplary screen shot includes separate fields for each person in Barb's family including field 2402 for her spouse and field's 2404 and 2406 for her son and daughter, respectively. Each of the family member fields includes information related to that family members day and, more specifically, indicators of the user's average and current stress levels, main events that occurred during that member's day, current location and, if not home, an estimated time of arrival at home based on scheduled activities in that member's schedule, travel habits, traffic, weather, etc. For instance, in FIG. 33, Barb's spouse experienced an average stress level and is experiencing a current stress level (e.g., based on biometric or other measurements) of 5 and 7 out of 10, respectively, the spouse's main event that day was a doctor's appointment from 10 to 11 AM, the spouse is currently driving to a practice location and is estimated to be arriving home at 8:04 PM. User conditions out of the ordinary such as the 7/10 current stress level may be visually distinguished as shown at 2410 to make sure Barb's attention is called thereto.

In addition to helping Barb understand who will be home when Barb gets home and who will be arriving later, the information presented in FIG. 33 is also intended to help Barb understand what happened to family members during the day and to help her empathize with family members that may have had a difficult day. While simple user condition information is presented in FIG. 33, other and more complex information may be presented in other embodiments. The idea here is that other people's physical or mental conditions may be indicated, activities that may affect the other user's conditions may be presented and location information is presented automatically without requiring either the family members or Barb to seek that information.

In at least some cases it is contemplated that other types of user preferences may be selectable or adjustable by each system user. For instance, a user may have privacy preferences related to which other system users have any access to user location, condition, circumstances and schedule information. For example, Barb Blue may want her family to have full access to all of her information but may not want anyone affiliated with her employee to have any direct access to her physical or mental condition.

As another instance, a user may have privacy preferences related to how location, condition, circumstances and schedule information can be used by optimization algorithms and other system applications that are operating to provide services directly to her and/or how that information can be used by optimization algorithms and other system applications that are operating to provide services to other system users. For example, a user may dial up or down the affect that her instantaneous stress level should have on optimization algorithms for that user or for other users where the algorithms take into account her conditions.

As another instance, a user may have a preference as to how rapidly adaptable or learning optimization algorithms evolve or learn based on user activities within the system. For instance, the user may have a preference that the system automatically restrict activity schedule options based on prior scheduling choices only after the same choice is made repetitively over a sequence of 5 decisions instead of 3.

As still one other instance, a user may have a preference regarding how much the preferences of other users affects system suggestions to the user. Similarly, a user may have a preference regarding how much other user's schedules, circumstances, locations and conditions affect suggestions to the user. These types of preferences may be user specific or may apply to all other users, may be dependent on time or perhaps other factors. Regarding user specific preferences, for instance, Barb Blue may want her spouse's information regarding preferences, location, conditions and circumstances to fully affect how the system guides Barb while Barb is at home but to only have a minimal effect on guidance to Barb while Barb is located at one of her employer's facilities and may want her boss's information to fully affect how the system guides her while at one of the employer's facilities and to have a lesser affect when Barb is not located at one of those facilities. While not shown it is contemplated that user preference screens akin to those described above with respect to FIGS. 6 through 10 may be presented to a user during a commissioning process or at other system use times when advantageous that will enable the user to set any of these other user preferences related to which data will be exposed to other system users and how the system will utilize various types of user data and other user data to provide services to a specific user as well as to other system users.

While the invention may be susceptible to various modifications and alternative forms, specific embodiments have been shown by way of example in the drawings and have been described in detail herein. However, it should be understood that the invention is not intended to be limited to the particular forms disclosed. Thus, the invention is to cover all modifications, equivalents, and alternatives falling within the spirit and scope of the invention as defined by the following appended claims.

To apprise the public of the scope of this invention, the following claims are made:

1. A method for helping a user optimize time use during transition times between scheduled activities, the method comprising the steps of:
maintaining a schedule database including at least first and second consecutive scheduled activities for a first system user with a transition period between the first and second consecutive scheduled activities;
during the transition period subsequent to the first activity and prior to commencement of the second activity, detecting occurrence of at least a first trigger set of circumstances;
upon occurrence of the at least a first trigger set of circumstances, automatically identifying a secondary activities set including at least first and second secondary activities that may be initiated during the transition period;
presenting the secondary activities set to the first user via at least one affordance;
receiving selection from the user of at least one of the secondary activities from the activities set; and
facilitating the selected secondary activity via at least one affordance.

2. The method of claim 1 wherein the at least one affordance that presents the secondary activities set and the at least one affordance that facilitates the selected secondary activity include the same affordances.

3. The method of claim 1 wherein selected activity can be facilitated via different affordance sets, the method further including the steps of, during the transition period, periodically identifying affordances within the vicinity of the user, identifying an optimal affordance set for facilitating the selected activity and, upon the optimal affordance set changing, switching from a current affordance set to the optimal affordance set to continue facilitating the selected activity.

4. The method of claim 3 wherein the step of switching includes automatically switching from the current affordance set to the optimal affordance set.

5. The method of claim 3 wherein the step of switching includes presenting an option to the user to switch from the current affordance set to the optimal affordance set and, upon the user selecting the option to switch, switching from the current set to the optimal set.

6. The method of claim 1 further including maintaining content associated with at least the first activity wherein at least one of the secondary activities includes options for handling the first activity content.

7. The method of claim 6 wherein options for handling the first activity content include accessing the first activity content for review.

8. The method of claim 7 further including maintaining content associated with at least the second activity wherein at least one of the secondary activities includes options for handling the second activity content.

9. The method of claim 8 wherein options for handling the second activity content include accessing the second activity content.

10. The method of claim 8 wherein the options for handling the first activity content and for handling the second activity content further include forwarding the content to another system user, deleting the content and saving the content to a database for subsequent access.

11. The method of claim 1 wherein at least one of the circumstances in the trigger set is related to duration of the transition period.

12. The method of claim 1 wherein at least one of a second user participated in the first activity or a second user is anticipated to participate in the second activity and wherein a possible secondary activity includes contacting the second user.

13. The method of claim 12 wherein another trigger set circumstance includes availability of the second user to participate in a communication.

14. The method of claim 13 further including tracking second user location and wherein second user availability is determined at least in part on instantaneous location of the second user.

15. The method of claim 1 wherein the at least one affordance used to facilitate the secondary activity includes a portable computing device.

16. The method of claim 1 further including automatically monitoring information related to a second system user wherein the second activity involves the second system user, at least one of the secondary activities including consideration of the second system user information by the first user.

17. The method of claim 16 wherein the step of monitoring includes monitoring at least one of the second system user's schedule and a biometric condition associated with the second system user.

18. The method of claim 1 wherein at least one of the trigger set circumstances is related to at least one of the physical and cognitive condition of the first user, the method further including sensing biometric conditions of the first user and using that information to discern at least one of a physical or a cognitive condition of the first user.

19. The method of claim 1 wherein at least one of the trigger set circumstances is related to user preferences specifying times when specific activities should be facilitated, at least one of the trigger set circumstances is related to a sensed user physical condition, at least one of the trigger set circumstances is related to a time zone associated with where a system user is located and at least one of the trigger set circumstances is related to existence of additional content associated with at least one of the first and second activities.

20. A method for helping a user optimize time use during transition times between scheduled activities, the method comprising the steps of:
maintaining a schedule database including at least first and second consecutive scheduled activities for a first system user with a transition period between the first and second consecutive scheduled activities;
detecting at least one physical or cognitive first user condition;
during the transition period subsequent to the first activity and prior to commencement of the second activity, automatically identifying, based at least in part on the at least one physical or cognitive first user condition, a secondary activities set including at least first and second secondary activities that may be initiated during the transition period;
presenting the secondary activities set to the first user via at least one affordance;
receiving selection from the user of at least one of the secondary activities from the activities set; and
facilitating the selected secondary activity via at least one affordance.

21. A method for helping a user optimize time use during transition times between scheduled activities, the method comprising the steps of:
maintaining a schedule database including at least first and second consecutive scheduled activities for a first system user with a transition period between the first and second consecutive scheduled activities;
detecting at least one physical or cognitive first user condition;
during the transition period subsequent to the first activity and prior to commencement of the second activity, automatically identifying, based at least in part on the at least one physical or cognitive first user condition as well as the duration of the transition period, a secondary activities set including at least first and second secondary activities that may be initiated during the transition period;
presenting the secondary activities set to the first user via at least one affordance;
receiving selection from the user of at least one of the secondary activities from the activities set; and
facilitating the selected secondary activity via at least one affordance.
